(19) United States
(12) Patent Application Publication
(10) Pub. No.: US 2024/0428539 A1
(43) Pub. Date: Dec. 26, 2024

(54) Devices, Methods, and Graphical User Interfaces for Selectively Accessing System Functions and Adjusting Settings of Computer Systems While Interacting with Three-Dimensional Environments

(71) Applicant: Apple Inc., Cupertino, CA (US)

(72) Inventors: Matan Stauber, San Francisco, CA (US); Israel Pastrana Vicente, Spring, TX (US); Stephen O. Lemay, Palo Alto, CA (US); William A. Sorrentino, III, Mill Valley, CA (US); Zoey C. Taylor, San Francisco, CA (US); Kristi E. Bauerly, Los Altos, CA (US); Daniel M. Golden, Sunnyvale, CA (US); Christopher B. Fleizach, Gilroy, CA (US); Evgenii Krivoruchko, San Francisco, CA (US); Amy E. DeDonato, San Francisco, CA (US)

(21) Appl. No.: 18/677,532

(22) Filed: May 29, 2024

Related U.S. Application Data
(60) Provisional application No. 63/549,984, filed on Feb. 5, 2024.
(60) Provisional application No. 63/541,753, filed on Sep. 29, 2023.
(60) Provisional application No. 63/522,073, filed on Jun. 20, 2023.
(60) Provisional application No. 63/470,969, filed on Jun. 4, 2023.

(51) Int. Cl. G06T 19/20

(52) U.S. Cl. CPC G06T 19/20; G06T 2219/2004; G06T 2219/2016

(57) ABSTRACT

While a first view of a three-dimensional environment is visible, a computer system detects a first input meeting selection criteria. If, when the first input was detected, a user was directing attention to a first portion of the first view that has a spatial relationship to a viewport through which the three-dimensional environment is visible, the computer system displays a user interface object including affordances for accessing functions of the computer system; otherwise, the computer system forgoes displaying the user interface object. While a different view of the three-dimensional environment is visible, the computer system detects a second input meeting the selection criteria. If, when the second input was detected, the user was directing attention to a second portion of the different view that has the same spatial relationship to the viewport, the computer system displays the user interface object; otherwise, the computer system forgoes displaying the user interface object.

### RELATED APPLICATIONS

This application claims priority to U.S. Provisional Patent Application No. 63/549,984, filed Feb. 5, 2024, U.S. Provisional Patent Application No. 63/541,753, filed Sep. 29, 2023, U.S. Provisional Patent Application No. 63/522,073, filed Jun. 20, 2023, and U.S. Provisional Patent Application No. 63/470,969, filed Jun. 4, 2023, each of which is hereby incorporated by reference in its entirety.

### TECHNICAL FIELD

The present disclosure relates generally to computer systems that are in communication with a display generation component and one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

As hardware technology related to virtual and augment reality continues to improve, virtual and augmented experiences delivered via such hardware technologies have become increasingly more immersive and/or realistic. Methods and user interfaces for interacting with and/or adjusting virtual environments, however, are often cumbersome, unintuitive, or inaccurate. For example, some current approaches involve accessing commonly used functions (e.g., brightness, volume, virtual assistants, notifications, and/or navigational controls) via a hardware control (e.g., a physical button) or a permanently displayed menu. Such approaches can be tedious (e.g., requiring multiple user inputs to access the desired functions) and/or error prone (e.g., due to the requiring a series of user inputs, which may not be correctly performed and/or accurately detected, resulting in unexpected outcomes which then require another series of user inputs to either undo/reverse or to access to achieve the actual desired outcome). Such approaches often have a steep learning curve (e.g., regarding the necessary inputs, or combination of inputs, needed to access the desired functions), while providing little feedback or instruction to a user of the hardware device.

Accordingly, there is a need for computer systems with improved methods and interfaces for providing computer-generated experiences to users, for accessing functions and/or adjusting settings of the computer systems in efficient and intuitive ways, and for providing improved feedback and/or instruction regarding user interactions with the computer systems. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for accessing system functions while interacting with a three-dimensional environment. Such methods and interfaces may complement or replace conventional methods for accessing system functions while interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In accordance with some embodiments, a method is performed at a computer system that is in communication with a display generation component and one or more input devices. The method includes, while a first view of a three-dimensional environment is visible, via the display generation component, from a first viewpoint, detecting a first user input that meets selection criteria. The method includes, in response to detecting the first user input that meets the selection criteria: in accordance with a determination that an attention of a user was directed to a first portion of the first view of the three-dimensional environment that has a first spatial relationship to a viewport through which the three-dimensional environment is visible, at a time when the first user input was detected, displaying, in the first view of the three-dimensional environment, a first user interface object that includes one or more affordances for accessing a set of functions of the computer system; and in accordance with a determination that the attention of the user was not directed to the first portion of the first view of the three-dimensional environment at the time when the first user input was detected, forgoing displaying the first user interface object in the first view of the three-dimensional environment. The method includes, while a second view of the three-dimensional environment is visible, via the display generation component, from a second viewpoint, wherein the second view of the three-dimensional environment is different from the first view of the three-dimensional environment and the second viewpoint is different from the first viewpoint, detecting a second user input that meets the selection criteria. The method includes, in response to detecting the second user input that meets the selection criteria: in accordance with a determination that the attention of the user was directed to a second portion of the second view of the three-dimensional environment that has the first spatial relationship to the viewport through which the three-dimensional environment is visible, at a time when the second user input was detected, displaying the first user interface object that includes the one or more affordances for accessing the set of functions of the computer system in the second view of the three-dimensional environment; and in accordance with a determination that the attention of the user was not directed to the second portion of the second view of the three-dimensional environment at the time when the second user input was detected, forgoing displaying the first user interface object in the second view of the three-dimensional environment.

In accordance with some embodiments, a method is performed at a computer system that is in communication with a first display generation component and one or more input devices. The method includes, while a respective view of a three-dimensional environment is visible, via the first display generation component, with a virtual environment corresponding to the three-dimensional environment having a first level of immersion of a plurality of levels of immersion, detecting, via the one or more input devices, a start of a first user input that meets adjustment criteria. The method includes, in response to detecting the start of the first user input that meets the adjustment criteria: in accordance with a determination that the computer system was generating audio outputs at a time when the start of the first user input was detected, adjusting a first audio output parameter for the audio outputs in accordance with the first user input, while the respective view of the three-dimensional environment continues to be visible, via the first display generation component, with the virtual environment corresponding to the three-dimensional environment maintained at the first level of immersion of a plurality of levels of immersion; and in accordance with a determination that the computer system was not generating audio outputs at the time when the start of the first user input was detected, adjusting a current level of immersion of the virtual environment in the three-dimensional environment from the first level of immersion to a second level of immersion of the plurality of levels of immersion that is different from the first level of immersion, in accordance with the first user input.

In accordance with some embodiments, a method is performed at a computer system that is in communication with a first display generation component and one or more input devices. The method includes, detecting, via the one or more input devices, a start of a first user input that meets adjustment criteria. The method includes, in response to detecting the start of the first user input that meets the adjustment criteria: in accordance with a determination that first criteria are met, adjusting a first parameter of the computer system in accordance with one or more first characteristic values of the first user input; and in accordance with a determination that second criteria different from the first criteria are met, adjusting a second parameter of the computer system, different from the first parameter of the computer system, in accordance with the one or more first characteristic values of the first user input.

In accordance with some embodiments, a method is performed at a computer system that is in communication with a first display generation component and one or more input devices. The method includes, while a respective view of an environment is visible, via the display generation component, detecting, via the rotatable input device, a first user input of a first type, and in response to detecting the first user input of the first type, displaying a menu that includes a plurality of options for adjusting settings of the computer system, and selecting a first option of the plurality of options for adjusting settings of the computer system. The method includes, while displaying the menu that includes the plurality of options for adjusting settings of the computer system, detecting, via the rotatable input device, a second user input of a second type, wherein the second type is different from the first type, and in response to detecting the second user input of the second type, selecting a second option, different from the first option, of the plurality of options for adjusting settings of the computer system.

In accordance with some embodiments, a method is performed at a computer system that is in communication with a first display generation component and one or more input devices. The method includes, while a first view of a three-dimensional environment is visible, via the display generation component, detecting, via the one or more input devices, a first user input. The method includes, in response to detecting the first user input: in accordance with a determination that attention of a user is directed to a first portion of a viewport into the three-dimensional environment during the first user input and that foreground content of the first view of the three-dimensional environment is not within the first portion of the viewport into the three-dimensional environment, displaying an indication of a system user interface; and in accordance with a determination that the attention of the user is directed to the first portion of the viewport into the three-dimensional environment during the first user input and that foreground content of the first view of the three-dimensional environment is within the first portion of the viewport into the three-dimensional environment, forgoing displaying the indication of the system user interface.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7U illustrate example techniques for triggering display of user interface elements for accessing system functions of a computer system based on user attention directed to a particular view region, in accordance with some embodiments.

FIGS. 7V-7AL illustrate example techniques for conditionally displaying user interface elements for accessing settings of a computer system based on the location of foreground content, in accordance with some embodiments.

FIGS. 8A-8R illustrate example techniques for automatically adjusting a relevant setting of the computer system based on a state of the computer system when a user input is detected, in accordance with some embodiments.

FIGS. 8S-8AX illustrate example techniques for displaying a plurality of options for adjusting settings of a computer system and selecting between different options of the plurality of options in response to different types of inputs, in accordance with some embodiments.

FIGS. 9A-9B are a flow diagrams of methods of triggering display of user interface elements for system functions based on user attention to a particular view region, in accordance with various embodiments.

FIG. 10 is a flow diagram of methods of performing different operations in response to inputs based on current system context, in accordance with various embodiments.

FIG. 11 is a flow diagram of methods of displaying a menu that includes plurality of options for adjusting settings of a computer system and selecting between options of the plurality of options, in accordance with some embodiments.

FIG. 12 is a flow diagram of methods of conditionally displaying user interface elements for accessing settings of a computer system based on the location of foreground content, in accordance with some embodiments.

FIG. 13 is a flow diagram of methods of adjusting a first parameter or a second parameter, based on whether first or second criteria are met, based on a characteristic of a user input, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays (or forgoes displaying) a first user interface object that includes one or more affordance for accessing a set of functions of the computer system, depending on a location of a user's attention when a user input is detected. Conditionally displaying the first user interface object based on a location of the user's attention when the user input is detected, reduces the number of inputs needed to access system functions of the computer system without cluttering the user interface with additional displayed controls, user interfaces, and/or user interface objects (e.g., the first user interface object and/or a control for displaying the first user interface object, do not need to be permanently displayed in order to enable access to the system functions of the computer system).

In some embodiments, a computer system adjusts an audio output parameter or a level of immersion of the computer system, depending on whether or not the computer system was generating audio at a time when a user input is detected. Conditionally adjusting the audio output parameter, or the level of immersion, depending on whether or not the computer system was generating audio at the time when the user input was detected, automatically adjusts a contextually-relevant setting of the computer system without requiring additional user input (e.g., additional user inputs to find and/or select a relevant setting of the computer system for adjustment).

In some embodiments, a computer system detects a start of a first user input that meets adjustment criteria. If first criteria are met, the computer system adjusts a first parameter of the computer system in accordance with the first user input; and if second criteria are met, the computer system adjusts a second parameter of the computer system in accordance with the first user input. The first criteria and the second criteria are optionally based on context, current selection, and/or a default setting of the computer system.

In some embodiments, while a respective view of an environment is visible, the computer system detects, via a rotatable input device, a first user input of a first type. In response to detecting the first user input of the first type, the computer system displays a menu that includes options for adjusting settings of the computer system, and selecting a first option of the plurality of options. While displaying the menu, the computer system detects, via the rotatable input device, a second user input of a second type, and in response, selects a second option of the plurality of options for adjusting settings of the computer system.

In some embodiments, while a first view of a three-dimensional environment is visible, the computer system detects a first user input. In response to detecting the first user input: if the attention of the user is directed to a first portion of a viewport during the first user input and that foreground content of the first view of the three-dimensional environment is not within the first portion of the viewport, the computer system displays an indication of a system user interface; and if the attention of the user is directed to the first portion of the viewport during the first user input and that foreground content of the first view of the three-dimensional environment is within the first portion of the viewport, the computer system forgoes displaying the indication of the system user interface.

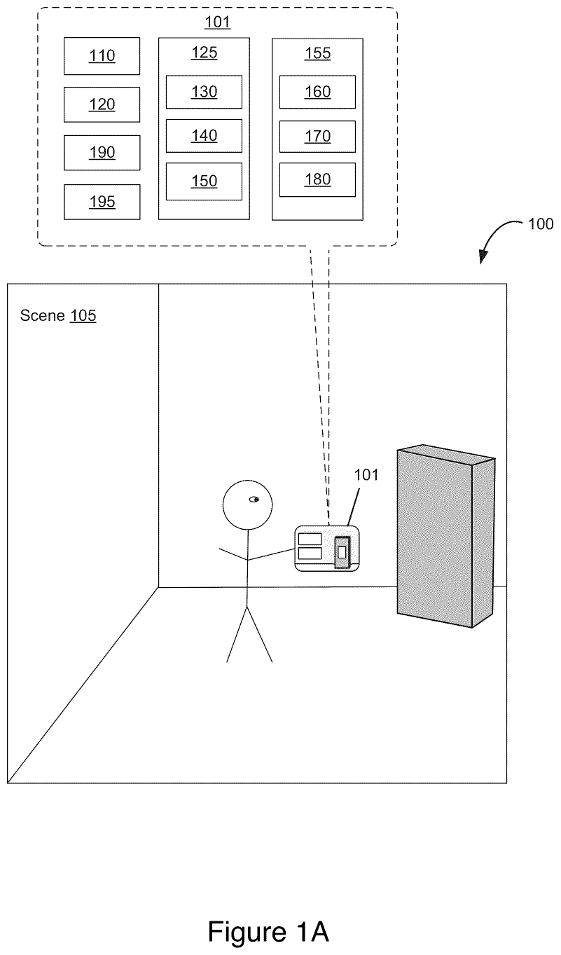

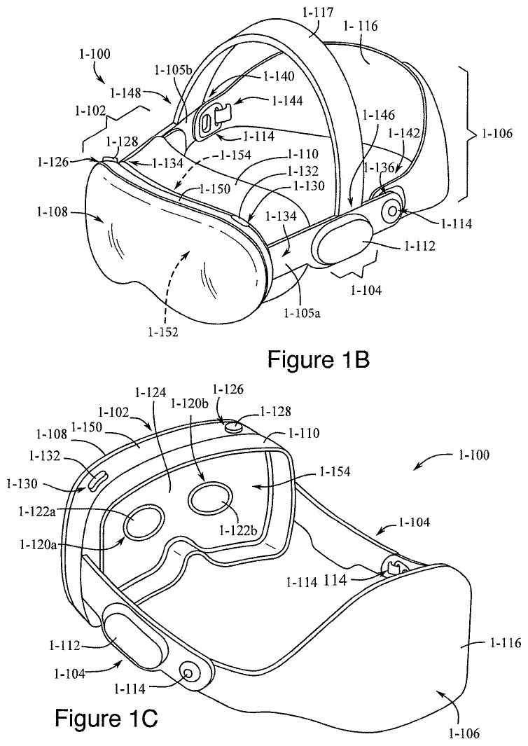

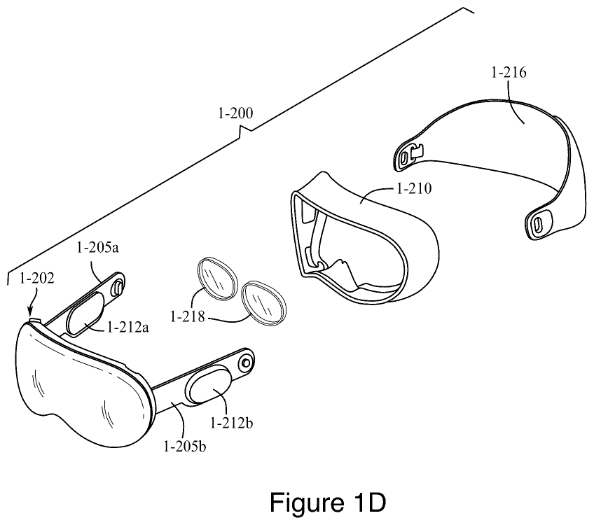

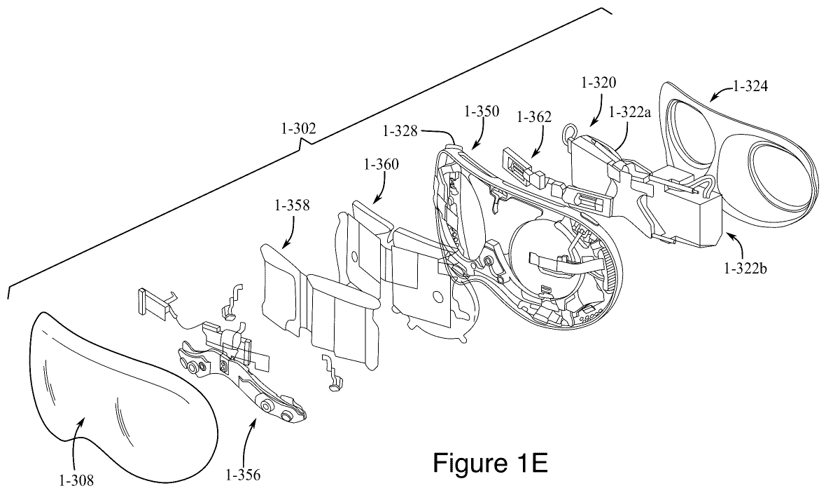

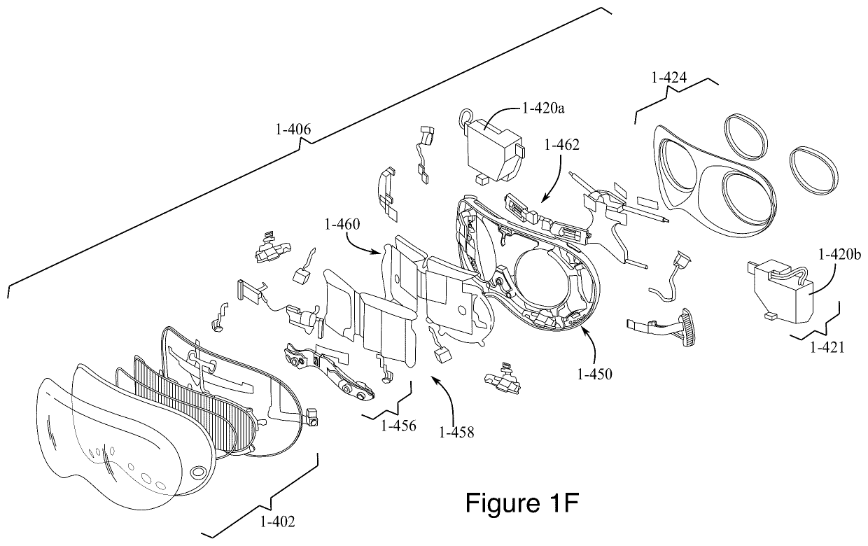

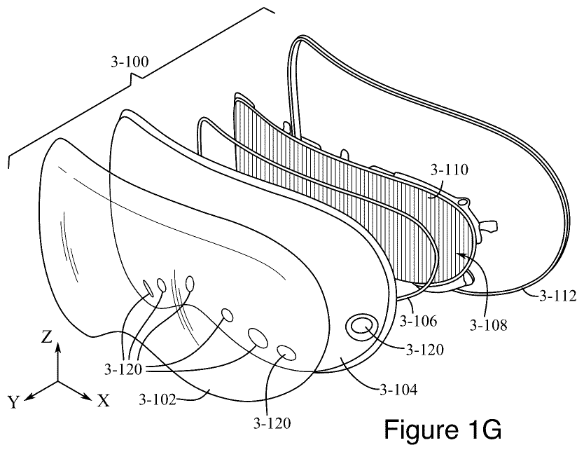

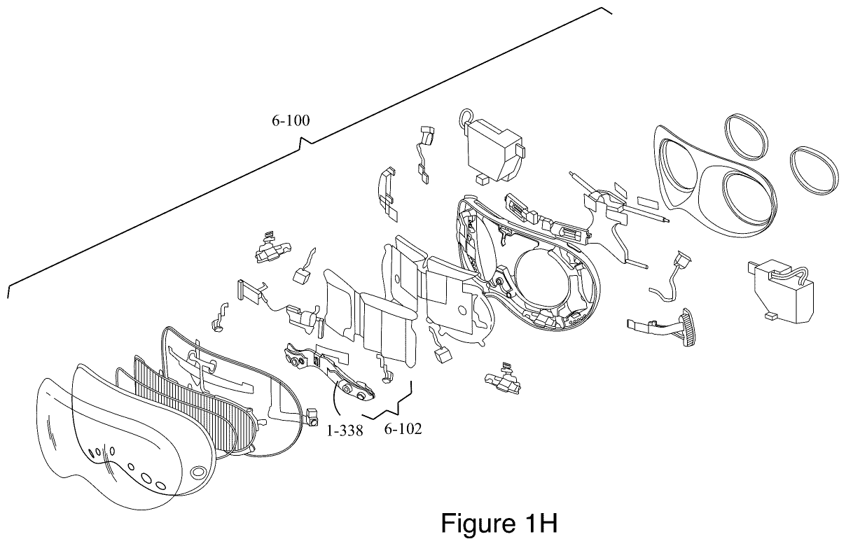

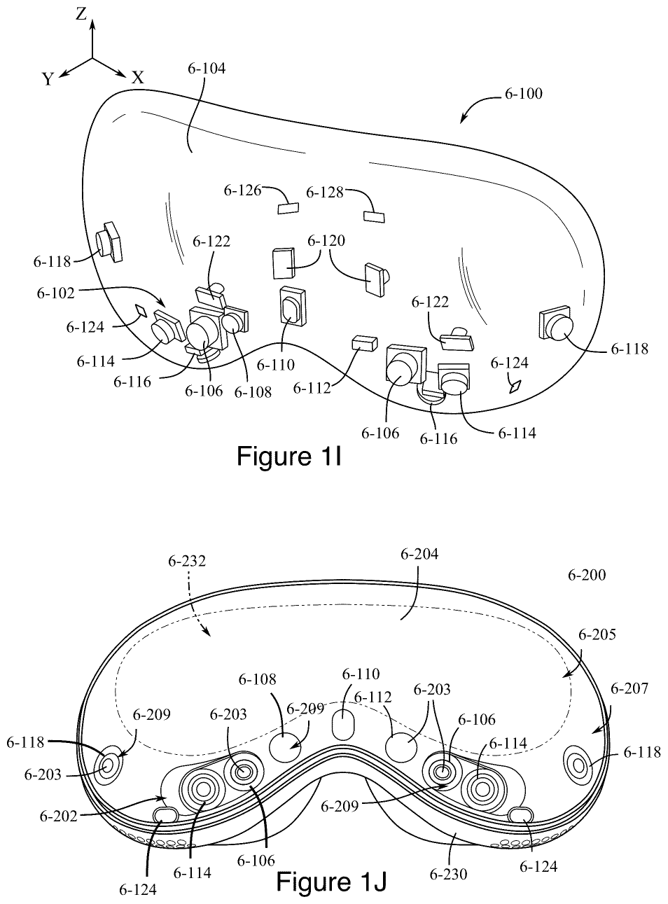

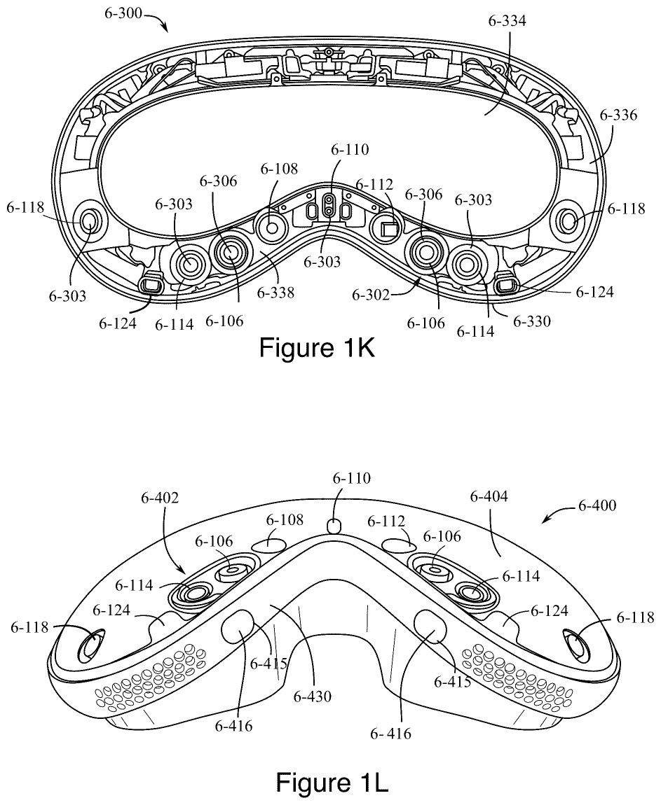

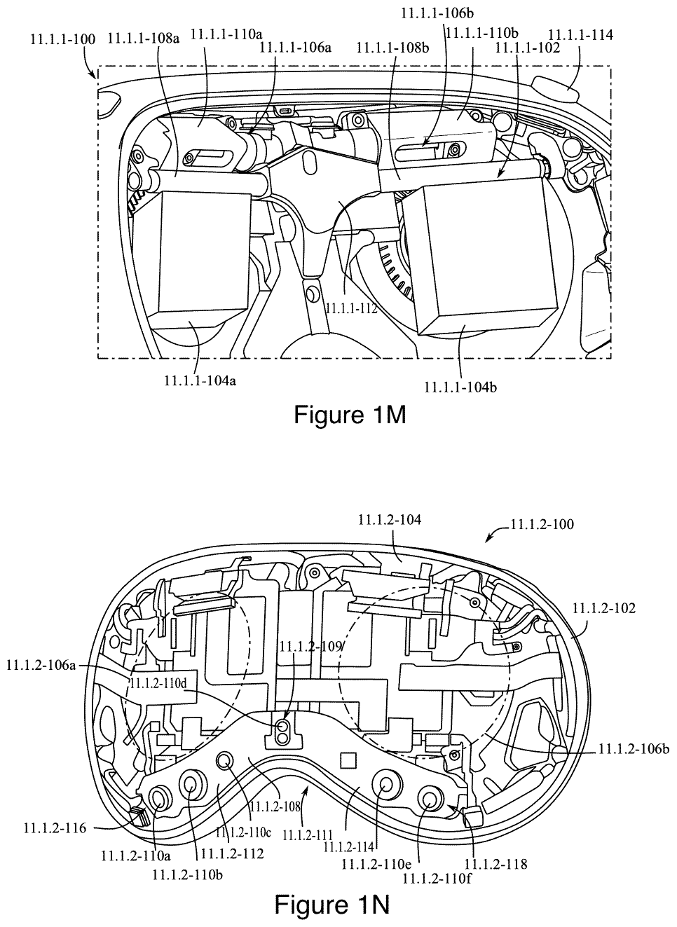

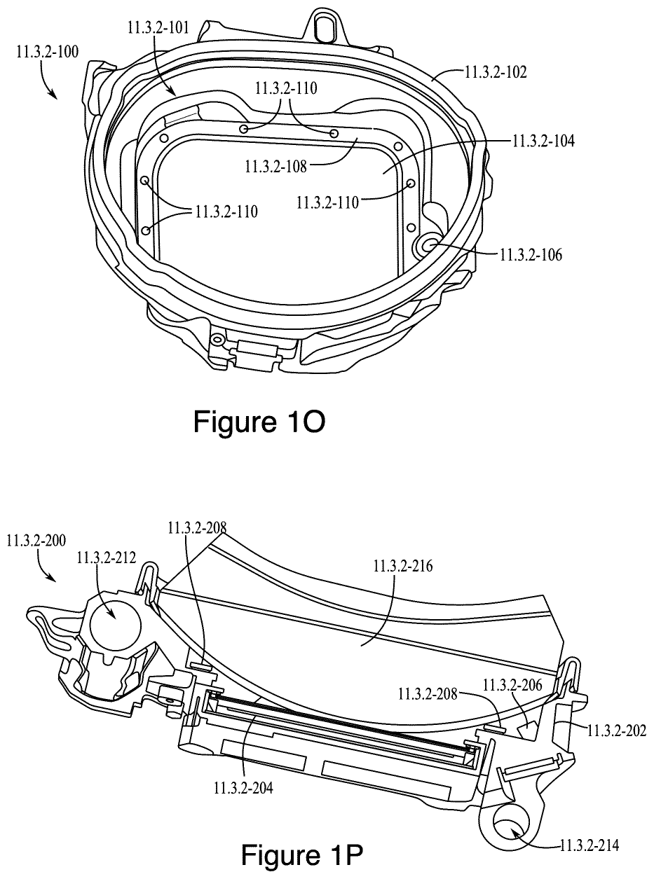

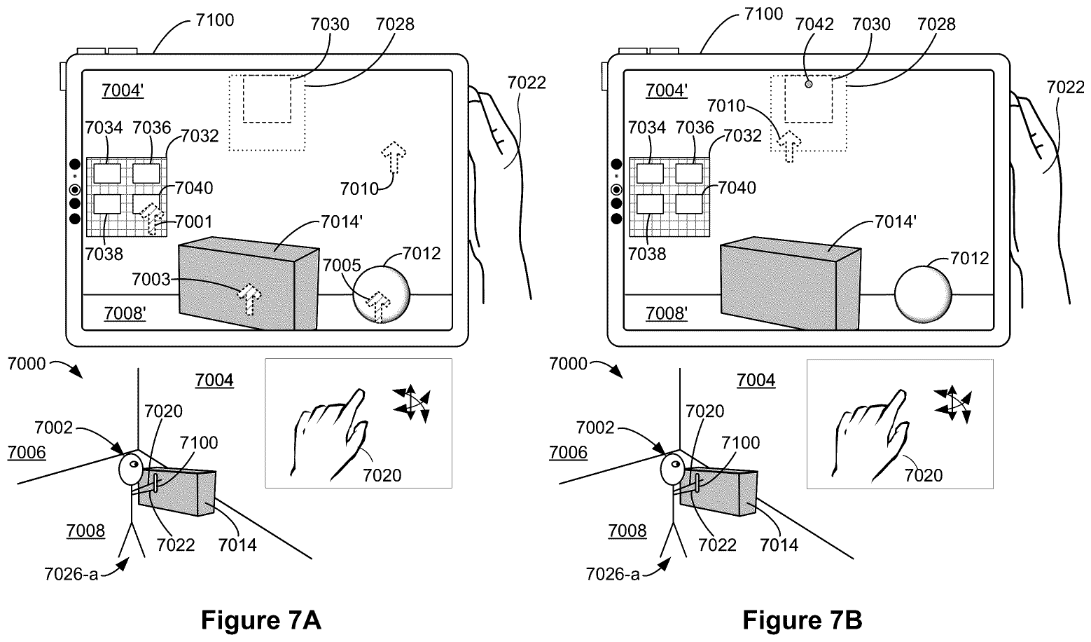

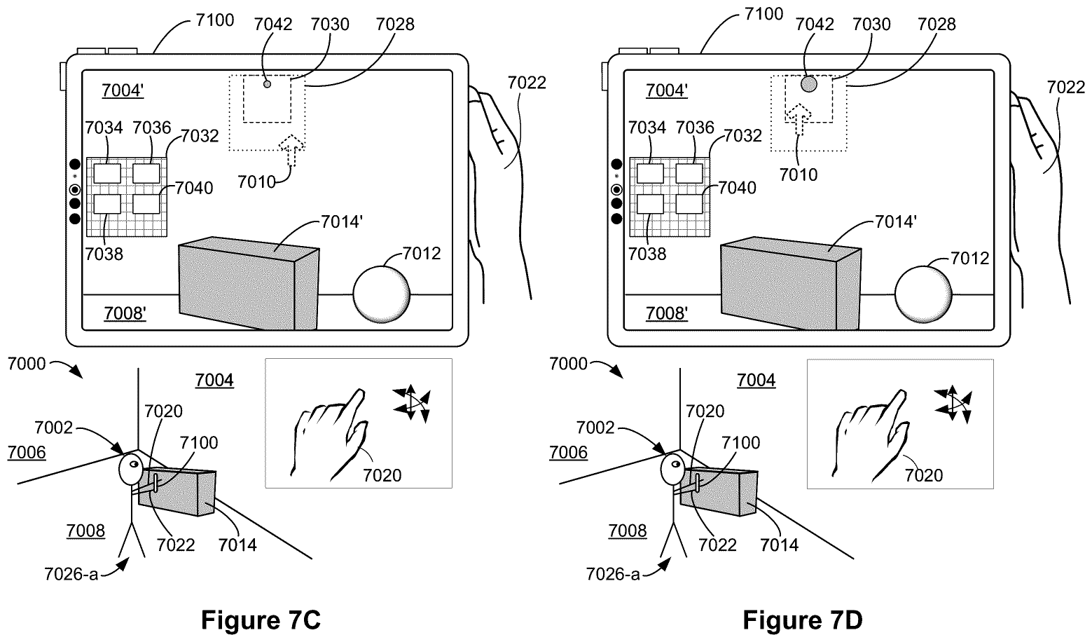

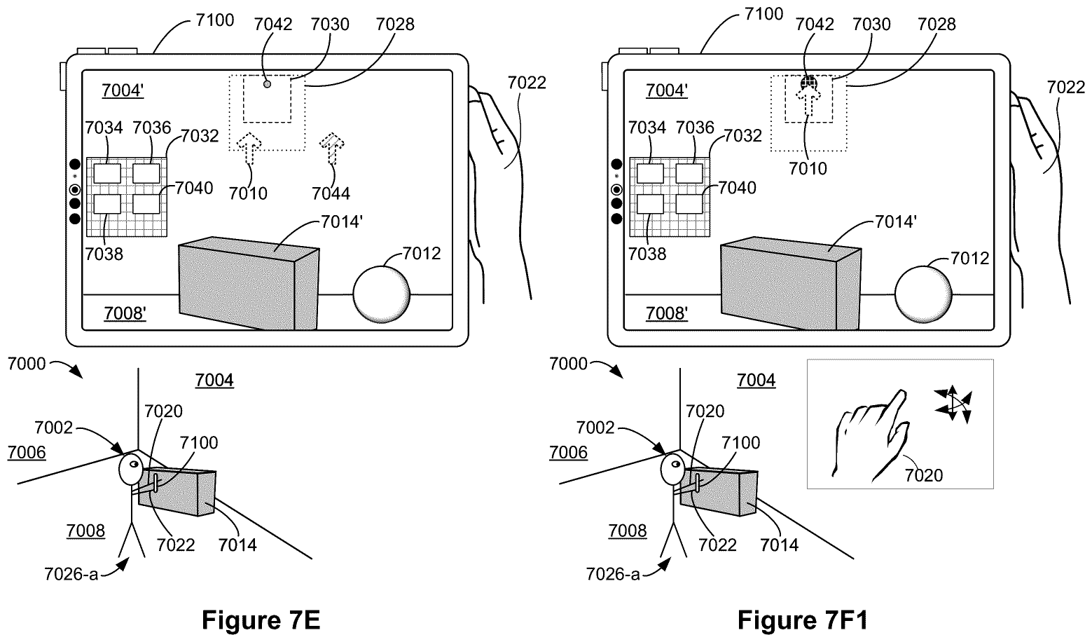

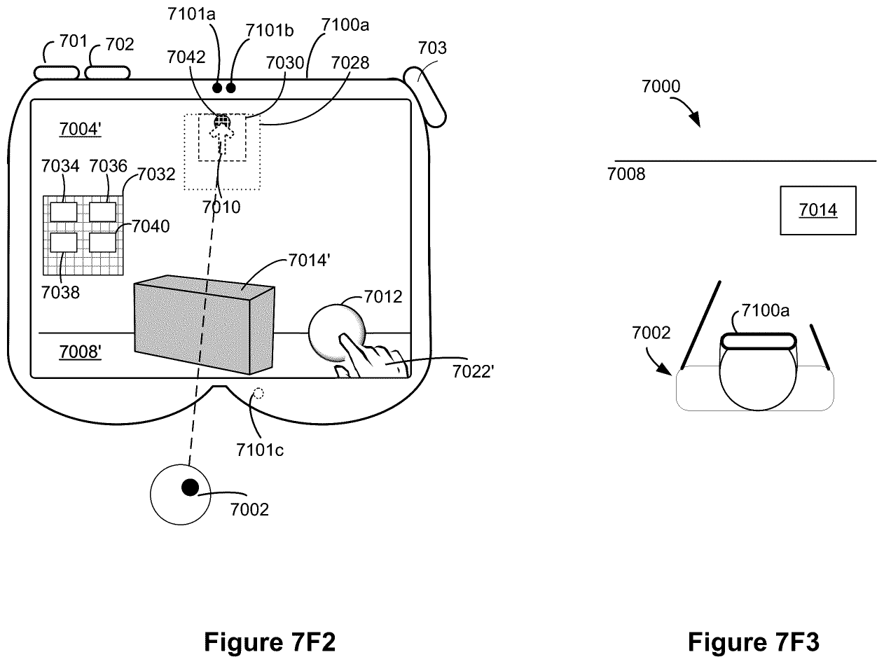

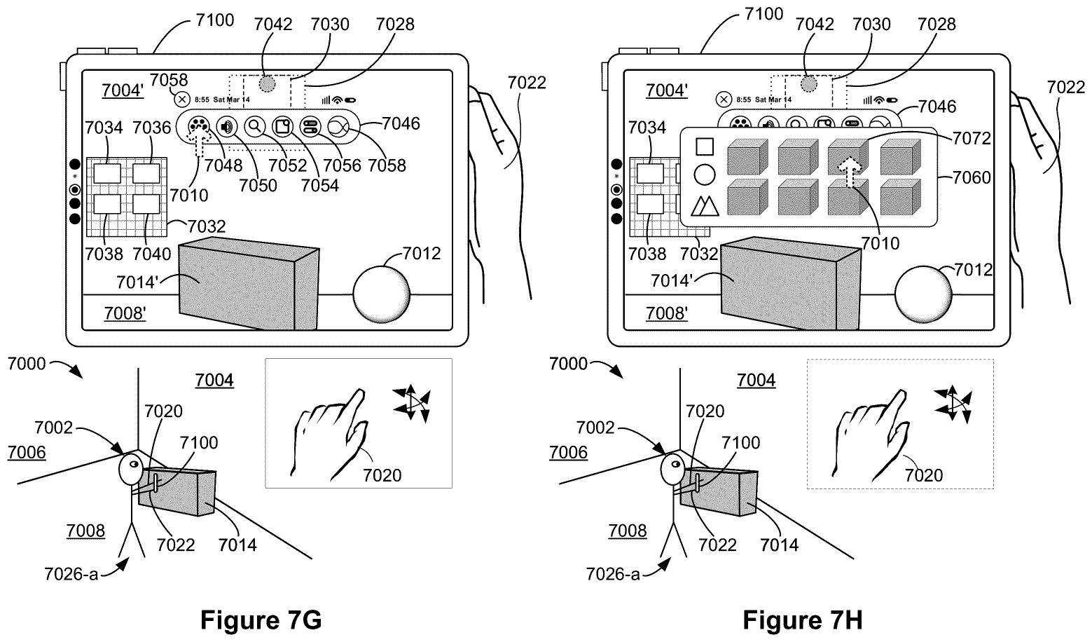

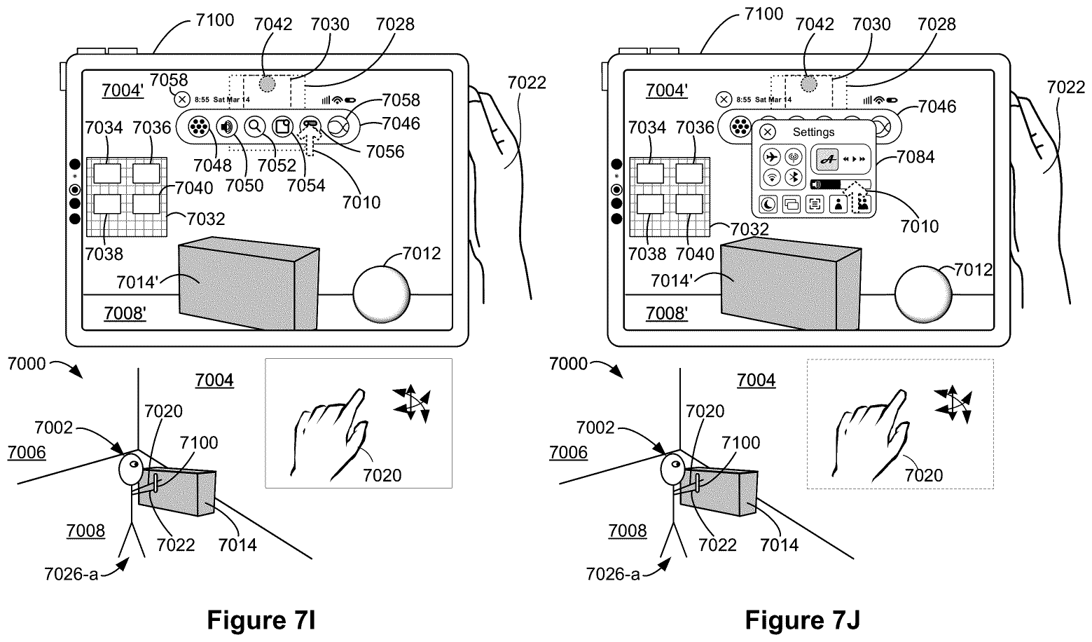

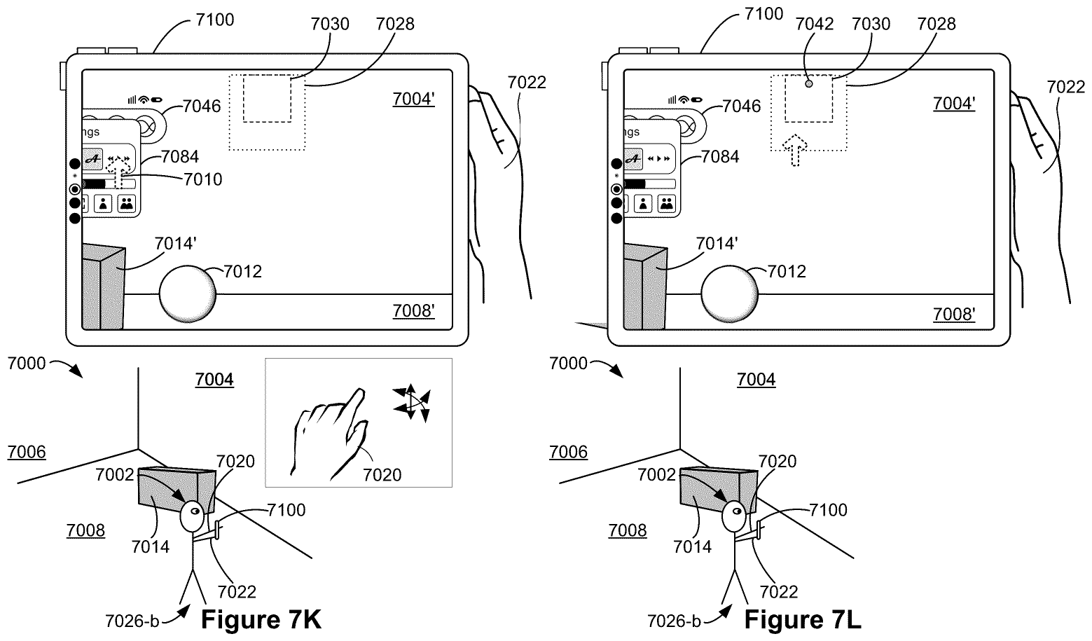

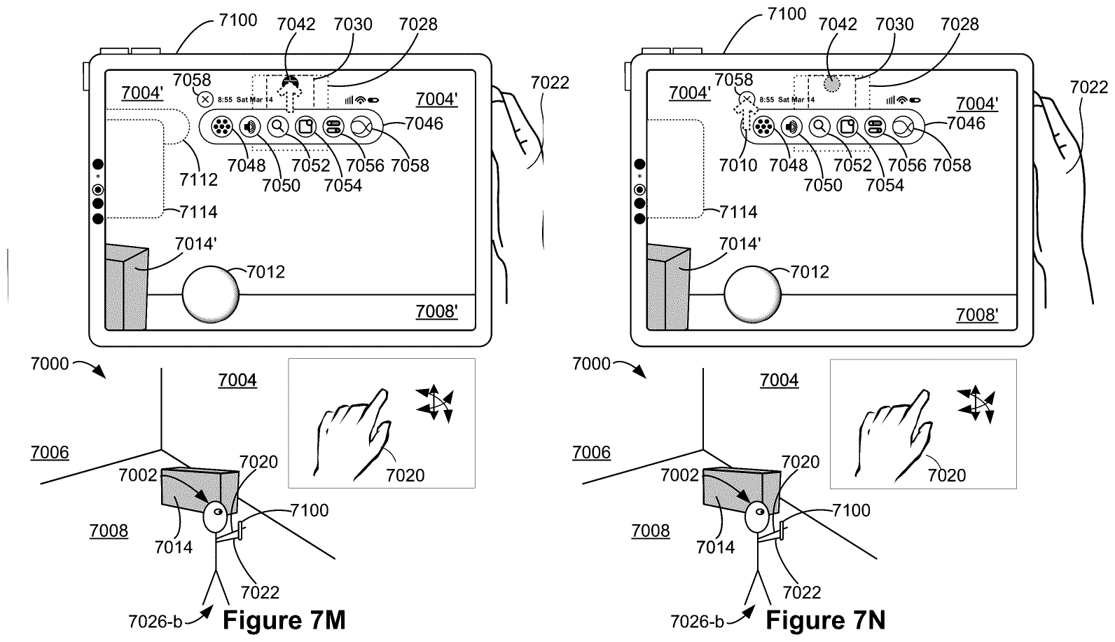

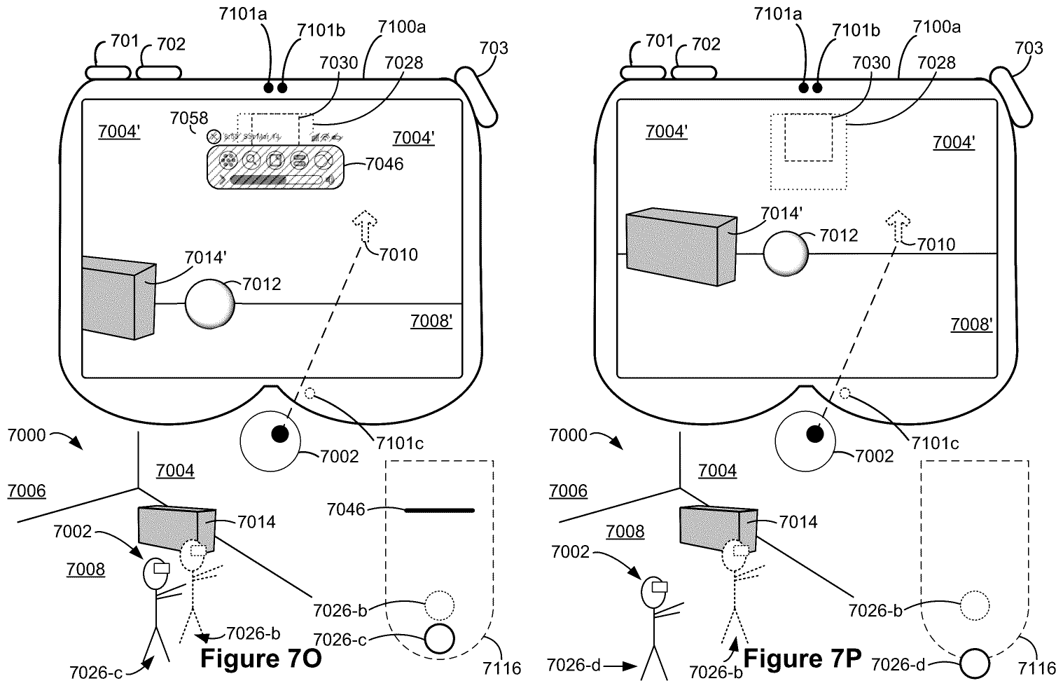

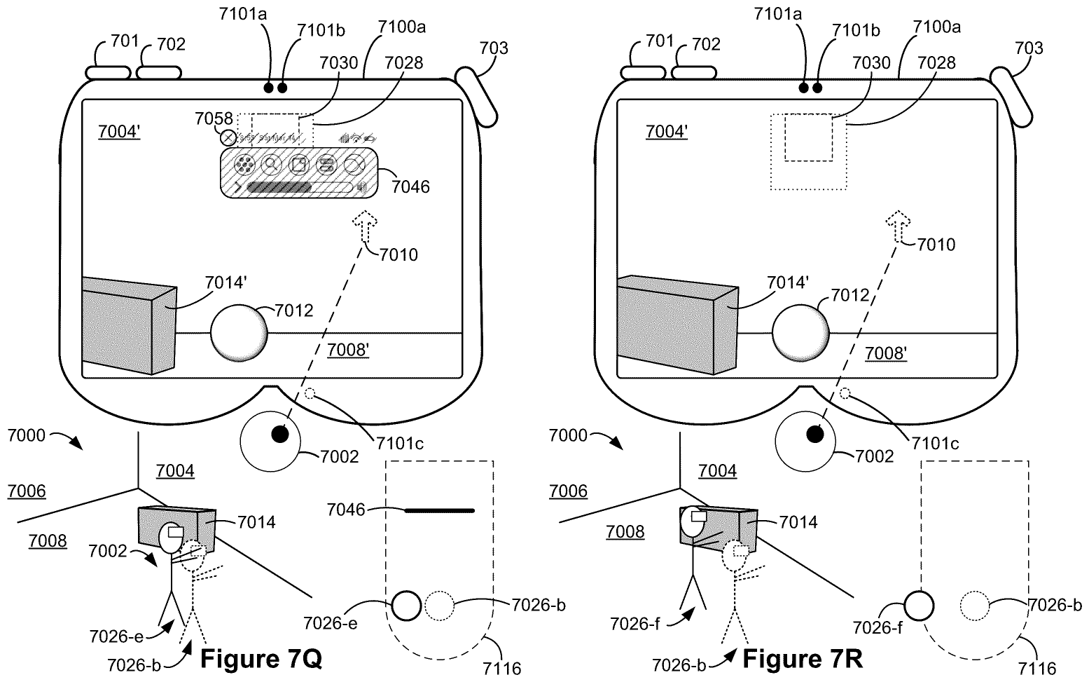

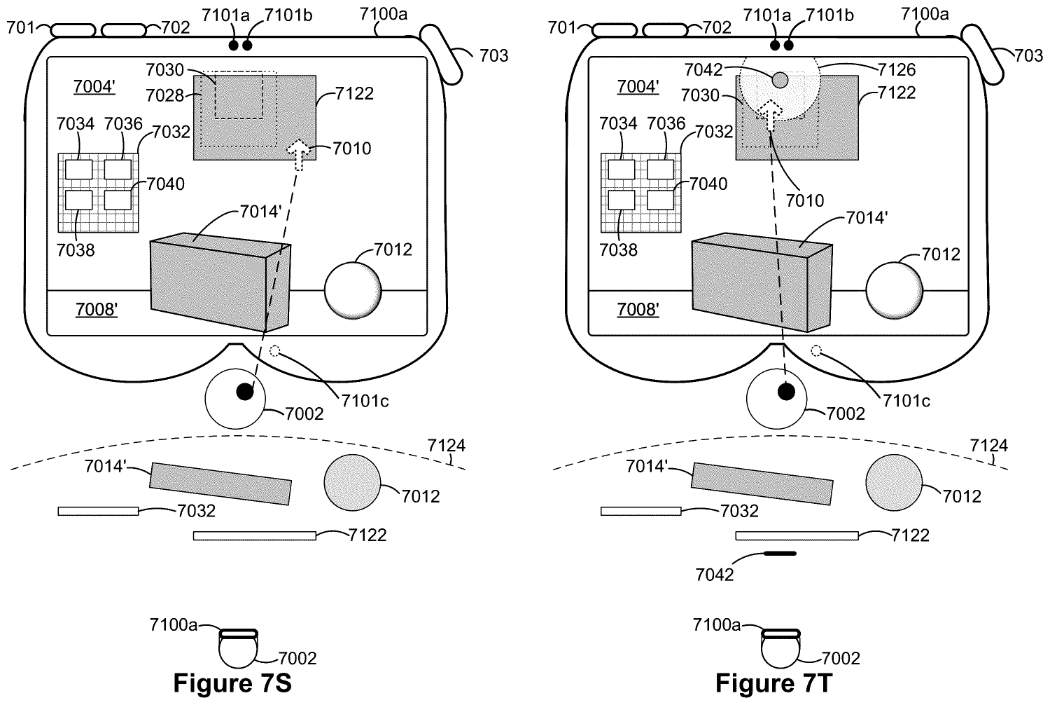

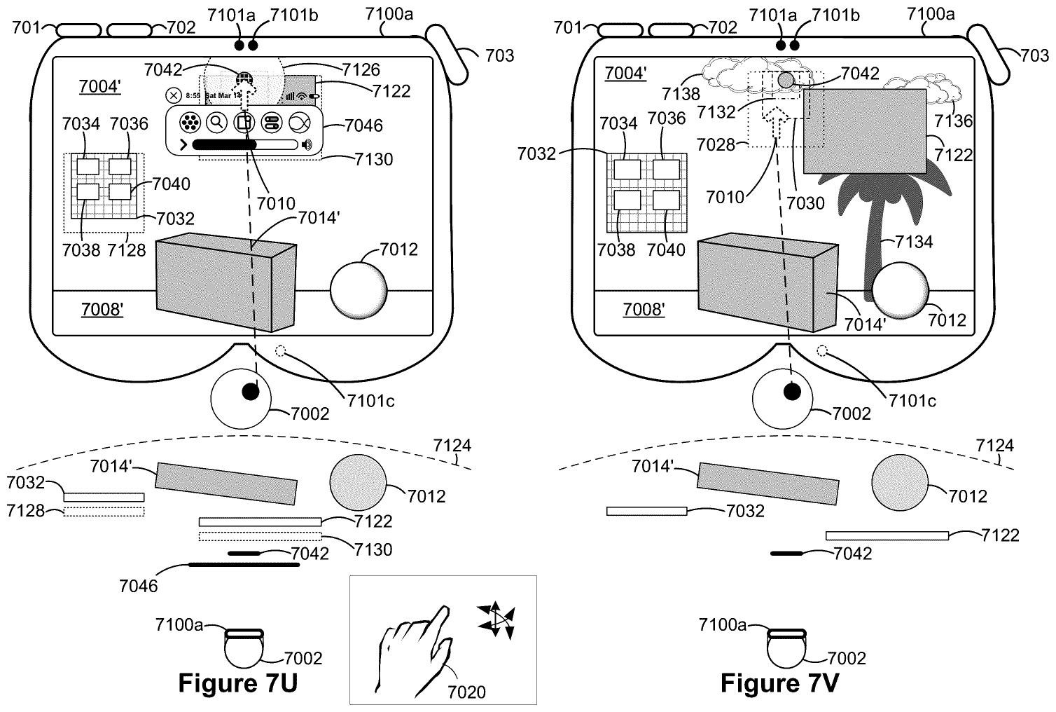

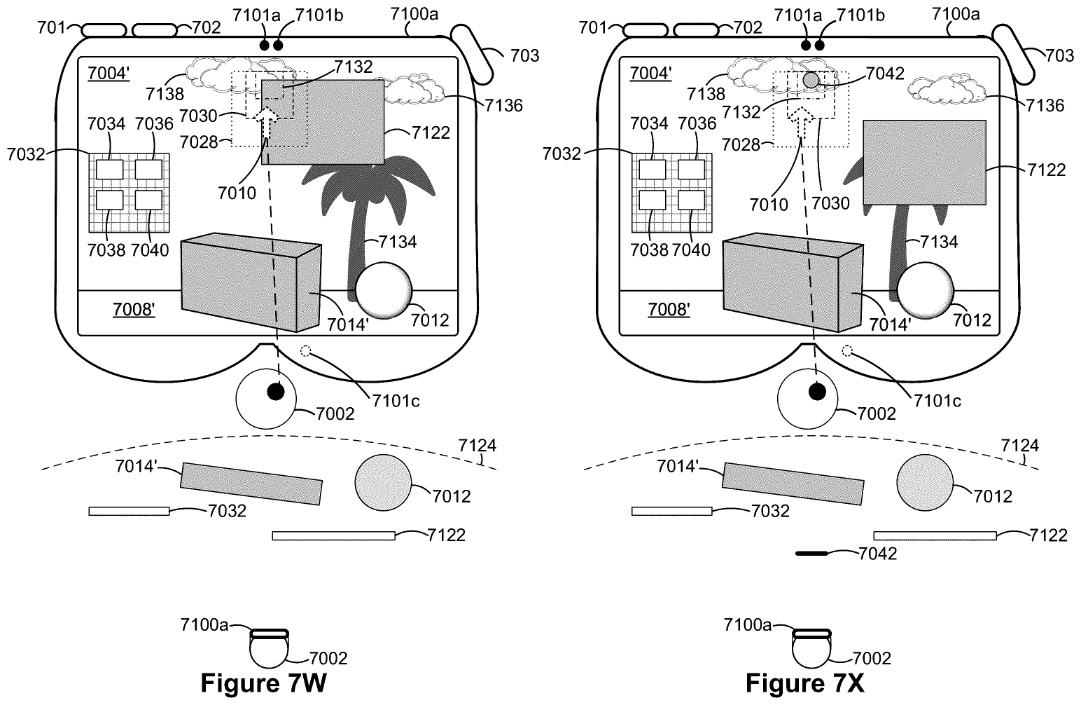

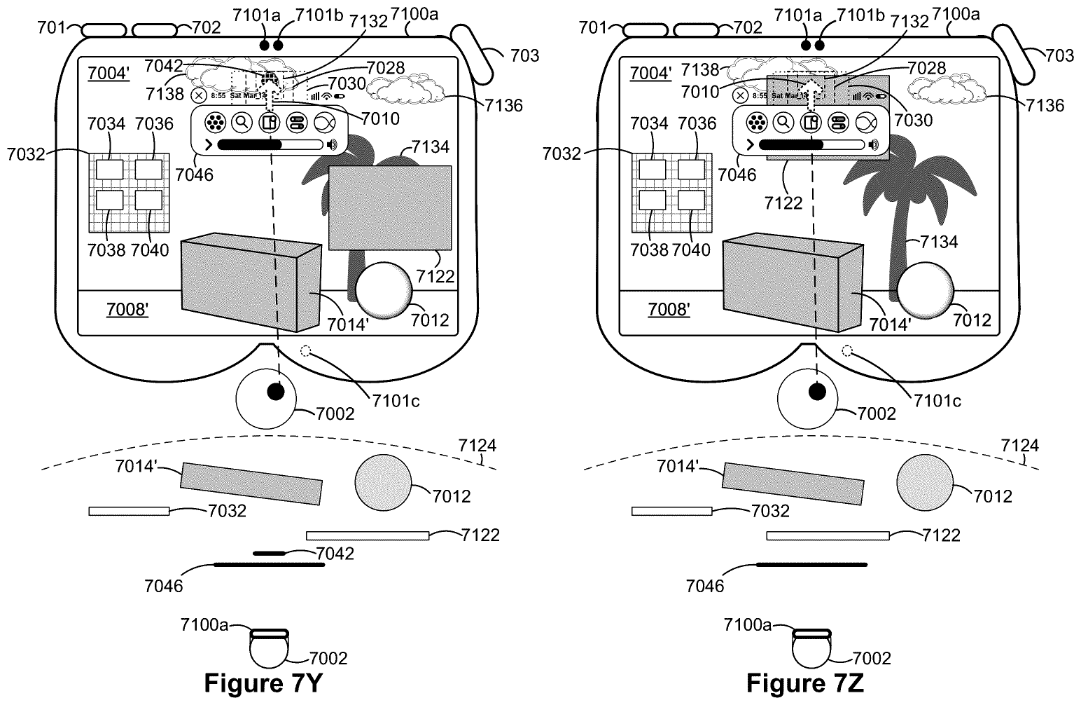

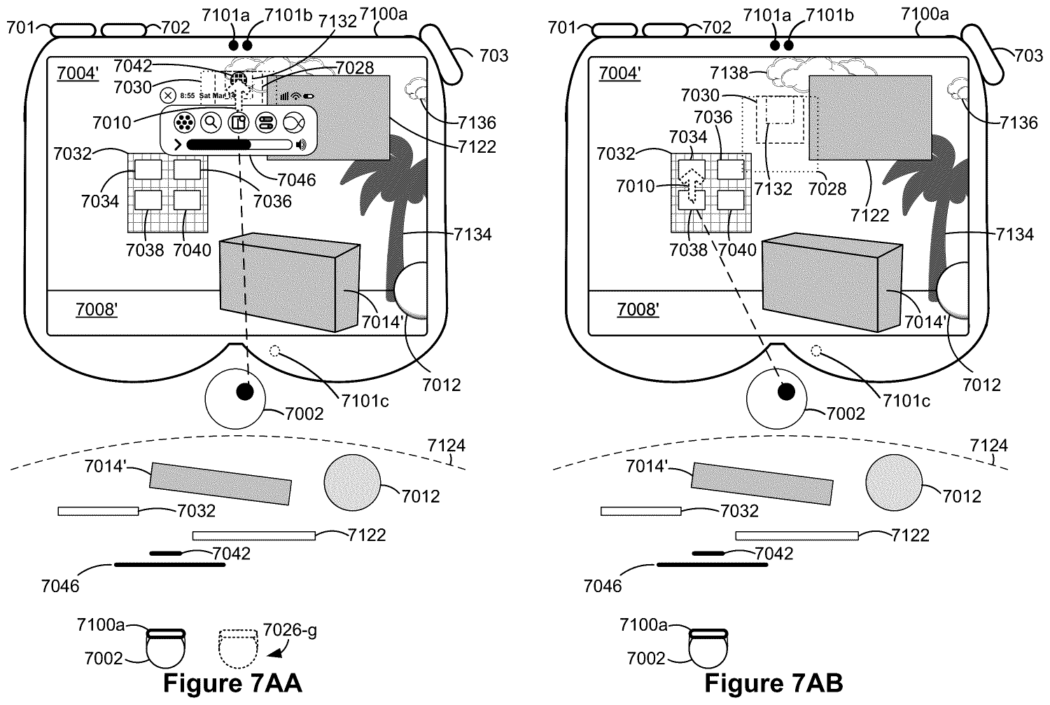

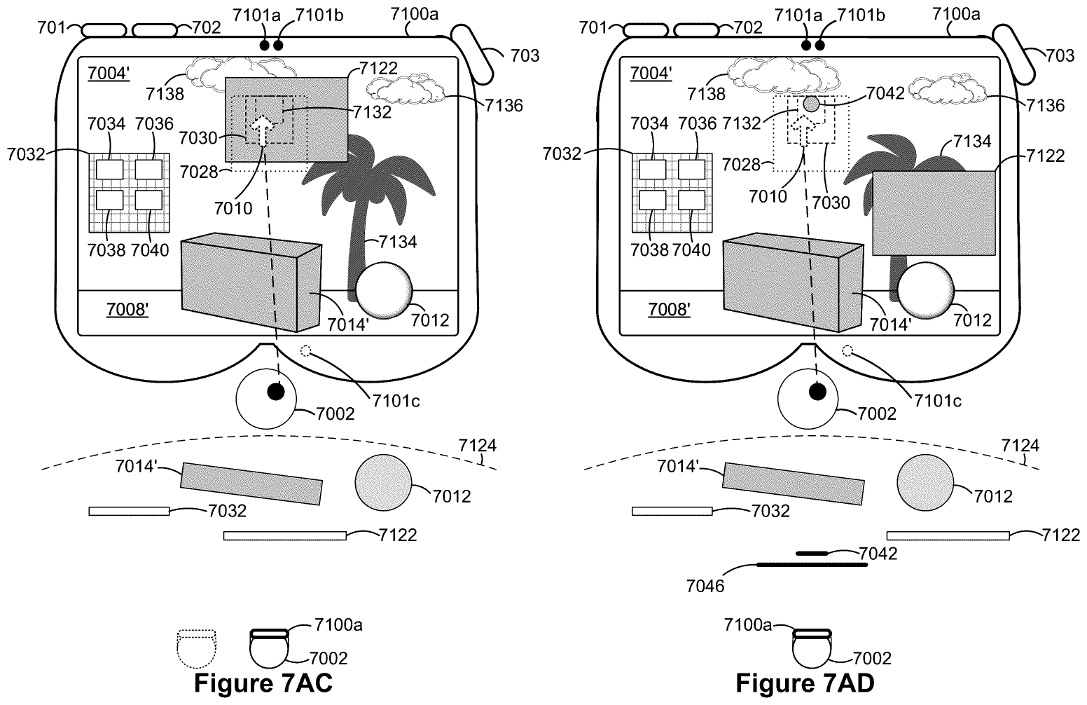

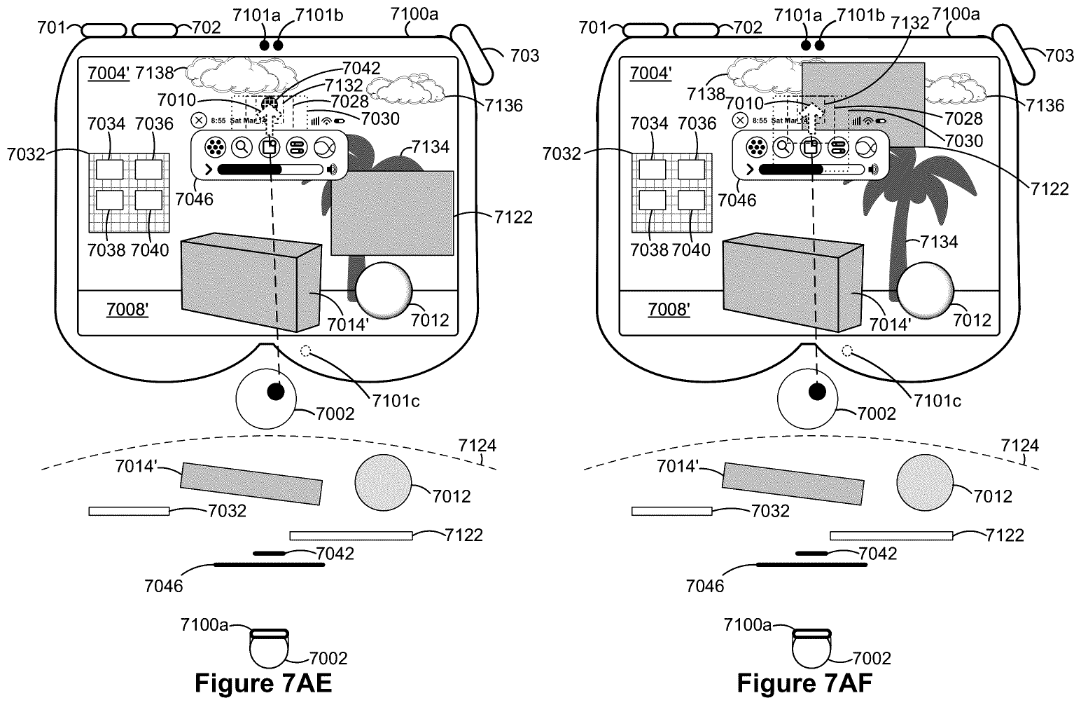

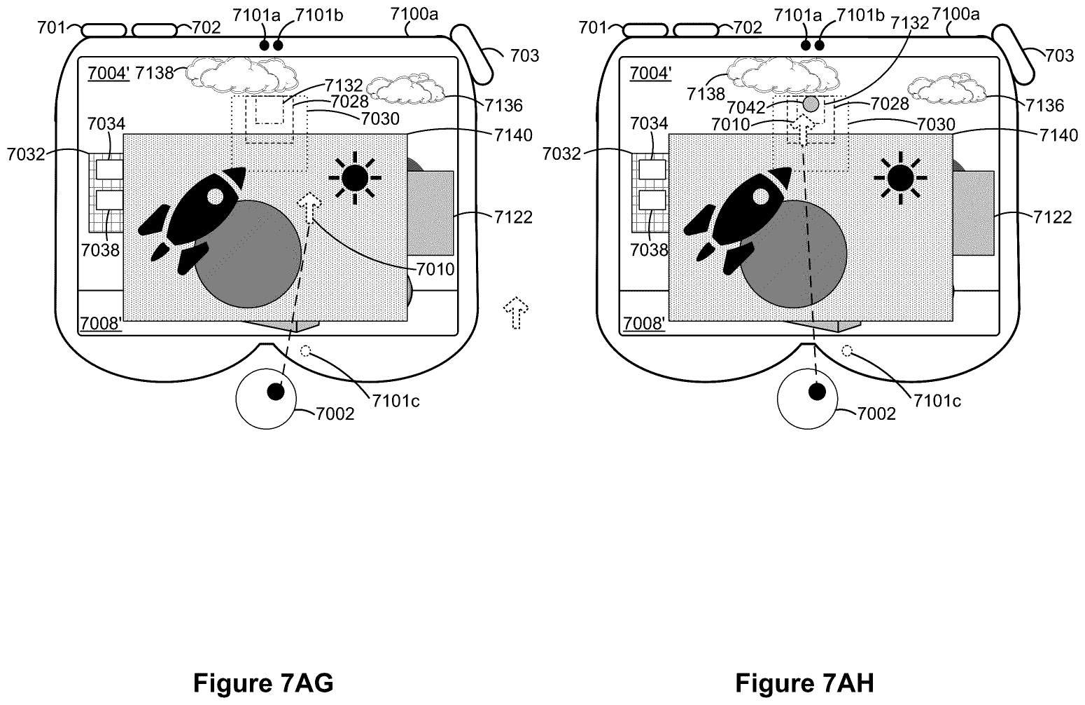

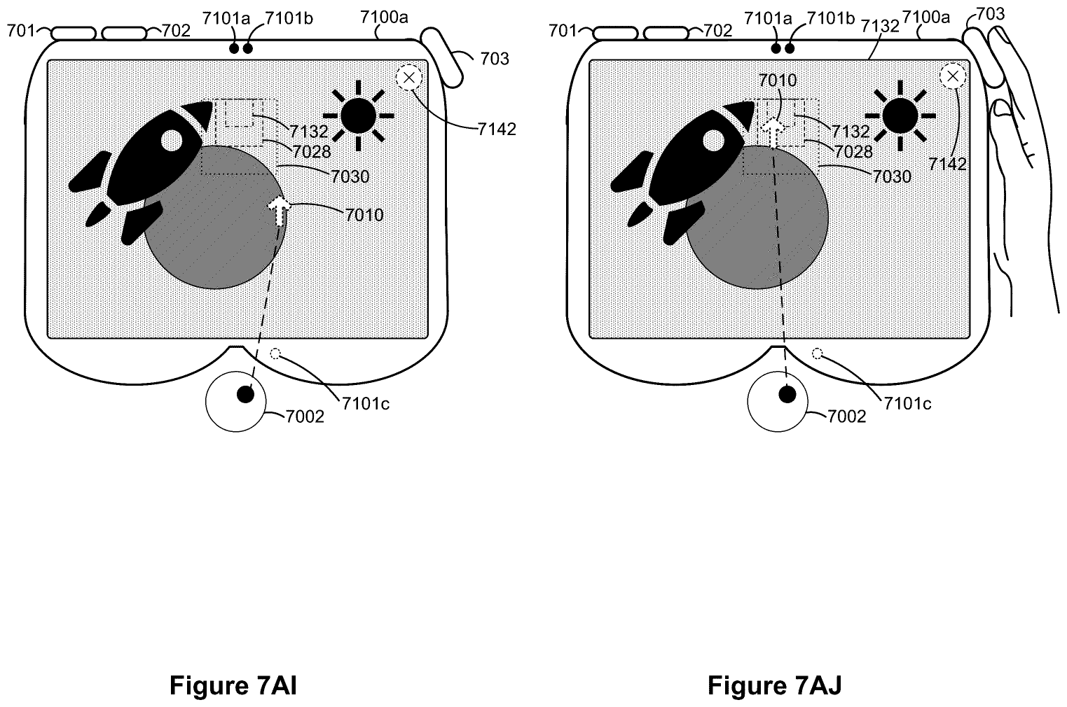

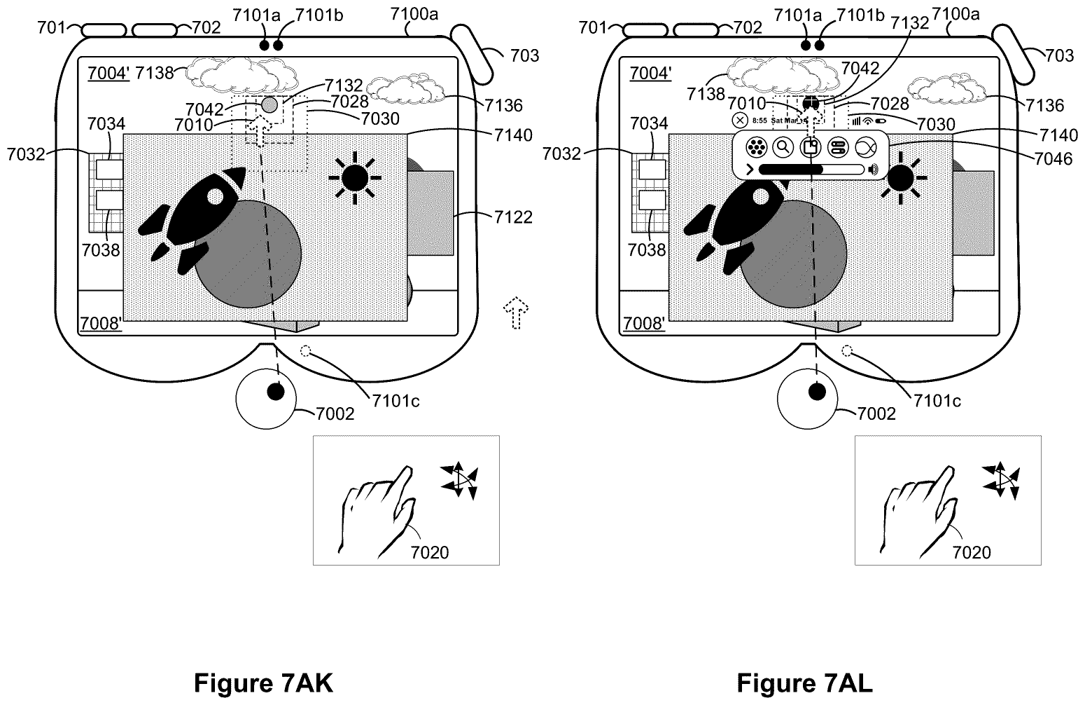

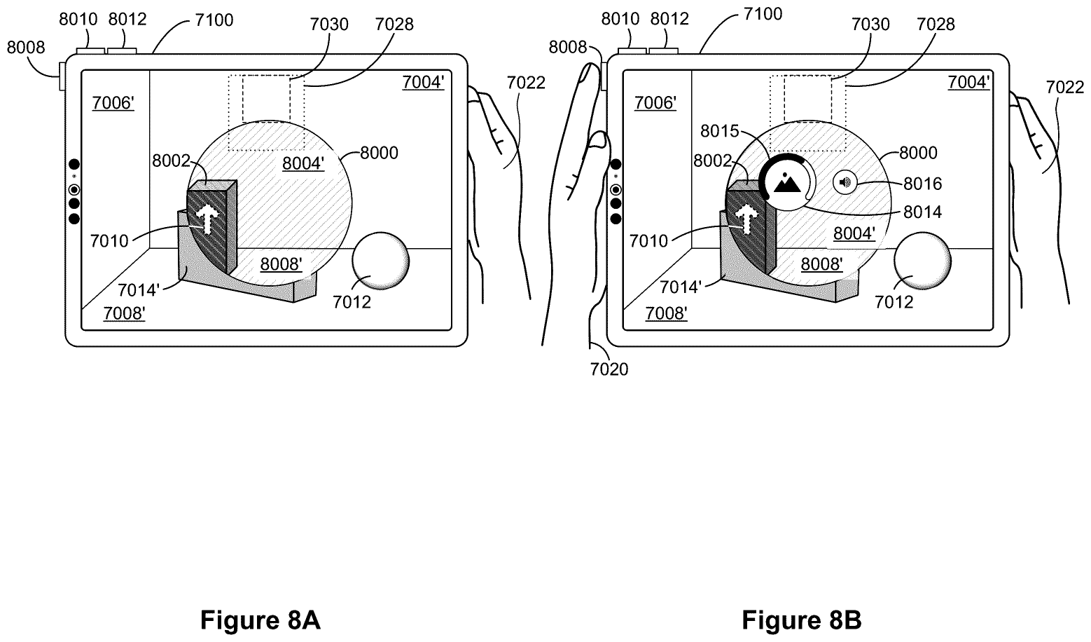

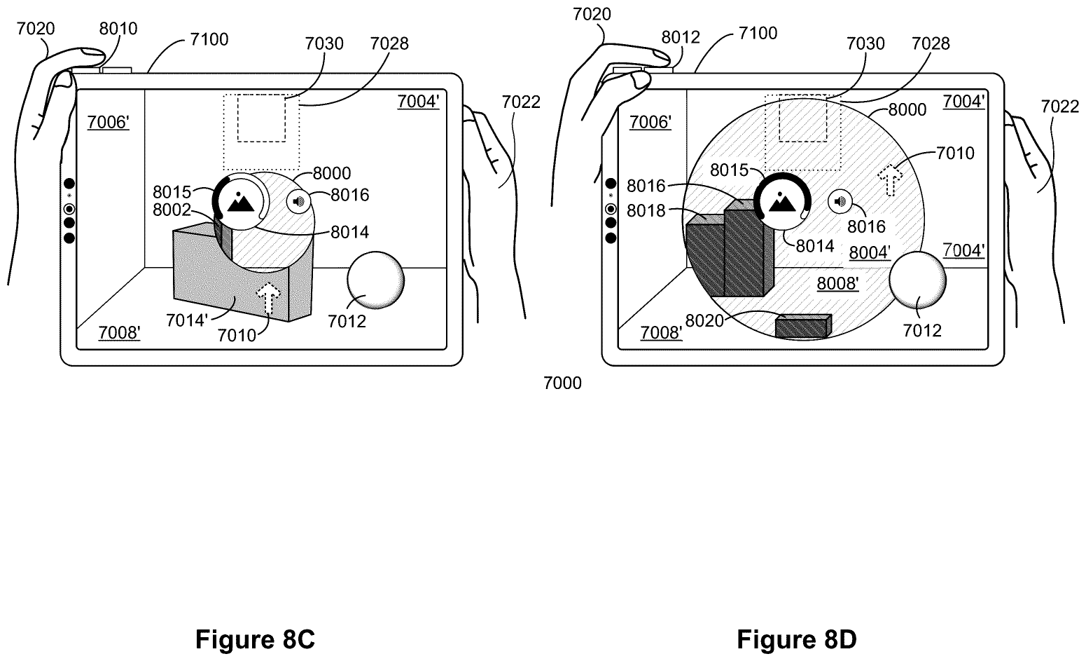

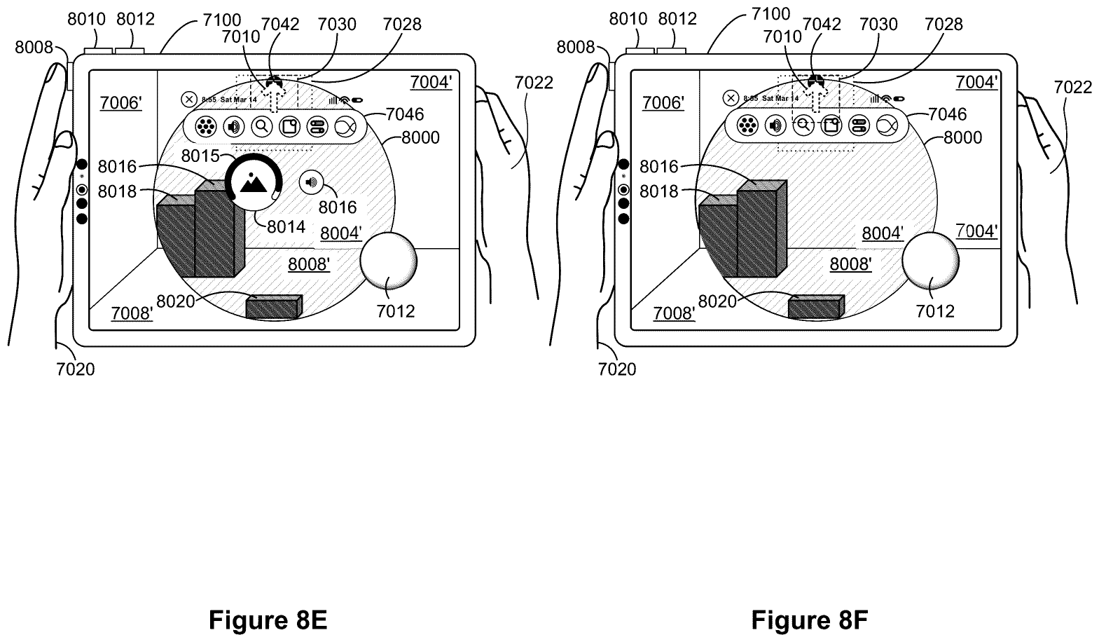

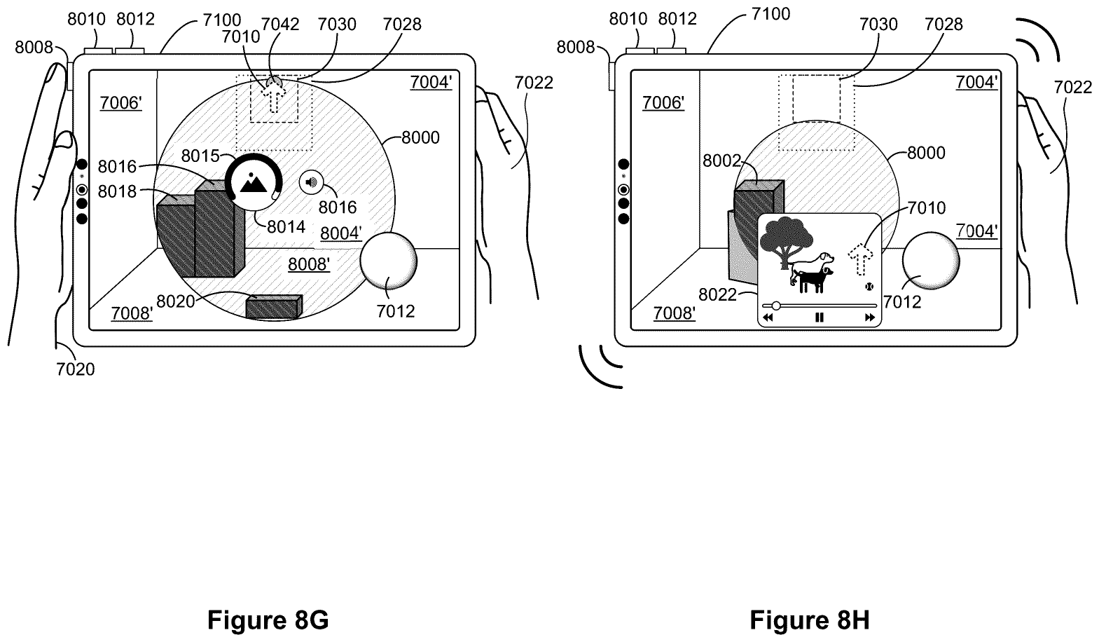

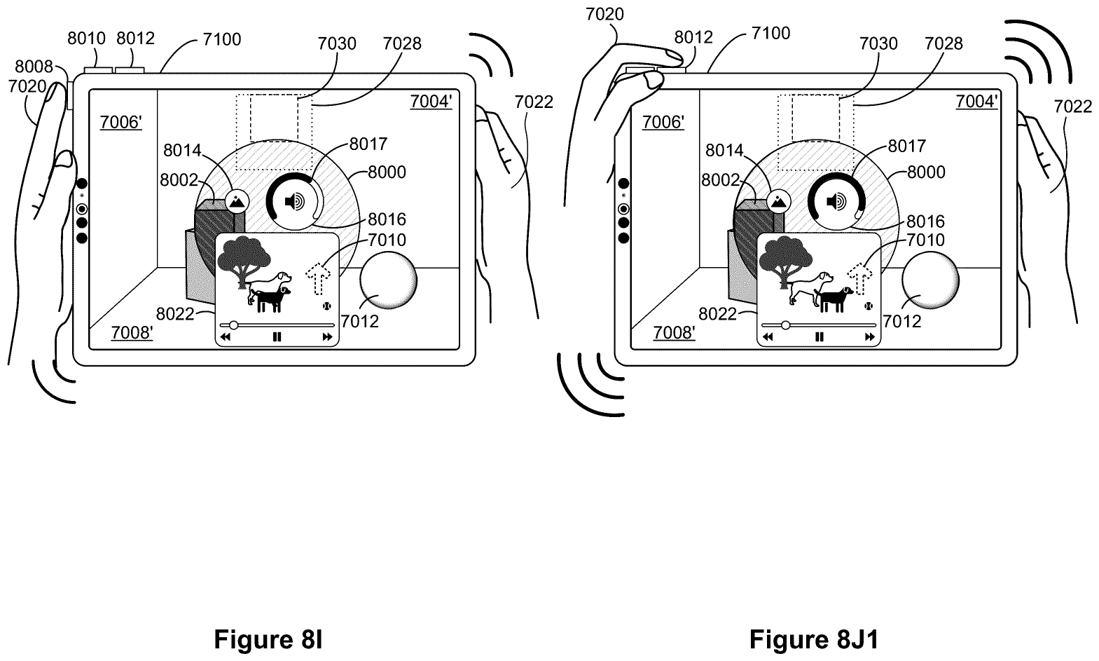

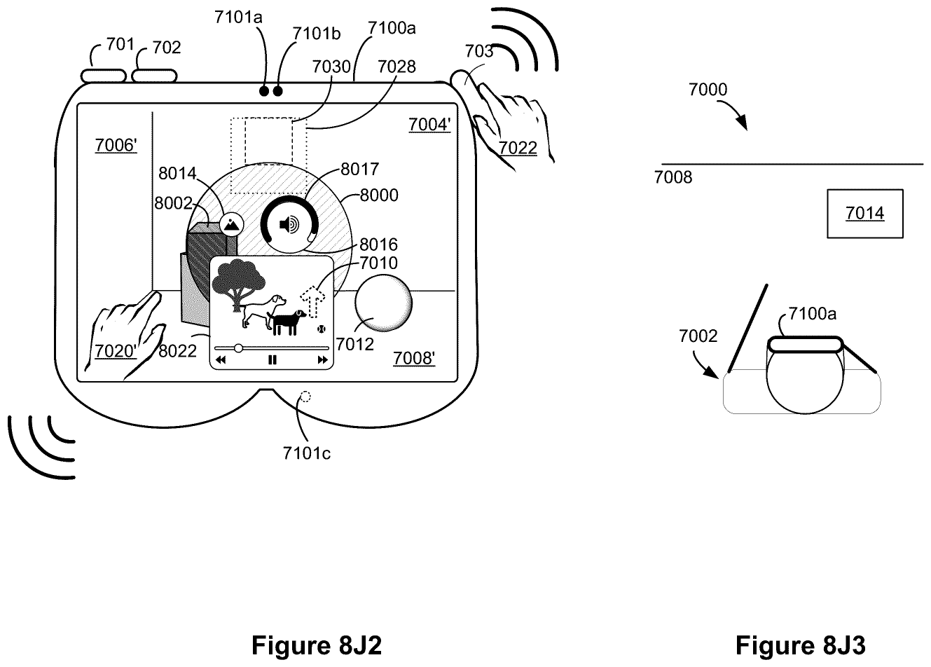

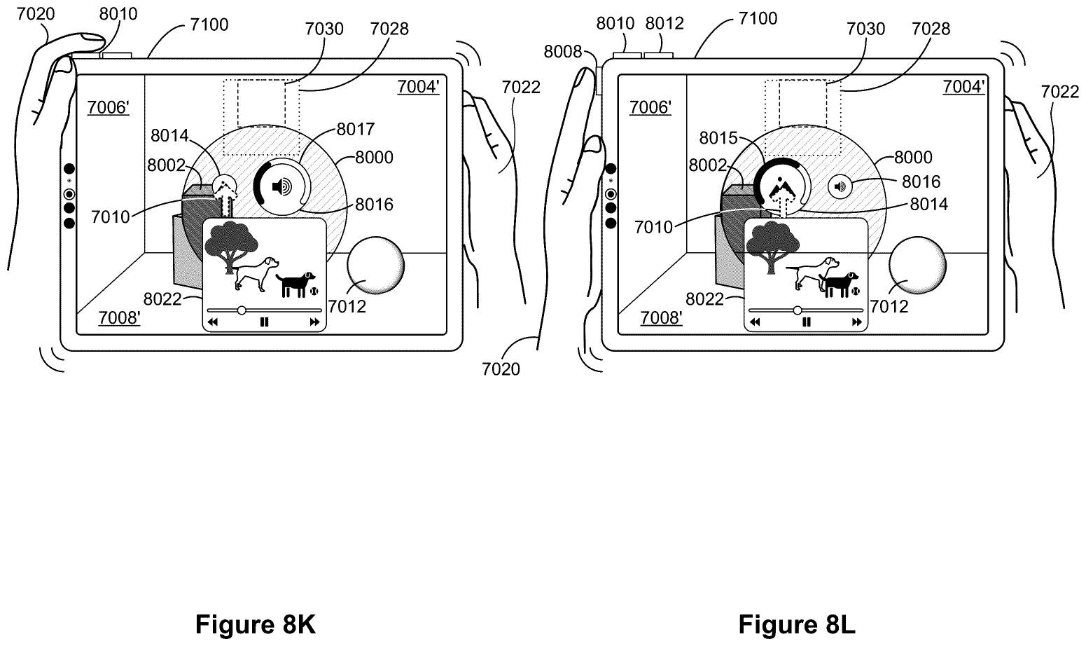

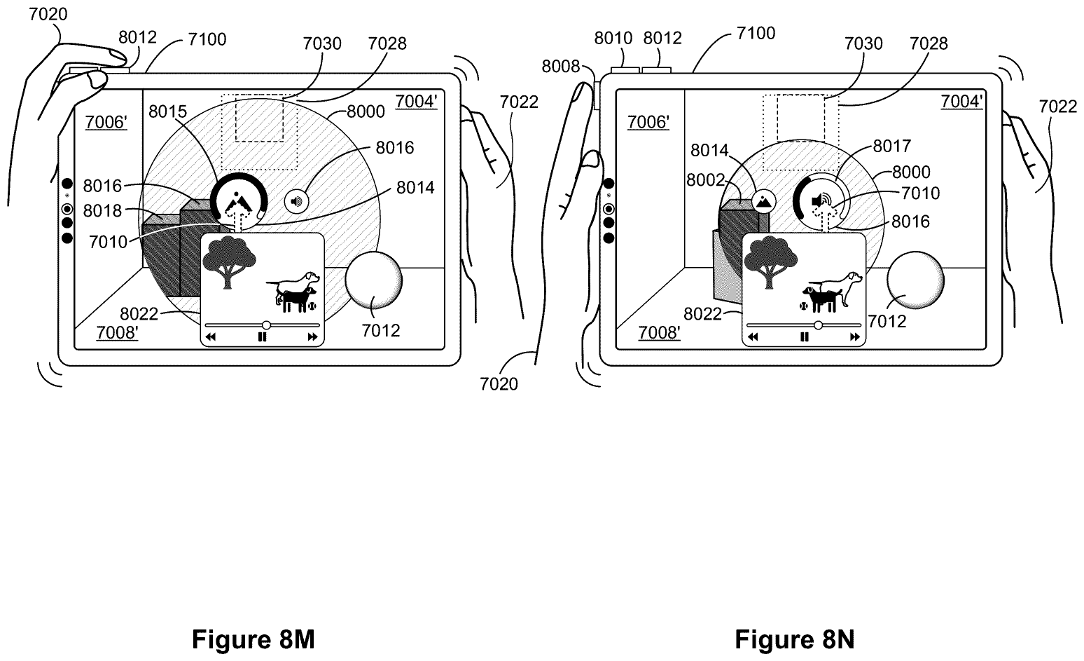

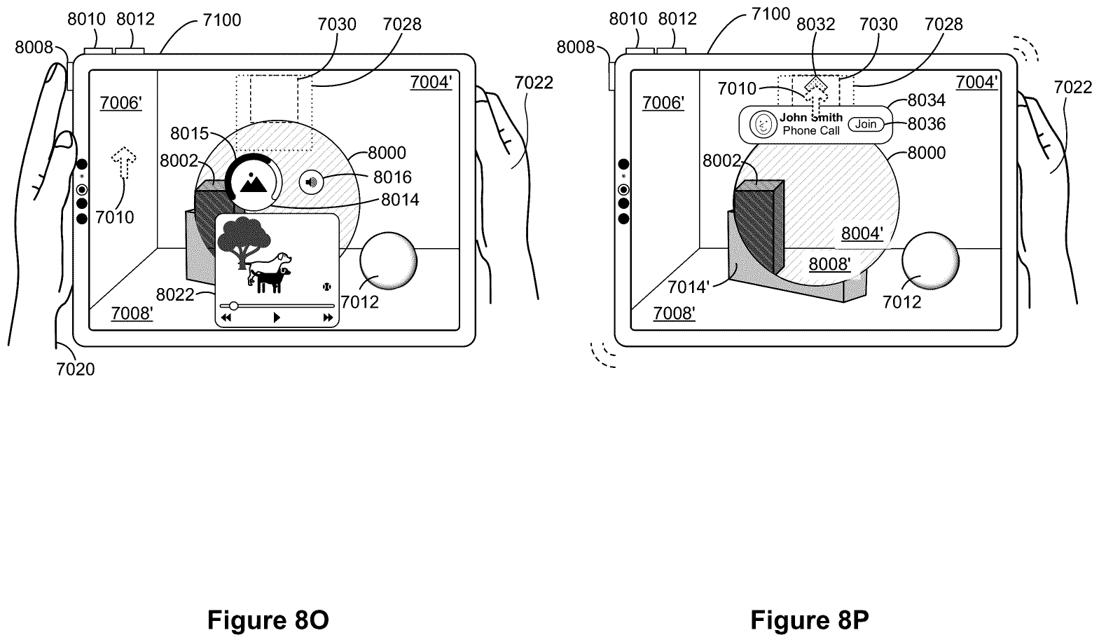

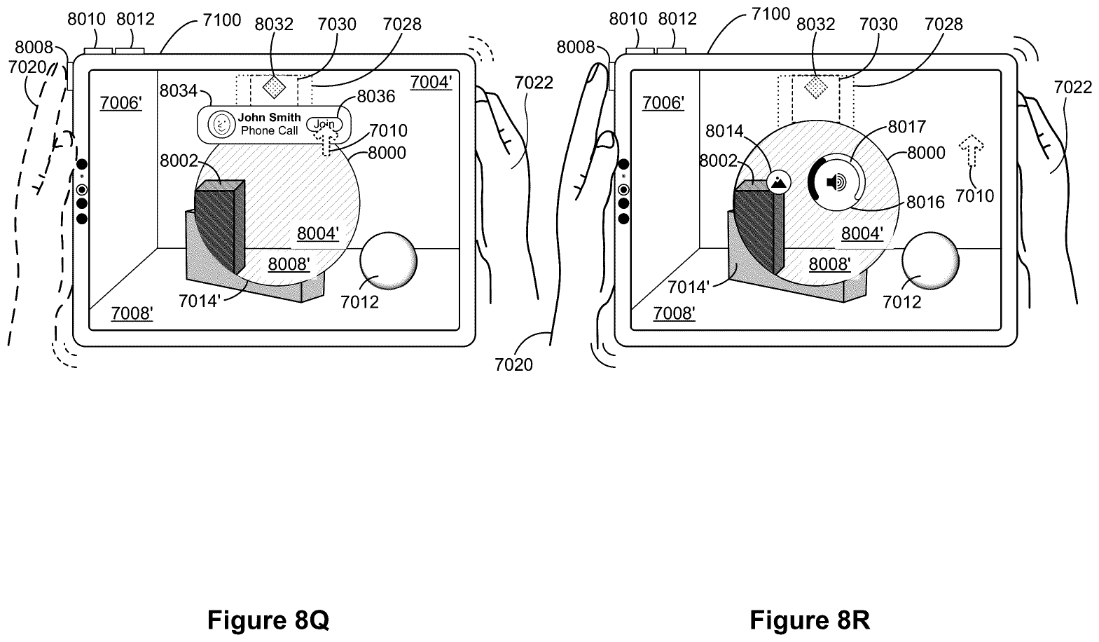

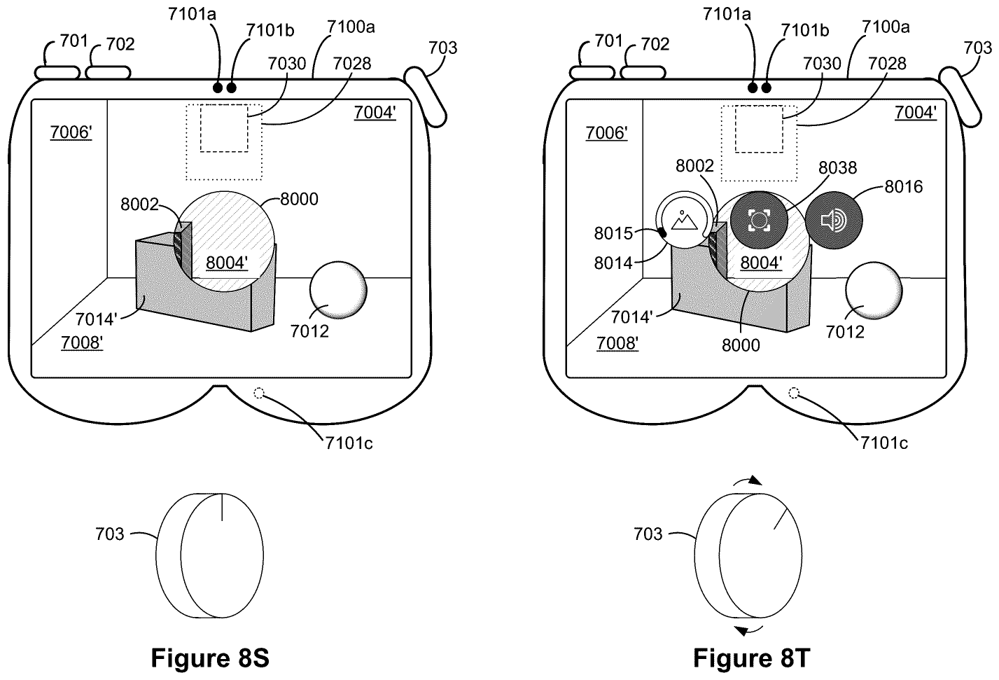

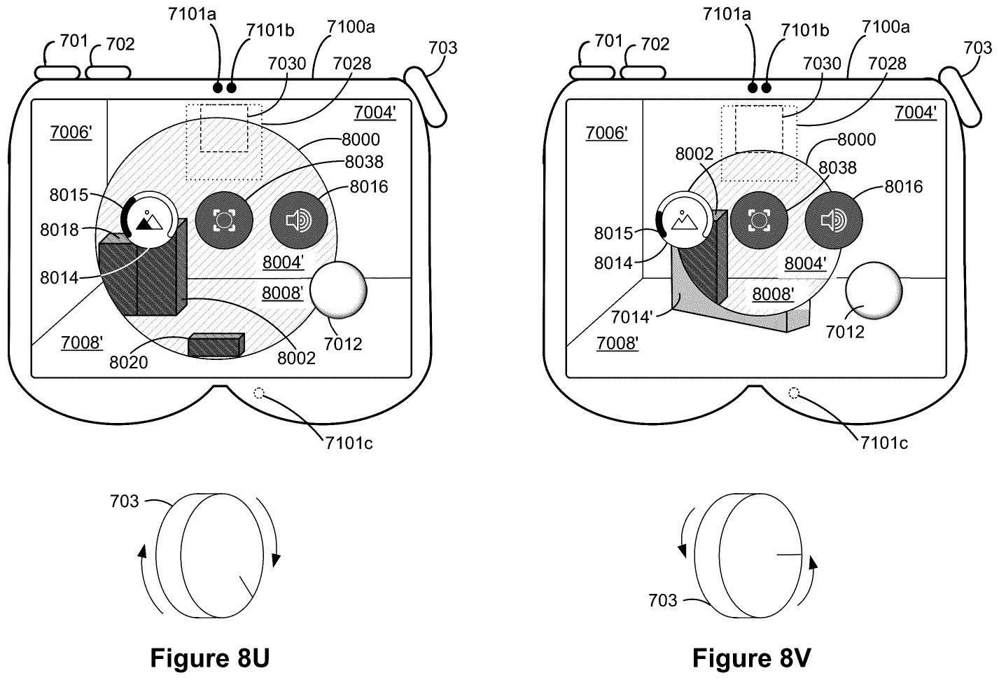

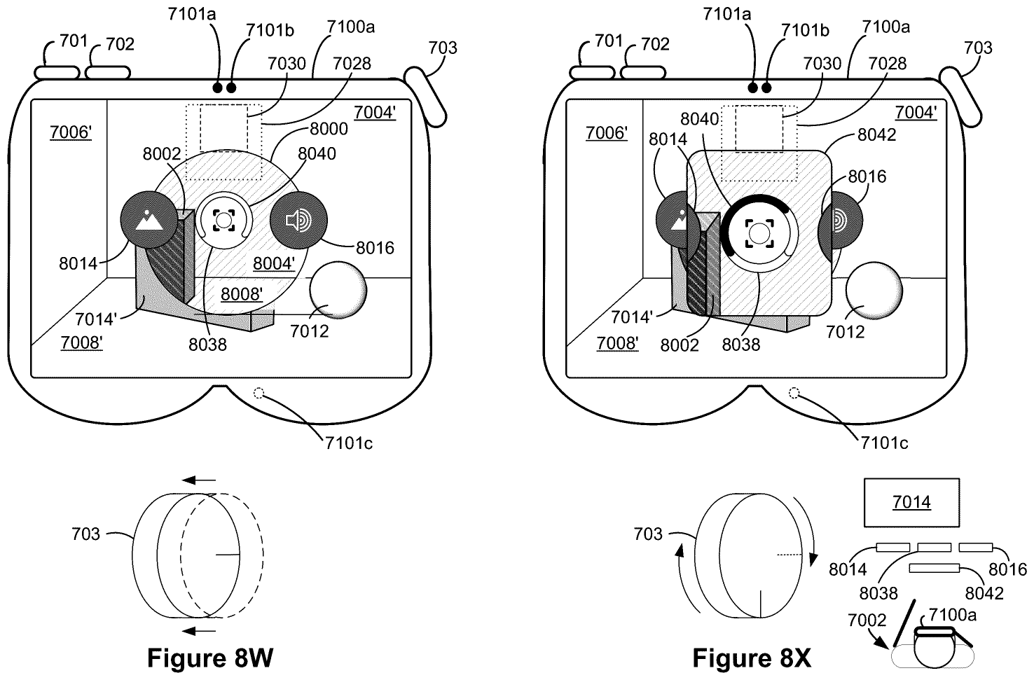

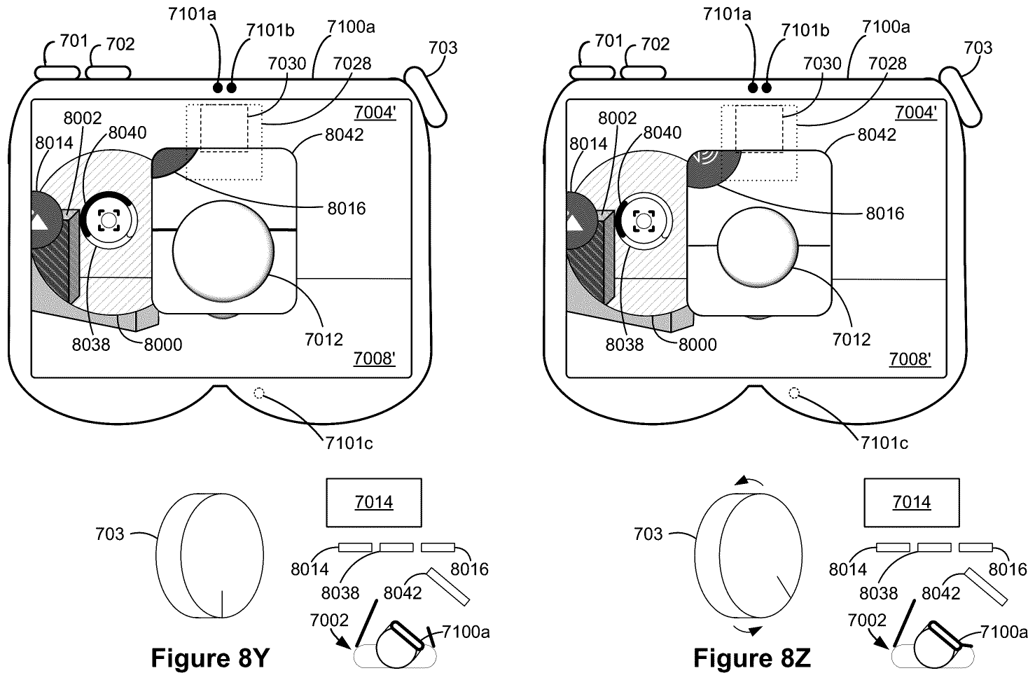

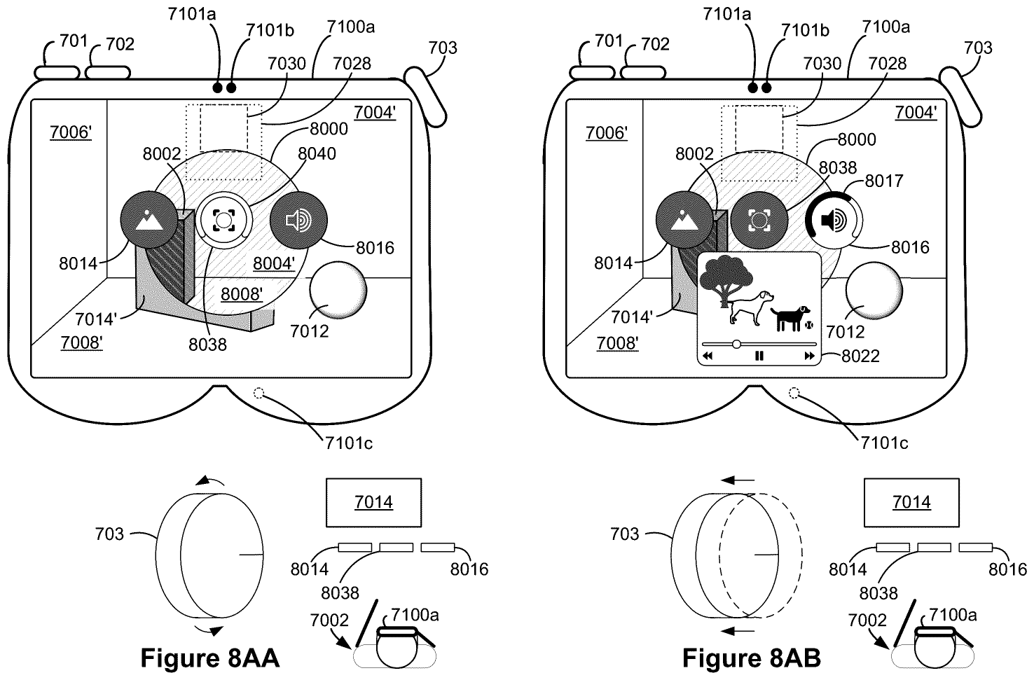

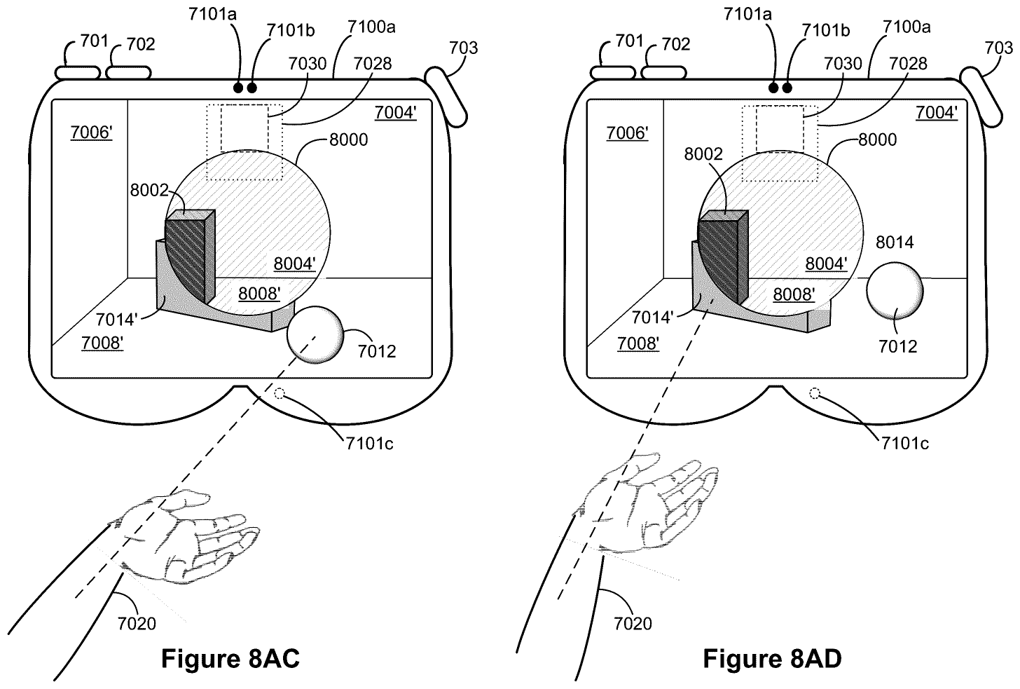

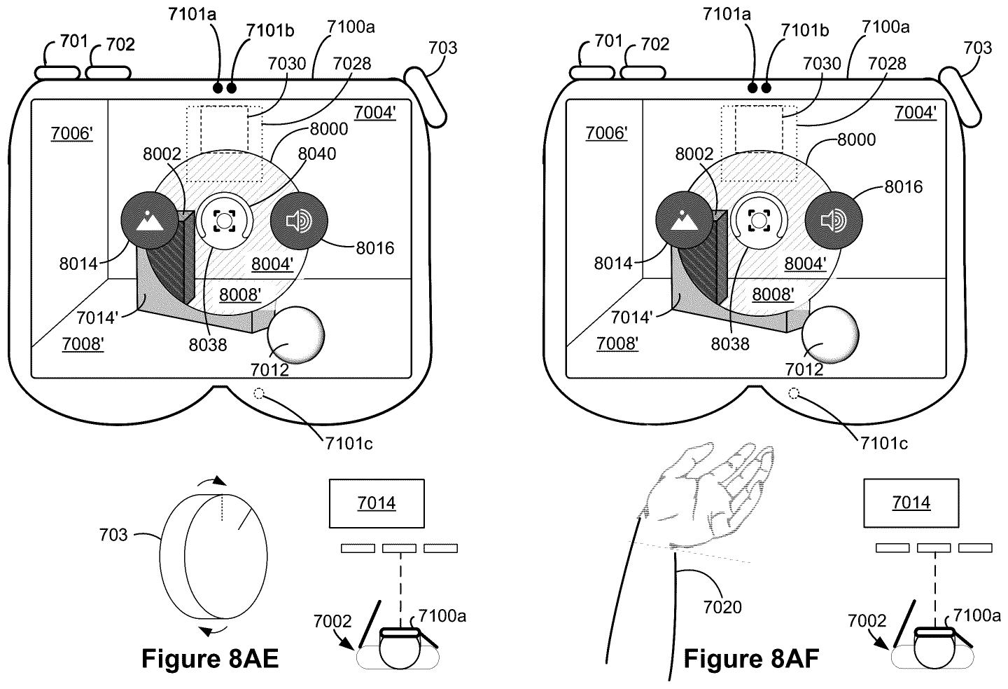

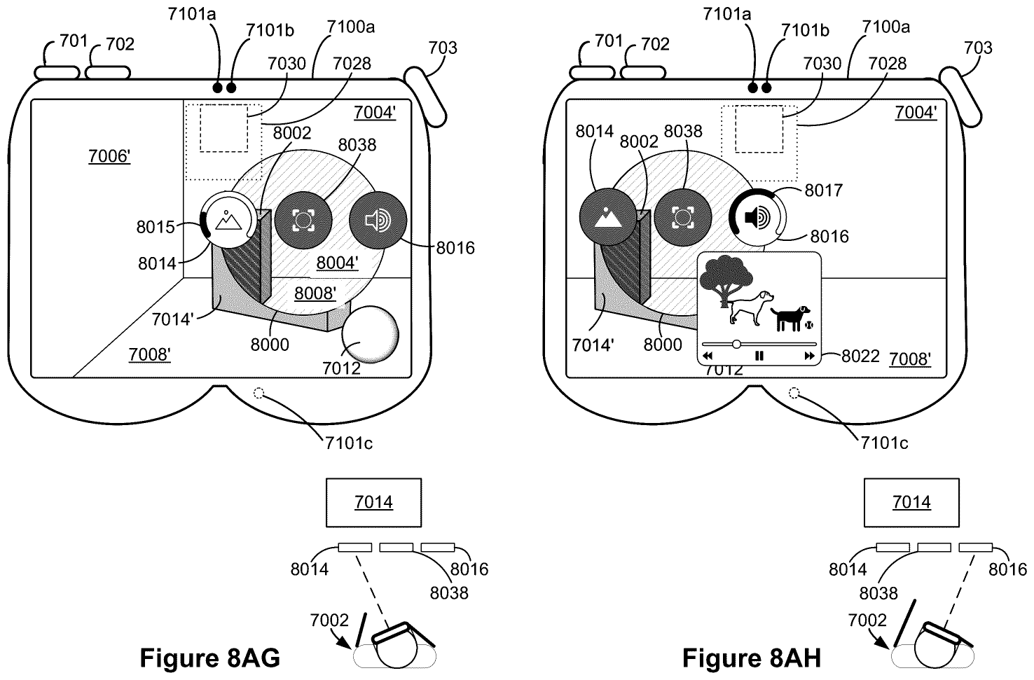

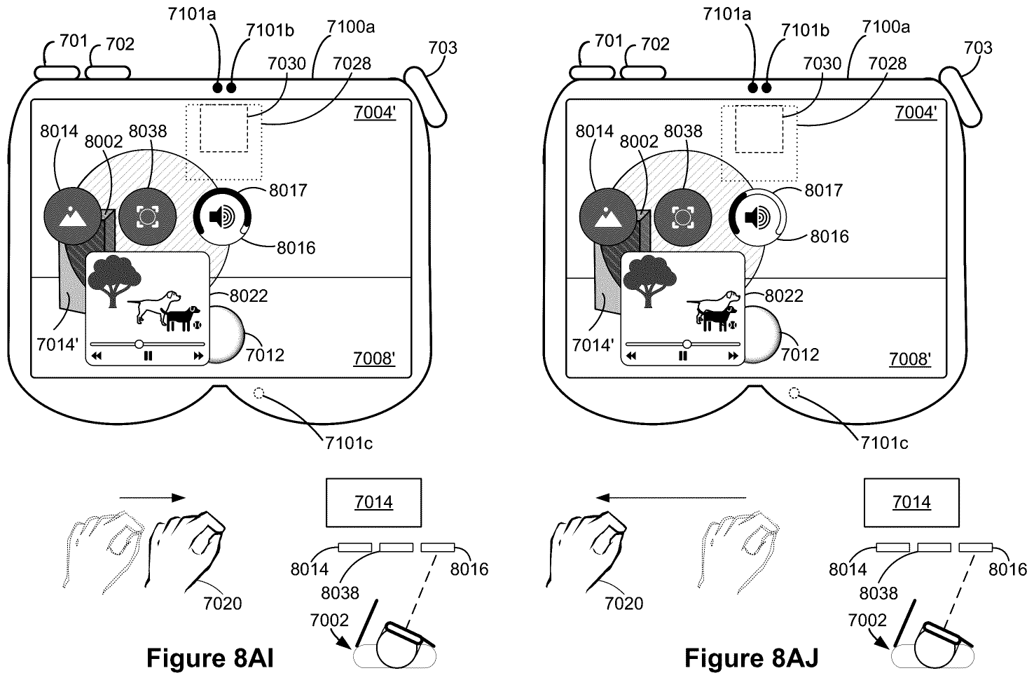

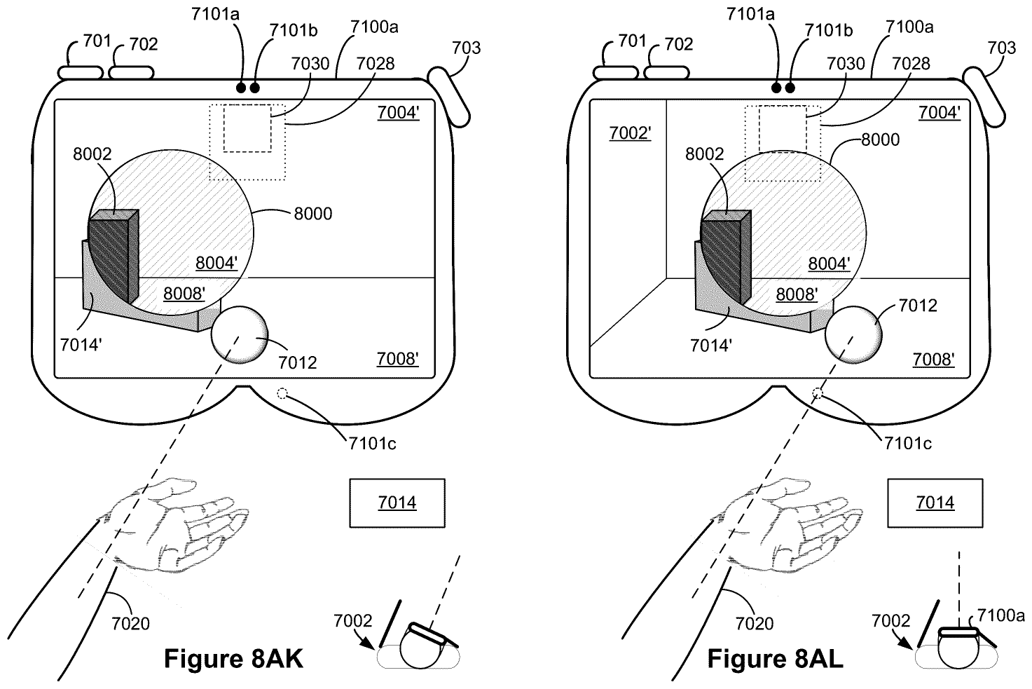

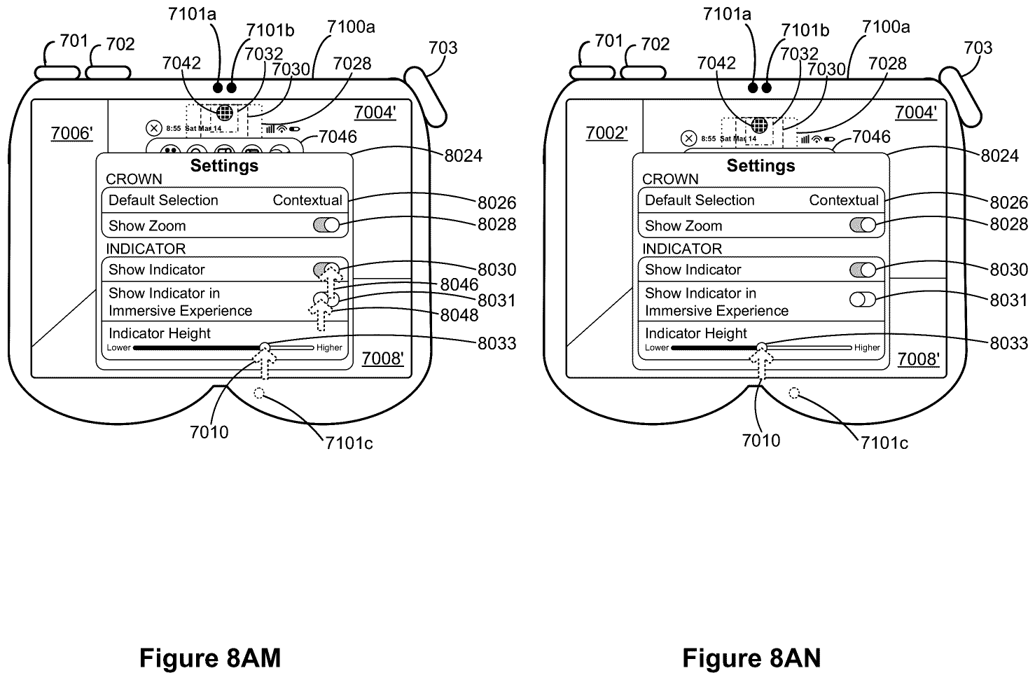

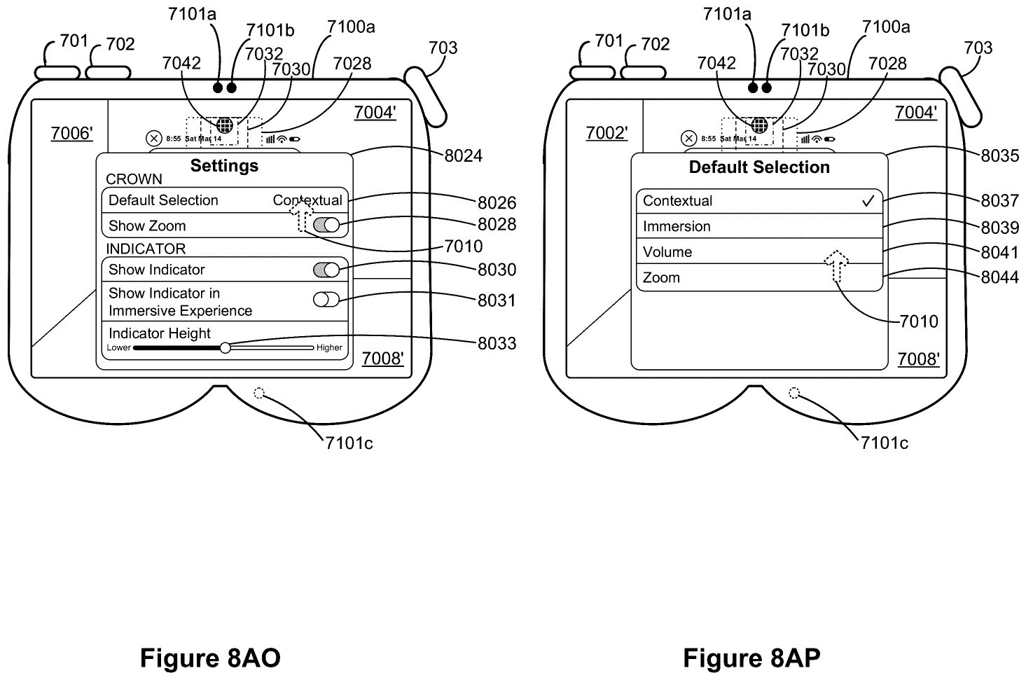

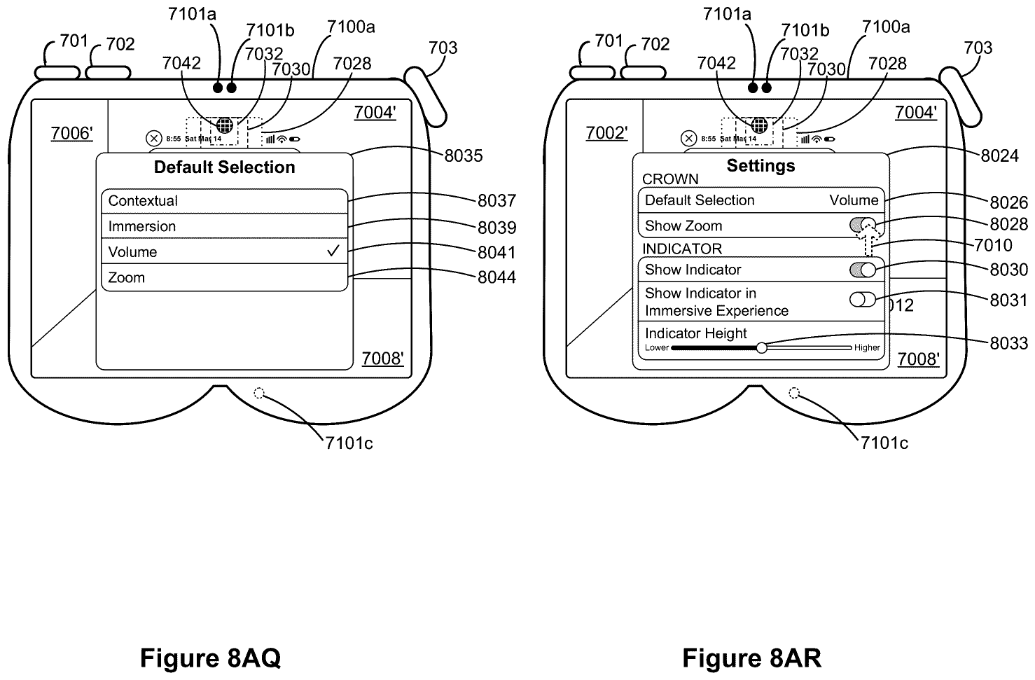

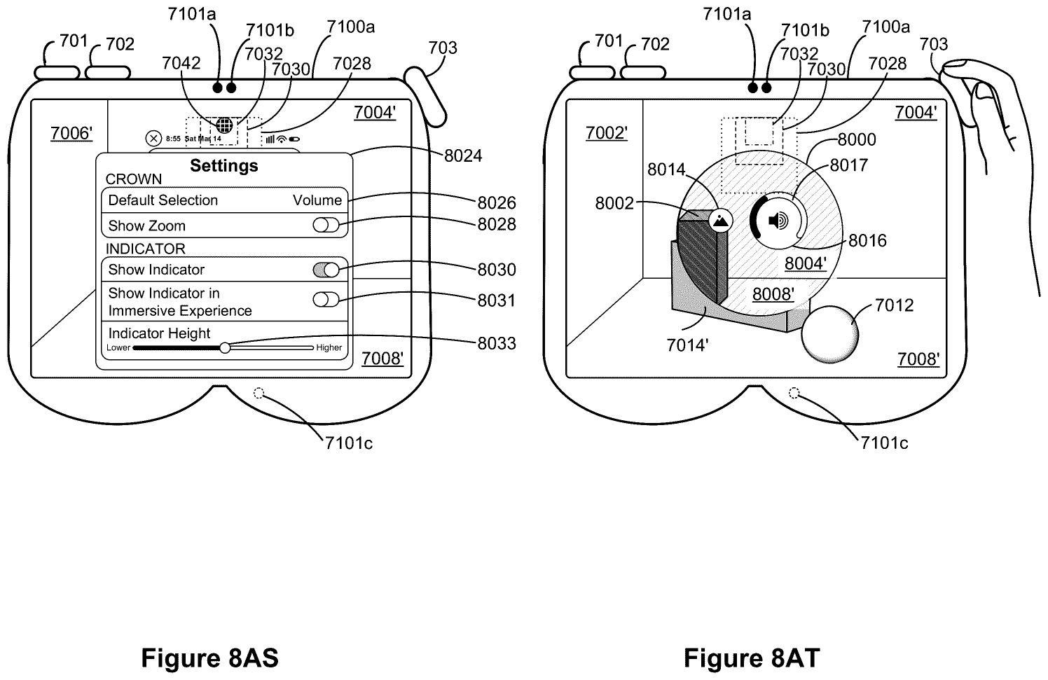

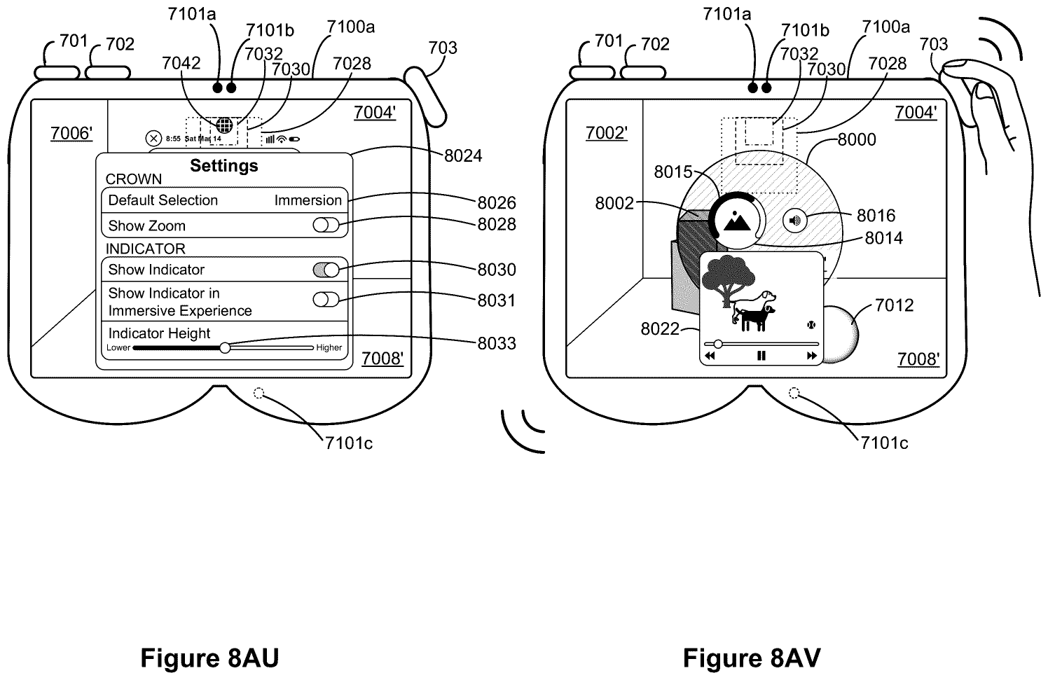

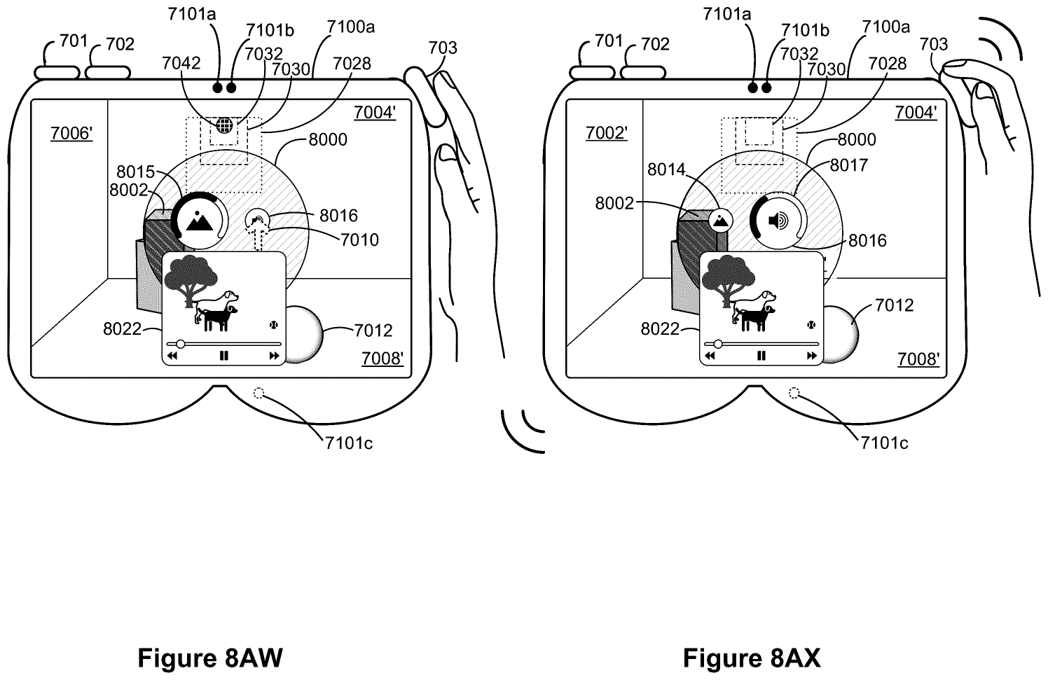

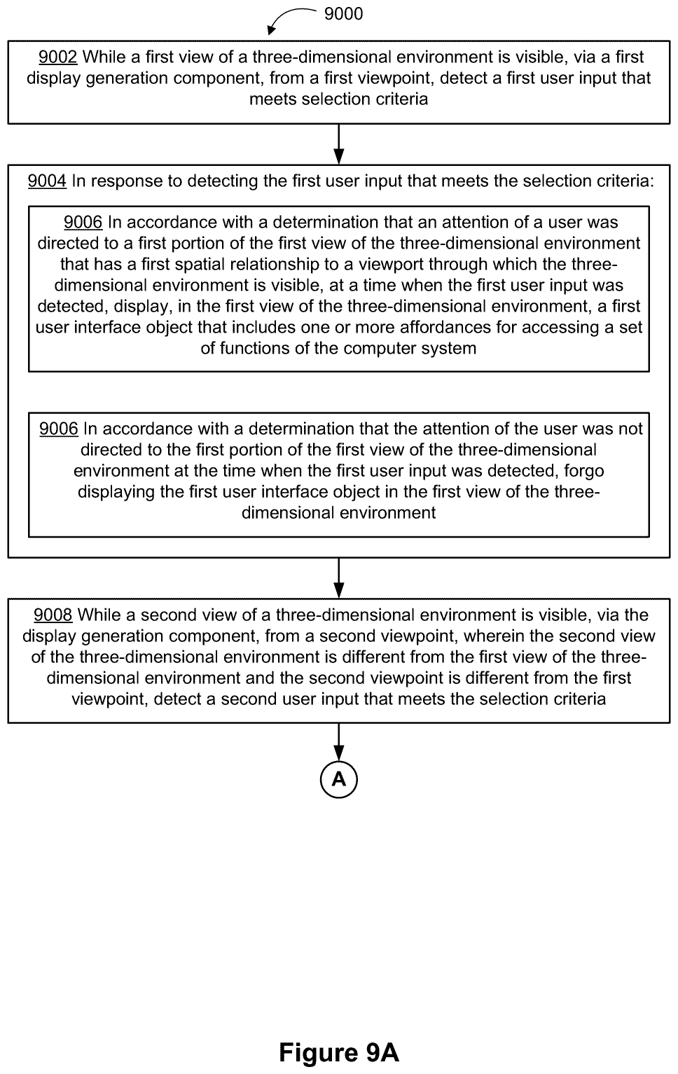

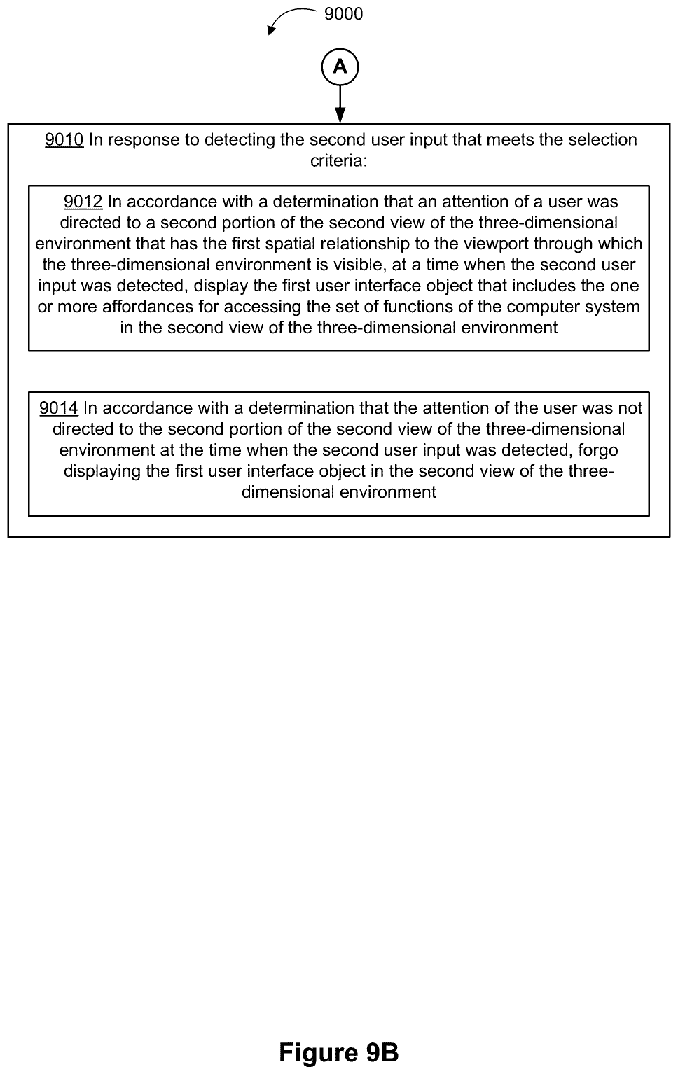

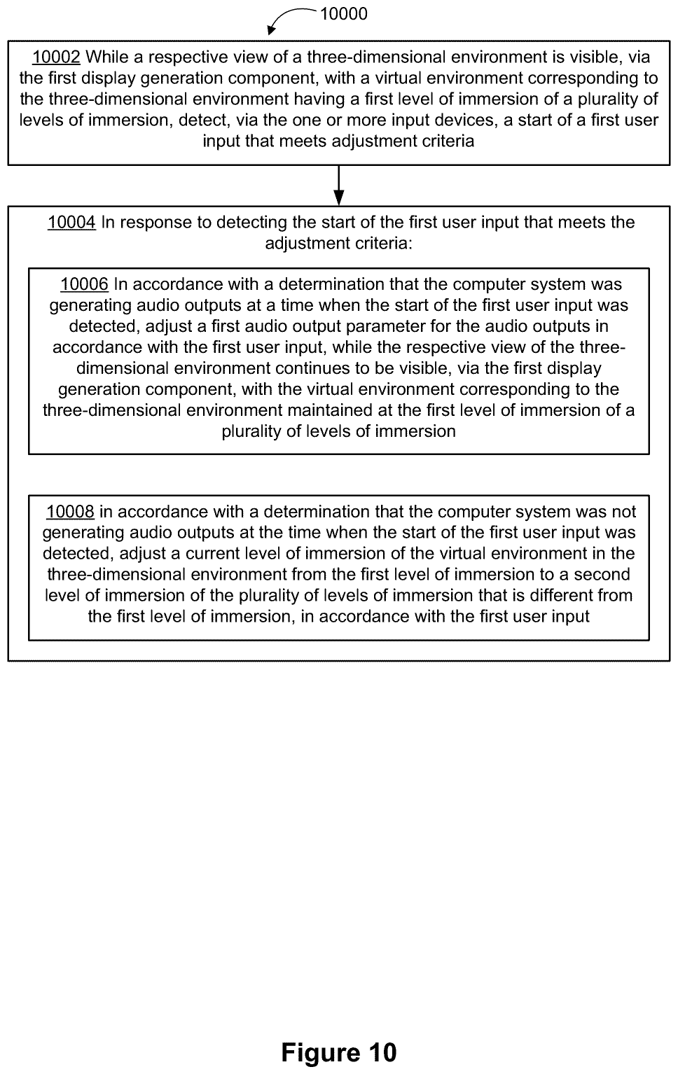

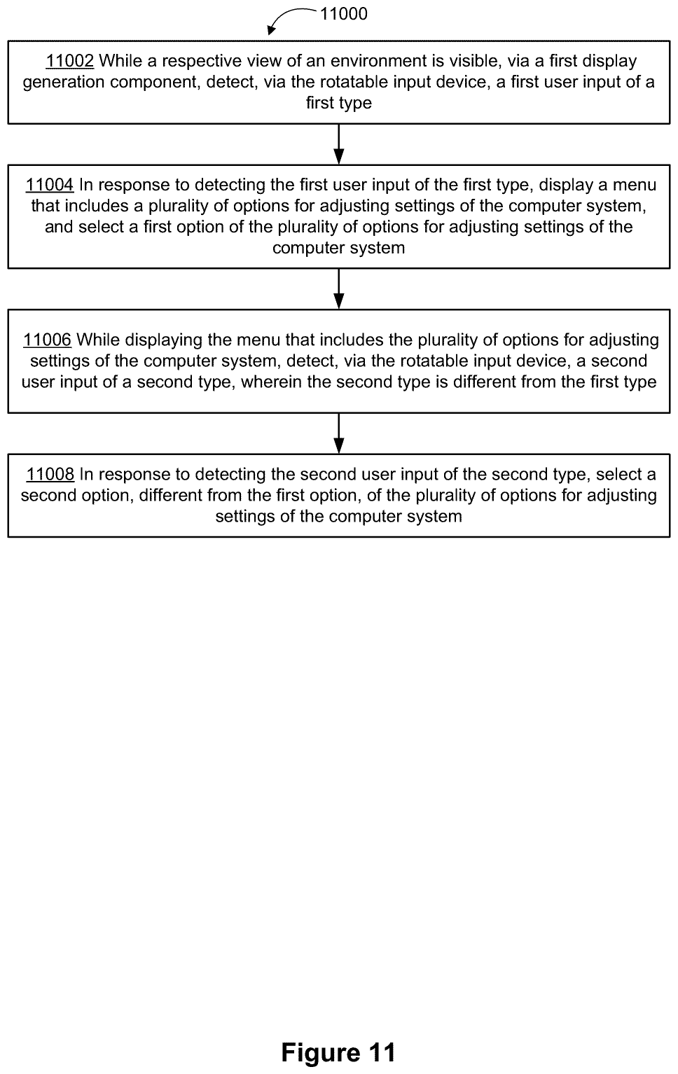

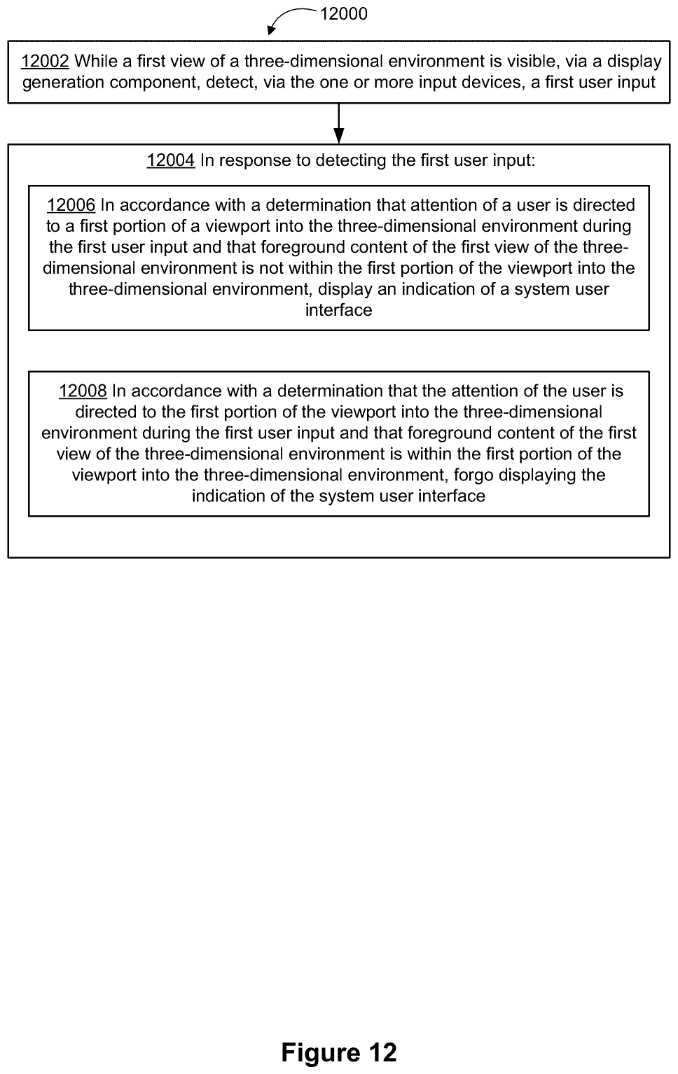

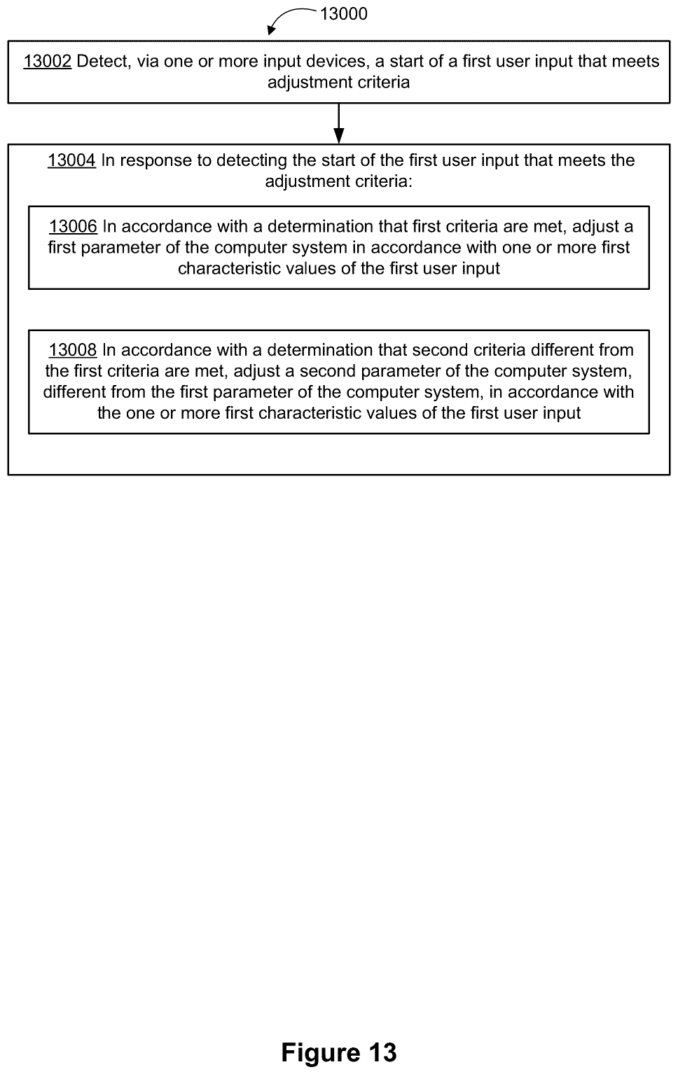

FIGS. 1A-6 provide a description of example computer systems for providing XR experiences to users. FIGS. 7A-7U illustrate example techniques for triggering display of system user interface elements based on user attention meeting associated criteria, in accordance with some embodiments. FIGS. 7V-7AL illustrate example techniques for conditionally displaying user interface elements for accessing settings of a computer system based on the location of foreground content, in accordance with some embodiments. FIGS. 8A-8R illustrate example techniques for performing different operations in response to inputs based on current system context, in accordance with some embodiments. FIGS. 8S-8AX illustrate example techniques for displaying a plurality of options for adjusting settings of a computer system and selecting between different options of the plurality of options in response to different types of inputs, in accordance with some embodiments. FIGS. 9A-9B are a flow diagram of methods of for triggering display of one or more user interface elements, in accordance with various embodiments. The user interfaces in FIGS. 7A-7U and 7AG-7AL are used to illustrate the processes in FIGS. 9A-9B. FIG. 10 is a flow diagram of methods of performing different operations in response to inputs based on current system context, in accordance with various embodiments. The user interfaces in FIGS. 8A-8R are used to illustrate the processes in FIG. 10. FIG. 11 is a flow diagram of methods of displaying a menu that includes plurality of options for adjusting settings of a computer system and selecting between options of the plurality of options, in accordance with some embodiments. The user interfaces in FIGS. 8S-8AL are used to illustrate the processes in FIG. 11. FIG. 12 is a flow diagram of methods of conditionally displaying user interface elements for accessing settings of a computer system based on the location of foreground content, in accordance with some embodiments. The user interfaces in FIGS. 7V-7AF are used to illustrate the processes in FIG. 12. FIG. 13 is a flow diagram of methods of adjusting a first parameter or a second parameter, based on whether first or second criteria are met, based on a characteristic of a user input, in accordance with some embodiments. The user interfaces in FIGS. 8AM-8AX are used to illustrate the processes in FIG. 13.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency or reduced opacity) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, reduced in opacity, and/or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency or reduced opacity) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

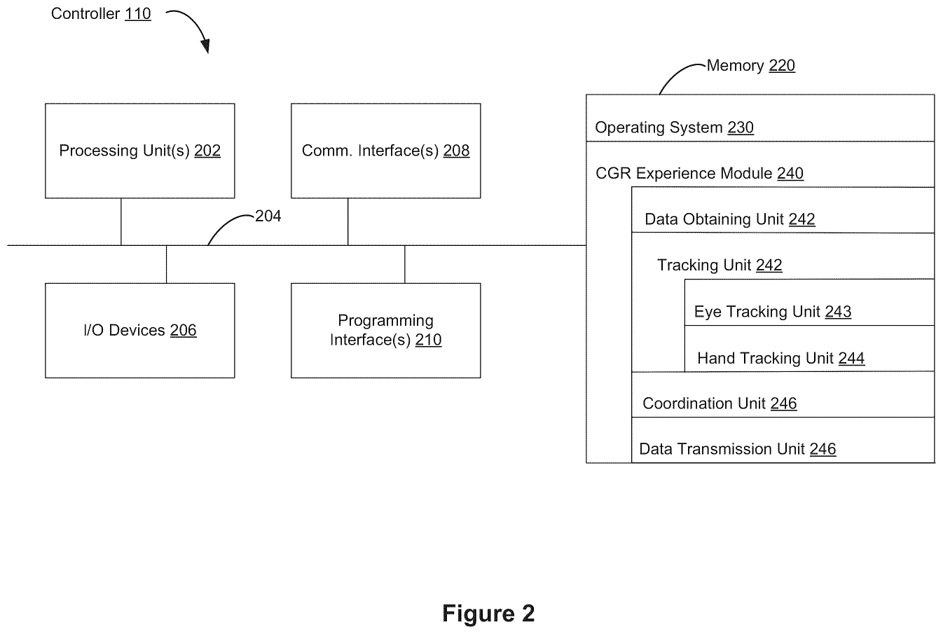

Hardware: There are many different types of electronic systems that enable a person to sense and/or interact with various XR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

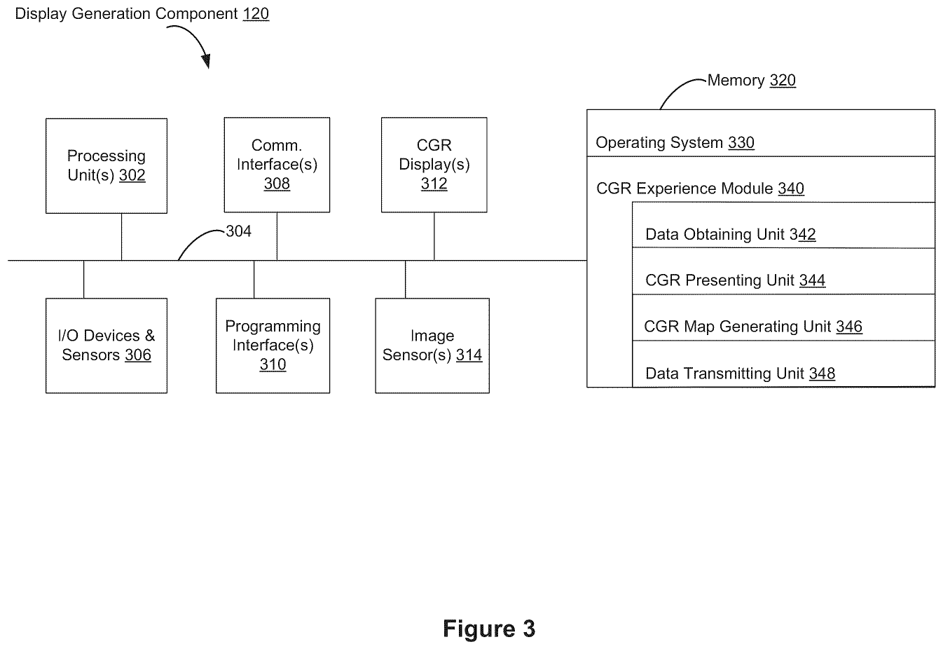

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (e.g., when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 11) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (e.g., as shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-IF can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and IF and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. For hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, cither alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, cither alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, cither alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, cither alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

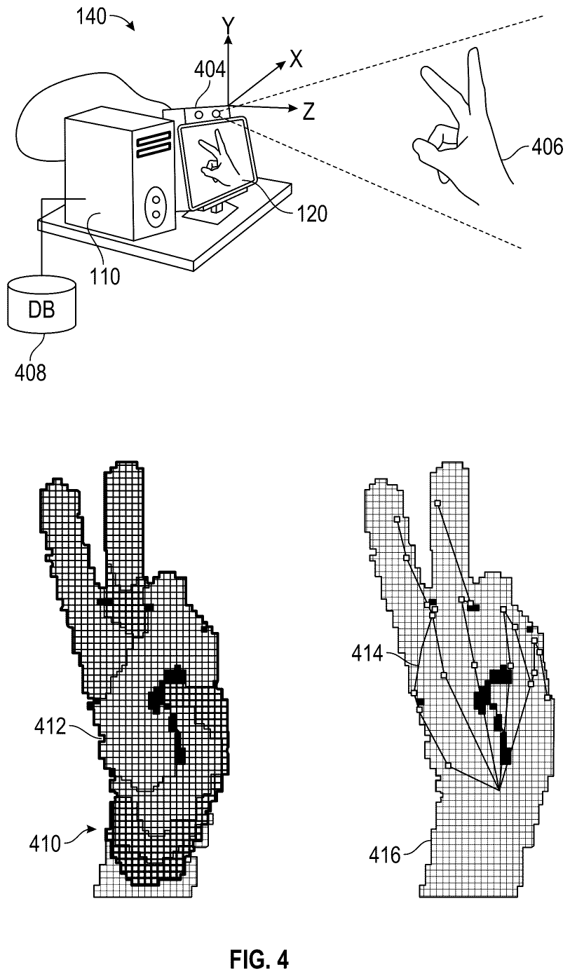

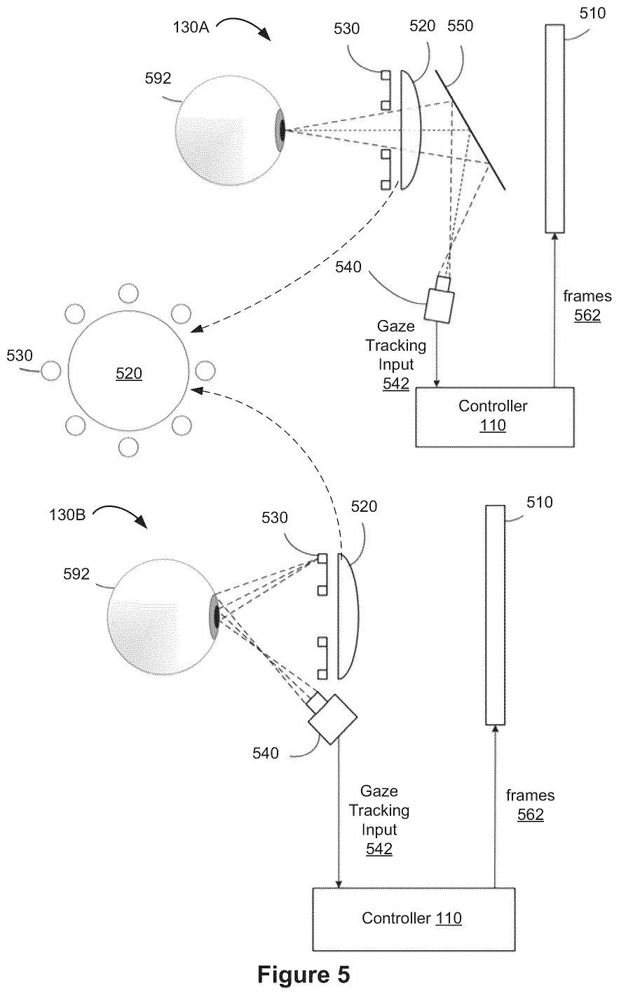

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 245 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze, or a gaze substitute such as a hand pointing gesture that indicates a portion of the three-dimensional environment with which the user intends to interact) to determine the target of the user input (e.g., for direct inputs, as described below). Thus, in implementations involving air gestures, the input gesture is, for example, detected attention (e.g., gaze, or a gaze substitute such as a hand pointing gesture that indicates a portion of the three-dimensional environment with which the user intends to interact) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze, or a gaze substitute such as a hand pointing gesture that indicates a portion of the three-dimensional environment with which the user intends to interact) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze, or a gaze substitute such as a hand pointing gesture that indicates a portion of the three-dimensional environment with which the user intends to interact) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head mounted device such as headset, helmet, goggles, or glasses, or a handheld device placed in a wearable frame, the head mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head mounted device or part of a head mounted device. In some embodiments, the head mounted eye-tracking device 130 is optionally used in conjunction with a display generation component that is also head mounted, or a display generation component that is not head mounted. In some embodiments, the eye tracking device 130 is not a head mounted device, and is optionally used in conjunction with a head mounted display generation component. In some embodiments, the eye tracking device 130 is not a head mounted device, and is optionally part of a non-head mounted display generation component.

In some embodiments, the display generation component 120 uses a display mechanism (e.g., left and right near-eye display panels) for displaying frames including left and right images in front of a user's eyes to thus provide 3D virtual views to the user. For example, a head mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

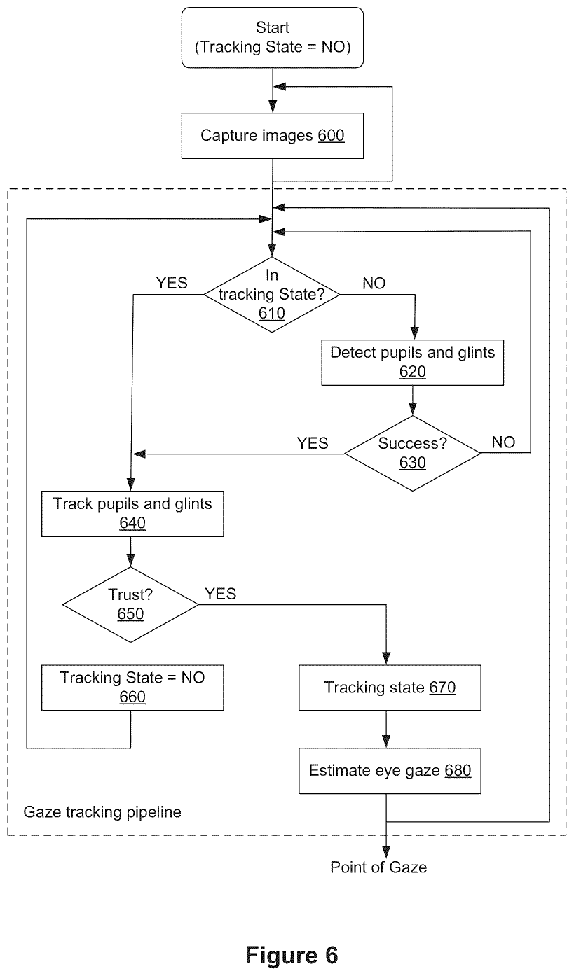

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gazc), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head mounted device, that is in communication with one or more display generation components and one or more input devices.

FIGS. 7A-7AL and 8A-8AX include illustrations of three-dimensional environments that are visible via a display generation component (e.g., a display generation component 7100, and display generation component 7100a, or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head mounted display or heads-up display that is made semi-transparent (e.g., less than 50%, 40%, 30%, 20%, 15%, 10%, or 5% of opacity) or transparent, such that the user can see through it to view the real world surrounding the user without removing the head mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, as shown in FIGS. 7A-7AL and 8A-8AX, the views of a three-dimensional environment sometimes do not include representation(s) of a user's hand(s), arm(s), and/or wrist(s). In some embodiments, the representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

FIGS. 7A-7U illustrate examples of triggering display of user interface elements for accessing system functions of a computer system based on user attention directed to a particular view region. FIGS. 9A-9B are a flow diagram of an exemplary method 9000 for triggering display of user interface elements for accessing system functions of a computer system based on user attention directed to a particular view region. The user interfaces in FIGS. 7A-7U are used to illustrate the processes described below, including the processes in FIGS. 9A-9B.

As shown in the examples in FIGS. 7A-7N, a display generation component 7100 of computer system 101 is a touchscreen held by user 7002. In some embodiments, the display generation component of computer system 101 is a head mounted display (e.g., head mounted display 7100a, as shown in FIGS. 7F2-7F3, 7O-7AL, 8J2-8J3, and 8S-8AX) worn on user 7002's head (e.g., what is shown in FIGS. 7A-7N as being visible via display generation component 7100 of computer system 101 corresponds to user 7002's field of view when wearing a head mounted display). In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. For example, in some embodiments, while the user's hand 7020 is within the field of view of the one or more sensors of HMD 7100a (e.g., within the field of view of the user), a representation of the user's hand 7020′ is displayed in the user interface displayed (e.g., as a passthrough representation and/or as a virtual representation of the user's hand 7020) on the display of HMD 7100a. in some embodiments, while the user's hand 7022 is within the field of view of the one or more sensors of HMD 7100a (e.g., within the field of view of the user), a representation of the user's hand 7022′ is displayed in the user interface displayed (e.g., as a passthrough representation and/or as a virtual representation of the user's hand 7022) on the display of HMD 7100a. In some embodiments, the user's hand 7020 and/or the user's hand 7022 are used to perform one or more gestures (e.g., one or more air gestures), optionally in conjunction with a gaze input. As described herein (e.g., below, with reference to FIGS. 7A-7AL and FIGS. 8A-8AX), a first event (e.g., a first user input, a first predefined gesture, a first air gesture, a first gaze input, and/or first movement/redirection of a user's attention) “in conjunction with” a second event (e.g., a second user input or a second portion of the first input, a second predefined gesture or a second portion of the first predefined gesture, a second air gesture or a second portion of the first air gesture, a second gaze input, and/or second movement/redirection of the user's attention) means (e.g., substantially) concurrent (e.g., simultaneous) occurrence of the first event and the second event (e.g., a first user input performed concurrently with a second gaze input, or a first gaze input performed concurrently with a second air gesture). In some embodiments, “substantially concurrent” includes detecting occurrence of (e.g., and/or performing a user input, predefined gesture, air gesture, gaze input, and/or movement/redirection of the user's attention corresponding to) the first event within a threshold time (e.g., 0.1, 0.2, 0.3, 0.5, 1, 2, or 5 seconds) of detecting the second event (e.g., the first event occurs and/or is detected slightly before or slightly after the second event). In some embodiments, the one or more gestures performed with the user's hand(s) 7020 and/or 7022 include a direct air gesture input that is based on a position of the representation of the user's hand(s) 7020′ and/or 7022′ displayed within the user interface on the display of HMD 7100a. For example, a direct air gesture input is determined as being directed to a user interface object displayed at a position that intersects with the displayed position of the representation of the user's hand(s) 7020′ and/or 7022′ in the user interface. In some embodiments, the one or more gestures performed with the user's hand(s) 7020 and/or 7022 include an indirect air gesture input that is based on a virtual object displayed at a position that corresponds a position at which the user's attention is currently detected (e.g., and/or is optionally not based on a position of the representation of the user's hand(s) 7020′ and/or 7022′ displayed within the user interface). For example, an indirect air gesture is performed with respect to a user interface object while detecting the user's attention (e.g., based on gaze or other indication of user attention) on the user interface object, such as a gaze and pinch (e.g., or other gesture performed with the user's hand).

In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

In some embodiments, one or more portions of the view of physical environment 7000 that is visible to user 7002 via display generation component 7100 or display generation component 7100a are digital passthrough portions that include representations of corresponding portions of physical environment 7000 captured via one or more image sensors of computer system 101. In some embodiments, one or more portions of the view of physical environment 7000 that is visible to user 7002 via display generation component 7100 or display generation component 7100a are optical passthrough portions, in that user 7002 can see one or more portions of physical environment 7000 through one or more transparent or semi-transparent portions of display generation component 7100 or display generation component 7100a.

FIG. 7A illustrates a physical environment that includes a physical wall 7004, a physical wall 7006, a physical floor 7008, the user 7002, the user's left hand 7020, the user's right hand 7022, and a physical object 7014. The user 7002 is at a first position 7026-a in the physical environment.

The display generation component 7100 of the computer system 101 displays a first view of a three-dimensional environment (e.g., that includes both virtual elements and representation of physical objects), and the computer system 101 is held by a hand 7022 of a user 7002. For example, the first view of the three-dimensional environment includes several representations of physical objects, including a representation 7014′ of the physical object 7014, a representation 7004′ of the physical wall 7004, and a representation 7008′ of the physical floor. The first view also includes a virtual object 7012, and a user interface 7032, which do not correspond to or represent any objects in the physical environment. In some embodiments, the user interface 7032 includes one or more interactive elements, such as an affordance 7034, an affordance 7036, an affordance 7038, and/or and affordance 7040 (e.g., affordances for interacting with the user interface 7032 and/or the three-dimensional environment displayed via the display generation component 7100). In some embodiments, the user interface 7032 is an application user interface (e.g., a window or other user interface of an application of the computer system 101).

In some embodiments, the display generation component 7100 comprises a head mounted display (HMD) 7100a. For example, as illustrated in FIG. 7F2 (e.g., and FIG. 8J2), the head mounted display 7100a includes one or more displays that displays a representation of a portion of the three-dimensional environment 7000′ that corresponds to the perspective of the user, while an HMD typically includes multiple displays including a display for a right eye and a separate display for a left eye that display slightly different images to generate user interfaces with stereoscopic depth, in the figures a single image is shown that corresponds to the image for a single eye and depth information is indicated with other annotations or description of the figures. In some embodiments, HMD 7100a includes one or more sensors (e.g., one or more interior-facing and/or exterior-facing image sensors 314), such as sensor 7101a, sensor 7101b and/or sensor 7101c for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments input elements are mechanical input elements, in some embodiments input elements are solid state input elements that respond to press inputs based on detected pressure or intensity. For example, in FIG. 7F2 (e.g., and FIG. 8J2), HMD 7100a includes one or more of button 701, button 702 and digital crown 703 for providing inputs to HMD 7100a. It will be understood that additional and/or alternative input devices may be included in HMD 7100a.

FIG. 7F3 (e.g., and FIGS. 8J3) illustrates a top-down view of the user 7002 in the physical environment 7000. For example, the user 7002 is wearing HMD 7100a, such that the user's hand(s) 7020 and/or 7022 (e.g., that are optionally used to provide air gestures or other user inputs) are physically present within the physical environment 7000 behind the display of HMD 7100a.

FIG. 7F2 (e.g., and FIG. 8J2) illustrates an alternative display generation component of the computer system than the display illustrated in FIGS. 7A-7F1, 7G-8J1 and 8K-8R. It will be understood that the processes, features and functions described herein with reference to the display generation component 7100 described in FIGS. 7A-7F1, 7G-8J1 and 8K-8R are also applicable to HMD 7100a, illustrated in FIGS. 7F2-7F3 and 8J2-8J3.

In some embodiments, the computer system 101 includes one or more sensors that track a gaze and/or eyes of the user 7002. In some embodiments, the computer system 101 displays a visual indicator (e.g., the arrow representing the user 7002's attention 7010) that represents a location that the computer system 101 detects the user's gaze as directed to. In some embodiments, the computer system 101 detects the user's attention 7010, but does not display a visual indicator on the display (e.g., and optionally, uses other forms of visual feedback, such as highlighting, simulated three-dimensional effects, and/or animations, in order to provide visual feedback regarding a detected location to which the user 7002's attention is directed). In some embodiments, the computer system 101 detects the location of the user's attention 7010 based on a pointing gesture provided by the user or based on a pointing direction of a pointing device.

The first view of the three-dimensional environment also includes a region 7028 and a region 7030, for triggering display of one or more specific user interface elements (e.g., a system function menu 7046 and/or an indicator 7042 (e.g., of the system function menu), as described in further detail below). In some embodiments, the system function menu 7046 and/or the indicator 7042 are not displayed unless the user's attention 7010 is directed to a location within the region 7028 and/or the region 7030 (e.g., and selection criteria, such as a predefined hand gesture of the hand 7002 and/or movement of the hand 7002, are met). For example, in FIG. 7A, the user's attention 7001, the user's attention 7003, and the user's attention 7005 are directed to locations that are not within the region 7028 or the region 7030. Even if the user 7002 performs a user input that meets selection criteria (e.g., a respective user input sometimes referred to herein as “the selection input,” which is a user input that includes a hand gesture by the hand 7020 and/or movement of the hand 7020, such as an air tap, an air pinch, or another air gesture, that meets the selection criteria), the computer system 101 does not display the system function menu 7046 or the indicator 7042.

In some embodiments, in response to detecting the user's attention 7001, the user's attention 7003, and/or the user's attention 7005 (e.g., in conjunction with the selection input), the computer system 101 performs different functions (e.g., other than displaying the system function menu 7046 and/or the indicator 7042).

For example, in response to detecting the user's attention 7001 directed to the affordance 7040 of the user interface 7032 (e.g., in conjunction with the selection input), the computer system 101 performs a function corresponding to the user interface 7032 (e.g., displaying content in the user interface 7032, updating displayed content in the user interface 7032, changing a size and/or position of the user interface 7032, or changing one or more settings for the user interface 7032).

For example, in response to detecting the user's attention 7003 directed to the representation 7014′ of the physical object 7014 (e.g., in conjunction with the selection input), the computer system 101 performs a function corresponding to the representation 7014′ of the physical object 7014 (e.g., applies a visual effect to a surface of the representation 7014′ of the physical object 7014, or adds and/or removes virtual content corresponding to a surface of the representation 7014′ of the physical object 7014).

For example, in response to detecting the user's attention 7005 directed to the virtual object 7012 (e.g., in conjunction with the selection input), the computer system 101 performs a function corresponding to the virtual object 7012 (e.g., changes a visual appearance of the virtual object 7012, changes a position and/or size of the virtual object 7012, or ceases to display the virtual object 7012).

For example, in response to detecting the user's attention 7010 directed to a location that does not correspond to any user interface elements (e.g., the user 7002's attention is not directed to any specific or interactive element in the displayed view of the three-dimensional environment) (e.g., in conjunction with the selection input), the computer system 101 forgoes performing any functions (e.g., because there are no interactive elements at the location to which the user's attention 7010 is directed).

In FIG. 7B, the user's attention 7010 is directed to a location within the region 7028, but outside the region 7030. In response, the computer system 101 displays the indicator 7042. In some embodiments, the indicator 7042 is displayed in response to detecting the user's attention 7010 directed to the location within the region 7028, but outside the region 7030, in conjunction with the selection input. In some embodiments, the indicator 7042 is displayed in response to detecting the user's attention 7010 directed to the location within the region 7024, but outside the region 7030, regardless of whether the user 7002 performs the selection input with the hand 7020 (e.g., and optionally, performing the selection input while the user's attention 7010 is directed to the location within the region 7028, but outside the region 7030, does not result in any additional functionality and/or display of additional user interface elements).

In some embodiments, the indicator 7042 is an indicator of a system function menu (e.g., the system function menu 7046, described in further detail below). In some embodiments, the indicator 7042 is displayed when the user's attention 7010 is directed to the location within the region 7028, but outside the region 7030, such that the region 7028 serves as a “hint region.” In other words, once the user's attention 7010 moves within the “hint region” (e.g., but not within the region 7030), the computer system 101 displays the indicator 7042 as a “hint” that additional functionality is available if the user's attention is directed within the smaller region 7030 and/or to the indicator 7042 itself (e.g., additional functionality described below in further detail, with respect to FIGS. 7D-7N).

In some embodiments, one or more visual characteristics of the indicator 7042 provide visual feedback regarding a state of the computer system 101. For example, the indicator 7042 has a first color (e.g., orange or red), if the computer system 101 is currently recording audio and/or processing inputs from one or more audio sensors (e.g., the user 7002 is in a phone call or other audio-only communication session with another user of another electronic device (e.g., that is in communication with the computer system 101). The indicator 7042 has a different color (e.g., green or blue) if the computer system 101 is currently recording audio and video, and/or processing inputs from both an audio sensor and a video sensor (e.g., the user 7002 is in a video call, and/or a AR or VR communication session, with another user of another electronic device (e.g., that is in communication with the computer system 101). In some embodiments, the indicator 7042 has a different appearance (e.g., a different shape and/or displaying a first icon or image) when there is a pending notification or system alert that the user 7002 has not yet viewed or otherwise interacted with (e.g., and the icon and/or image corresponds to an application that generated the notification or alert).

In FIG. 7C, the user's attention 7010 moves to a new location that is within the region 7028, but remains outside the region 7030. The computer system 101 maintains display of the indicator 7042, but does not otherwise perform additional functions and/or display additional user interface elements. In some embodiments, the computer system 101 maintains display of the indicator 7042, regardless of whether the user 7002 performs the selection input with the hand 7020 (e.g., and optionally, performing the selection input while the user's attention 7010 is directed to the new location within the region 7028, but outside the region 7030, still does not result in any additional functionality and/or display of additional user interface elements).

In FIG. 7D, the user's attention 7010 moves to a new location that is within the region 7030 (e.g., but is not directed to the indicator 7042, which is displayed within the region 7030). In some embodiments, in response to detecting the user's attention 7010 directed to the new location that is within the region 7030, the computer system 101 changes an appearance of the indicator 7042 (e.g., displays the indicator 7042 with a larger size). In some embodiments, changing the appearance of the indicator 7042 includes displaying an animated transition (e.g., displaying an animation of the indicator 7042 expanding in size from the size shown in FIG. 7C to the size shown in FIG. 7D). In some embodiments, changing the appearance of the indicator 7042 includes changing a shape, color, and/or other visual characteristic of the indicator 7042.

In some embodiments, when the user's attention 7010 is directed to a location that is near (e.g., within a threshold distance from, and/or within a preconfigured enclosing region of) the indicator 7042 (e.g., and optionally, the user's attention 7010 is directed to a location that is within the threshold distance from the indicator 7042 as long as the user's attention 7010 is directed to any location within the region 7030), the computer system 101 applies a visual effect to the indicator 7042. For example, the computer system 101 applies a lighting effect (e.g., an illuminated circle, centered on the location to which the user's attention 7010 is directed) to the indicator 7042. In some embodiments, the visual effect is centered on the location to which the user's attention 7010 is directed, but the visual effect is applied to the indicator 7042 without applied to other indicators or objects (e.g., the visual effect appears on portions of the indicator 7042, but not on other objects or the background). In some embodiments, an appearance of the visual effect is selected in accordance with the location to which the user's attention 7010 is directed. For example, when the user's attention 7010 is directed to a location that is far from the indicator 7042, such as in FIG. 7D, a lighting effect is applied to a lower left region of the indicator 7042 (e.g., a lower left quadrant of the indicator 7042). When the user's attention is directed to a different location within the region 7030 (e.g., at the same or similar horizontal location as in FIG. 7D, but closer to the indicator 7042 in a vertical direction), the lighting effect is applied to the indicator 7042, except in an upper right quadrant of the indicator 7042. In other words, the lighting effect is displayed with a size and/or a location that reflects the relative position and distance of the user's attention to the indicator 7042.

In some embodiments, if the user 7002 performs the selection input with the hand 7020 while the user's attention 7010 is directed to the new location within the region 7030, the computer system 101 does not perform additional functions and/or display additional user interface elements. In some embodiments, if the user 7002 performs the selection input with the hand 7020 while the user's attention 7010 is directed to the new location within the region 7030, the computer system 101 displays the system function menu 7046 (e.g., as shown in FIG. 7G, and skipping over FIGS. 7E-7F).

In FIG. 7E, the user's attention 7010 moves to a location that is outside the region 7030, but still within the region 7028. In response to detecting the user's attention is no longer directed to a location within the region 7030, the computer system 101 changes the appearance of the indicator 7042 (e.g., back to the appearance of the indicator 7042 in FIGS. 7B and 7C). In some embodiments, if the user's attention 7044 moves to a location that is outside both the region 7030 and the region 7028, the computer system 101 ceases to display the indicator 7042. In some embodiments, changing the appearance of the indicator 7042 includes displaying an animated transition (e.g., an animated transition of the indicator 7042 shrinking in size, and/or disappearing, depending on where the user's attention 7010 is directed).

FIG. 7F (e.g., FIGS. 7F1, 7F2 and 7F3, where a user interface analogous to the user interface shown in FIG. 7F1 is shown on HMD 7100a in FIG. 7F2) illustrates an alternative to FIG. 7E, where the user's attention 7010 is instead directed to the indicator 7042. In response to detecting the user's attention 7010 directed to the indicator 7042 (e.g., in conjunction with the selection gesture), the computer system 101 changes an appearance of the indicator 7042 (e.g., changes a size, a color, a shape, opacity, and/or a brightness of the indicator 7042). In some embodiments, changing the appearance of the indicator 7042 includes displaying one or more additional user interface elements (e.g., additional indicators, such as a chevron or another circular indicator like the indicator 7042).

While the user's attention 7010 is directed to the indicator 7042, the user performs the selection gesture (e.g., a direct or indirect air gesture) with the hand 7020 (e.g., and/or hand 7022, as illustrated by representation of hand 7022′ in FIG. 7F2). For example, FIG. 7F2 illustrates an indirect hand gesture performed with the representation of the user's hand 7022′ while the user's attention 7010 is directed to the indicator 7042. In response to detecting the user's attention 7010 directed to the indicator 7042 in conjunction with the selection gesture, and as shown in FIG. 7G, the computer system 101 displays the system function menu 7046.

FIG. 7G illustrates the system function menu 7046, which includes an affordance 7048, an affordance 7050, an affordance 7052, an affordance 7045, an affordance 7056, and an affordance 7058 (e.g., affordances for accessing one or more system functions of the computer system 101). In some embodiments, if the user 7002 activates a respective affordance of the system function menu 7046 (e.g., by directing the user's attention 7010 to the respective affordance, optionally in conjunction with a predefined user input that is optionally the same as the selection input), the computer system 101 displays a respective user interface for a respective system function (e.g., sometimes referred to herein as a “system space”). In some embodiments, the system function menu 7046 is displayed with a default position that has a first spatial relationship to (e.g., centered on, and slightly below) the indicator 7042 (e.g., but that spatial relationship is not necessarily maintained if the indicator 7042, the user 7002, and/or a viewpoint of the user 7002 moves). In some embodiments, the system function menu 7046 replaces display of the indicator 7042 (e.g., when the system function menu 7046 is displayed, the indicator 7042 is no longer displayed), as represented by the dotted outline of the indicator 7042 in FIG. 7G.

While displaying the system function menu 7046, the user's attention 7010 is directed to the affordance 7048 (e.g., a home affordance, and/or application library affordance), optionally in conjunction with a predefined user input (e.g., a user input analogous to the selection input described above). In response, as shown in FIG. 7H, the computer system 101 displays a system space 7060. In some embodiments, the system space 7060 includes a home menu user interface that includes a collection of representations or affordances that are arranged in a regular pattern (e.g., in a grid pattern, along a line, radially, circumferentially, and/or other patterns). In some embodiments, the representations or affordances correspond to various software applications that can be executed on computer system 101 (e.g., an email application, a web browser, a messaging application, a maps application, a video player, an audio player, or other software application). For example, user input (e.g., a pinch input, a tap input, a gaze input, and/or other input) directed to a representation or affordance in home menu user interface launches a software application associated with the representation or affordance in the three-dimensional environment.

In some embodiments, the system space 7060 includes a plurality of affordances (e.g., such as an affordance 7072, and/or seven other affordances that are analogous the affordance 7072). In some embodiments, one or more affordances of the plurality of affordances include an application launch affordance (e.g., the affordance 7046 is an application launch icon or an application icon), which when activated (e.g., by the user 7002 performing a predefined gesture while the user's attention 7010 is directed to the affordance 7072), causes the computer system 101 to display an application user interface (e.g., of an application that corresponds to the activated application launch affordance). In some embodiments, the one or more affordances of the plurality of affordances include a user contact affordance (e.g., the affordance 7072 is an icon or other visual representation corresponding to a user contact stored in memory of the computer system 101), which when activated, cause the computer system 101 to display a contact user interface (e.g., a user interface that includes contact information and/or one or more options for initiating a communication session or otherwise communicating with a respective user contact that corresponds to the activated user contact affordance). In some embodiments, the one or more affordances of the plurality of affordances include an experience affordance (e.g., the affordance 7046), which when activated, causes the computer system 101 to display virtual content and/or initiate a virtual reality or augmented reality experience.

In some embodiments, the system space 7060 includes at least two of: an application launch affordance, a user contact affordance, and an experience affordance. In some embodiments, the system space 7060 provides access to different types of affordances (e.g., application launch affordances, user contact affordances, and/or experience affordances), but displays one type of affordance at a time. For example, in FIG. 7H, the system space 7060 could display application launch affordances (e.g., each cube, which represents a respective affordance, is an application launch affordance) without displaying other types of affordances, such as the contact affordances and/or experience affordances. The user 7002 can switch between the different types of affordances by interacting with one or more of three affordances in the user interface, which are represented by the square, the circle, and the two triangles, which are stacked vertically along the left side of the system space 7060. In some embodiments, the computer system 101 displays a respective type of affordance in response to detecting the user's attention 7010 directed to a respective affordance that corresponds to the respective type of affordance, optionally in conjunction with a predefined gesture (e.g., the circle affordance corresponds to the user contact affordance type, and the user 7002 can switch to displaying user contact affordances by directing the user's attention to the circle affordance and performing the predefined gesture).

As shown in FIG. 7H, in some embodiments, system spaces such as the system space 7060 are displayed in front of (e.g., closer to a viewpoint of the user 7002) and/or partially overlapping the system function menu 7046. In some embodiments, the computer system 101 ceases to display the system function menu 7046 when displaying the system space 7060 (e.g., when activated/displayed, system spaces replace display of the system function menu 7046). In some embodiments, a system space, such as the system space 7060, has a first spatial relationship to the system function menu 7046. If the system function menu is repositioned or redisplayed at a new location (e.g., as described below in greater detail, with reference to FIGS. 7K-7N), system spaces such as the system space 7060 are repositioned (e.g., automatically, without requiring a user input) such that the system space 7060 maintains the first spatial relationship to the system function menu 7046. In some embodiments, system space 7060 is consistently displayed with the first spatial relationship to the system function menu 7046 (e.g., if the system space 7060 cease to be displayed, and the system function menu 7046 is repositioned and/or redisplayed in a new location, and the system space 7060 is subsequently redisplayed).

FIG. 7I illustrates an alternative to FIG. 7G, where the user's attention 7010 is instead directed to the affordance 7056. In response to detecting the user's attention 7010 directed to the affordance 7056, optionally in conjunction with a predefined user input (e.g., a user input analogous to the selection input described above), and as shown in FIG. 7J, the computer system 101 displays a system space 7084.

In some embodiments, the system space 7084 is a settings user interface which includes one or more affordances, such as sliders, buttons, dials, toggles, and/or other controls, for adjusting additional system settings of the computer system 101 (e.g., additional system settings that do not appear in system function menu 7046 itself). In some embodiments, the system space 7084 includes an affordance for transitioning the computer system 101 to an airplane mode, an affordance for enabling or disabling a cellular function of the computer system 101, an affordance for enabling or disabling a Wi-Fi function of the computer system 101, and/or an affordance for enabling or disabling a Bluetooth function of the computer system 101. In some embodiments, the system space 7084 includes a slider for adjusting a brightness setting (e.g., for the display) of the computer system 101. In some embodiments, the system space 7084 includes one or more controls associated with hardware functions of the computer system 101 (e.g., a flashlight function, and/or a camera function) and/or one or more controls associated with software functions of the computer system 101 (e.g., an alarm function, a timer function, a clock function, and/or a calculator function). In some embodiments, system space 7084 includes one or more affordances for controlling system settings of the computer system 101 that are also accessible using another affordance in system function menu 7046. For example, system space 7084 optionally includes a slider for adjusting an output volume level of the computer system 101, which can also be accessed and/or adjusted using an affordance 7050 (e.g., a volume affordance) in system function menu 7046. In some embodiments, the one or more sliders, buttons, dials, toggles, and/or other controls, are adjusted in response to detecting the user's attention 7010 (e.g., directed to the slider for adjusting an output volume level, as in FIG. 7J) in conjunction with a predefined user input (e.g., user input that includes a predefined hand gesture and/or movement of the user's hand 7020).

While FIG. 7G and FIG. 7J display two exemplary system spaces, the system function menu 7024 provides access to additional user interfaces. Some other exemplary system spaces are described below.

For example, in response to detecting the user's attention 7010 directed to the affordance 7052 (e.g., a search affordance), optionally in conjunction with a predefined user input (e.g., analogous to the selection input), the computer system 101 displays a system space corresponding to a search function of the computer system 101 (e.g., a “search system space”). In some embodiments, the search system space includes a text field for text entry (e.g., via one or more physical input mechanisms such as a physical keyboard and/or one or more virtual controls or user interface elements, such as a virtual keyboard). In some embodiments, the text field of the system space 7050 displays text of a search term or search query entered by the, such as text associated with (e.g., transcribed from) a detected verbal input from the user. In some embodiments, the search system space provides visual feedback as the user 7002 is speaking. In some embodiments, the visual feedback varies based on at least one characteristic (e.g., volume, speed, and/or length) of the verbal input. In some embodiments, search system space. In some embodiments, the text field of the search system space updates in real time (e.g., as the user 7002 is speaking). In some embodiments, the text field of the search system space displays the text of the detected verbal input after (e.g., in response to) detecting completion of the verbal input (and optionally after detecting that the user 7002 has stopped speaking for a threshold amount of time). In some embodiments, in response to detecting (e.g., completion of) the verbal input, the computer system 101 automatically performs one or more functions (e.g., an Internet search, an application search, a document or file search, and/or other content search) associated with the verbal input. In some embodiments, the computer system 101 performs the one or more functions associated with the verbal input in response to detecting a first portion of the verbal input, and continues to perform the one or more functions while the verbal input continues (e.g., the search is continually updated as additional portions of the verbal input are detected).

For example, in response to detecting the user's attention 7010 directed to the affordance 7054 (e.g., a notifications affordance), optionally in conjunction with a predefined user input (e.g., analogous to the selection input), the computer system 101 displays a system space corresponding to a notification center or notification history function of the electronic device (e.g., a “notifications system space”). In some embodiments, the notifications system space includes a plurality of notifications (e.g., recently generated or received notifications).

In some embodiments, the notifications that appear in the notifications system space can be configured by the user. For example, the user can configure the notifications system space to display notifications within a certain amount of time (e.g., the past 30 minutes, the past hour, or the past 12 hours) and not outside of the amount of time, the user can configure the notifications system space to display notifications from selected applications and not other applications (e.g., permitting display of notifications from a messaging application and/or an e-mail application, while suppressing display of notifications from other applications), and/or the user can configure how the notifications in the notifications system space are displayed (e.g., grouped by application, grouped by contact, and/or grouped by particular time window (e.g., received between 9 AM and 5 PM)).

For example, in response to detecting the user's attention 7010 directed to the affordance 7050 (e.g., a volume affordance), optionally in conjunction with a predefined user input (e.g., analogous to the selection input), the computer system 101 displays a volume system space. In some embodiments, the volume system space includes one or more controls (e.g., dials, sliders, and/or other adjustable controls) for adjusting one or more volume/audio levels of the computer system 101. In some embodiments, a respective control in the volume system space adjust the respective volume/audio level for a particular hardware component (e.g., a first speaker and a second speaker of the portable multifunction device 100), application (e.g., each application of the portable multifunction device 100 has a corresponding control for adjusting a volume/audio level of that application), and/or type of audio (e.g., system-related audio, application-related audio, and/or notification-related audio). In some embodiments, the volume system space includes a respective slider for a respective audio level that is selected based on context and/or a state of the portable multifunction device 100 (e.g., if the portable multifunction device 100 is playing music, then the respective slider adjusts audio for a music application; if the portable multifunction device 100 is connected to a communication session, the respective slider adjusts audio for phone calls, video calls, and/or virtual reality communication sessions; and/or if the portable multifunction device 100 is generating an audio alert, the respective slider adjusts audio for notifications and/or alert sounds). In some embodiments, the volume system space includes a user interface 8014 and/or a user interface 8016, as described in further detail below with reference to FIGS. 8A-8R.

In some embodiments, the system function menu 7024 includes additional affordances for accessing other system spaces in addition to and/or in place of those shown in FIGS. 7G-7J. For example, the system function menu 7024 includes an affordance, which when activated, displays a system space for selecting (e.g., and/or displaying) different virtual environments. Exemplary virtual environments include a simulated “light” or “dark” mode for a currently displayed three-dimensional environment, and/or a day or night mode for a currently displayed three-dimensional environment. In some embodiments, the virtual environments include a virtual or mixed reality environment for various natural settings (e.g., beach, mountains, underwater, and/or other natural settings), geographical locations (e.g., urban environment, coffee shop, library, theater, and/or other locations and/or landmark), experiences (e.g., camping, fishing, rafting, and/or other virtual experiences), for example. In some embodiments, the system space for selecting different virtual environments also includes one or more affordances for controlling settings corresponding to virtual environments. Exemplary settings include a time of day setting for controlling a simulated time of day in the currently displayed three-dimensional environment, and/or a volume setting for adjusting sounds associated with the currently display three-dimensional environment.

In some embodiments, one or more affordances of the system function menu 7024 do not correspond to a system space. For example, in response to detecting the user's attention 7010 directed to the affordance 7058 (e.g., a voice assistant affordance), optionally in conjunction with a predefined user input (e.g., analogous to the selection input), the computer system 101 does not display any system space (e.g., but still provides access to and/or enables one or more system functions of the computer system 101). In some embodiments, while the user's attention 7010 is directed to the affordance 7058, the user 7002 can interact (e.g., via verbal inputs and/or voice commands) with a virtual assistance of the computer system 101. In some embodiments, the computer system 101 changes an appearance of the affordance 7058 while the user 7002 is interacting with the virtual assistant and/or while access to the virtual assistant is enabled (e.g., by highlighting, displaying a selection outline around, enlarging, and/or animating the affordance 7058). In some embodiments, the computer system 101 displays visual feedback to indicate that a verbal input to the virtual assistant is being detected. In some embodiments, in response to detecting completion of a verbal input, the virtual assistant of the computer system 101 automatically performs one or more functions corresponding to the verbal input (e.g., executes a voice command).

In FIG. 7K, the user 7002 moves to a new position 7026-b in the physical environment (e.g., changing a viewpoint of the user relative to the physical environment and the three-dimensional environment). In response to detecting movement of the user 7002 from the old position 7026-a to the new position 7026-b (and changing the viewpoint of the user relative to the relative to the physical environment and the three-dimensional environment), the computer system 101 updates the displayed view of the three-dimensional environment. The representation 7014′ of the physical object 7014 has been shifted to the left (e.g., to reflect the movement of the user 7002 relative to the physical object 7014 in the physical environment), and the virtual object 7012 has also been shifted to the left (e.g., by the same amount or a similar amount). In some embodiments, as described in further detail below with reference to FIGS. 7O-7R, an appearance of the system function menu 7046 changes as the user 7002 moves (e.g., farther) away from the system function menu 7046. For case of illustration, however, no changes in the appearance of the system function menu 7046 are shown in FIGS. 7K and 7L.

In some embodiments, the system function menu 7046 and/or system spaces (e.g., the system space 7084) are world-locked and/or environment-locked, such that the system function menu 7046 and/or system spaces maintain a specific spatial relationship to (e.g., a reference point in) the three-dimensional environment. When the user 7002 moves to the new position 7026-b, the system function menu 7046 and the system space 7084 are also shifted to the left in the updated view of the three-dimensional environment. The user 7002 can continue to interact with the system function menu 7046 and/or the system space 7084 (e.g., as shown by the user's attention 7010 directed to affordances of the system space 7084 in FIG. 7K), as described above, but at the updated locations in the view of the three-dimensional environment).

In FIG. 7L, the user's attention 7010 is directed to a location within the region 7028, but outside the region 7030. FIG. 7L is analogous to FIG. 7B, but while the computer system 101 displays the updated view of the three-dimensional environment that corresponds to the user 7002's new position 7026-b. In response to detecting that the user's attention is directed to the location within the region 7028, but outside the region 7030, the computer system 101 displays (e.g., redisplays) the indicator 7042 (e.g., consistent with the behavior of the computer system 101 as described above with reference to FIG. 7B).

In FIG. 7M, the user's attention 7010 is directed to the indicator 7042. In response to detecting that the user's attention 7010 is directed to the indicator 7042, and that the user 7002 performs the selection input, the computer system 101 displays (e.g., redisplays) the system function 7046. The system function menu 7046 is displayed (e.g., repositioned or redisplayed) at the default location that has the first spatial relationship to the indicator 7046 (e.g., the system function menu 7046 in FIG. 7M is displayed centered on, and slightly below, the indicator 7042). In some embodiments, the system function menu 7046 is repositioned from a previous position (e.g., shown by an outline 7112) if the distance between the old position and the new position (e.g., shown in FIG. 7M) is less than a threshold distance. In some embodiments, the system function menu 7046 ceases to be displayed at the old position and the system function menu 7046 is redisplayed at the new position (e.g., in FIG. 7M) if the distance between the old position and the new position is, or exceeds, the threshold distance.

The outline 7112 and an outline 7114 illustrate the previous positions of the system function menu 7046 and the system space 7084, respectively, before the user's attention 7010 was directed to the indicator 7042 (e.g., the positions of the system function menu 7046 and the system space 7084 in FIG. 7L). In some embodiments, when the system function menu 7046 is repositioned or redisplayed, the system space 7114 ceases to be displayed. In some embodiments, when the system function menu 7046 is repositioned or displayed, the system space 7114 is also repositioned or redisplayed (e.g., in an analogous fashion to the system function menu 7046, and/or to maintain the same or substantially the same spatial relationship between the system space 7084 and the system function menu 7046 as in FIGS. 7J-7L).

In some embodiments, the computer system 101 displays an animated transition of the system function menu 7046 being repositioned and/or redisplayed. For example, if the system function menu 7046 is repositioned without being redisplayed (e.g., because the new location of the system function menu 7046 is a short distance from the previous location of the system function menu), the animated transition includes displaying an animation of the system function menu 7046 sliding (e.g., or otherwise moving) from the previous location to the new location. If the new location of the system function menu 7046 is a long distance from the previous location, the animated transition includes an animation of the system function menu 7046 fading out at the previous location and fading in (e.g., reappearing) at the new location. If the new location of the system function menu 7046 is a medium distance from the previous location, the animated transition includes an animation of the system function menu 7046 sliding and fading out (e.g., before the system function menu 7046 reaches the new location), and sliding and fading in (e.g., reappearing and sliding into place) at the new location (e.g., a mix of the “short distance” and “long distance” animations).

In some embodiments, in contrast to the system function menu 7046 and/or system spaces, the region 7028 and the region 7030 are viewpoint-locked/head-locked, such that the region 7028 and the region 7030 maintain a spatial relationship to the viewpoint (e.g., the display) through which the view of the three-dimensional environment is displayed. In other words, regardless of the movement of the user 7002, and/or what is displayed via the display generation component 7100, the region 7030 and the region 7028 always appear in the same or substantially the same location (e.g., top center) relative to the physical viewport (e.g., physical display or screen) of the computer system 101.

In FIG. 7N, the user's attention 7010 is directed to the affordance 7058. In response to detecting the user's attention 7010 is directed to the affordance 7058, and that the user 7002 performs a predefined gesture (e.g., an analogous gesture to the selection gesture), the computer system 101 ceases to display the system function menu 7046 (e.g., and optionally, any system space that was displayed concurrently with the system function menu 7046). In some embodiments, the computer system 101 ceases to display the system function menu 7046 in response to detecting the user's attention 7010 is directed to the affordance 7058, and that the user 7002 performs the predefined gesture (e.g., to avoid scenarios where the user 7002 can unintentionally cease to display the system function menu 7046). In some embodiments, the computer system 101 also ceases to display the system function menu 7046 if the user's attention 7010 is directed to a location in the view of the three-dimensional environment other than the system function menu 7046 and/or the indicator 7042 (e.g., regardless of where that location is, such as to another user interface such as the user interface 7032 in FIG. 7A), and optionally, the user 7002 performs a dismissal gesture (e.g., to provide additional flexibility and options for ceasing to display the system function menu 7046). In some embodiments, the computer system 101 also ceases to display the system function menu 7046 if the user's attention 7010 is directed to a location in the view of the three-dimensional environment other than the system function menu 7046 and/or the indicator 7042 (e.g., optionally, and any other user interface or user interface object that responds to user inputs) and the user performs a dismissal gesture (e.g., an air tap, an air pinch, and/or another air gesture).

FIGS. 7O-7R illustrate that, in some embodiments, the computer system 101 ceases to display the system function menu 7046 when the user 7002 (e.g., a viewpoint of the user 7002) moves beyond a threshold distance from a previous location (e.g., the current viewpoint of the user 7002 changes to a new viewpoint that is outside of respective spatial range of the original viewpoint of the user 7002). In FIGS. 7O-7R (and in FIG. 7U), the system function menu 7046 is shown with an alternate appearance (e.g., a different appearance as compared to FIG. 7N), but the system function menu 7046 otherwise has similar or identical behavior and characteristics as the system function menu 7046 described previously in FIGS. 7A-7N.

In FIG. 7O, the user 7002 moves to a new position 7026-c, which changes the viewpoint of the user 7002 (e.g., the new viewpoint of the user at the position 7026-c is different from the previous viewpoint of the user 7002 at the position 7026-b). Compared to the original position 7026-b, the new position 7026-c is farther away from the system function menu 7046 (e.g., and so the system function menu 7046, the representation 7014′ of the physical object 7014, and the virtual object 7012 are displayed further from the current viewpoint of the user 7002 at the position 7026-c, and appear smaller in size than in the previous viewpoint of the user 7002 at the position 7026-b). FIG. 7O also includes a top-down view (e.g., in the lower right portion of FIG. 7O), which shows the user 7002's current position 7026-c, relative to the user 7002's original position 7026-b, and the system function menu 7046. The top-down view also includes a boundary 7116. In FIG. 7O, the new position 7026-c is still within the boundary 7116 (e.g., no portion of the user 7002 has crossed the boundary 7116).

Compared to the view of the three-dimensional environment visible from the user 7002's previous viewpoint (e.g., at the position 7026-b) in FIG. 7N, in the view of the three-dimensional environment that is visible from the user 7002's new viewpoint (e.g., at the position 7026-c) in FIG. 7O, the representation 7014′ of the physical object 7014, the virtual object 7012, and the system function menu 7046 are displayed farther away from the viewpoint of the user 7002 (e.g., because the user 7002 has moved to the new position 7026-c, which is farther away from the representation 7014′, the virtual object 7012, and the system function menu 7046 (e.g., an environment-locked system function menu).

Since the user 7002's new position 7026-c (e.g., and/or the viewpoint of the user 7002 at the position 7026-c) is still within the boundary 7116 (e.g., no portion of the user 7002 is outside of the boundary 7116, and/or the viewpoint of the user 7002 remains within a spatial range of the original viewpoint of the user 7002 at the position 7026-b), the computer system 101 maintains display of the system function menu 7046, but the system function menu 7046 is displayed (e.g., and/or moved to a new position in the three-dimensional environment) with a different visual appearance (e.g., a dimmer appearance, a reduced opacity appearance, and/or a blurrier appearance, as represented by the diagonal line pattern applied to the system function menu 7046 in FIG. 7O). In some embodiments, displaying the system function menu 7046 with the different visual appearance includes changing a respective value for one or more display properties (e.g., a brightness, opacity, a sharpness, and/or a color) of the system function menu 7046.

In some embodiments, the boundary 7116 defines a threshold amount of movement of the user 7002 from an original position. For example, in FIG. 7O, the original position is the position 7026-b, and the boundary 7116 is defined relative to the original position 7026-b. In some embodiments, the boundary 7116 allows for a different amount of movement (e.g., a first threshold amount of movement) in a first direction, and a different amount of movement (e.g., a second threshold amount of movement, different than the first threshold amount of movement) in a second direction, Stated differently, the boundary 7116 may have a shape such that movement of the user 7002 by a first distance in a first direction causes the user to cross the boundary 7116 sooner (e.g., or later) than movement of the user 7002 by the first distance in a second direction. For example, for the boundary 7116 in FIG. 7O, movement of the user 7002 backwards (e.g., away from the system function menu 7046), directly to the left, and/or direction to the right, all cause the user 7002 to cross the semi-circular region of the boundary 7116 after moving substantially the same distance. In contrast, movement of the user 7002 in a forward direction (e.g., a direction that decreases the distance between the user 7002 (or, optionally, the viewpoint of the user 7002) and the system function menu 7046), requires a farther distance before the user 7002 crosses the (e.g., rectangular portion of the) boundary 7116. In some embodiments, the boundary 7116 has a customizable (e.g., user-defined) shape and/or size (e.g., to allow the user 7002 to customize how far the user 7002 can move from the system function menu 7046 before the computer system 101 ceases to display the system function menu 7046).

For ease of illustration and description, reference is made to the position of the user 7002 relative to the boundary 7116. In some embodiments, the boundary 7116 is defined relative to an original viewpoint of the user 7002 (e.g., a viewpoint of the user 7002 that is visible from the position 7026-b, in FIG. 7O), and the boundary 7116 represents a “spatial range” of the original viewpoint of the user 7002. In such embodiments, the descriptions regarding a change in position of the user 7002 (e.g., movement of the user to a position that is inside or outside the boundary 7116) are also applicable to a change in viewpoint of the user 7002 (e.g., a change in viewpoint of the user 7002 such that the current viewpoint is within or outside the spatial range (e.g., defined by the boundary 7116) of the original viewpoint of the user 7002).

In some embodiments, after the appearance of the system function menu 7046 is changed, if the user 7002 (e.g., and/or the viewpoint of the user 7002) returns to the position 7026-b (e.g., and/or the original viewpoint of the user 7002 at the position 7026-b), the computer system 101 redisplays the system function menu 7026 with its original appearance (e.g., the system function menu is no longer displayed with a more translucent, dimmed, and/or blurred appearance, and/or the original appearance of the system function menu 7046 before movement of the user 7002 and/or the viewpoint of the user 7002 away from the position 7026-b and/or the viewpoint of the user 7002 at the position 7026-b).

In some embodiments, the computer system 101 changes the appearance of the system function menu 7046 if the user 7002 remains within the boundary 7116 at the new position 7026-c (e.g., and/or the viewpoint of the user 7002 remains within the spatial range of the original viewpoint of the user 7002 at the position 7026-b), but at least a portion of the user 7002 (e.g., and/or the viewpoint of the user 7002 at the position 7026-c) is within a threshold distance (e.g., 0.1, 0.2, 0.5, 1, 2, or 5 m) of the boundary 7116 (e.g., within a region that has an outer boundary defined by the boundary 7116, and an inner boundary that is threshold distance away from (e.g., extending inwards from) the boundary 7116).

In some embodiments, an amount of change in appearance of the system function menu 7046 reflects the relative position of the user 7002 (e.g., and/or the viewpoint of the user 7002) to the boundary 7116. For example, when the user 7002 (e.g., and/or the viewpoint of the user 7002) is close to (e.g., but still within) the boundary 7116, the system function menu (e.g., and/or a system space) is displayed with a very dim and/or very blurry appearance. When the user 7002 (e.g., and/or the viewpoint of the user 7002) is further from (e.g., but still within) the boundary 7116, the system function menu is displayed with a moderately dim and/or moderately blurry appearance. This provides visual feedback to the user 7002 regarding the current position of the user 7002 (e.g., and/or the current viewpoint of the user 7002) relative to the boundary 7116.

In FIG. 7P, the user 7002 has moved to a new position 7026-d, which changes the viewpoint of the user 7002, and results in a portion of the user 7002 crossing the boundary 7116 (e.g., as shown in the top-down view). Since the user's position 7026-d is outside the boundary 7116 (e.g., at least a portion of the user 7002 is outside of the boundary 7116 while the user 7002 is at the position 7026-d, and/or the viewpoint of the user 7002 at the position 7026-d is outside the spatial range of the original viewpoint of the user at the position 7026-b), the computer system 101 ceases to display the system function menu 7046.

FIGS. 7Q and 7R are analogous to FIGS. 70 and 7P, but show the user 7002 moving to a new position 7026-e and a new position 7026-f (e.g., and/or a change in viewpoint of the user 7002, as the user 7002 moves to the positions 7026-e and 7026-f), in a different direction (e.g., to the left of the original position 7026-b) as compared to FIGS. 70 and 7P.

In FIG. 7Q, the user 7002 moves to a new position 7026-e, which changes the viewpoint of the user. The computer system 101 updates the displayed view of the three-dimensional environment (e.g., the representation 7014′ of the physical object 7014, the virtual object 7012, and the system function menu 7046 are displayed at locations that are farther to the right (e.g., as compared to their locations in the view that is visible in FIG. 7N). The top-down view in FIG. 7Q shows the user 7002's new position 7026-e, relative to the user 7002's original position 7026-b, the system function menu 7046, and the boundary 7116 (e.g., the same boundary 7116 as in FIGS. 70 and 7P).

Since the user 7002's new position 7026-e is still within the boundary 7116 (e.g., and/or the viewpoint of the user 7002 at the position 7026-e is still within the spatial range of the original viewpoint of the user 7002 at the position 7026-b), the computer system 101 maintains display of the system function menu 7046, but the system function menu 7046 is displayed with a different visual appearance (e.g., a dimmer appearance, a reduced opacity appearance, and/or a blurrier appearance, as represented by the diagonal line pattern applied to the system function menu 7046 in FIG. 7Q, and which is optionally the same or substantially the same as the different visual appearance described above with reference to FIG. 7O).

In FIG. 7R, the user 7002 moves to (e.g., continues moving to) a new position 7026-f, which changes the viewpoint of the user 7002. At the new position 7026-f, at least a portion of the user 7002 has crossed the boundary 7116 (e.g., and/or the viewpoint of the user 7002 at the position 7026-f is outside the spatial range of the original viewpoint of the user 7002 at the position 7026-b), and as a result, the computer system 101 ceases to display the system function menu 7046.

In some embodiments, the behaviors of the system function menu 7046 described above with reference to FIGS. 7O-7R are also applicable to system spaces such as the system space 7060 in FIG. 7H and/or the system space 7084 in FIG. 7J (e.g., and/or other system spaces accessible from the system function menu 7046, as described above with reference to FIG. 7G).

FIGS. 7S-7U illustrate that, in some embodiments, displaying the system function menu 7046 causes at least some displayed user interface objects to be moved farther from the viewpoint of the user 7002 (e.g., “pushed back” in a simulated depth dimension relative to a viewpoint of the user).

FIG. 7S shows a view of the three-dimensional environment while neither the indicator 7042 nor the system function menu 7046 are displayed. The view of the three-dimensional environment also includes a user interface 7122. In some embodiments, the user interface 7122 is an application user interface (e.g., a window or other user interface that corresponds to an application of the computer system 101).

FIG. 7S also includes a top-down view showing the relative depth (e.g., z-direction or z-depth) of the displayed user interface objects, relative to the user 7002 (or, optionally, the viewpoint of the user). A boundary 7124 is also shown, which represents an extent of the virtual content (e.g., virtual environments, virtual backgrounds, and/or virtual experiences) that is currently being displayed by the computer system 101.

In FIG. 7T, the user's attention 7010 is directed to a location within the region 7030, and in response, the computer system 101 displays the indicator 7042. In some embodiments, because the indicator 7042 overlaps with (e.g., overlays and/or occludes) the user interface 7122, a portion of the user interface 7122 is displayed with a different appearance (e.g., dimmed, blurred, reduced in opacity, reduced in color saturation, and/or faded out, in order to maintain visibility of the indicator 7042), but optionally, some portions of the user interface 7122 (e.g., that are outside the region 7122) are not changed in appearance. In some embodiments, changing the appearance of the portion of the user interface 7122 includes changing a value for one or more display properties (e.g., brightness, opacity, sharpness, and/or color) of the portion of the user interface 7122.

In some embodiments, a region 7126 is centered on the indicator 7042, and any (e.g., portions of any) user interface objects that are within the region 7126 are displayed with different appearances (e.g., in an analogous manner as described above with reference to the portion of the user interface 7122) (e.g., the region 7126 represents a threshold spatial range of (e.g., centered on) the indicator 7042, and anything within the threshold spatial range is changed in appearance). As shown in the top-down view, the indicator 7042 is displayed at a location that is closer to the user 7002 (or, optionally, the viewpoint of the user) than any other user interface object. In some embodiments, no user interface objects are moved when the indicator 7042 is displayed (e.g., to make space for, and/or increase visibility of, the indicator 7042).

In FIG. 7U, the user's attention 7010 is directed to the indicator 7042 (e.g., and the user performs the selection gesture, such as the selection gesture described above with reference to FIG. 7F1), and in response, the computer system 101 displays the system function menu 7046. In contrast to FIG. 7T, when no user interface objects were moved when the indicator 7042 was displayed, in FIG. 7U, the computer system 101 moves (e.g., changes a position of) the user interface 7032 and the user interface 7122 to be farther from the viewpoint of the user 7002, when the system function menu 7046 is displayed. The outline 7128 shows the previous location of the user interface 7032, and the outline 7130 shows the previous location of the user interface 7122. This is also shown in the top-down view of the three-dimensional environment, where the user interface 7032 and the user interface 7122 are displayed farther from the viewpoint of the user 7002 (e.g., farther upwards, relative to their previous locations, which are represented by the outline 7128 and the outline 7130, respectively).

In some embodiments, only user interface objects that meet specific criteria (e.g., “push-back criteria”) are moved, while user interface object that do not meet the push-back criteria are not moved. For example, in FIG. 7U, the representation 7014′ of the physical object 7014, and the virtual object 7012, are displayed at the same positions as in FIG. 7T (e.g., are not moved).

In some embodiments, all displayed user interface objects are moved (e.g., by the same or substantially the same amount) when the system function menu 7046 is displayed. In some embodiments, only user interface objects that are visible in the view of the three-dimensional environment (e.g., visible from the viewpoint of the user 7002, when the system function menu 7046 is displayed), are moved. In some embodiments, a subset of displayed user interface objects (e.g., and/or objects that are visible in the current view of the three-dimensional environment) are moved.

In some embodiments, user interface objects that would at least partially overlap with the system function menu 7046 are user interface objects that meet the push-back criteria. For example, if the user interface 7122 was displayed at a location where the system function menu 7046 is to be displayed, the user interface 7122 would be moved when the system function menu 7046 is displayed (e.g., but other user interface objects, such as the user interface 7032 are optionally not moved, because they are not displayed at a location that would overlap with the system function menu 7046).

In some embodiments, specific types of user interface objects meet push-back criteria (e.g., while user interface objects that do not have a type that is one of the specific types, do not meet the push-back criteria). For example, “floating” user interface objects meet the push-back criteria, so the user interface 7032 and the user interface 7122 are moved (e.g., because the user interface 7032 and the user interface 7122 are not in contact with and/or otherwise associated with, a surface of the three-dimensional environment or physical environment), while the representation 7014′ of the physical object 7014 and the virtual object 7012 are not moved (e.g., because they are in contact with, placed on, lie on, and/or are otherwise associated with the representation 7008′ of the floor 7008). For example, user interfaces that are application windows meet the push-back criteria (e.g., so application windows are moved to increase visibility of the system function menu 7046, but no representations of physical objects and/or virtual objects are moved, which maintains consistency in the appearance of the three-dimensional environment). In some embodiments, specific user interface object types do not meet the push-back criteria (e.g., representations of physical environment, and/or representations of participants (e.g., other than the user 7002) in a shared virtual and/or augmented reality experience, and/or other participants in an active communication session that includes the computer system 101)). In some embodiments, similar behavior (e.g., moving and/or “pushing back” user interface objects when the system function menu 7046 is displayed) is also applicable when other user interface objects are displayed. For example, the same behavior of the user interface 7032, the user interface 7122, the representation 7014′ of the physical object 7014, and the virtual object 7012 applies when a system spaces such as the system space 7060 in FIG. 7H and/or the system space 7084 in FIG. 7J (e.g., and/or other system spaces accessible from the system function menu 7046, as described above with reference to FIG. 7G) are displayed (e.g., instead of, or in addition to, when the system function menu 7046 is displayed).

In some embodiments, the behaviors described above are not applicable to system alerts (e.g., status alerts, alerts for error conditions, and/or alerts triggered based on conditions established at a different time in the past via one or more user applications and/or system applications, and/or other alerts that are not generated in response to a user input but satisfaction of some previously established conditions other than a currently detected user input). For example, if the user interface 7122 corresponds to a system alert, the user interface 7122 is not moved in response to displaying the system function menu 7046 in FIG. 7U. In some embodiments, no user interface objects (e.g., the user interface 7032 and/or the user interface 7122) are moved in response to displaying a system alert (e.g., so that events that cause system alerts to be displayed do not also cause other user interface elements to be pushed away from a current viewpoint of the user 7002).

In some embodiments, if (e.g., and/or when) the system function menu 7046 ceases to be displayed (e.g., as described above with reference to FIGS. 7N-7R), any user interface objects that were moved when the system function menu 7046 are displayed at their original locations (e.g., the original locations before the user interface objects were moved). For example, in FIG. 7U, if the system function menu 7046 ceases to be displayed, the user interface 7032 returns to the position shown by the outline 7128, and the user interface 7122 returns to the position shown by the outline 7130 (e.g., the positions shown in FIGS. 7S and 7T, before the user interface 7032 and the user interface 7122 were moved).

FIGS. 7V-7AF show an alternative to FIGS. 7S-7U, where the indicator 7042 (e.g., of system function menu 7046) is not displayed when foreground content (e.g., the user interface 7122) is near and/or overlapping (e.g., is within a region 7132) around the indicator 7042.

FIG. 7V shows a view of the three-dimensional environment (e.g., the same three-dimensional environment described above with reference to FIGS. 7A-7U), which includes the region 7028 and the region 7030. FIG. 7V also includes a region 7132, which is smaller than (e.g., and optionally, a sub-region of) the region 7030 and/or the region 7028, as well as background content which includes a (e.g., virtual) palm tree 7134, a (e.g., virtual) cloud 7138, and a (e.g., virtual) cloud 7136. In some embodiments, foreground content includes system spaces, such as a home menu user interface (e.g., the system space 7060 described with reference to FIG. 7H), a settings user interface (e.g., the system space 7084 described with reference to FIG. 7J), or another user interface corresponding to a function of the computer system 101 (e.g., one or more system spaces corresponding to a search function, a notification history function, a volume control function, a virtual environment selection function, and/or a virtual assistant function, as described above with reference to FIGS. 7G-7J). In some embodiments, foreground content (e.g., the user interface 7122, the user interface 7032, the representation 7014′ of the physical object 7014, and/or the virtual object 7012) is displayed on top of (e.g., occluding, in front of, and/or closer to the viewpoint of the user 7002 as compared to) background content (e.g., the user interface 7122 is displayed on top of the palm tree 7134 and the cloud 7136; and the virtual object 7012 is displayed in front of the palm tree 7134).

In some embodiments, a respective application (e.g., installed on and/or stored in memory) of the computer system 101 identifies (e.g., defines) one or more foreground elements (e.g., that are associated with the respective application) as foreground content. For example, in FIG. 7V, the respective application identifies the user interface 7032 as foreground content (e.g., because the user 7002 interacts directly with the user interface 7032 via the affordance 7034, the affordance 7036, the affordance 7038, and/or the affordance 7040). In some embodiments, the respective application identifies (e.g., defines) background content (e.g., in addition to, or in lieu of, identifying foreground content). For example, the respective application may display or include ambient environmental content (e.g., but that a user does not and/or cannot interact with directly (e.g., via user inputs)). Allowing applications to define foreground and/or background (e.g., application) content allows for a more efficient man-machine interface, as important application content (e.g., interactive application elements that the user 7002 would interact with directly) can be defined as foreground content (e.g., removing the need to reposition and/or cease to display other user interface elements such as the indicator 7042 and/or the system function menu 7046, in order to access and/or make space for the interactive application elements), while other application content (e.g., non-interactive application elements) can be defined as background content (e.g., and foreground content is displayed on top of and/or in front of the background content, eliminating the need to reposition and/or cease to display background content in order to view or interact with foreground content).

Similar to FIG. 7D, the user's attention 7010 is directed to a location that is within the region 7030. In some embodiments, in response to detecting the user's attention 7010 directed to the location within the region 7030 (e.g., for a threshold amount of time, such as 0.1, 0.2, 0.3, 0.5, 1, 2, 5, or 10 seconds) (e.g., optionally, in conjunction with another user input such as an air tap, an air pinch, or another air gesture that is detected while the user's attention 7010 is directed to the location within the region 7030), and in accordance with a determination that foreground content (e.g., the user interface 7122, the user interface 7032, the representation 7014′ of the physical object 7014, and/or the virtual object 7012) is not within the region 7132, the computer system displays (e.g., via the head-mounted display 7100a or display generation component 7100 more generally) the indicator 7042. For example, in FIG. 7V, the user interface 7122 (e.g., foreground content) is within the region 7028 and the region 7030, but is not within the region 7132, so the computer system displays the indicator 7042. Although the examples in FIGS. 7V-7AF show the indicator 7042 and in some cases the system function menu 7046 being conditionally displayed based on whether the user interface 7122 is visible or not within the region 7132, one of ordinary skill in the art will readily appreciate that the user interface 7122 is representative of foreground content more generally, and that other foreground content (e.g., any other foreground content besides the user interface 7122) being visible within the region 7132 may prevent display of the indicator 7042 and/or the system function menu 7046 and/or cause the indicator 7042 and/or the system function menu 7046 to cease to be displayed, as described herein with reference to FIGS. 7V-7AF.

In some embodiments, in response to detecting the user's attention 7010 directed to a first portion of the display generation component 7100a (e.g., the region 7132 as described above, or optionally another region such as the region 7030), and in accordance with a determination that foreground content (e.g., the user interface 7122, the user interface 7032, the representation 7014′ of the physical object 7014, and/or the virtual object 7012) is not within the first portion of the display generation component 7100a, the computer system 101 displays the indicator 7042 (e.g., and in accordance with a determination that foreground content is within the first portion of the display generation component 7100a, the computer system 101 forgoes displaying the indicator 7042). For example, if the first portion of the display generation component 7100a is the region 7030, then in FIG. 7V, the computer system 101 would forgo displaying the indicator 7042 because the user interface 7122 is within the first portion of the display generation component 7100a (e.g., the region 7030). As used herein, the region 7132 can also be considered to be an exemplary first portion of the display generation component 7100a, and the descriptions below with respect to the region 7132 can be generalized to any suitable first portion of the display generation component 7100a (e.g., the region 7028 and/or the region 7030).

In some embodiments, the computer system displays the indicator 7042 regardless of whether or not background content (e.g., the palm tree 7134, the cloud 7138, and/or the cloud 7136) is within the region 7132. For example, in FIG. 7V, the cloud 7132 is within the region 7132, and also overlaps with the location of the indicator 7042, but the computer system displays the indicator 7042 (e.g., regardless of the position of and/or overlap with the cloud 7132). In some embodiments, the indicator 7042 is displayed on top of (e.g., occluding, in front of, and/or closer to the viewpoint of the user 7002 as compared to) any background content (e.g., the cloud 7138) within the region 7132.

In FIG. 7W, the user interface 7122 moves from a location such that the user interface 7122 is entirely outside the region 7132 to a new location such that the user interface 7122 is at least partially within the region 7132. In response to detecting that foreground content (e.g., the user interface 7122) is within the region 7132 (e.g., while the user's attention 7010 remains directed to a location within the region 7030), the computer system ceases to display the indicator 7042 (e.g., because the indicator 7042 would otherwise overlap with foreground content (e.g., the user interface 7122)).

FIG. 7W illustrates that the user interface 7122 is moved relative to the viewport, thereby causing the computer system to cease to display the indicator 7042, without changing a current viewpoint of the user 7002 (e.g., the user interface 7122 is moved relative to the three-dimensional environment and/or the user 7002). In some embodiments in which the region 7028, the region 7030, and the region 7132 are viewpoint-locked/head-locked, the computer system ceases to display the indicator 7042 if the user interface 7122 becomes visible within the region 7132 due to a change in viewpoint of the user 7002 (e.g., the user 7002 moves from a first location to a second location in the physical environment, and/or the user 7002 turns or otherwise moves the user 7002's head (e.g., which also moves the head-mounted display 7100a)).

In some embodiments, the computer system does not respond to user inputs (e.g., gaze inputs and/or air gestures) that correspond to a request to display the indicator 7042 or the system function menu 7046 (e.g., the computer system will not display the indicator 7042 and/or the system function menu 7046), if and/or while foreground content is within the region 7132 (e.g., as in the scenario illustrated in FIG. 7W), regardless of what user inputs are performed and/or where the user's attention 7010 is directed).

In FIG. 7X, the user interface 7122 moves from the location within the region 7132 to a location that is outside the region 7132, and in response, the computer system 101 redisplays the indicator 7042 (e.g., even though background content, such as the cloud 7138, is within the region 7132). In some embodiments, the computer system 101 redisplays the indicator 7042 only if the attention of the user 7010 is directed to an appropriate location (e.g., a location within the region 7028, the region 7030, and/or the region 7132), and does not redisplay the indicator 7042 if the attention of the user 7010 is directed to a different location (e.g., even though foreground content is not (e.g., no longer) within the region 7132).

FIG. 7X illustrates that the user interface 7122 is moved relative to the viewport, thereby causing the computer system to redisplay the indicator 7042, without changing a current view of the user 7002 (e.g., the user interface 7122 is moved relative to the three-dimensional environment and/or the user 7002). In some embodiments in which the region 7028, the region 7030, and the region 7132 are viewpoint-locked/head-locked, the computer system redisplays the indicator 7042 when the computer system detects that foreground content (e.g., the user interface 7122) is no longer visible within the region 7132 due to a change in viewpoint of the user 7002 (e.g., the user 7002 moves from a first location to a second location in the physical environment, and/or the user 7002 turns or otherwise moves the user 7002's head (e.g., which also moves the head-mounted display 7100a)), as described in further detail below with reference to FIG. 7AA.

In FIG. 7Y, the user's attention 7010 is directed to the indicator 7042 (e.g., in conjunction with detecting a user input such as an air gesture), and the computer system displays the system function menu 7046 (e.g., in response to detecting the user's attention 7010 directed to the indicator 7042, optionally, in conjunction with detecting the user input/air gesture). In some embodiments, the indicator 7042 and the system function menu 7046 are concurrently displayed. In some embodiments, the system function menu 7046 in FIG. 7Y is analogous to the system function menu 7046 in FIG. 7G, and includes the affordance 7048, the affordance 7052, the affordance 7054, the affordance 7056, and/or the affordance 7058 (e.g., affordances for accessing one or more system functions of the computer system 101, as described above with reference to FIG. 7G).

In some embodiments, an appearance of the indicator 7042 changes when the system function menu 7046 is displayed (e.g., in FIG. 7Y, the indicator 7042 has a different appearance than in FIG. 7X), as previously described with reference to FIG. 7F1, for example. In some embodiments, the system function menu 7046 replaces display of the indicator 7042 (e.g., the indicator 7042 ceases to be displayed when and/or while the system function menu 7046 is displayed, as described above with reference to FIGS. 7G and 7M, for example).

In some embodiments, the system function menu 7046 is displayed in response to detecting the attention of the user 7010 directed to a location in the region 7030 (e.g., optionally, in conjunction with detecting a user input such as an air gesture), and the system function menu 7046 can be displayed without first displaying the indicator 7046 (e.g., or at the same time as the indicator 7046 is initially displayed). In such embodiments, the computer system 101 forgoes displaying the system function menu 7046 if foreground content is within the region 7132 (e.g., even if the attention of the user 7010 is directed to a location in the region 7030, optionally, in conjunction with detecting a user input such as an air gesture), in an analogous manner to how the computer system 101 forgoes displaying the indicator 7042 as described above with reference to FIG. 7W.

In FIG. 7Z, the user interface 7122 again moves to a location that is within the region 7132. In some embodiments, the indicator 7042 and the system function menu 7046 have different behavior with respect to foreground content. For example, as shown in FIG. 7Z, in response to detecting foreground content (e.g., the user interface 7122) within the region 7132, the computer system ceases to display the indicator 7042 (e.g., as described above with reference to FIG. 7W), and maintains displays of the system function menu 7046 (e.g., even though and/or regardless of whether foreground content, such as the user interface 7122, is within the region 7132). In some embodiments, whether or not the indicator 7046 is displayed concurrently with the system function menu 7046, once the system function menu 7046 is displayed, the system function menu 7046 continues to be displayed even if foreground content, such as the user interface 7122, becomes visible within the region 7132.

In FIG. 7AA, a current viewpoint of the user 7002 changes (e.g., because the user 7002 moves from an original position 7026-g (e.g., shown by a dotted outline of the user 7002 in FIG. 7AA) to a new position (e.g., to the left of the original position 7026-g) in the physical environment (e.g., shown by the solid outline of the user 7002 in FIG. 7AA). The background content (e.g., the palm tree 7134, the cloud 7138 and the cloud 7136) are world-locked, as is the foreground content that includes the user interface 7122, the user interface 7032, the representation 7014′ of the physical object 7014, and the virtual object 7012.

Due to the change in viewpoint, the user interface 7122 (e.g., which is world-locked) is no longer within the region 7132 (e.g., the region 7028, the region 7030, and the region 7132 are viewpoint-locked/head-locked, and are displayed at locations with the same spatial relationship to a viewport (e.g., via the head-mounted display 7100a or display generation component 7100 more generally) through which the view of the three-dimensional environment is visible, in both FIGS. 7Z and 7AA). In some embodiments, as shown in the top-down view of the three-dimensional environment, the indicator 7042 and/or the system function menu 7046 are also viewpoint-locked/head-locked (e.g., and maintain respective spatial relationships to the viewport while moving relative to the three-dimensional environment in accordance with the movement of the user 7002).

In response to detecting that foreground content (e.g., the user interface 7122) is no longer within the region 7132, the computer system redisplays the indicator 7042. The system function menu 7046 was previously displayed (e.g., in FIG. 7Z, even when foreground content is within the region 7132), and the computer system maintains display of the system function menu 7046 (e.g., the system function menu 7046 is displayed regardless of whether foreground content is or is not within the region 7132).

In FIG. 7AB, the user's attention 7010 moves away from the system function menu 7046 (and the indicator 7042), and in response, the computer system ceases to display the system function menu 7046 (and the indicator 7042) (e.g., because the user's attention 7010 is not directed to a location within the region 7028, the region 7030, or the region 7132).

In some embodiments, one or more characteristics (e.g., a size, a shape, and/or a location) of the region 7028, the region 7030, and the region 7132 are (e.g., user) configurable. For example, in FIG. 7AB, the user 7002 adjusts (e.g., configures) the respective locations of the region 7028, the region 7030, and the region 7132 to new respective locations that are further from a top edge of the display generation component 7100a (e.g., and closer to a center point of the display generation component 7100a), as compared to the respective locations of the respective regions in FIG. 7AA.

In FIG. 7AC, the user 7002 moves to a different position in the physical environment (e.g., back to the original position 7026-g, shown in FIG. 7AA), which changes the viewpoint of the user 7002 (e.g., the user 7002 moves back to the original position in FIG. 7Z, before the change in position of the user 7002 described above in FIG. 7AA). Due to the change in viewpoint, foreground content (e.g., the user interface 7122) is within the region 7132, and the computer system does not display the indicator 7042 (e.g., and/or the system function menu 7046), even though the user's attention 7010 is directed to a location within the region 7132 (e.g., and/or even though the user 7002 performs a user input such as an air gesture). In some embodiments, the computer system does not display the indicator 7042 and/or the system function menu 7046, as long as foreground content (e.g., the user interface 7122) is within the region 7132.

In FIG. 7AD, foreground content (e.g., the user interface 7122) is no longer within the region 7132 (e.g., the user interface 7122 is moved away from and/or outside of the region 7132). In response to detecting that foreground content is no longer within the region 7132, the computer system displays (e.g., redisplays) the indicator 7042. In some embodiments, the indicator 7042 is displayed at a new location (e.g., an adjusted location as compared to the location of the indicator in FIG. 7V or 7X), to reflect the change in location of the region 7028, the region 7030, and the region 7132 (e.g., because the region 7028, the region 7030, and the region 7132 were adjusted to be further from the top edge of the display generation component 7100a, the indicator 7042 is also adjusted to be displayed further from the top edge of the display generation component 7100a (e.g., by the same amount, or by a proportional amount, as the adjustment to the region 7028, the region 7030, and the region 7132).

In FIG. 7AE, the user's attention 7010 is directed to the indicator 7042 (e.g., for a threshold amount of time such as 0.1, 0.2, 0.3, 0.5, 1, 2, 5, or 10 seconds), and in response, the computer system displays the system function menu 7046. In some embodiments, the system function menu 7046 is also displayed at an adjusted position (e.g., relative to the position of the system function menu in FIG. 7Y), to reflect the change in location of the region 7028, the region 7030, and the region 7132 (e.g., because the region 7028, the region 7030, and the region 7132 were adjusted to be further from the top edge of the display generation component 7100a, the system function menu 7046 is also adjusted to be displayed further from the top edge of the display generation component 7100a (e.g., by the same amount, or by a proportional amount, as the adjustment to the region 7028, the region 7030, and the region 7132). In some embodiments, the system function menu 7046 is displayed with a particular spatial relationship to the indicator 7042, and the system function menu 7046 is displayed at the adjusted position (e.g., because the indicator 7042 is displayed at an adjusted position, to reflect the change in location of the region 7028, the region 7030, and the region 7132).

FIG. 7AF is analogous to FIG. 7Z, but with the adjusted region 7028, region 7030, and region 7132. In FIG. 7AF, foreground content (e.g., the user interface 7122) is within the region 7132 (e.g., the user interface 7122 is moved from the location in FIG. 7AE to the location in FIG. 7AF). In response to detecting that foreground content is within the region 7132, the computer system ceases to display the indicator 7042. The computer system maintains display of the system function menu 7046 (e.g., even though and/or regardless of whether foreground content is within the region 7132).

In FIGS. 7AG-7AL, user interface elements for accessing settings of the computer system are conditionally displayed based at least in part on whether an immersive experience is active or not.

In FIG. 7AG, the computer system 101 displays, via the display generation component 7100a, an application user interface 7140. In FIG. 7AG, the application corresponding to the application user interface 7140 is not currently displaying content (e.g., in the application user interface 7140) as an immersive experience. In some embodiments, applications can display content as an immersive experience (e.g., and/or display an immersive experience), which causes at least some (e.g., an optionally, all) other user interface elements (e.g., the user interface 7032, the user interface 7122, the cloud 7136, the cloud 7138, the representation 7008′ of the physical floor 7008, and/or the representation 7004′ of the physical wall 7004) to no longer be displayed while the application displays content as an immersive experience. In some embodiments, if the application corresponding to the application user interface 7140 is not displaying content as an immersive experience, the application content in constrained to the boundaries of the application user interface 7140.

In FIG. 7AH, while the computer system 101 displays the application user interface 7140 (e.g., does not display an immersive experience), the computer system 101 detects the user's attention 7010 directed to a location within the region 7132. In response, the computer system 101 displays the indicator 7042 (e.g., because no immersive experience is being displayed). In some embodiments, if the indicator 7042 was displayed prior to displaying the application user interface 7140 (e.g., as in FIG. 7AE), the computer system 101 maintains display of the indicator 7042 when the application user interface 7140 is displayed (e.g., the application corresponding to the application user interface 7140 is launched or is otherwise triggered to display application content), as long as the application content displayed (e.g., in the application user interface 7140) is not displayed as an immersive experience.

In some embodiments, FIG. 7AI shows a transition from FIG. 7AH, where the computer system 101 transitions to displaying the application content in the application user interface 7140 of FIG. 7AH as an immersive experience, with the immersive experience shown in FIG. 7AI. In some embodiments, if the indicator 7042 (e.g., in FIG. 7AH) is displayed before the transition to displaying the immersive experience, the indicator 7042 ceases to be displayed (e.g., during and/or after the transition to displaying the immersive experience), even if the user's attention 7010 remains directed to the same location (e.g., if FIG. 7AH shows the state before the transition, and FIG. 7AJ shows the state after the transition).

In some embodiments, FIG. 7AI is an alternative to FIG. 7AG, except the application content within the application user interface 7140 of FIG. 7AG is being displayed as an immersive experience. In FIG. 7AI, no non-application content is displayed (e.g., because non-application content is optionally not displayed while an immersive experience is displayed).

In some embodiments, displaying an immersive experience includes displaying a close affordance, such as a close affordance 7142. In some embodiments, the close affordance, when selected, causes the computer system to exit the immersive experience and/or reduce a level of immersion of the immersive experience, such as to a state shown in FIG. 7AK. In some embodiments, the close affordance 7142 is displayed when the user's attention 7010 is directed to a particular location (e.g., the upper right corner of the display generation component 7100a) and not when the user's attention is directed to other locations (e.g., the close affordance 7142 is displayed only when the user's attention 7010 is directed to a particular location). In some embodiments, the close affordance 7142 is displayed in accordance with settings of the computer system 101 (e.g., accessibility settings analogous to the accessibility setting for enabling display of the indicator 7042 while an immersive experience is displayed).

In FIG. 7AJ, while an immersive experience is displayed, the computer system 101 detects that the user's attention 7010 is directed to a location within the region 7132. In contrast to FIG. 7AH, where the computer system 101 displays the indicator 7042, in FIG. 7AJ, the computer system 101 forgoes displaying the indicator 7042. In some embodiments, the indicator 7042 is not (e.g., is never) displayed while an immersive experience is displayed (e.g., to avoid breaking and/or lowering the level of immersion). In some embodiments, the indicator 7042 can be displayed if certain settings (e.g., accessibility settings) are enabled for the computer system (e.g., a user of the computer system 101 can force the indicator 7042 to be displayed if the appropriate criteria are otherwise met (e.g., as described above with reference to FIGS. 7A-7AF)). An example of these settings is shown in, and described in more detail with respect to, FIG. 8AQ below. In some embodiments, the computer system 101 can be configured (e.g., via a settings user interface, such as the one shown in FIG. 8AQ) to always enable display of the indicator 7042 (e.g., when appropriate criteria are met) and/or to always enable display of the close affordance 7142 (e.g., including while an immersive experience is displayed). In some embodiments, the close affordance 7142 can be concurrently displayed with the indicator 7042 (e.g., when appropriate criteria are met).

FIG. 7AJ also shows a user input directed to the digital crown 703 (e.g., a touch or press input that activates a button mechanism of the digital crown 703). While FIG. 7AJ shows a user input directed to the digital crown 703, in some embodiments, this user input is a different kind of user input (e.g., a user input activating the button 701 or the button 702, an air gesture (e.g., optionally in combination with a gaze input directed to a particular location or affordance, such as the close affordance 7142), and/or any other suitable user input for lowering the current level of immersion, exiting a (e.g., fully) immersive experience or mode, navigating to a different user interface, and/or navigating to or displaying a home user interface or other system user interface).

In FIG. 7AK, in response to detecting the user input directed to the digital crown 703, the computer system 101 switches or transitions to displaying the application user interface 7140 (e.g., in lieu of the immersive experience shown in FIGS. 7AI and 7AJ). The user's attention 7010 continues to be directed to a location within the region 7132, and since no immersive experience is currently being shown (e.g., because the application user interface 7140 is displayed in lieu of the immersive experience), the computer system 101 displays (e.g., and/or redisplays) the indicator 7042.

In FIG. 7AL, the user's attention 7010 is directed to the indicator 7042, and in response, the computer system 101 displays the system function menu 7046. In some embodiments, the computer system 101 displays the system function menu 7046 in response to detecting a user input (e.g., performed by the user's hand 7020 in FIG. 7AL) such as an air gesture, selection input, or other user input (e.g., an air gesture or selection input as described above with reference to FIGS. 7A-7AD).

In some embodiments (e.g., as described above with reference to FIG. 7D), the system function menu 7046 is displayed in response to detecting a user input (e.g., performed by the user's hand 7020 in FIG. 7AK), such as an air gesture, selection input, or other user input (e.g., an air gesture or selection input as described above with reference to FIGS. 7A-7AD), while the user's attention 7010 is directed to a location within the region 7132 (e.g., the location of the user's attention 7010 in FIG. 7AK).

Additional descriptions regarding FIGS. 7A-7U and 7AG-7AL are provided below in reference to method 9000 described with respect to FIGS. 7A-7U and 7AG-7AL, and additional descriptions regarding FIGS. 7V-7AF are provided below in reference to method 12000 described with respect to FIGS. 7V-7AF.

FIGS. 8A-8AX illustrate examples of automatically adjusting a relevant setting of the computer system based on a state of the computer system when a user input is detected. FIG. 10 is a flow diagram of an exemplary method 10000 for automatically adjusting a relevant setting of the computer system based on a state of the computer system when a user input is detected. FIG. 11 is a flow diagram of an exemplary method 11000 for displaying a menu that includes plurality of options for adjusting settings of a computer system and selecting between options of the plurality of options. FIG. 13 is a flow diagram of an exemplary method 13000 for adjusting a first parameter or a second parameter, based on whether first or second criteria are met. The user interfaces in FIGS. 8A-8AX are used to illustrate the processes described below, including the processes in FIG. 10, FIG. 11, and FIG. 13.

As shown in the examples in FIGS. 8A-8AX, content that is visible via a display generation component 7100 (e.g., the computer system 101) is displayed on a touch screen held by user 7002. In some embodiments, the display generation component 7100 is a head mounted display 7100a worn on user 7002's head as shown in FIGS. 8S-8AX (e.g., what is shown in FIGS. 8A-8R as being visible via the display generation component 7100 corresponds to user 7002's field of view when wearing a head mounted display 7100a).

FIGS. 8A-8G illustrate a first scenario in which no audio is playing and/or being generated by the computer system 101 (e.g., no media player is playing media content and/or no virtual content that is displayed includes an audio component).

FIG. 8A illustrates a view of a three-dimensional environment that includes both (representation of) physical object and virtual objects. The three-dimensional environment includes a representation 7004′ of a physical wall 7004, a representation 7006′ of a physical wall 7006, a representation 7008′ of a physical floor 7008, and a representation 7014′ of a physical object 7014 (e.g., the physical wall 7004, the physical wall 7006, the physical floor 7008, and the physical object 7014 are the same as the ones in the physical environment 7000, shown in FIG. 7A). The three-dimensional environment also includes virtual content, such as a virtual object 7012 (e.g., the same virtual object 7012 discussed above with reference to FIGS. 7A-7U) and a virtual content region 8000. In some embodiments, the virtual content region 8000 represents virtual content that is displayed (or not displayed, and/or obscured background content (e.g., of pass-through objects corresponding to real objects such as the physical object 7014, the physical wall 7004, the physical wall 7006, and/or the physical floor 7008 in the physical environment 7000), and represent a current level of immersion (e.g., as described herein, with reference to different levels of immersion). The virtual content region 8000 includes a region 8004′ (e.g., of virtual content applied to and/or obscuring the representation 7004′ of the physical wall 7004), a region 8008′ (e.g., of virtual content applied to and/or obscuring the representation 7008′ of the physical floor 7008), and a virtual object 8002. A region 7028 and a region 7030 (e.g., the same as or analogous to region 7028 and the same as or analogous to region 7030, described above with reference to FIGS. 7A-7U) are also displayed, and are viewpoint-locked/head-locked (e.g., as described above with reference to FIGS. 7A-7U).

In FIG. 8B, a user of the computer system 101 (e.g., the user 7002, as shown in FIG. 7A, with a left hand 7020 and a right hand 7022) performs a user input (e.g., a request to adjust a setting of the computer system 101). In some embodiments, the user input is an air tap, an air pinch, or another air gesture (e.g., a user input that does not involve a physical input mechanism of the computer system 101). In some embodiments, as shown in FIG. 8B, the user input is detected via a physical input mechanism (e.g., the user 7002 pushes a button 8008 with the hand 7020). In some embodiments, the computer system 101 includes a plurality of physical input mechanisms (e.g., the button 8008, a button 8010, and/or a button 8012), which provide different functionality with respect to adjusting settings of the computer system 101 (e.g., a respective button enables adjustment of a respective setting of the computers system 101, a respective button switches what setting of the computer system 101 is enabled for adjustment, a respective button increases and/or decreases a value for a respective setting of the computer system 101 (and/or adjusts the setting upwards and/or downwards). In some embodiments, the computer system 101 includes a different type of physical input mechanism, such as a crown or other rotatable input mechanism.

For ease of discussion, in FIGS. 8A-8AX, the computer system 101 is illustrated with three physical input mechanisms (e.g., the button 8008, the button 8010, and the button 8012). The button 8008, when activated, enables adjustment of a setting of the computer system 101 (e.g., but does not change a value for the setting and/or adjust the setting itself). The button 8010, when activated, decreases a value for the setting (e.g., and/or adjusts the setting downwards, which can optionally be repeated multiple times to further decrease the value for the setting). The button 8012, when activated, increases a value for the setting (e.g., and/or adjusts the setting upwards, which can optionally be repeated multiple times to further increase the value for the setting). In some embodiments, where the computer system 101 includes a rotatable input mechanism (e.g., a physical crown, a knob, and/or another rotatable input mechanism), the functionality of the button 8010 and the button 8012 are achieved by a direction of rotation of the rotatable input mechanism (e.g., rotating the rotatable input mechanism in a first direction increases a value for the setting, and rotating the rotatable input mechanism in an opposite direction decreases the value for the setting). Optionally, a speed and/or magnitude of the rotation controls by how much and/or how fast the value for the setting is increased and/or decreased (e.g., faster and/or larger rotations increase and/or decrease the value by a larger amount and/or a larger rate of change, and slower and/or smaller rotations increase and/or decrease the value by a smaller amount and/or a smaller rate of change).

In some embodiments, the portable multifunction device 100 provides feedback (e.g., visual feedback, audio feedback, and/or haptic feedback) when the portable multifunction device 100 detects that a current value for a setting is the maximum (e.g., or minimum) value for that setting, and the portable multifunction device 100 detects a user input to further increase (e.g., or decrease) the current value for the setting. In some embodiments, the feedback provides an indication that the current value cannot be further adjusted beyond a maximum or minimum value. For example, if the portable multifunction device 100 detects a user input attempting to increase a current level of immersion beyond the maximum level of immersion, the portable multifunction device 100 displays visual feedback (e.g., the black bar of the visual indicator 8015 expanding beyond the boundaries of the visual indicator 8015, around the edge of the user interface 8014, and towards the bottom of the user interface 8014), but once the user input terminates (e.g., the user ceases to attempt to increase the level of immersion), the portable multifunction device 100 ceases to display the visual feedback (e.g., the black bar returns to the bounds of the visual indicator 8015, where it completely occupies the entirety of the visual indicator 8015 to indicate that the current level of immersion is the maximum level of immersion) and the portable multifunction device 100 maintains the maximum level of immersion.

Returning to FIG. 8B, in response to detecting activation of the button 8008, the computer system 101 displays a user interface 8014 (e.g., corresponding to a level of immersion setting of the computer system 101) and a user interface 8016 (e.g., corresponding to a volume setting of the computer system 101). In FIG. 8B, since the computer system 101 is not playing (e.g., generating and/or outputting) any audio, the computer system 101 defaults to adjusting the level of immersion, and displays the user interface 8014 with a larger size as compared to the user interface 8016. The user interface 8014 is also displayed with a visual indicator 8015, which indicates a current level of immersion of the computer system 101 (e.g., and also that the level of immersion is the current setting that is being adjusted).

In some embodiments, the user interface 8014 and the user interface 8016 are viewpoint-locked/head-locked, such that the user interface 8014 and the user interface 8016 are always displayed with the same or substantially the same spatial relationship to a viewport (e.g., the display generation component 7100) of the computer system 101. For example, the user interface 8014 and the user interface 8016 exhibit the same viewpoint-locked/head-locked behavior as the region 7028 and the region 7030, described above with reference to FIGS. 7A-7U (with specific mention with respect to FIG. 7M).

In FIG. 8C, the user 7002 activates the button 8010 with the hand 7020, which decreases the level of immersion (e.g., the setting currently being adjusted). Since the user 7002 decreases the level of immersion, the virtual content region 8000 is reduced in size (e.g., is displayed with a smaller size in FIG. 8C, as compared to FIG. 8B, and optionally displays an animated transition from the larger size to the smaller size). As a result of the region 8000 shrinking in size, more of the representation 7014′ of the physical object 7014 is visible (e.g., portions of the representation 7014′ of the physical object 7014 that were previously obscured by the virtual content region 8000 in FIG. 8B, are now visible in FIG. 8C). The visual indicator 8015 of the user interface 8014 is also updated to reflect the adjusted value of the level of immersion (e.g., the visual indicator 8015 is a bar that represents the current level of immersion, with a full black bar representing complete immersion (e.g., a maximum level of immersion) and a completely empty bar representing no immersion (e.g., a minimum level of immersion)). Specifically, the black bar of the visual indicator 8015 is shorter in FIG. 8C, than in FIG. 8B, because the user 7002 has decreased the level of immersion.

In FIG. 8D, the user 7002 activates the button 8012 with the hand 7020, which increases the level of immersion. As shown by the visual indicator 8015, the user 7002 increases the level of immersion to a level that is above the level of immersion in FIG. 8B. In response to detecting activation of the button 8012, the computer system 101 increases the level of immersion (e.g., by increasing the size of the virtual content region 8000 to a size that is larger than the size of the virtual content region in FIG. 8B). The larger virtual content region 8000 includes a virtual object 8018 and a virtual object 8020, neither of which were displayed in FIG. 8B or 8C (e.g., because the current level of immersion in FIGS. 8B and 8C were too low, and the virtual content region 8000 was too small). The region 8004′ and the region 8008′ also increase in size (e.g., as the virtual content region 8000 is increased in size). Since the virtual content region 8000 represents the current level of immersion, in some embodiments, the representation 7014′ of the physical object 7014 ceases to be displayed when the virtual content region 8000 increases in size (e.g., because the virtual content region 8000 completely obscures the representation 7014′ of the physical object 7014). Virtual objects such as the virtual object 7012 are not obscured by the virtual content region 8000, and so the virtual object 7012 is displayed on top of (e.g., concurrently with) the virtual region 8000 (e.g., and the visual effects and/or virtual objects in the virtual content region 8000.

FIG. 8E illustrates an alternative to FIG. 8B, where the user's attention 7010 is directed to an indicator 7042 (e.g., the same indicator 7042 described above with reference to FIGS. 7A-7U). The computer system 101 displays a system function menu 7046 (e.g., the same system function menu 7046 described above with reference to FIGS. 7A-7U) (e.g., because the user's attention 7010 is directed to the indicator 7042 and the user 7002 performed a selection gesture). In some embodiments, the selection gesture is a gesture that meets selection criteria, and the selection criteria includes a criterion is met when the button 8008 is activated (e.g., by the hand 7020) (e.g., optionally, while the user's attention 7010 is directed to the indicator 7042). In some embodiments, the system function menu 7046 is displayed in response to detecting the user's attention 7010 directed to the indicator 7042, in conjunction with an air tap, an air pinch, and/or another air gesture (e.g., a user input that does not involve the button 8008, and/or another physical input mechanism of the computer system 101), and in FIG. 8E, the system function menu 7046 remains displayed (e.g., because the system function menu 7046 is environment-locked/world-locked, and/or the system function menu 7046 does not cease to be displayed unless the user 7002 activates a close affordance of the system function menu 7046 (e.g., as described above with reference to the close affordance 7058 of FIG. 7N),

As shown in FIG. 8E, in some embodiments, the user interface 8014 and the user interface 8016 are concurrently displayed with the system function menu 7046 (e.g., in scenarios where criteria to display the user interface 8014, the user interface 8016, and the system function menu 7046 are concurrently met). In some embodiments, if the user interface 8014 and the user interface 8016 would be displayed at locations that cause the user interface 8014 and/or the user interface 8016 to overlap with the system function menu 7046, the position of the user interface 8014 and/or the user interface 8016 are adjusted when the system function menu 7046 is displayed (e.g., the user interface 8014 and/or the user interface 8016 are shifted upward, downward, to the left, and/or to the right, such that the user interface 8014 and the user interface 8016 do not overlap with the system function menu 7046 (e.g., which is displayed at a default location with a specific spatial relationship to the indicator 7042)). In some embodiments, the user interface 8014 and the user 8016 are displayed overlapping the system function menu 7046 (e.g., between the viewpoint of the user 7002 and the system function menu 7046, such that the user interface 8014 and the user interface 8016 appear closer to the viewpoint of the user 7002, than the system function menu 7046). In some embodiments, the user interface 8014 and the user interface 8016 are displayed closer to the viewpoint of the user 7002, but the user interface 8014 and the user interface 8016 do not overlap or occlude the system function menu 7046 and/or the indicator 7042.

FIG. 8F illustrates that, in some embodiments, when the system function menu 7046 is displayed, the computer system 101 ceases to display the user interface 8014 and the user interface 8016 (e.g., and/or the computer system 101 forgoes displaying the user interface 8014 and the user interface 8016, in response to detecting activation of the button 8008 by the user's hand 7020, if the system function menu 7046 is already being displayed).

FIG. 8G illustrates that, in some embodiments, the system function menu 7046 is not displayed (e.g., and/or cannot be displayed or invoked by the user 7002, despite the user's attention 7010 being directed to the indicator 7042 while the user 7002 performs the selection input) while the user interface 8014 and the user interface 8016 are displayed (e.g., in response to detecting activation of the button 8008).

In some embodiments, both the scenario in FIG. 8F and the scenario in FIG. 8G are applicable, and depend on which user interface(s) are displayed first. For example, if the system function menu 7046 is displayed before the user 7002 activates the button 8008, the user interface 8014 and the user interface 8016 cannot be displayed until the system function menu 7046 ceases to be displayed (e.g., as in FIG. 8F). Conversely, if the user interface 8014 and the user interface 8016 are displayed before the user's attention 7010 is directed to the indicator 7010 (e.g., in conjunction with the selection gesture), the system function menu 7046 cannot be displayed (e.g., until the user interface 8014 and the user interface 8016 cease to be displayed).

FIGS. 8H-8N illustrate a second scenario in which audio is playing and/or being generated by the computer system 101 (e.g., a media player is playing media content that includes an audio component, and/or some displayed virtual content includes an audio component).

FIG. 8H is analogous to FIG. 8A, but also illustrates a user interface 8022 (e.g., a media player user interface that includes video content, a progress bar that provides a visual indication of the current progress of the playing video, and playback controls such as a fast forward, rewind, and pause control). The user's attention 7010 is directed to the user interface 8022 (e.g., the user 7002 is watching the video that is playing in the user interface 8022). Sound waves (e.g., the curved lines expanding from the lower left corner and the upper right corner of the computer system 101) illustrate that the video that is playing in the user interface 8022 includes an audio component.

FIG. 8I is analogous to FIG. 8B, but since audio is playing when the computer system 101 detects activation of the button 8008 by the hand 7020, the computer system 101 instead defaults to adjusting an audio level for the computer system 101, and displays the user interface 8016 (e.g., which corresponds to the volume setting of the computer system 101) with a larger size as compared to the user interface 8014. The user interface 8016 is also displayed with a visual indicator 8017, which indicates a current audio level of the computer system 101 (e.g., and also that the audio level is the current setting that is being adjusted). In some embodiments, the user interface 8014 and the user interface 8016 have the same or substantially the same relative position (e.g., the user interface 8014 is always displayed to the left of the user interface 8016), regardless of which corresponding setting is being adjusted (e.g., the size of the user interface 8014 and/or the user interface 8016 changes, depending on which setting is being adjusted). In some embodiments, the positions of the user interface 8014 and the user interface 8016 change depending on which setting is being adjusted (e.g., the user interface corresponding to the setting that is being adjusted is always displayed to the left of the user interface corresponding to the other setting). For example, in FIG. 8I, the user interface 8014 and the user interface 8016 would switch positions (e.g., but with the same or substantially the same size as shown in FIG. 8I).

In some embodiments, the volume setting controls the audio level for all audio generated by the computer system 101 (e.g., the volume setting is a universal volume setting). In some embodiments, the volume setting is a dynamic volume setting, and adjusts the audio level for specific types of audio (e.g., audio that is currently playing). For example, in FIG. 8I, the dynamic volume setting adjusts the audio level for the media player (e.g., without adjusting an audio level for other audio generated by the computer system 101, such as audio levels for audio alerts or notifications).

In FIG. 8J (e.g., FIGS. 8J1, 8J2 and 8J3, where a user interface analogous to the user interface shown in FIG. 8JI is shown on HMD 7100a in FIG. 8J2), the user 7002 activates the button 8012 with the hand 7020 (e.g., and/or activates the digital crown 703 with hand 7022 on HMD 7100a), which increases the audio level. As shown by the visual indicator 8017, the computer system 101 increases the audio level to an audio level that is above the audio level of FIG. 8I. This is also illustrated by the larger, and thicker, sound waves in FIG. 8J (e.g., as compared to FIG. 8I). In some embodiments, the audio level is adjusted while the video continues to play in the user interface 8022 (e.g., FIG. 8J illustrates a different visual component of the video that is playing in the user interface 8022, as compared to FIG. 8I, and the progress bar in FIG. 8J has also advanced compared to the progress bar in FIG. 8I).

In FIG. 8K the user 7002 activates the button 8010 with the hand 7020, which decreases the audio level. As shown by the visual indicator 8017, the computer system 101 decreases the audio level to an audio level that is below the audio level of FIGS. 8I and 8J. This is also illustrated by the smaller, and thinner, sound waves in FIG. 8K (e.g., as compared to FIGS. 8I and 8J).

In FIG. 8K, the user's attention 7010 also moves to a location corresponding to the user interface 8014 (e.g., for adjusting the level of immersion of the computer system 101). In some embodiments, since the user 7002 is currently adjusting the audio level for the computer system 101 (e.g., via the button 8010), the computer system 101 does not switch to adjusting the level of immersion for the computer system 101. In other words, once the user 7002 begins adjusting a respective setting of the computer system 101, the computer system 101 continues to adjust the respective setting regardless of where the user's attention is directed (e.g., to prevent scenarios where the user 7002 unintentionally and/or accidentally adjusts one or more other settings (e.g., while the user's attention 7010 shifts to different locations)).

In FIG. 8L, the user 7002 is no longer adjusting the audio level of the computer system 101 (e.g., the hand 7020 is not activating the button 8010 or the button 8012). In some embodiments, when the user 7002 is not (e.g., actively) adjusting the audio level of the computer system 101 (e.g., and/or actively adjusting any other setting of the computer system 101), the user 7002 can select and adjust a non-default setting. For example, in FIG. 8L, audio is still playing (e.g., as illustrated by the sound waves, and the continued progression of the video in the user interface 8022), so in response to detecting activation of the button 8008 by the user's hand 7020, the computer system 101 defaults to adjusting the audio level for the computer system 101. The user 7002, however, can direct the user's attention 7010 to the user interface 8014 (e.g., as shown in FIG. 8L), optionally in conjunction with a predefined gesture (e.g., an air tap, an air pinch, another air gesture, and/or a user input directed to a physical input mechanism of the computer system 101 such as the button 8008). In response, the computer system 101 enables adjustment of the level of immersion of the computer system 101 (e.g., instead of enabling adjustment of the default setting when sound is playing, which would be adjusting an audio level of the computer system 101).

FIG. 8M is analogous to FIGS. 8J, and illustrates the user 7002 activating the button 8012, and increasing the level of immersion of the computer system 101. In FIG. 8M, the virtual content region 8000 expands (e.g., relative to the size of the virtual content region 8000 in FIG. 7L) (e.g., even though the video in the user interface 8022 continues to play, and the computer system 101 is generating audio).

FIG. 8N illustrates an alternative to FIG. 8M, where the user's attention moves (e.g., back) to the user interface 8016, and the computer system 101 enables (e.g., reenables) adjustment of the audio level for the computer system 101 (e.g., reverts to adjusting the default setting, after enabling a non-default setting for adjustment in FIG. 8L).

FIG. 8O illustrates an alternative to FIG. 8H, and in FIG. 8O, the computer system 101 displays the user interface 8022, but the video content in the user interface 8022 is not playing (e.g., as illustrated by the playback controls including a play control, rather than a pause control as in FIG. 8H, where the video is playing in the user interface 8022). This is further illustrated by the lack of sound waves in FIG. 8O. Since audio is not playing, in response to detecting activation of the button 8008 by the user's hand 7020, the computer system 101 defaults to adjusting the level of immersion of the computer system 101 (e.g., even though the user interface 8022 is displayed).

FIGS. 8P-8R illustrate a third scenario, where audio is playing (e.g., being generated by the computer system 101), but the audio that is playing does not have a corresponding visual component (e.g., is audio-only content, unlike the video in the user interface 8022 of FIGS. 8H-8L).

In FIG. 8P, the computer system 101 receives an incoming request to join a communication session (e.g., a phone call with another user John Smith). The computer system 101 displays a user interface 8034, which displays information corresponding to the communication session (e.g., the name of the other user, John Smith, and the type of communication session (e.g., phone call)), and a “Join” affordance 8036 (e.g., for accepting the request to join the communication session and joining the communication session). In some embodiments, the computer system 101 initially displays an indicator 8032 in response to receiving the incoming request to join the communication session. In some embodiments, the indicator 8032 is analogous to the indicator 7042 (e.g., the indicators 7042 described above with reference to FIGS. 7A-7U), but in response to detecting the user's attention 7010 directed to the indicator 8032 (e.g., in conjunction with a predefined user input such as an air tap, an air pinch, and/or another air gesture, and/or a user input directed to a physical input mechanism of the computer system 101), the computer system 101 displays the user interface 8034 (e.g., instead of or in place of the system function menu 7046, which is normally displayed (e.g., when there is not an incoming request to join a communication session)). In some embodiments, the indicator 8032 is visually distinct from the indicator 7024 (e.g., the indicator 7024 has a circular shape, while the indicator 8034 has a diamond shape, and/or the indicator 8034 has a different size or color than the indicator 8034). In some embodiments, the indicator 8032 represents an alternate appearance of the indicator 7024 (e.g., the indicator 7024 has different appearances in different contexts, such as a diamond shape when there is an incoming request to join a communication session, and a square shape if there are pending or new notifications that the user has not viewed and/or interacted with).

In FIG. 8Q, the user's attention 7010 is directed to the “Join” affordance, optionally in conjunction with a predefined user input (e.g., an air tap, an air pinch, and/or another air gesture, and/or a user input directed to a physical input mechanism of the computer system 101).

In FIG. 8R, the computer system 101 joins (e.g., connects to) the communication session. The computer system 101 generates audio corresponding to the communication session (e.g., outputs phone audio corresponding to the active phone call) and ceases to display the user interface 8034 (e.g., such that no visual component is displayed by the computer system 101, while the computer system 101 generates the audio corresponding to the communication session). In some embodiments, the indicator 8032 also ceases to be displayed. In some embodiments, the indicator 8032 remains displayed (e.g., to provide visual feedback that the computer system 101 is connected to an active communication session) (e.g., and optionally, the indicator 8032 is an alternate appearance of the indicator 7024, such that a visual characteristic of the indicator 8032 provides visual feedback regarding a state of the computer system 101, as described above with reference to FIG. 7B).

In response to detecting activation of the button 8008 by the hand 7020 (e.g., and because audio is playing), the computer system 101 defaults to adjusting the audio level of the computer system 101 (e.g., the audio level corresponding to audio generated for the communication session).

In some embodiments, the computer system 101 generates an audio alert in response to receiving the incoming request to join the communication session (e.g., in conjunction with display the indicator 8032 and/or the user interface 8034) (e.g., audio is generated by the computer system 101 in FIGS. 8P and 8Q, even before the computer system 101 joins or connects to the communication session). In such embodiments, in response to detecting activation of the button 8008 (e.g., as shown by the dotted hand 7020 in FIG. 8Q), the computer system 101 also defaults to adjusting the audio level of the computer system 101 and displays the user interface 8014, the user interface 8016, and the visual indicator 8017 (e.g., with the same appearances as shown in FIG. 8R),

In some embodiments, the user interface 8014 and the user interface 8016 cease to be displayed after the user 7002 ceases to adjust the respective setting (e.g., regardless of whether the respective setting is the level of immersion or the audio level for the computer system 101). In some embodiments, the user interface 8014 and the user interface 8016 cease to be displayed after a threshold amount of time (e.g., 0.1, 0.2, 0.3, 0.5, 1, 2, 5, 10, or 15 seconds) has elapsed since the user 7002 last adjusted the respective setting. In some embodiments, the user interface 8014 and the user interface 8016 cease to be displayed if the user's attention 7010 is not directed to either the user interface 8014 or the user interface 8016 (e.g., for a threshold amount of time, such as 0.1, 0.2, 0.3, 0.5, 1, 2, 5, 10, or 15 seconds). In some embodiments, the user interface 8014 and the user interface 8016 cease to be displayed after (e.g., a first threshold amount of time has elapsed since) the user 7002 ceases to adjust the respective setting and the user's attention 7010 is no longer directed to the user interface 8014 or the user interface 8016 (e.g., for at least a second threshold amount of time, which is optionally the same as, or different from, the first threshold amount of time) (e.g., but not if the user 7002 continues to adjust the respective setting while the user's attention 7010 is no longer directed to the user interface 8014 or the user interface 8016, and not if the user 7002 ceases to adjust the respective setting but the user's attention 7010 is still directed to the user interface 8014 or the user interface 8016).

In some embodiments, the user interface 8014 and the user interface 8016 cease to be displayed in response to detecting a predefined user input (e.g., an air tap, an air pinch, and/or another air gesture, and/or a user input directed to a physical input mechanism of the computer system 101).

FIGS. 8S-8AL illustrate exemplary ways of navigating between different user interfaces (e.g., the same user interfaces and/or analogous user interfaces described above with reference to FIGS. 8A-8R) and/or interacting with (e.g., selecting) different user interfaces (e.g., for adjusting settings of the computer system).

FIG. 8S is analogous to FIG. 8A, and illustrates a view of a three-dimensional environment that includes both virtual objects and representations of physical objects. The three-dimensional environment includes the representation 7004′ of the physical wall 7004, the representation 7006′ of the physical wall 7006, the representation 7008′ of the physical floor 7008, and the representation 7014′ of the physical object 7014 (e.g., the physical wall 7004, the physical wall 7006, the physical floor 7008, and the physical object 7014 are the same as the ones in the physical environment 7000, shown in FIG. 7A). The three-dimensional environment also includes virtual content, such as a virtual object 7012 (e.g., the same virtual object 7012 discussed above with reference to FIGS. 7A-7AL) and a virtual content region 8000 (e.g., the same virtual content region 8000 in FIG. 8A). In some embodiments, the virtual content region 8000 represents virtual content that is displayed (e.g., displayed on top of, superimposed on, and/or applied to (e.g., a surface of) other content (e.g., pass-through objects corresponding to real objects such as the physical object 7014, the physical wall 7004, the physical wall 7006, and/or the physical floor 7008 in the physical environment 7000)), and represent a current level of immersion (e.g., as described herein, with reference to different levels of immersion). In FIG. 8S, the virtual content region 8000 includes the region 8004′ (e.g., of virtual content applied to and/or obscuring the representation 7004′ of the physical wall 7004), and the virtual object 8002. The region 7028 and the region 7030 (e.g., the same as or analogous to the regions 7028 and 7030, respectively, described above with reference to FIGS. 7A-7AL) are also indicated in FIG. 8S (e.g., and the region 7132, described above with reference to FIGS. 7V-7AL, is optionally also present), and are viewpoint-locked/head-locked (e.g., as described above with reference to FIGS. 7A-7AL). FIG. 8S also illustrates a side-view of the digital crown 703. For illustration purposes, the digital crown 703 is shown with a notch (e.g., at the 12 o'clock position or “upward” position).

In FIG. 8T, the user 7002 rotates the digital crown 703 (e.g., by a first threshold amount), as shown by the arrows, and the rotation of the notch away from the 12 o'clock position (e.g., to a 1 o'clock position). In response to detecting the rotation of the digital crown 703 (e.g., by the first threshold amount), the computer system displays the user interface 8014 (e.g., corresponding to a level of immersion setting of the computer system 101, as described above with reference to FIGS. 8A-8R), a user interface 8038 (e.g., corresponding to a zoom setting and/or zoom level of the computer system 101), and the user interface 8016 (e.g., corresponding to a volume setting of the computer system 101, as described above with reference to FIGS. 8A-8R). While FIG. 8T shows a clockwise rotation of the digital crown 703, in some embodiments, the computer system displays the user interface 8014, the user interface 8038, and the user interface 8016 regardless of which direction the digital crown 703 is rotated (e.g., the digital crown 703 could be rotated in the counterclockwise direction in FIG. 8T, optionally, by the first threshold amount). In some embodiments, if the digital crown 703 is not rotated by the first threshold amount (e.g., is rotated by less than the first threshold amount), the computer system forgoes displaying the user interface 8014, the user interface 8038, and the user interface 8016.

In some embodiments, the computer system 101 automatically selects a respective user interface of the user interface 8014, the user interface 8038, and the user interface 8016. For example, in FIG. 8T, the computer system automatically selects the user interface 8014 (e.g., because the user interface 8014 is a default user interface that is initially selected by default, and/or because the user interface 8014 is in the left-most position). In some embodiments, another user interface (e.g., the user interface 8038, or the user interface 8016) is automatically selected by the computer system 101 in response to detecting the rotation of the digital crown 703 (e.g., and optionally, in some embodiments, the user interface 8014, the user interface 8038, and the user interface 8016 are displayed in a different order, for example, to reflect the different default user interface that is automatically selected).

In some embodiments, the user interface that is automatically selected is displayed with a visual appearance (e.g., with a different size, shape, and/or color) that is different from the other displayed user interfaces (e.g., to visually distinguish the selected user interface from the other displayed user interfaces). In some embodiments, the automatically selected user interface includes a visual indicator (e.g., that provides a visual indication of a current value and/or level of a setting corresponding to the automatically selected user interface). For example, in FIG. 8T, the user interface 8014 is automatically selected. The user interface 8014 is displayed with a different appearance (e.g., a white background with a black outline) as compared to the other displayed user interfaces (e.g., the user interface 8038 and the user interface 8016 are displayed with gray backgrounds and white outlines). The user interface 8014 also includes the visual indication 8015, which indicates the current level of immersion.

In some embodiments, the computer system 101 provides audio feedback regarding the automatically selected user interface (e.g., a voiceover or narration that describes the currently selected user interface). For example, in FIG. 8T, the computer system 101 outputs audio that announces “immersion,” “level of immersion,” or a similar phrase and/or description for the setting corresponding to the user interface 8014.

In some embodiments, the computer system 101 displays additional user interfaces (e.g., corresponding to additional settings of the computer system). In some embodiments, the number of user interfaces that are displayed, and/or the positioning and/or order of the displayed user interface is configurable (e.g., via a settings user interface of the computer system 101). For ease of discussion, navigation between and/or selection of the user interface 8014, the user interface 8038, and the user interface 8016 are described, but analogous functionality can be applied to any number of applicable user interfaces (e.g., corresponding to different settings of the computer system 101).

In some embodiments, the computer system 101 displays fewer user interfaces than shown in FIG. 8T. For example, the computer system 101 displays the user interface 8014 and the user interface 8016, but does not display the user interface 8038, and the descriptions below are similarly applicable to such embodiments. In some embodiments, the user interface 8038 is displayed if a corresponding zoom function is enabled for the computer system 101. For example, the computer system 101 may include one or more accessibility settings and/or options, which include a zoom function. If the zoom function for the computer system 101 is enabled (e.g., and/or configured), the computer system 101 displays the user interface 8038 (e.g., in addition to the user interface 8014 and the user interface 8016). In some embodiments, a respective user interface is displayed in accordance with a determination that a respective setting (e.g., and/or function) corresponding to the respective user interface is enabled (e.g., and not displayed in accordance with a determination that the respective corresponding setting is not enabled).

In some embodiments, if only one respective user interface corresponding to a respective setting of the computer system is available for selection (e.g., no settings corresponding to other user interfaces are available for or enabled for adjustment), the computer system 101 selects the respective setting of the computer system. In some embodiments, the computer system 101 optionally forgoes displaying the user interface 8014, the user interface 8038, and the user interface 8016 (e.g., the computer system does not display any user interfaces corresponding to settings of the computer system, as only one setting of the computer system is available for or enabled for adjustment). In some embodiments, the computer system 101 optionally adjusts the respective setting of the computer system in accordance with the rotation of the digital crown 703 (e.g., as described below in greater detail, with reference to FIGS. 8U-8Z and/or 81-8J), in addition to or in lieu of displaying the user interface 8014, the user interface 8038, and the user interface 8016. For example, if only the user interface 8014 is available for selection (e.g., the user interface 8016 is not displayed and/or the current audio level of the computer system 101 is not enabled for adjustment because no audio is currently being generated by the computer system 101, and the user interface 8038 is not displayed and/or the zoom function of the computer system 101 is not enabled for adjustment), the computer system adjusts the level of immersion in response to detecting the rotation of the digital crown 703.

In FIG. 8U, while the user interface 8014 is selected, the user 7002 further rotates the digital crown 703 (e.g., as shown by the arrows and movement of the notch to the 4 o'clock position). In response to detecting the further rotation of the digital crown 703, the computer system adjusts the level of immersion in a first direction. In FIG. 8U, the digital crown 703 is rotated in the clockwise direction, which optionally corresponds to an increase in the level of immersion (e.g., as shown by expansion of the content region 8000 in FIG. 8U, relative to FIG. 8T).

In some embodiments, an initial amount of rotation (e.g., the initial amount of rotation shown in FIG. 8T, and/or an initial amount of rotation up to the first threshold amount of rotation needed to display the user interface 8014, the user interface 8038, and the user interface 8016) does not result in adjustment of the current level of immersion (e.g., is ignored and/or not processed by the computer system 101 for purposes of adjusting the current level of immersion).

In some embodiments, one or more of the displayed user interfaces (e.g., the user interface 8014, the user interface 8038, and/or the user interface 8016) include an icon (e.g., a respective user interface includes a respective icon that corresponds to a respective setting of the computer system 101). In some embodiments, for the currently selected user interface, the icon also provides a visual indication of the (e.g., approximate) value and/or level of the corresponding setting. For example, the user interface 8014 includes an immersion icon that consists of two mountains and a star. When the current level of immersion is between 0 and 25%, the immersion icon is completely white (e.g., as shown in FIG. 8T and FIG. 8V). When the current level of immersion is between 25% and 50%, a first mountain of the immersion icon is filled in (e.g., displayed with a black appearance), as shown in FIG. 8U. When the current level of immersion is between 50% and 75%, both mountains of the immersion icon are filled in, and when the current level of immersion is between 75% and 100%, both mountains and the star of the immersion icon are filled in. The above ranges are purely exemplary, and different ranges can be applied (e.g., in combination with different icons with different number of parts that can be separately filled in).

In FIG. 8V, the computer system detects further rotation of the digital crown 703 (e.g., as shown by movement of the notch to the 3 o'clock position) in the opposite direction (e.g., as compared to FIG. 8U), and in response, the computer system adjusts the level of immersion in a second direction that is opposite the first direction (e.g., clockwise rotation increases the level of immersion in FIG. 8U, and counter-clockwise rotation decreases the level of immersion in FIG. 8V). In FIG. 8V, since the level of immersion has been decreased (e.g., relative to FIG. 8U), the content region 8000 is also displayed with a smaller size (e.g., relative to the size of the content region 8000 in FIG. 8U).

In some embodiments, the computer system 101 enables adjustment to the level of immersion until the computer system detects that the digital crown 703 has not been rotated or adjusted (e.g., has stopped being rotated, and remains still or substantially still) for at least a threshold amount of time (e.g., 0.1, 0.2, 0.3, 0.5, 1, 2, 5, or 10 seconds). In some embodiments, the threshold amount of time is measured from a time when the digital crown 703 was last rotated/adjusted.

In some embodiments, in response to detecting that the digital crown 703 has not been rotated or adjusted for the threshold amount of time, the computer system ceases to display the user interface 8014, the user interface 8038, and the user interface 8016. In some embodiments, if the user 7002 stops rotating the digital crown 703, waits for a duration that is less than the threshold amount of time, then resumes rotating or adjusting the digital crown 703, the computer system 101 maintains display of the user interface 8014, the user interface 8038, and the user interface 8016 (e.g., and continues to enable adjustment to the selected user interface or transition to selection of a different user interface). In some embodiments, after ceasing to display the user interface 8014, the user interface 8038, and the user interface 8016 (e.g., in response to detecting that the digital crown 703 was not rotated or adjusted for the threshold amount of time), to further adjust settings of the computer system 101 (e.g., the level of immersion), the user 7002 can repeat the steps described above with reference to FIG. 8S, to redisplay the user interface 8014, the user interface 8038, and the user interface 8016. In some embodiments, if the digital crown 703 is no longer being rotated, but the first threshold amount of time has not elapsed, the computer system maintains display of the user interface 8014, the user interface 8038, and the user interface 8016.

In FIG. 8W, while displaying the user interface 8014, the user interface 8038, and the user interface 8016, the computer system 101 detects a different type of input (e.g., a type of input that does not include rotation of the digital crown 703) received via the digital crown 703. For example, as shown by the arrows in FIG. 8W, the digital crown 703 can include a button that is activated by pressing on a surface of the digital crown 703 (e.g., and optionally, pressing/activating the button of the digital crown 703 occurs in a direction that is perpendicular to a plane in which the digital crown 703 is rotated).

In response to detecting the different type of input via the digital crown 703, the computer system 101 selects another user interface of the user interface 8014, the user interface 8038, and the user interface 8016. For example, in FIG. 8V, the user interface 8014 was selected. In response to detecting the different type of input in FIG. 8W, the computer system 101 selects the user interface 8038. The user interface 8038 is displayed with an appearance that is different from the other user interfaces (e.g., the user interface 8014 and the user interface 8016 are displayed with gray backgrounds and white outlines, while the user interface 8038 is displayed with a white background and black outline (e.g., visual emphasis is moved from the previously-selected user interface 8014 to the currently-selected user interface 8038)), and the user interface 8038 is displayed with a visual indicator 8040 (e.g., that indicates a current zoom level for the computer system 101). In some embodiments, the computer system 101 outputs audio feedback regarding the selection of a new user interface (e.g., the user interface 8038 in FIG. 8W). In some embodiments, the computer system 101 outputs audio feedback each time the selected user interface changes (e.g., each time the user 7002 triggers selection of a different user interface, as described in FIGS. 8T and 8W, for example).

In FIG. 8X, after selecting the user interface 8038, the computer system 101 detects rotation of the digital crown 703 (e.g., in the clockwise direction, as shown by movement of the notch from the 3 o'clock position to the 6 o'clock position). In response to detecting the rotation of the digital crown 703, the computer system 101 adjusts the current zoom level for the computer system 101 (e.g., increases the current zoom level). In some embodiments, adjusting the current zoom level for the computer system 101 includes displaying a zoom user interface 8042. In some embodiments, the zoom user interface 8042 displays a portion of the view of the three-dimensional environment with an increased level of zoom (e.g., with an increased scale and/or magnification), relative to portions of the view of the three-dimensional environment which are not visible in the zoom window 8042. In some embodiments, the zoom user interface 8042 is displayed over the entire display generation component 7100a (e.g., the level of zoom for the entire view of the three-dimensional environment that is visible via the display generation component is adjusted). In some embodiments, the zoom user interface 8042 is displayed with a size that is less than the entire display generation component 7100a (e.g., a different level of zoom is applied to only a portion of the view of the three-dimensional environment that is visible via the display generation component 7100a).

In some embodiments, the zoom user interface 8042 is viewpoint-locked/head-locked (e.g., is always displayed in the center of the display generation component 7100a). In some embodiments, the user interface 8014, the user interface 8038, and/or the user interface 8016 are world-locked.

For example, in FIG. 8Y, the user 7002's head turns (e.g., which changes the viewpoint of the user 7002). Despite the change in viewpoint, the zoom user interface 8042 is (e.g., still) displayed in the center of the display generation component 7100a (e.g., the same position, relative to the edges of the display generation component 7100a (e.g., relative to the viewport), as in FIG. 8X). In contrast, the user interface 8014, the user interface 8038, and the user interface 8016 are world-locked, and so are shifted relative to the display generation component 7100a and the viewport (e.g., the user 7002 turns to the right, and so the user interface 8014, the user interface 8038, and the user interface 8016 are shifted to the left, relative to the display generation component 7100a, to reflect the change in viewpoint). This viewpoint-locked/head-locked behavior of the zoom user interface 8042, and the world-locked behavior of the user interface 8014, the user interface 8038, and the user interface 8016 is also shown in the top down view of the three-dimensional environment (e.g., the zoom user interface 8042 rotates with the head of the user 7002, such that the zoom user interface 8042 always appears in the center of the viewport of the user 7002, while the user interface 8014, the user interface 8038, and the user interface 8016 do not move with the user 7002).

In FIG. 8Z, the digital crown 703 is rotated counterclockwise (e.g., an opposite direction of rotation as compared to FIG. 8X, as shown by movement of the notch from the 6 o'clock position to the 4 o'clock position), and in response, the computer system 101 adjusts the current zoom level for the computer system 101 (e.g., decreases the current zoom level). For example, the virtual object 7012 (e.g., within the zoom user interface 8042) is smaller in FIG. 8Z than in FIG. 8Y (e.g., because the current level of zoom in FIG. 8Z is lower than in FIG. 8Y, and so the virtual object 7012 is displayed with a reduced scale and/or level of magnification as compared to FIG. 8Y). In some embodiments, the current level of zoom is adjusted in accordance with a magnitude of the rotation of the digital crown 703. For example, in FIG. 8X, the digital crown 703 is rotated by a greater magnitude than in FIG. 8Z, and the level of zoom is adjusted (e.g., increased) by a greater amount in response to the rotation of the digital crown 703 in FIG. 8X, and the level of zoom is adjusted (e.g., decreased) by a lesser amount in response to the rotation of the digital crown 703 in FIG. 8Z.

In FIG. 8AA, as shown in the top-down view, the user 7002 turns the user 7002's head back to the original orientation (e.g., the same orientation as in FIG. 8X, which also causes the current viewpoint to return to the same viewpoint as in FIG. 8X). The digital crown 703 continues to be rotated in the counterclockwise direction (e.g., as shown by movement of the notch to the 3 o'clock position) until the current level of zoom is 0 (e.g., no zoom, no increased scale and/or no increased magnification, which is also reflected by the visual indicator 8040), and the computer system ceases to display the zoom user interface 8042. In some embodiments, the zoom user interface 8042 is displayed (e.g., with the viewpoint-locked/head-locked behavior described above) as long as the current zoom level is above 0 (or another value corresponding to a “normal” zoom level, or a level corresponding to a state where objects and/or user interfaces are displayed at a default size, or a level corresponding to a state where objects and/or user interfaces are not displayed with an increased scale and/or magnification). In some embodiments, when the current zoom level is adjusted back to the 0 value, the computer system ceases to display the zoom user interface 8042.

In FIG. 8AB, the computer system 101 detects a different type of input (e.g., a type of input that does not include rotation of the digital crown 703 as described above with reference to FIG. 8W) received via the digital crown 703. In some embodiments, the different type of input includes activating a button of the digital crown 703 (e.g., a press and release of a button of the digital crown 703). In some embodiments, the different type of input includes holding a button of the digital crown 703 (e.g., pressing a button of the digital crown 703 for at least a threshold amount of time such as 0.1, 0.2, 0.3, 0.5, 1, 2, 5, or 10 seconds).

In response to detecting the different type of input via the digital crown 703, the computer system 101 selects another user interface of the user interface 8014, the user interface 8038, and the user interface 8016.

For example, in FIG. 8AA, the user interface 8038 was selected. In response to detecting the different type of input in FIG. 8AB, the computer system 101 instead selects the user interface 8016. The user interface 8016 is displayed with an appearance that is different from the other user interfaces (e.g., the user interface 8014 and the user interface 8038 are displayed with gray backgrounds and white outlines, while the user interface 8016 is displayed with a white background and black outline), and the user interface 8016 is displayed with the visual indicator 8017 (e.g., that indicates a current audio level for the computer system 101).

In some embodiments, the computer system 101 selects the user interface 8016 (e.g., only) if there is audio playing when the computer system 101 detects the different type of input via the digital crown 703. For example, in FIG. 8AB, a video is playing in the user interface 8022 (e.g., a media player user interface that includes video content, a progress bar that provides a visual indication of the current progress of the playing video, and playback controls such as a fast forward, rewind, and pause control, as described above with reference to FIG. 8H). If the video in the user interface 8022 were paused, and/or if the user interface 8022 was not displayed, (e.g., and no audio was playing when the computer system 101 detects the different type of input via the digital crown 703), the computer system 101 forgoes selecting the user interface 8016 (e.g., and optionally selects the user interface 8014, which would be the only other selectable user interface that is not currently selected).

In some embodiments, while the user interface 8016 is selected, the current audio level (e.g., for the video that is playing in the user interface 8022, and/or for the computer system 101) can be adjusted by rotating the digital crown 703 (e.g., in an analogous manner as adjustments to the level of immersion and/or the level of zoom, as described above with reference to FIGS. 8S-8AA).

While FIGS. 8S-8AB illustrate a particular method of navigating between different user interfaces (e.g., the same user interfaces and/or analogous user interfaces described above with reference to FIGS. 8A-8R) and/or interacting with (e.g., selecting) different user interfaces (e.g., for adjusting settings of the computer system), FIGS. 8AC-8AL illustrate an alternative method of navigating between different user interfaces and/or interacting with different user interfaces.

FIG. 8AC is analogous to FIG. 8S, but illustrates a wrist-based pointer. In some embodiments (e.g., in FIG. 8S and/or FIGS. 7A-7AL), the user 7002 interacts with the computer system 101 via the user's attention 7010 (e.g., optionally, in conjunction with other user inputs and/or air gestures). In some embodiments (e.g., in FIGS. 8AC-8AL), the user 7002 interacts with the computer system 101 via the wrist-based pointer (e.g., for accessibility and/or to accommodate for handicaps, physical limitations, and/or comfort of the user 7002).

In FIG. 8AK, the wrist-based pointer originates from a wrist of the hand 7020 of the user 7002. The user 7002 can interact with and/or select different objects and/or user interfaces in the three-dimensional environment using the wrist-based pointer. For example, in FIG. 8AK, the hand 7020 of the user 7002 directs the wrist-based pointer to the virtual object 7012 to select the virtual object 7012 (e.g., for repositioning the virtual object 7012 to a new position in the three-dimensional environment, as shown in FIG. 8AD).

In FIG. 8AD, the hand 7020 of the user 7002 directs the wrist-based pointer to the representation 7014′ of the physical object 7014, which selects the representation 7014′ of the physical object 7014. The user 7002 can interact with the representation 7014′ of the physical object 7014 (e.g., reposition, rotate, and/or resize).

While FIGS. 8AC-8AD illustrate the use of the wrist-based pointer in repositioning the virtual object 7012, the wrist-based pointer can be used to perform any suitable function for interacting with the computer system 101 (e.g., selecting and/or activating an affordance (e.g., the affordance 7048, the affordance 7050, the affordance 7052, the affordance 7054, and/or the affordance 7056, of the system function menu 7046 in FIG. 7G), and/or triggering display of user interfaces (e.g., substituting for the attention of the user 7010, directed to the indication 7042, or for triggering display of the system function menu 7046, as described in FIGS. 7F2 and 7G)).

FIG. 8AE is analogous to FIG. 8T, and illustrates rotation of the digital crown 703 (e.g., by at least the same first threshold amount as in FIG. 8T), as shown by the arrows, and the rotation of the notch away from the 12 o'clock position (e.g., to a 1 o'clock position). In response to detecting the rotation of the digital crown 703 (e.g., by at least the first threshold amount), the computer system displays the user interface 8014, the user interface 8038, and the user interface 8016.

In contrast to FIG. 8T, where the user interface 8014 is selected (e.g., by default), in FIG. 8AE, the computer system 101 selects a user interface in accordance with a head position of the user 7002 (e.g., in accordance with a “head pointer” or head-based pointer, originating from the head of the user 7002). For example, in FIG. 8AE, as shown by the top-down view, the head of the user 7002 is pointed at (e.g., the eyes of the user 7002 are aligned with) the user interface 8038, so in response to detecting the rotation of the digital crown (e.g., by at least the first threshold amount), the computer system selects the user interface 8038 (e.g., a user interface at which the head of the user 7002 is pointed, and/or a user interface that is closest to a location at which the head of the user 7002 is pointed).

As shown in FIG. 8AE, the user interface 8038 is displayed with a different appearance (e.g., the same appearance as in FIGS. 8W-8AA, where the user interface 8038 is also selected) as compared to the user interface 8014 and the user interface 8016.

In some embodiments, the user interface 8014 is selected in response to detecting that the head of the user 7002 is directed to the user interface 8014 for a threshold amount of time (e.g., 0.1, 0.2, 0.3, 0.5, 1, 2, 5, or 10 seconds). This helps prevent accidental selection of user interfaces. For example, the computer system 101 does not select a user interface while the head of the user 7002 is in an intermediate position (e.g., or a plurality of intermediate positions) during movement of the user 7002's head from an initial position to a desired position, to prevent rapid selection and/or reselection of user interfaces (e.g., user interfaces that are between a starting position to which the user 7002's head is directed at the initial position, and a final position to which the user 7002's head is directed at the desired position), before the user 7002's head reaches the desired position (e.g., the user 7002 is able to point the user 7002's head at the desired user interface). Alternatively or in addition, selection of a different user interface in response to movement of the user 7002's head includes hysteresis to prevent rapid selection and/or reselection of user interfaces that might be alternately selected while the user 7002's head is near a threshold position used to select between the user interfaces.

FIG. 8AF illustrates that while the user interface 8014, the user interface 8038, and the user interface 8016 are displayed, the wrist-based pointer is not enabled. Although the hand 7020 of the user 7002 is pointed at the user interface 8014, the computer system 101 does not select the user interface 8014. Instead, the computer system 101 selects (e.g., maintains selection of) the user interface 8038, as that is the user interface at which the head of the user 7002 is pointed.

In FIG. 8AG, the user 7002 turns (e.g., redirects the head-pointer) such that the head of the user 7002 is directed to the user interface 8014 (e.g., as shown in the top-down view). In response to detecting that the head of the user 7002 is directed to the user interface 8014, the computer system 101 selects the user interface 8014. As shown in FIG. 8AG, the user interface 8014 is displayed with a different appearance (e.g., the same appearance as in FIGS. 8T-8V, where the user interface 8014 is also selected) as compared to the user interface 8038 and the user interface 8016.

In FIG. 8AH, the user 7002 (e.g., again) turns (e.g., redirects the head-pointer, in a different direction) such that the head of the user 7002 is directed to the user interface 8016 (e.g., as shown in the top-down view). In response to detecting that the head of the user 7002 is directed to the user interface 8016, the computer system 101 selects the user interface 8016. As shown in FIG. 8AH, the user interface 8016 is displayed with a different appearance (e.g., the same appearance as in FIG. 8AB, where the user interface 8016 is also selected) as compared to the user interface 8014 and the user interface 8038.

In some embodiments, as described above with reference to FIG. 8AB, the computer system 101 selects the user interface 8016 (e.g., only) if there is audio playing when the computer system 101 detects that the head of the user 7002 is directed to the user interface 8016. For example, in FIG. 8AH, the user interface 8022 (e.g., the same user interface 8022 in FIG. 8AB, optionally playing the same video in FIG. 8AB) is displayed in FIG. 8AH to indicate that audio is playing (e.g., and so the user interface 8016 is available for selection).

In some embodiments, if no audio is detected when the computer system 101 detects that the head of the user 7002 is directed to the user interface 8016, the computer system 101 forgoes selecting the user interface 8016 (e.g., the user interface 8016 cannot be selected if audio is not playing). For example, if the user interface 8022 was not displayed (e.g., and no other audio was playing), the computer system 101 does not select the user interface 8016 (e.g., and optionally maintains selection of the last selected user interface (e.g., the user interface 8014 in FIG. 8AG)). In some embodiments, if no audio is playing when the user 7002 rotates the digital crown 703 (e.g., by at least the first threshold amount), user interface 8016 is not displayed in response.

In FIG. 8AI, (e.g., while the user interface 8016 is selected, based on the head-based pointer), the user 7002 performs an air pinch and drag with the hand 7020. In response to detecting the air pinch and drag with the hand 7020, the computer system 101 adjusts a current audio level for the computer system 101 (e.g., and/or for the video that is playing in the user interface 8022) (e.g., because the user interface 8016 is selected). In some embodiments, in response to detecting the air pinch and drag with the hand 7020, the computer system 101 adjusts a setting corresponding to a user interface to which the user's attention (e.g., based on the head-based pointer) is directed when the (e.g., beginning of the) air pinch and drag is detected. In some embodiments, when the air pinch and drag with the hand 7020 is in a first direction (e.g., a rightward direction as shown in FIG. 8AI), the computer system 101 increases a current audio level for the computer system 101 (e.g., and/or the video that is playing in the user interface 8022).

In some embodiments, the current audio level can be adjusted by either the air pinch and drag with the hand 7020 described with reference to FIGS. 8AI and 8AJ, or by rotating the digital crown 703 (e.g., as described with reference to FIGS. 8S-8AB). In some embodiments, the current level of immersion (e.g., when the user interface 8014 is selected, as in FIGS. 8T-8V) or the current level of zoom (e.g., when the user interface 8038 is selected, as in FIGS. 8W-8AA) can similarly be adjusted by either rotating the digital crown 703 (e.g., as described above with reference to FIGS. 8T-8AA), or by an air pinch and drag with the hand 7020 (e.g., as described with reference to FIGS. 8AI-8AJ).

In FIG. 8AJ, the air pinch and drag with the hand 7020 (e.g., optionally a continuation of the air pinch and drag with the hand 7020 in FIG. 8AI, or a new, subsequent air pinch and drag with the hand 7020) moves in a direction opposite that in FIG. 8AI (e.g., a leftward direction as shown in FIG. 8AJ). In response to detecting the air pinch and drag with the hand 7020 in FIG. 8AJ, the computer system 101 adjusts (e.g., decreases) a current audio level for the computer system 101 (e.g., and/or for the video that is playing in the user interface 8022).

FIG. 8AK illustrates that after a threshold amount of time (e.g., 0.1, 0.2, 0.3, 0.5, 1, 2, 5, 10, 20, or 30 seconds) has elapsed where no adjustment is made to a setting of the computer system 101 (e.g., a setting corresponding to the currently selected user interface in FIGS. 8A-8AJ), the computer system 101 ceases to display the user interface 8014, the user interface 8038, and the user interface 8016. In some embodiments, the computer system 101 also re-enables the wrist-based pointer (e.g., which was disabled in FIG. 8AF upon invocation of the user interface 8014, the user interface 8038, and the user interface 8016), as shown by the dotted line emanating from the user's hand 7020.

FIG. 8AL illustrates that, in some embodiments, the computer system 101 also disables the head-based pointer (e.g., when the wrist-based pointer is re-enabled). In a transition from FIG. 8AK to FIG. 8AL, the user 7002 turns (e.g., to the left of the user 7002). While the viewpoint of the user 7002 changes to reflect the movement of the user 7002, the wrist-based pointer continues to be used for selection (e.g., of the virtual object 7012), and no head-based pointer is enabled; accordingly, the same virtual object 7012 continues to be selected (e.g., whereas if the head-based pointer were enabled, movement of the user 7002's head would have moved the head-based pointer and changed which object was selected).

While FIGS. 8AC-8AL illustrate switching between a wrist-based pointer and a head-based pointer, the descriptions of FIGS. 8AC-8AL are applicable to any suitable input types. For example, while the user interface 8014, the user interface 8038, and the user interface 8016 are displayed, a first type of user input (e.g., a user input that includes movement of, a pose of, and/or is otherwise based on a first body part of the user 7002; or a user input received via a first input mechanism (e.g., the digital crown 703) and/or involving a first type of movement of the first input mechanism (e.g., rotation of the digital crown 703, or activating a button of the digital crown 703)) is active (e.g., is enabled, is detected, and/or is processed by the computer system 101) while a second type of user input (e.g., a user input that includes movement of, a pose of, and/or is otherwise based on a second body part of the user 7002 that is different from the first body part of the user 7002; or a user input received via a second input mechanism (e.g., the button 701 or the button 702) that is different from the first input mechanism and/or involving a second type of movement of the first input mechanism (e.g., rotation of the digital crown 703, or activating a button of the digital crown 703) that is different from the first type of movement of the first input mechanism) is not active (e.g., is not enabled, is not detected, and/or is not processed by the computer system 101). While the user interface 8014, the user interface 8038, and the user interface 8016 are displayed, the second type of user input is active, but the first type of user input is not active.

In some embodiments, multiple types of user inputs can be used to navigate between and/or select user interfaces. For example, in FIGS. 8S-8AB, activating a button of the digital crown 703 causes different user interfaces to be selected. In some embodiments, the computer system 101 (e.g., also) selects different user interfaces (e.g., navigates between different selectable user interfaces) in accordance with a head position of the user 7002 (e.g., as described with reference to FIGS. 8AE-8AL) (e.g., and/or in accordance with a wrist-based pointer of the user 7002), in addition to (e.g., or in lieu of) selecting different user interfaces in response to detecting activation of the button of the digital crown 703.

For example, in FIGS. 8AE-8AL, the computer system 101 selects different user interfaces in accordance with a head position of the user 7002 (e.g., a head-based pointer). In some embodiments, the computer system 101 (e.g., also) selects different user interfaces (e.g., navigates between different selectable user interfaces) in response to detecting activation of a button of the digital crown 703 (e.g., as described with reference to FIGS. 8S-8AB) (e.g., and/or in accordance with a wrist-based pointer of the user 7002), in addition to (e.g., or in lieu of) selecting different user interfaces in accordance with the head position of the user 7002 (e.g., the head-based pointer).

FIG. 8AM-8AX show example settings relating to display of the indicator 7042, and display of user interfaces in connection with activation of a button and/or digital crown of the computer system 101, and user interface behavior reflecting changes to those settings.

FIG. 8AM shows a settings user interface 8024. In some embodiments, the settings user interface 8024 is accessed via the system function menu 7046 (e.g., an affordance of the system function menu 7046), and/or a system space (e.g., the system space 7084 described with reference to FIG. 7J) of the computer system 101. In some embodiments, the settings user interface 8024 includes additional options (e.g., for adjusting and/or configuring additional settings of the computer system 101) beyond what is shown in FIG. 8AM, and/or includes options or affordances for navigating to additional settings (e.g., additional settings other than crown and/or indicator-related settings of the computer system 101, as shown in FIG. 8AM).

The settings user interface 8024 includes a “Default Selection” setting 8026, a “Show Zoom” setting 8028, a “Show Indicator” setting 8030, a “Show Indicator in Immersive Experience” setting 8031, and an “Indicator Height” setting 8033.

The “Default Selection” setting 8026 controls a default selection of a setting to be adjusted when the digital crown 703 is rotated (e.g., as described above with reference to FIGS. 8S-8AL). In some embodiments, the “Default Selection” setting 8026 controls a default selection of a setting to be adjusted when a different kind of user input is detected (e.g., a button press or activation of a different physical mechanism, as in FIGS. 8A-8R, and/or an air gesture or other type of user input).

In some embodiments, when the “Default Selection” setting 8026 is set to a “contextual” option 8037 (e.g., as shown in FIG. 8AP), the default setting to be adjusted is based on specific criteria (e.g., context-specific criteria, such as whether or not audio is playing). For example, FIGS. 8A-8R show behavior consistent with the “Default Selection” setting 8026 set to the “contextual” option 8037. If audio is not playing for the computer system 101, then the default setting to be adjusted is the level of immersion (e.g., as in FIG. 8B). If audio is playing for the computer system 101, then the default setting to be adjusted is the current audio level (e.g., as in FIG. 8I).

In some embodiments, the “Default Selection” setting 8026 can be set to a specific setting (e.g., an “immersion” option 8039, a “volume” option 8041, or a “zoom” option 8044, as shown in FIG. 8AP) to be adjusted by default (e.g., without regard for whether specific criteria are met or not). In some embodiments, the “zoom” option 8044 is only displayed and/or selectable if the “Show Zoom” setting 8028 (e.g., described in greater detail below) is enabled. In some embodiments, the “zoom” option 8044 is displayed and/or selectable regardless of whether the “Show Zoom” setting 8028 is enabled or disabled, but the “Show Zoom” setting 8028 is automatically enabled if the “zoom” option 8044 is selected for the “Default Selection” setting 8026.

In some embodiments, the “Show Zoom” setting 8028 controls whether an option for adjusting a level of zoom for the computer system 101 is accessible and/or adjustable (e.g., in FIGS. 8A-8R, the “Show Zoom” setting 8028 is not enabled, so only the level of immersion and the current audio level of the computer system 101 are adjustable; and in FIGS. 8S-8AL, the “Show Zoom” setting 8028 is enabled, so the level of zoom is adjustable, in addition to the level of immersion and the current audio level). In FIG. 8AM, the “Show Zoom” setting 8028 is enabled, consistent with FIGS. 8S-8AL described above.

In some embodiments, the “Show Indicator” setting 8030 controls whether the indicator 7042 is displayed (e.g., as a global and/or universal setting). In some embodiments, relevant criteria (e.g., the user's attention 7010 directed to an appropriate location, optionally, in combination with an air gesture, selection gesture, or other user input) must still be met to display the indicator 7042 when the “Show Indicator” setting 8030 is enabled. In FIG. 8AM, the “Show Indicator” setting 8030 is enabled, and the computer system 101 displays the indicator 7042 when appropriate (e.g., as in FIG. 8AM itself, as well as when relevant criteria are met in FIGS. 7A-8AL). In some embodiments, if the “Show Indicator” setting 8030 is not enabled (e.g., and/or if the “Show Indicator” setting 8030 is disabled in response to a user input detected while a user's attention 8046 is directed to the “Show Indicator” setting 8030), then the indicator 7042 is not displayed (e.g., even if the relevant criteria described above are met). This allows for additional customization of the user interfaces of the computer system 101 (e.g., the indicator 7042 can be enabled for easy access to system functions via the system function menu 7046; or the indicator 7042 can be disabled to avoid unnecessary distraction or to increase a level of immersion while using the computer system 101).

In some embodiments, the “Show Indicator in Immersive Experience” setting 8031 controls whether the indicator 7042 can be displayed while the computer system 101 is displaying an immersive experience or application content that is an immersive experience (e.g., as shown in FIGS. 7AI and 7AJ). In FIG. 8AM, the “Show Indicator in Immersive Experience” setting 8031 is disabled, which is consistent with the behavior shown in FIGS. 7AI and 7AJ (e.g., the indicator 7042 is not displayed in FIG. 7AJ, even though the user's attention 7010 is directed to a location within the region 7032). If, however, the “Show Indicator in Immersive Experience” setting 8031 was enabled (e.g., via a user input detected while a user's attention 8048 is directed to the “Show Indicator in Immersive Experience” setting 8031), then in FIG. 7AJ, the indicator 7042 would be displayed. This allows for additional customization relating to displayed user interfaces, and can also enable easy access to system functions even when immersive experiences are displayed, if needed.

In some embodiments, the “Indicator Height” setting 8033 controls a vertical height of the indicator 7042 (e.g., and optionally, the region 7028, the region 7030, and/or the region 7032). In some embodiments, the “Indicator Height” setting 8033 includes a slider (e.g., or another suitable, adjustable control or affordance). In some embodiments, the “Indicator Height” setting 8033 includes an option for specifying a height of the indicator 7042, the region 7028, the region 7030, and/or the region 7032 (e.g., by manually entering a height and/or offset distance). In FIG. 8AM, the computer system 101 detects the user's attention 7010 directed to the slider of the “Indicator Height” setting 8033 (e.g., optionally, in combination with an air gesture, a selection gesture, a button press, or another user input).

In FIG. 8AN, the user adjusts the slider of the “Indicator Height” setting 8033 towards a “lower” end of the slider (e.g., and away from the “higher” end of the slider, and the indicator 7042, the region 7028, the region 7030, and the region 7032 are displayed at (e.g., and/or moved to) a lower vertical position as compared to FIG. 8AM. In some embodiments, the vertical position of the indicator 7042, the region 7028, the region 7030, and/or the region 7032 are moved and/or updated as the slider of the “Indicator Height” setting 8033 is adjusted (e.g., to provide visual feedback to the user as the slider is adjusted). In some embodiments, adjusting the “Indicator Height” setting 8033 also adjusts the displayed position of the system function menu 7046 (e.g., when displayed) by the same (e.g., or proportional) amount (e.g., to maintain a particular spatial relationship between the indicator 7042 and the system function menu 7046).

In FIG. 8AO, the user's attention 7010 is directed to the “Default Selection” setting 8026. In response (e.g., and in response to detecting a user input such as an air gesture, a selection gesture, a button activation, or another user input, while the user's attention 7010 is directed to the “Default Selection” setting 8026), as shown in FIG. 8AP, the computer system 101 displays a user interface 8035 (e.g., for selecting an option for the “Default Selection” setting 8026).

In some embodiments, the user interface 8035 includes a “contextual” option 8037, which, when selected, causes the computer system to operate in accordance with behavior described above with reference to FIGS. 8A-8R (e.g., if no audio is playing, the computer system 101 defaults to adjusting the level of immersion; and if audio is playing, the computer system 101 defaults to adjusting the current audio level), when the computer system 101 detects activation of the button 8008 (e.g., as in FIG. 8B) and/or rotation of the digital crown 703 (e.g., as in FIG. 8T).

In some embodiments, the user interface 8035 includes an “Immersion” option 8039, which, when selected, configures the computer system 101 to adjust the level of immersion by default (e.g., whether or not audio is playing) (e.g., when the computer system 101 detects activation of the button 8008 (e.g., as in FIG. 8B) and/or rotation of the digital crown 703 (e.g., as in FIG. 8T)).

In some embodiments, the user interface 8035 includes a “Volume” option 8041, which, when selected, configures the computer system 101 to adjust the current audio level by default (e.g., whether or not audio is playing). In some embodiments, if the “Volume” option 8041 is selected for the “Default Selection” setting 8026 but no audio is currently playing (e.g., when the computer system 101 detects activation of the button 8008 (e.g., as in FIG. 8B) and/or rotation of the digital crown 703 (e.g., as in FIG. 8T)), the computer system 101 adjusts a global or universal audio level for the computer system 101 (e.g., for audio across multiple applications and/or for system audio, such as for alerts). In some embodiments, if the “Volume” option 8041 is selected for the “Default Selection” setting 8026 but no audio is currently playing (e.g., when the computer system 101 detects activation of the button 8008 (e.g., as in FIG. 8B) and/or rotation of the digital crown 703 (e.g., as in FIG. 8T)), the computer system 101 adjusts the audio level, and uses the adjusted audio level the next time audio is played.

In some embodiments, the user interface 8035 includes a “Zoom” option 8044, which, when selected, configures the computer system 101 to default to adjusting a level of zoom for the computer system 101 when the computer system 101 detects activation of the button 8008 (e.g., as in FIG. 8B) and/or rotation of the digital crown 703 (e.g., as in FIG. 8T). In some embodiments, the “Zoom” option 8044 is not displayed if the “Show Zoom” setting 8028 is not enabled in the settings user interface 8024. In some embodiments, the “Zoom” option 8044 is displayed (e.g., regardless of whether or not the “Show Zoom” setting 8028 is enabled), and selecting the “Zoom” option 8044 in the user interface 8035 automatically enables the “Show Zoom” setting 8028 in the settings user interface 8024 (e.g., if the “Show Zoom” setting 8028 was not enabled prior to selection of the “Zoom” option 8044).

In FIG. 8AP, the user's attention 7010 is directed to the “volume” option 8041 (e.g., optionally, in combination with an air gesture, a selection gesture, or another user input). In response, as shown in FIG. 8AQ, the computer system 101 updates the “Default Selection” setting 8026 to the “volume” option 8041.

FIG. 8AR shows the updated settings user interface 8024, which also reflects the change to the “Default Selection” setting 8026 to the “volume” option 8041. In FIG. 8AR, the user's attention 7010 is directed to the “Show Zoom” function 8028 (e.g., optionally, in combination with an air gesture, a selection gesture, or another user input). In response, as shown in FIG. 8AS, the “Show Zoom” settings 8028 is disabled.

FIG. 8AT shows the effects of updating the “Default Selection” setting 8026 in the settings user interface 8024. In FIG. 8AT, the computer system 101 detects rotation of the digital crown 703. Since the “Default Selection” is set to the “volume” option 8041, the computer system 101 defaults to adjusting the current audio level of the computer system 101, even though no audio is currently playing. In addition, the user interface 8038 (e.g., corresponding to a zoom setting and/or zoom level of the computer system 101) is not shown, because the “Show Zoom” settings 8028 was disabled in response to the user input in FIG. 8AR.

FIGS. 8AU and 8AV are analogous to FIGS. 8AS and 8AT, except that the “Default Selection” setting 8026 in FIG. 8AU is set to the “immersion” option 8039. In FIG. 8AV, in response to detecting the rotation of the digital crown 703, the computer system 101 defaults to adjusting the level of immersion, even though audio is currently playing (e.g., as shown by the playing video in the user interface 8022, and the sound waves in FIG. 8AV).

FIG. 8AW shows that while the computer system 101 has defaulted to adjusting the level of immersion (e.g., and while the video in the user interface 8022 continues to play, with audio), the computer system 101 detects that the user's attention 7010 is directed to the user interface 8016 (e.g., which corresponds to the volume setting of the computer system 101) in combination with a user input activating the button of the digital crown 703.

In response, as shown in FIG. 8AX, the computer system 101 switches to adjusting the current audio level. While FIGS. 8AW and 8AX show one method of switching between adjusting the level of immersion and adjusting the current audio level, in some embodiments, the user can perform this switch using any suitable user input or combination of user inputs, with some examples described above with reference to FIGS. 8A-8AL. In some embodiments, the switching is performed in response to one or more of: the user's attention (e.g., based on the user's gaze); a combination of user's attention with rotation of the digital crown 703; a combination of an air gesture or selection gesture with the user's attention being directed to a specific user interface such as the user interface 8016; and/or a button activation (e.g., regardless of where the user's attention is directed)).

In some embodiments, the user can switch back to adjusting the level of immersion (e.g., by directing the user's attention 7010 to the user interface 8014 in FIG. 8AX, in combination with activation of the button of the digital crown 703 (or, optionally, any of the alternatives described above)). In some embodiments, analogous switching is enabled regardless of what the “Default Selection” setting 8026 is set to (e.g., in FIG. 8AT, the user can switch to adjusting the level of immersion, in an analogous manner as described above with reference to FIGS. 8AW-8AX).

Additional descriptions regarding FIGS. 8A-8R are provided below in reference to method 10000 described with respect to FIGS. 8A-8R, additional descriptions regarding FIGS. 8S-8AL are provided below in reference to method 11000 described with respect to FIGS. 8S-8AL, and additional descriptions regarding FIGS. 8AM-8AX are provided below in reference to method 13000 described with respect to FIGS. 8AM-8AX.

FIGS. 9A-9B are a flow diagram of an exemplary method 9000 for triggering display of user interface elements for system functions based on user attention to a particular view region, in accordance with some embodiments. In some embodiments, method 9000 is performed at a computer system (e.g., computer system 101 in FIG. 1A) that is in communication with a display generation component (e.g., display generation component 120 in FIGS. 1A, 3, and 4, display generation component 7100 in FIGS. 7A and 8A, and/or display generation 7100a in FIGS. 7F2, 7O-7AL, 8J2, and 8S-8AX) (e.g., a heads-up display, a display, a touchscreen, a projector, a head mounted display (HMD), an inner display of a two-sided display generation component, a display on a handheld device, a display on a wearable device, or another type of display) and one or more input devices (e.g., cameras (e.g., color sensors, infrared sensors, and other depth-sensing cameras) (e.g., that point downward at a user's hand and/or forward from the user's head), touch-sensors, touch-sensitive surfaces, proximity sensors, motion sensors, buttons, joysticks, and/or other sensors and input devices). In some embodiments, the method 9000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 9000 are, optionally, combined and/or the order of some operations is, optionally, changed.

Method 9000 is a method of triggering display of user interface elements for accessing system functions of a computer system based on user attention directed to a particular view region, in accordance with some embodiments. Displaying a first user interface object that includes one or more affordances for accessing a set of functions of the computer system, in response to detecting a first user input that meets selection criteria, in accordance with a determination that an attention of a user was directed to a respective portion of a respective view of three-dimensional environment that has a first spatial relationship to a viewport through which the three-dimensional environment is visible at a time when a first user input was detected, and forgoing displaying the first user interface object, in response to detecting the first user input that meets the selection criteria, and in accordance with a determination that the attention of the user was not directed to the respective portion of the respective view of the three-dimensional environment at the time when the first user input was detected, reduces the number of inputs needed to access system functions of the computer system without cluttering the user interface with additional displayed controls, user interfaces, and/or user interface objects (e.g., the first user interface object and/or a control for displaying the first user interface object, do not need to be permanently displayed in order to enable access to the system functions of the computer system).

While a first view of a three-dimensional environment (e.g., a three-dimensional environment that includes a passthrough view of the physical environment of the display generation component, a mixed reality view that includes both virtual content and a representation of the physical environment surrounding the display generation component, or a fully virtual three-dimensional environment) is visible (e.g., visible in a passthrough mode that corresponds to a lowest level of immersion, a mixed reality mode that corresponds to one or more intermediate levels of immersion, or a virtual reality mode that corresponds to a maximum level of immersion) (e.g., the view of the three-dimensional environment shown in FIG. 7A), via the display generation component (e.g., the display generation component 7100 in FIG. 7A), from a first viewpoint, the computer system detects (9002) a first user input (e.g., performed by the hand 7020 in any of FIGS. 7A-7G) that meets selection criteria (e.g., a user input that includes a hand gesture and/or movement of a user's hand such as an air pinch, air long pinch, and/or air tap gesture; or a user input of another input type other than an air gesture (e.g., a tap on a touch-sensitive surface, a button press on a controller, and/or a voice command)). In some embodiments, the computer system is capable of displaying the three-dimensional environment with different levels of immersion, includes a low level of immersion in which passthrough content dominates the view of the three-dimensional environment with minimal virtual content, one or more intermediate levels of immersion in which virtual content and passthrough content are both displayed and virtual objects are displayed with three-dimensional spatial relationships to the representations of physical objects and surfaces in the passthrough view of the physical environment, and a high level of immersion in which virtual content dominates the view of the three-dimensional environment with little to no representation of the physical object and surfaces in the physical environment. In some embodiments, the passthrough view and/or the representation of the physical environment in the mixed-reality view are visible via the display generation component through a video feed that includes the video image of the physical environment. In some embodiments, the passthrough view and/or the representation of the physical environment in the mixed reality view are visible via the display generation component through a transparent or semitransparent portion of the display generation component in the physical environment.

In response to detecting the first user input that meets the selection criteria (9004), the computer system, in accordance with a determination that an attention (e.g., based on gaze, or based on a gaze substitute such as a hand pointing gesture or a focus selector or a virtual line of sight provided by a pointing device, that indicates a portion of the three-dimensional environment with which the user intends to interact) of a user (e.g., the user that provided the first user input, and/or a user that is collaborating with the user that provided the first user input in controlling the computer system) was directed to a first portion of the first view of the three-dimensional environment that has a first spatial relationship to a viewport through which the three-dimensional environment is visible (e.g., in the upper center edge portion of the viewport, in the lower left corner of the viewport, in the upper right corner of the viewport, or another portion of the viewport), at a time when the first user input was detected, the computer system displays (9006), in the first view of the three-dimensional environment (e.g., in the first portion of the first view, at the location of the user's attention, and/or at a location that has a preconfigured spatial relationship to the first portion of the first view), a first user interface object (e.g., the system function menu 7046 in FIG. 7G) that includes one or more affordances (e.g., the affordances 7048, 7050, 7052, 7054, 7056, and 7058, of the system function menu 7046, in FIG. 7G) for accessing a set of functions of the computer system (e.g., the first user interface object includes one or more indicators of system status (e.g., active communication sessions, screen recording sessions, location tracking, navigation sessions, and/or other system status), and/or one or more user interface objects for accessing respective system functions and/or other functionalities (e.g., displaying an application launching user interface including application icons for various applications, displaying a listing of communication contacts of the user, and/or displaying a control user interface for controlling various system settings, displaying a listing of experiences, displaying a volume control for the system, displaying do not disturb control for changing a do not disturb state of the device, displaying one or more wireless communication affordances for changing a wireless communication state of the device such as turning WiFi, cellular data, and/or Bluetooth on/off, and/or changing a display brightness)) For example, as described with reference to FIGS. 7F, the user's attention 7010 is directed to the indicator 7042 that is within the region 7030, and in FIG. 7G, the portable multifunction device 100 displays the system function menu 7046.

In response to detecting the first user input that meets the selection criteria (9004), the computer system, in accordance with a determination that the attention (e.g., based on gaze, or based on a gaze substitute such as a hand pointing gesture or a focus selector or a virtual line of sight provided by a pointing device, that indicates a portion of the three-dimensional environment with which the user intends to interact) of the user was not directed to the first portion of the first view of the three-dimensional environment at the time when the first user input was detected (e.g., the gaze of the user is directed to a location outside of the first portion of the first view of the three-dimensional environment, or an attention of a user is not detected), the computer system forgoes displaying (9006) the first user interface object in the first view of the three-dimensional environment (e.g., continuing to display the first view of the three-dimensional environment without displaying the first user interface object) (e.g., in FIGS. 7A-7C, the user's attention 7010 is not directed to the indicator 7042 or to a location within the region 7030, and the portable multifunction device 100 does not display the system function menu 7046).

While a second view of the three-dimensional environment is visible (e.g., the second view corresponds to the same or substantially the same level of immersion as the first view or corresponds to a different level of immersion from the first view), via the display generation component, from a second viewpoint, wherein the second view of the three-dimensional environment is different from the first view of the three-dimensional environment (e.g., the second view corresponds to the same level of immersion as the first view or corresponds to a different level of immersion from the first view) (e.g., the second view includes a different view of the same virtual content, different virtual content, a different view of the passthrough content, and/or different passthrough content, compared to the first view) and the second viewpoint is different from the first viewpoint (e.g., a viewpoint different from the first viewpoint, and/or a current viewpoint of the user after the current viewpoint of the user moved away from the first viewpoint) (e.g., in FIG. 7K-7N, the user 7002 moves to the position 7026-b, which changes the viewpoint and the view displayed via the display generation component 7100), the computer system detects (9008) a second user input that meets the selection criteria;

In response to detecting the second user input that meets the selection criteria (9010), the computer system, in accordance with a determination that the attention (e.g., based on gaze, or based on a gaze substitute such as a hand pointing gesture or a focus selector or a virtual line of sight provided by a pointing device, that indicates a portion of the three-dimensional environment with which the user intends to interact) of the user was directed to a second portion of the second view of the three-dimensional environment that has the first spatial relationship to the viewport through which the three-dimensional environment is visible (e.g., in the upper center edge portion of the viewport, in the lower left corner of the viewport, in the upper right corner of the viewport, or another portion of the viewport), at a time when the second user input was detected, displays (9012) the first user interface object that includes the one or more affordances for accessing the set of functions of the computer system (e.g., the first user interface object optionally has an identical set of affordances in the first view and in the second view of the three-dimensional environment, or has slightly different sets of affordances (e.g., with some affordances in both sets and some affordance(s) in one of the sets of affordances) in the first view and in the second view of the three-dimensional environment) depending on the current status and/or context of the computer system) in the second view of the three-dimensional environment (e.g., in the second portion of the second view, at the location of the user's attention, and/or at a location that has the preconfigured spatial relationship to the second portion of the second view) (e.g., in FIG. 7M, the user's attention 7010 is directed to the indicator 7042, and the portable multifunction device 100 displays the system function menu 7046). In some embodiments, if the first view and the second view both display a portion of the three-dimensional environment in which the first user interface object is initially displayed in the first view, the computer system optionally moves the first user interface object from its displayed location in the first view (e.g., a location in the three-dimensional environment that corresponds to the first portion of the first view and/or a location that has the preconfigured spatial relationship to the first portion of the first view) to a new display location in the second view (e.g., a location in the three-dimensional environment that corresponds to the second portion of the second view and/or a location that has the preconfigured spatial relationship to the second portion of the second view). In some embodiments, if the second view does not display a portion of the three-dimensional environment in which the first user interface object is initially displayed in the first view, the computer system optionally ceases to display the first user interface object (e.g., if the first user interface object is not closed in accordance with user request or automatically closed due to lack of user interaction) at its displayed location in the first view, and redisplays the first user interface object at the new display location in the second view, such that, if the user returns to the first view, the first user interface object is no longer at its initially displayed location in the first view.

In response to detecting the second user input that meets the selection criteria (9010), the computer system, in accordance with a determination that the attention (e.g., based on gaze, or based on a gaze substitute such as a hand pointing gesture or a focus selector or a virtual line of sight provided by a pointing device, that indicates a portion of the three-dimensional environment with which the user intends to interact) of the user was not directed to the second portion of the second view of the three-dimensional environment at the time when the second user input was detected, forgoes displaying (9014) the first user interface object in the second view of the three-dimensional environment (e.g., continues to display the second view of the three-dimensional environment without displaying the first user interface object in the second view of the three-dimensional environment) (e.g., in FIG. 7L, the user's attention is not directed to the indicator 7042 or to a location within the region 7030, and the portable multifunction device 100 does not display the system function menu 7046).

In some embodiments, while displaying the first view of the three-dimensional environment, before detecting the first user input (e.g., an air pinch input, an air tap input, a pinch input, a tap input, an air pinch and drag input, an air drag input, a drag input, a click and drag input, a gaze input, and/or other input) that meets the selection criteria, the computer system detects the attention (e.g., based on gaze, or based on a gaze substitute such as a hand pointing gesture or a focus selector or a virtual line of sight provided by a pointing device, that indicates a portion of the three-dimensional environment with which the user intends to interact) of the user directed to a respective portion of the first view of the three-dimensional environment (e.g., a respective portion that has the first spatial relationship to the viewport through which the three-dimensional environment is visible, a respective portion that fully encloses the first portion of the first view, and/or a respective portion of the first view that at least partially includes the portion of the environment that corresponds to the first portion of the first view). In some embodiments, while detecting the attention (e.g., based on gaze, or based on a gaze substitute such as a hand pointing gesture or a focus selector or a virtual line of sight provided by a pointing device, that indicates a portion of the three-dimensional environment with which the user intends to interact) of the user, the computer system displays a first indicator corresponding to the first user interface object (e.g., a dot, an icon, a unitary user interface object that does not have internal affordances for performing different operations, a user interface object that optionally has one or more visual characteristics that are indicative of status information associated with the computer system and/or the three-dimensional environment) in the first view of the three-dimensional environment (e.g., in the respective portion of the first view, at the location of the user's attention, at the respective location that the first user interface object is ultimately displayed in the first view, and/or at a location that has the preconfigured spatial relationship to the respective portion of the first view). In some embodiments, while displaying the second view of the three-dimensional environment, before detecting the second user input that meets the selection criteria, the computer system detects the attention of the user directed to a respective portion of the second view of the three-dimensional environment (e.g., a respective portion that has the first spatial relationship to the viewport through which the three-dimensional environment is visible, a respective portion that fully encloses the second portion of the second view, and/or a respective portion of the second view that at least partially includes the portion of the environment that corresponds to the second portion of the second view); and while detecting the attention of the user, the computer system displays the first indicator corresponding to the first user interface object. In some embodiments, during the movement of the current viewpoint, if the user's attention is maintained at the respective portion of the currently displayed view that has the first spatial relationship to the viewport through which the three-dimensional environment is visible, the computer system maintains display of the first indicator in the respective portion of the currently displayed view that has the first spatial relationship to the viewport during the movement of the viewpoint. For example, in FIG. 7B, the portable multifunction device 100 displays the indicator 7042 in response to detecting the user's attention 7010 directed to the region 7028, in accordance with some embodiments. Displaying a first indicator corresponding to the first user interface object, while detecting the attention of the user directed to a respective portion of the first view of the three-dimensional environment, provides improved visual feedback to the user (e.g., improved visual feedback regrading a detected location of the user's attention, and improved visual feedback that further interaction with the computer system is available (e.g., via the first indicator)).

In some embodiments, while displaying the first view of the three-dimensional environment, before detecting the first user input that meets the selection criteria and before displaying the first indicator in the first view of the three-dimensional environment, the computer system detects the attention (e.g., based on gaze, or based on a gaze substitute such as a hand pointing gesture that indicates a portion of the three-dimensional environment with which the user intends to interact) of the user directed to a respective portion of the first view of the three-dimensional environment (e.g., a respective portion that has the first spatial relationship to the viewport through which the three-dimensional environment is visible, a respective portion that fully encloses the first portion of the first view, and/or a respective portion that at least partially includes the portion of the three-dimensional environment that corresponds to the first portion of the first view). In some embodiments, in response to detecting the attention (e.g., based on gaze, or based on a gaze substitute such as a hand pointing gesture that indicates a portion of the three-dimensional environment with which the user intends to interact) of the user directed to the respective portion of the first view of the three-dimensional environment (e.g., before detecting the first user input that meets the selection criteria): in accordance with a determination that the respective portion of the first view (e.g., bigger than the first portion of the first view in one or more dimensions, fully enclosing the first portion of the first view, partially enclosing the first portion of the first view) has a second spatial relationship (e.g., same as the first spatial relationship, or different from the first spatial relationship) to the viewport through which the three-dimensional environment is visible (and optionally that the user's attention is maintained in the respective portion of the first view for at least a threshold amount of time), the computer system displays the first indicator corresponding to the first user interface object in the first view of the three-dimensional environment (e.g., in the respective portion of the first view, at the location of the user's attention, at the respective location that the first user interface object is ultimately displayed in the first view, and/or at a location that has the preconfigured spatial relationship to the respective portion of the first view); and in accordance with a determination that the respective portion of the first view does not have the second spatial relationship to the viewport through which the three-dimensional environment is visible, the computer system forgoes displaying the first indicator corresponding to the first user interface object in the first view of the three-dimensional environment. In some embodiments, while displaying the second view of the three-dimensional environment before detecting the second user input that meets the selection criteria, the computer system detects the attention of the user directed to a respective portion of the second view of the three-dimensional environment. In response to detecting the attention of the user directed to the respective portion of the second view of the three-dimensional environment (e.g., before detecting the second user input that meets the selection criteria): in accordance with a determination that the respective portion of the second view has the second spatial relationship to the viewport through which the three-dimensional environment is visible (and optionally that the user's attention is maintained in the respective portion of the second view for at least a threshold amount of time), the computer system displays the first indicator corresponding to the first user interface object in the second view of the three-dimensional environment (e.g., in the respective portion of the second view, at the location of the user's attention, at the respective location that the first user interface object is ultimately displayed in the second view, and/or at a location that has a preconfigured spatial relationship to the respective portion of the second view); and in accordance with a determination that the respective portion of the second view does not have the second spatial relationship to the viewport through which the three-dimensional environment is visible, the computer system forgoes displaying the first indicator corresponding to the first user interface object in the second view of the three-dimensional environment. For example, in FIG. 7A, the user's attention 7010 is directed to a portion of the first view of the three-dimensional environment that does not have the second spatial relationship (e.g., a region of the first view that is outside the top center region represented by the region 7028) to the viewport (e.g., the display generation component 7100), and the portable multifunction device 100 does not display an indicator (e.g., the indicator 7042 in FIG. 7B). In contrast, in FIG. 7B, the user's attention 7010 is directed to a portion of the first view of the three-dimensional environment that has the second spatial relationship (e.g., the user's attention 7010 is within the region 7028), and the portable multifunction device 100 displays the indicator 7042, in accordance with some embodiments. Displaying the first indicator corresponding to the first user interface object, in accordance with a determination that a respective portion of the first view (e.g., to which a user's attention is directed) has a second spatial relationship to the viewport through which the three-dimensional environment is visible, and forgoing displaying the first indicator, in accordance with a determination that the respective portion of the first view (e.g., to which the user's attention is directed) does not have the second spatial relationship, reduces the number of inputs needed to access system functions of the computer system (e.g., via interaction with the first indicator, which corresponds to the first user interface object that includes one or more affordances for accessing a set of functions of the computer system) without cluttering the user interface with additional displayed controls, user interfaces, and/or user interface objects (e.g., the first user interface object and/or a control for displaying the first user interface object, do not need to be permanently displayed in order to enable access to the system functions of the computer system) and provides improved visual feedback to the user (e.g., improved visual feedback that further interaction with the computer system is available, via the first indicator).

In some embodiments, while detecting the attention (e.g., based on gaze, or based on a gaze substitute such as a hand pointing gesture that indicates a portion of the three-dimensional environment with which the user intends to interact) of the user, the computer system increases visual prominence of the first indicator in the first view of the three-dimensional environment (e.g., until a steady state view of the first indicator is displayed, and/or until the user's attention is moved away from the reactive region for maintaining display of the first indicator (e.g., the first portion of the first view that has the first spatial relationship to the viewport, a respective portion of the first view that has the second spatial relationship to the viewport, and/or a portion that fully encloses the first portion of the first view and is greater than the respective portion of the first view in one or more dimensions)). In some embodiments, in response to detecting the user's attention directed to a respective portion of the view that is currently visible via the display generation component and that has the second spatial relationship to the viewport, the computer system displays an animated transition that shows the first indicator emerging at a location that corresponds to the ultimate display position of the first user interface object (e.g., increases in size, opacity, color saturation, and/or other display parameters that affect visual prominence) in the view that is currently visible; and as the user's attention moves into a target region (e.g., the first region of the first view, and/or a region that has the first spatial relationship to the currently visible view) that is within the respective portion of the view that is currently visible, the computer system displays a steady state view of the first indicator that has a greater visual prominence than the initially displayed appearance of the first indicator. For example, in FIG. 7D, the indicator 7042 is displayed with increased visual prominence (e.g., at a larger size, increased opacity, increased color saturation, increased brightness, and/or other changes in display properties that increase visual prominence), as compared to FIG. 7B or 7C, while the user's attention 7010 is directed to a location within the region 7030 (e.g., and optionally the portable multifunction device 100 displays an animated transition of the indicator 7042 expanding in size, increasing opacity, increasing color saturation, increasing brightness, and/or changing other display properties to increase visual prominence), in accordance with some embodiments. Increasing visual prominence of the first indicator in the first view of the three-dimensional environment, while detecting (e.g., and/or continuing to detect) the attention of the user, provides improved visual feedback to the user (e.g., improved visual feedback that further interaction with the computer system is available, by drawing the user's attention to an increasingly prominent first indicator).

In some embodiments, displaying the first indicator in the first view (e.g., the first view is an example of the view that is currently visible, and the view that corresponds to the current viewpoint) of the three-dimensional environment includes: in accordance with a determination that the computer system has a first status (e.g., the first status includes a first type of communication session is active, a first type of media capture session is ongoing, a low battery status, a normal network connection status, and/or other status of the computer system), displaying the first indicator with a first value for a first visual characteristic (e.g., a shape, a color, a size, a brightness, an opacity, and/or another visual characteristic); and in accordance with a determination that the computer system has a second status (e.g., the second status is different from the first status, and/or the second status is concurrently present with the first status, or exists without the first status) (e.g., the second status includes a second type of communication session is active, a second type of media capture session is ongoing, a full battery status, a faulty network connection status, and/or other status of the computer system), displaying the first indicator with a second value for a second visual characteristic (e.g., a shape, a color, a size, a brightness, an opacity, and/or another visual characteristic), wherein the second value for the second visual characteristic is different from the first value for the first visual characteristic (e.g., different in terms of value, visual characteristic, or both, for the different statuses associated with the computer system). In some embodiments, the first indicator has a first value for the first visual characteristic and a second value for the second visual characteristic to indicate that the computer system has both the first status and the second status; and when the first status is changed to a third status, the computer system updates the first indicator to have a third value for the first visual characteristic and the second value for the second visual characteristic to indicate that the computer system has both the third status and the second status. In some embodiments, if the computer does not have the second status any more, the computer system changes the second visual characteristic to a default value or removes the second visual characteristic from the first indicator while continue to display the first indicator with the third value for the first visual characteristic to indicate the third status of the computer system. Other combinations of visual characteristics and values are possible to indicate presence of one or more statuses of the computer system. For example, as described with reference to FIG. 7B, in some embodiments, one or more visual characteristics of the indicator 7042 provide visual feedback regarding a state of the computer system 101. For example, the indicator 7042 has a first color (e.g., orange or red), if the computer system 101 is currently recording audio and/or processing inputs from one or more audio sensors (e.g., the user 7002 is in a phone call or other audio-only communication session with another user of another electronic device (e.g., that is in communication with the computer system 101). The indicator 7042 has a different color (e.g., green or blue) if the computer system 101 is currently recording audio and video, and/or processing inputs from both an audio sensor and a video sensor (e.g., the user 7002 is in a video call, and/or a AR or VR communication session, with another user of another electronic device (e.g., that is in communication with the computer system 101), in accordance with some embodiments. Displaying the first indicator with a first value for a first visual characteristic, in accordance with a determination that the computer system has a first status, and displaying the first indicator with a second value for a second visual characteristic (e.g., wherein the second value for the second visual characteristic is different from the first value for the first visual characteristic), in accordance with a determination that the computer system has a second status (e.g., that is different than the first status), provides improved visual feedback to the user (e.g., improved visual feedback regarding a current status of the computer system).

In some embodiments, in accordance with a determination that the computer system has the first status, displaying the first indicator with the first value for the first visual characteristic includes: in accordance with a determination that media capturing (e.g., audio, video, and/or screen capture) is in progress at the computer system (e.g., video capturing of the view of the three-dimensional environment is ongoing, audio recording of a communication session is ongoing, audio recording of the physical environment, video recording of the physical environment is ongoing), displaying the first indicator with a respective value selected from a first set of values for the first visual characteristic (e.g., displaying the first indicator with a first color that is optionally animated (e.g., blinking, pulsating, and/or otherwise animated to indicate the progress of the media recording)); and in accordance with a determination that media capturing (e.g., audio, video, and/or screen capture) is not in progress at the computer system, ceasing to display the first indicator with the respective value selected from the first set of values for the first visual characteristic (e.g., displaying the first indicator with a default color different from the first color, ceasing to animate the first indicator, and/or displaying the first indicator with a different color to indicate another status associated with the computer system). In some embodiments, the first visual characteristic includes a shape of the first indicator, and media capture status is indicated by the shape of the indicator (e.g., a triangular icon indicates that no video recording is ongoing, and a circular icon indicates that media recording is ongoing), and optionally the color or another visual characteristic is used to indicate the type of media capture that is ongoing. In some embodiments, the media capture records an active communication session, such as a phone call, a shared experience, a video call. In some embodiments, the media capture records the audio and/or video input captured by the sensors of the computer system, and/or the audio and video output of the display generation component and/or other output device of the computer system (e.g., audio and video received from another device). For example, as described with reference to FIG. 7B, in some embodiments, the indicator 7042 has a first color (e.g., orange or red), if the computer system 101 is currently recording audio and/or processing inputs from one or more audio sensors (e.g., the user 7002 is in a phone call or other audio-only communication session with another user of another electronic device (e.g., that is in communication with the computer system 101), in accordance with some embodiments. For example, the indicator 7042 has a different color (e.g., green or blue) if the computer system 101 is currently recording audio and video, and/or processing inputs from both an audio sensor and a video sensor (e.g., the user 7002 is in a video call, and/or a AR or VR communication session, with another user of another electronic device (e.g., that is in communication with the computer system 101), in accordance with some embodiments. Displaying the first indicator with a respective value selected from a first set of values for the first visual characteristic, in accordance with a determination that media capturing is in progress at the computer system, and ceasing to display the first indicator with the respective value selected from the first set of values for the first visual characteristic, in accordance with a determination that media capturing is not in progress, provides improved visual feedback to the user (e.g., improved visual feedback regarding whether or not media capturing is in progress at the computer system).

In some embodiments, in accordance with a determination that media capturing (e.g., audio, video, and/or screen capture) is in progress at the computer system, displaying the first indicator with a respective value selected from the first set of values for the first visual characteristic includes: in accordance with a determination that the media capture includes recording of a first type of media (e.g., audio, and/or audio without video), displaying the first indicator with a first respective value selected from the first set of values for the first visual characteristic; and in accordance with a determination that the media capture includes recording of a second type of media (e.g., images, video, and/or both image and audio) different from the first type of media, displaying the first indicator with a second respective value, different from the first respective value, selected from the first set of values for the first visual characteristic. For example, the computer system uses different colors for audio recording without video versus concurrent audio and video recording (e.g., showing the first indicator with an orange or red color for audio recording without video recording and showing the first indicator with a green or blue color for video recording), in accordance with some embodiments. For example, as described with reference to FIG. 7B, in some embodiments, the indicator 7042 has a first color (e.g., orange or red), if the computer system 101 is currently recording audio and/or processing inputs from one or more audio sensors (e.g., the user 7002 is in a phone call or other audio-only communication session with another user of another electronic device (e.g., that is in communication with the computer system 101); and the indicator 7042 has a different color (e.g., green or blue) if the computer system 101 is currently recording audio and video, and/or processing inputs from both an audio sensor and a video sensor (e.g., the user 7002 is in a video call, and/or a AR or VR communication session, with another user of another electronic device (e.g., that is in communication with the computer system 101). Displaying the first indicator with a first respective value selected from the first set of values for the first visual characteristic, in accordance with a determination that the media capture includes recording of a first type of media, and displaying the first indicator with a second respective value that is different from the first respective value selected from the first set of values for the first visual characteristic, in accordance with a determination that the media capture includes recording of a second type of media different from the first type of media, provides improved visual feedback to the user (e.g., improved visual feedback regarding whether or not media capturing is in progress at the computer system, and/or improved visual feedback regarding what type of media capture is in progress at the computer system).

In some embodiments, displaying, in response to detecting the first user input (and in accordance with a determination that the attention of the user was directed to the first portion of the first view that has the first spatial relationship to the viewport), the first user interface object in the first view of the three-dimensional environment (e.g., the first view is an example of the view that is currently visible via the display generation component, and the first user input is an example of the user input that triggers the display of the first user interface object in the currently visible view) includes: replacing display of the first indicator with display of the first user interface object (e.g., at the location of the first indicator) (e.g., displaying an animated transition that shows the first indicator transforming into the first user interface object, and/or the first user interface object emerging out of the first indicator) in the first view of the three-dimensional environment. For example, in FIG. 7G, the indicator 7042 is represented with a dotted outline to indicate that in some embodiments, the system function menu 7046 replaces display of the indicator 7042 (e.g., e.g., when the system function menu 7046 is displayed, the indicator 7042 is no longer displayed), in accordance with some embodiments. Replacing display of the first indicator with display of the first user interface object, in response to detecting the first user input, reduces the number of inputs needed to display appropriate content (e.g., the user does not need to perform additional user inputs to cease displaying the first indicator) and avoids cluttering the UI with unneeded user interfaces and/or controls (e.g., the first indicator does not need to be displayed if the first user interface object is already displayed).

In some embodiments, the respective portion of the first view of the three-dimensional environment is larger than the first portion of the first view of the three-dimensional environment in one or more dimensions (e.g., in the vertical dimension and/or in the horizontal dimension of the viewport). For example, in some embodiments, a larger reactive region is made available in the upper edge portion or another portion of the viewport to trigger display of the first indicator when the attention of the user is detected within the larger reactive region; however, after the first indicator is displayed in response to detecting the user's attention inside the larger reactive region, the user input that meets the selection criteria does not trigger the display of the first user interface object unless the user's attention is moved into the smaller reactive region within the larger reactive region and closer to the location of the first indicator. If the user input that meets the selection criteria is detected while the user's attention is within the smaller reactive region within the larger reactive region, the first indicator is transformed into the first user interface object and/or the first user interface object replaces display of the first indicator in the first view of the three-dimensional environment. For example, in FIGS. 7B and 7G, the region 7028 is larger than the region 7030 (e.g., in both width and height). In FIG. 7B, the portable multifunction device 100 displays the indicator 7042 in response to detecting the user's attention 7010 directed to a location in the region 7028, but does not display the system function menu 7046 (e.g., even in response to detecting other user inputs while the user's attention 7010 is directed to the location in the region 7028), in accordance with some embodiments. In FIG. 7G, the portable multifunction device 100 displays the system function menu in response to detecting the user's attention 7010 is directed to the indicator 7042 (e.g., which is withing the smaller region 7030) (e.g., in conjunction with a predefined gesture), in accordance with some embodiments. Providing different functionality based on a respective portion of the first view of the three-dimensional environment, and based on a first region of the first view of the three-dimensional environment that is smaller than the respective portion of the first view of the three-dimensional environment, enables the computer system to provide improved visual feedback and guidance to the user regarding accessing different functions of the computer system without needing to permanently display controls and/or user interfaces (e.g., the respective portion of the first view of the three-dimensional environment can be used to trigger display of hints or other visual indicators that guide the user to directing the user's attention to the smaller first region, which can be used to trigger display of the first user interface object for accessing system functions of the computer system).

In some embodiments, while displaying the first indicator in the first view of the three-dimensional environment, detecting that the attention (e.g., based on gaze, or based on a gaze substitute such as a hand pointing gesture that indicates a portion of the three-dimensional environment with which the user intends to interact) of the user has moved from a first location in the respective portion of the first view that is outside of first portion of the first view to a second location in the respective portion of the first view that is within the first portion of the first view; and in response to detecting that the attention (e.g., based on gaze, or based on a gaze substitute such as a hand pointing gesture that indicates a portion of the three-dimensional environment with which the user intends to interact) of the user has moved from the first location in the respective portion of the first view that is outside of first portion of the first view to the second location in the respective portion of the first view that is within the first portion of the first view, changing an appearance of the first indicator from a first appearance to a second appearance different from the first appearance (e.g., changing from a transient appearance to a steady state appearance, enlarging the size of the first indicator, change the color of the first indicator, making the first indicator solid as opposed to translucent, and/or otherwise indicate to the user that a selection input detected while the user's attention is maintained in the current portion of the first view would cause the first user interface object to be displayed in the first view). For example, in FIG. 7B, the user's attention 7010 is directed to a location in the region 7028 but outside the region 7030, and the portable multifunction device 100 displays the indicator 7042 with a first appearance (e.g., a first size and with a first color/pattern), in accordance with some embodiments. In FIGS. 7F, the user's attention 7010 moves to the indicator 7042, and the portable multifunction device 100 displays the indicator 7042 with a second appearance (e.g., a larger size and a different color/pattern, as comparted to FIG. 7B), in accordance with some embodiments. Changing an appearance of the first indicator from a first appearance to a second appearance different from the first appearance, in response to detecting that the attention of the user has moved from a first location in the respective portion of the first view that is outside of the first portion of the first view, to a second location in the respective portion of the first view that is within the first portion of the first view, provides improved visual feedback to the user (e.g., improved visual feedback regarding additional interactions available with the computer system).

In some embodiments, before displaying the first user interface object, and while displaying the first indicator in the first view of the three-dimensional environment, the computer system detects first movement of a current viewpoint of the user from the first viewpoint to a third viewpoint (e.g., same as the second viewpoint, or different from the second viewpoint) different from the first viewpoint. In some embodiments, in response to detecting the first movement of the current viewpoint of the user from the first viewpoint to the third viewpoint, the computer system displays the first indicator in a third view of the three-dimensional environment without changing a respective spatial relationship between a respective location of the first indicator in a currently displayed view of the three-dimensional environment to the viewport through which the three-dimensional environment is visible (e.g., maintaining the respective spatial relationship between the respective location of the first indicator in the currently displayed view of the three-dimensional environment to the viewport through which the three-dimensional environment is visible, and/or maintaining the spatial relationship between the first indicator and the viewport). For example, in FIG. 7L, the user 7002 moves to a new position 7026-b, and the portable multifunction device 100 displays the indicator 7042 at a location that has the same or substantially the same spatial relationship to the viewport (e.g., the display generation component 7100) that the indicator 7042 has to the viewport in FIG. 7B (e.g., when the user 7002 is at the position 7026-a), in accordance with some embodiments. Displaying the first indicator in a third view of the three-dimensional environment without changing a respective spatial relationship between a respective location of the first indicator in a currently displayed view of the three-dimensional environment to the viewport through which the three-dimensional environment is visible, in response to detecting the first movement of the current viewpoint of the user from the first viewpoint to the third viewpoint, reduces the number of inputs needed to display user interface elements in appropriate positions (e.g., the user does not need to perform additional user inputs to reposition the first indicator each time the viewpoint changes), and also reduces the number of inputs needed to access system functions of the computer system (e.g., the user does not need to change the viewpoint again to re-access and/or redisplay the first indicator, and/or perform additional user inputs to reposition the first indicator, in order to access the system functions of the computer system via the (e.g., first user interface object that corresponds to the) first indicator).

In some embodiments, while displaying the first user interface object in the first view of the three-dimensional environment, the computer system detects second movement of a current viewpoint of the user from the first viewpoint to a fourth viewpoint (e.g., same as the second viewpoint, or different from the second viewpoint) different from the first viewpoint. In some embodiments, in response to detecting the second movement of the current viewpoint of the user from the first viewpoint to the fourth viewpoint: in accordance with a determination that a respective location of the first user interface object in the three-dimensional environment is within a fourth view of the three-dimensional environment corresponding to the fourth viewpoint, the computer system displays the first user interface object in the fourth view of the three-dimensional environment without changing the respective location of the first user interface object in the three-dimensional environment. In some embodiments, in response to detecting the second movement of the current viewpoint of the user from the first viewpoint to the fourth viewpoint, in accordance with a determination that the respective location of the first user interface object in the three-dimensional environment is not within the fourth view of the three-dimensional environment corresponding to the fourth viewpoint, the computer system forgoes displaying the first user interface object in the fourth view of the three-dimensional environment (e.g., maintaining the first user interface object at its initially displayed location in the three-dimensional environment, or ceasing to display the first user interface object in the three-dimensional environment). For example, in FIG. 7K, the user 7002 moves to the position 7026-b, and the portable multifunction device 100 maintains display of the system function menu 7046 and the system space 7084 (e.g., at the same or substantially the same positions in the three-dimensional environment as in FIG. 7J, when the user 7002 is at the position 7026-a), in accordance with some embodiments. Displaying the first user interface object in the fourth view of the three-dimensional environment without changing the respective location of the first user interface object in the three-dimensional environment, in response to detecting movement of the current viewpoint of the user from the first viewpoint to a fourth viewpoint, and in accordance with a determination that a respective location of the first user interface object in the three-dimensional environment is within a fourth view of the three-dimensional environment corresponding to the fourth viewpoint, reduces the number of inputs needed to display content at an appropriate location (e.g., the user does not need to perform additional user inputs to return the first user interface object to the respective location in the three-dimensional environment

In some embodiments, while displaying the first user interface object in the fourth view of the three-dimensional environment (e.g., at a respective location that has the preconfigured spatial relationship to the first view of the three-dimensional environment, but not the preconfigured spatial relationship to the fourth view of the three-dimensional environment, because the first user interface object is environment-locked to its initial display location in the first view of the three-dimensional environment), the computer system detects that the attention (e.g., based on gaze, or based on a gaze substitute such as a hand pointing gesture that indicates a portion of the three-dimensional environment with which the user intends to interact) of the user is directed to a respective portion of the fourth view of the three-dimensional environment that has a second spatial relationship to the viewport through which the three-dimensional environment is visible (e.g., a respective portion of the fourth view that has the first spatial relationship to the viewport through which the three-dimensional environment is visible, a respective portion that fully encloses a respective portion of the fourth view that has the first spatial relationship to the fourth view, and/or a respective portion that at least partially includes the portion of the three-dimensional environment that corresponds to the respective portion of the fourth view). In some embodiments, in response to detecting that the attention (e.g., based on gaze, or based on a gaze substitute such as a hand pointing gesture that indicates a portion of the three-dimensional environment with which the user intends to interact) of the user is directed to the respective portion of the fourth view of the three-dimensional environment while displaying the first user interface object in the fourth view of the three-dimensional environment, the computer system displays the first indicator corresponding to the first user interface object in the fourth view of the three-dimensional environment (e.g., in the respective portion of the fourth view, at the location of the user's attention, at the respective location that the first user interface object will be moved to in the fourth view, and/or at a location in the fourth view that has the preconfigured spatial relationship to the respective portion of the fourth view). For example, in some embodiments, while the first user interface object is displayed at its initial display location after the viewpoint has moved and the view of the three-dimensional environment has changed to a different view, if the computer system detects that the user's attention is directed to a respective portion of the current view of the three-dimensional environment that has the first spatial relationship to the viewport, the computer system displays the first indicator in the current view of the three-dimensional environment (e.g., while the first user interface object is still displayed at its initial environment-locked location in the current view of the three-dimensional environment). For example, in FIG. 7L, the user's attention 7010 is directed to a location in the region 7028 but outside the region 7030, and in response, the portable multifunction device 100 displays the indicator 7042 (e.g., that correspond to the system function menu 7046), in accordance with some embodiments. Displaying the first indicator corresponding to the first user interface object in the fourth view of the three-dimensional environment, in response to detecting that the attention of the user is directed to the respective portion of the fourth view of the three-dimensional environment that has the second spatial relationship to the viewport through which the three-dimensional environment is visible, reduces the number of user inputs needed to display appropriate content (e.g., the first indicator at an appropriate location), and reduces the number of user inputs needed to access system functions of the computer system (e.g., the user does not need to perform additional user inputs to change the viewpoint back to a previous viewpoint in order to display the first indicator for accessing the first user interface object that includes the one or more affordances for accessing system functions of the computer system).

In some embodiments, while displaying the first user interface object in the fourth view of the three-dimensional environment at the respective location in the three-dimensional environment (and, while the first indicator is displayed in the fourth view of the three-dimensional environment in response to the user's attention directed to a respective portion of the fourth view that has the first spatial relationship to the viewport), the computer system detects a third user input (e.g., an air pinch input, an air tap input, a pinch input, a tap input, an air pinch and drag input, an air drag input, a drag input, a click and drag input, a gaze input, and/or other input) that meets the selection criteria. In some embodiments, in response to detecting the third user input that meets the selection criteria: in accordance with a determination that the attention (e.g., based on gaze, or based on a gaze substitute such as a hand pointing gesture that indicates a portion of the three-dimensional environment with which the user intends to interact) of the user was directed to the first indicator at a time when the third user input was detected (e.g., while the gaze of the user was directed to a third portion of the fourth view of the three-dimensional environment that has the first spatial relationship to the viewport through which the three-dimensional environment is visible), the computer system ceases to display the first user interface object at the respective location in the three-dimensional environment and redisplaying the first user interface object at a new location in the three-dimensional environment that is different from the respective location of the first user interface object shown in the first view and the fourth view of the three-dimensional environment (e.g., the new location of the first user interface object has the preconfigured spatial relationship to the viewport in the fourth view of the three-dimensional environment, the respective location of the first user interface object has the preconfigured spatial relationship to the viewport in the first view of the three-dimensional environment, but not in the fourth view of the three-dimensional environment). In some embodiments, in response to detecting the third user input that meets the selection criteria: in accordance with a determination that the attention of the user was not directed to the first indicator at a time when the third user input was detected (e.g., while the attention of the user was not directed to a third portion of the fourth view of the three-dimensional environment that has the first spatial relationship to the viewport through which the three-dimensional environment is visible), the computer system maintains display of the first user interface object at the respective location of the first user interface object shown in the first view and the fourth view of the three-dimensional environment. For example, in FIG. 7M, the portable multifunction device 100 ceases to display the system function menu 7046 at the location indicated by the outline 711, and displays the system function menu 7046 directly underneath the indicator 7042, in response to detecting the user's attention 7010 directed to the indicator 7042 (e.g., in conjunction with a predefined gesture), in accordance with some embodiments. Ceasing to display the first user interface object at the respective location in the three-dimensional environment and redisplaying the first user interface object at a new location in the three-dimensional environment that is different from the respective location of the first user interface object shown in the first view and the fourth view of the three-dimensional environment, reduces the number of user inputs needed to display the first user interface object at the correct location (e.g., the user does not need to perform a first input to cease displaying the first user interface object at the respective location, and a second input to redisplay the first user interface object at the new location; and/or the user does not need to perform additional user inputs to first cease displaying the first user interface object to display the first user interface object at the new location).

In some embodiments, in response to detecting the third user input that meets the selection criteria: in accordance with a determination that the attention (e.g., based on gaze, or based on a gaze substitute such as a hand pointing gesture that indicates a portion of the three-dimensional environment with which the user intends to interact) of the user was directed to the first indicator at a time when the third user input was detected, the computer system displays movement of the first user interface object toward the new location in the three-dimensional environment, and reduces visual prominence of the first user interface object (e.g., ceases to display the first user interface object after the movement, and/or fades out the first user interface object (e.g., with reduced opacity, size, color saturation, brightness, and/or other changes in display properties that cause reduced visual prominence) during the movement), before redisplaying the first user interface object at the new location in the three-dimensional environment. For example, as described with reference to FIG. 7M, in some embodiments, if the new location of the system function menu 7046 is a medium distance from the previous location, the portable multifunction device 100 displays an animated transition that includes an animation of the system function menu 7046 sliding and fading out (e.g., before the system function menu 7046 reaches the new location), and sliding and fading in (e.g., reappearing and sliding into place) at the new location, in accordance with some embodiments. Displaying movement of the first user interface object toward the new location, and reducing visual prominence of the first user interface object, before redisplaying the first user interface object at the new location, in response to detecting the third user input that meets the selection criteria, provides improved visual feedback to the user (e.g., improved visual feedback that the first user interface object is being redisplayed and no further user inputs are needed to display the first user interface object at an appropriate location).

In some embodiments, in response to detecting the third user input that meets the selection criteria: in accordance with a determination that the attention (e.g., based on gaze, or based on a gaze substitute such as a hand pointing gesture that indicates a portion of the three-dimensional environment with which the user intends to interact) of the user was directed to the first indicator at a time when the third user input was detected and that the respective location and the new location are within a first threshold distance of each other (e.g., the respective location and the new location are both visible within the fourth view, and/or the respective location and the new location are separated by less than half of the width of the viewport or separated by another threshold distance), the computer system moves the first user interface object from the respective location to the new location in the three-dimensional environment (e.g., maintaining display of the first user interface object throughout the movement from the respective location to the new location in the three-dimensional environment). For example, as described with reference to FIG. 7M, in some embodiments, if the new location of the system function menu 7046 is a short distance from the previous location of the system function menu, the portable multifunction device 100 displays an animated transition that includes an animation of the system function menu 7046 sliding (e.g., or otherwise moving) from the previous location to the new location, in accordance with some embodiments. Moving the first user interface object from the respective location to the new location in the three-dimensional environment, in response to detecting the third user input that meets the selection criteria, and in accordance with a determination that the respective location and the new location are within a first threshold distance, provides improved visual feedback to the user (e.g., improved visual feedback that the first user interface object is being redisplayed and no further user inputs are needed to display the first user interface object at an appropriate location).

In some embodiments, in response to detecting the third user input that meets the selection criteria: in accordance with a determination that the attention (e.g., based on gaze, or based on a gaze substitute such as a hand pointing gesture that indicates a portion of the three-dimensional environment with which the user intends to interact) of the user was directed to the first indicator at a time when the third user input was detected and that the respective location and the new location are separated by more than a first threshold distance and less than a second threshold distance (e.g., the respective location and the new location are both visible within the fourth view but the respective location and the new location are separated by more than half of the width of the viewport or separated by more than another threshold distance), the computer system displays movement of the first user interface object from the respective location toward the new location in the three-dimensional environment, and reduces visual prominence of the first user interface object (e.g., ceasing to display the first user interface object after the movement, and/or fading out the first user interface object (e.g., with reduced opacity, size, color saturation, brightness, and/or other changes in display properties that cause a reduction in visual prominence) during the movement), before redisplaying the first user interface object at the new location in the three-dimensional environment. For example, if the new location and the respective location are separated by an intermediate distance but are still within the same view that is currently visible, the computer system shows the first user interface object moves toward the new location, but fades out before reaching the new location, and then redisplayed at the new location, in accordance with some embodiments. For example, as described with reference to FIG. 7M, in some embodiments, if the new location of the system function menu 7046 is a medium distance from the previous location, the portable multifunction device 100 displays an animated transition that includes an animation of the system function menu 7046 sliding and fading out (e.g., before the system function menu 7046 reaches the new location), and sliding and fading in (e.g., reappearing and sliding into place) at the new location, in accordance with some embodiments. Displaying movement of the first user interface object from the respective location toward the new location in the three-dimensional environment, and reducing visual prominence of the first user interface object, before redisplaying the first user interface object at the new location in the three-dimensional environment, in response to detecting the third user input that meets the selection criteria, and in accordance with a determination that the respective location and the new location are separated by more than a first threshold distance and less than a second threshold distance, provides improved visual feedback to the user (e.g., improved visual feedback that the first user interface object is being redisplayed and no further user inputs are needed to display the first user interface object at an appropriate location).

In some embodiments, in response to detecting the third user input that meets the selection criteria: in accordance with a determination that the attention (e.g., based on gaze, or based on a gaze substitute such as a hand pointing gesture that indicates a portion of the three-dimensional environment with which the user intends to interact) of the user was directed to the first indicator at a time when the third user input was detected and that the respective location and the new location are separated by more than a third threshold distance (e.g., greater than the first threshold distance and the second threshold distance) (e.g., the respective location and the new location are both visible within the fourth view but the respective location and the new location are separated by close to the full width of the viewport), the computer system ceases display of the first user interface object at the respective location without moving the first user interface object (e.g., fades out (e.g., reducing in opacity, color saturation, brightness, and/or making other changes in display properties to reduce visual prominence) the first user interface object at the respective location, or promptly removes the first user interface object from display at the respective location), before redisplaying the first user interface object at the new location in the three-dimensional environment. For example, if the new location and the respective location are separated by a large distance but are still within the same view that is currently visible, the computer system shows the first user interface object disappearing at the respective location and then popping up again at the new location, in accordance with some embodiments. For example, as described with reference to FIG. 7M, in some embodiments, if the new location of the system function menu 7046 is a long distance from the previous location, the portable multifunction device 100 displays an animated transition that includes an animation of the system function menu 7046 fading out at the previous location and fading in (e.g., reappearing) at the new location, in accordance with some embodiments. Ceasing display of the first user interface object at the respective location without moving the first user interface object, before redisplaying the first user interface object at the new location in the three-dimensional environment, in response to detecting the third user input that meets the selection criteria, and in accordance with a determination that the respective location and the new location are separated by more than a third threshold distance, provides improved visual feedback to the user (e.g., improved visual feedback that the first user interface object is being redisplayed and no further user inputs are needed to display the first user interface object at an appropriate location).

In some embodiments, detecting the first user input that meets the selection criteria (e.g., the first user input is an example of a respective user input that meets the selection criteria, and that triggers display of the first user interface object or the first indicator) includes detecting an input performed by a hand of the user (e.g., a touch gesture performed by the hand on a touch-sensitive surface, a manipulation of a control by the hand, an air gesture performed by the hand, or another type of input performed by the hand). For example, in FIGS. 7F, the portable multifunction device 100 detects the user's attention 7010 directed to the indicator 7042 in conjunction with a selection gesture (e.g., a user input such as an air tap, and air pinch, or another air gesture), and in response, the portable multifunction device 100 displays the system function menu 7046 (e.g., as shown in FIG. 7G), in accordance with some embodiments. Displaying a first user interface object that includes one or more affordances for accessing a set of functions of the computer system, in response to detecting an input performed by a hand of a user, and in accordance with a determination that an attention of a user was directed to a respective portion of a respective view of three-dimensional environment that has a first spatial relationship to a viewport through which the three-dimensional environment is visible at a time when a first user input was detected, and forgoing displaying the first user interface object, in response to detecting the input performed by the hand of the user, in accordance with a determination that the attention of the user was not directed to the respective portion of the respective view of the three-dimensional environment at the time when the first user input was detected, reduces the number of inputs needed to access system functions of the computer system without cluttering the user interface with additional displayed controls, user interfaces, and/or user interface objects (e.g., the first user interface object and/or a control for displaying the first user interface object, do not need to be permanently displayed in order to enable access to the system functions of the computer system).

In some embodiments, detecting the first user input that meets the selection criteria (e.g., the first user input is an example of a respective user input that meets the selection criteria, and that triggers display of the first user interface object or the first indicator) includes detecting an air gesture (e.g., an air pinch gesture, an air tap gesture, or another type of air gesture that corresponds to a request for selecting a target of the user's attention, and/or a target at the location of the air gesture). For example, in FIGS. 7F, the portable multifunction device 100 detects the user's attention 7010 directed to the indicator 7042 in conjunction with a selection gesture (e.g., a predefined user input such as an air tap, and air pinch, and/or another air gesture), and in response, the portable multifunction device 100 displays the system function menu 7046 (e.g., as shown in FIG. 7G), in accordance with some embodiments. Displaying a first user interface object that includes one or more affordances for accessing a set of functions of the computer system, in response to detecting an air gesture, and in accordance with a determination that an attention of a user was directed to a respective portion of a respective view of three-dimensional environment that has a first spatial relationship to a viewport through which the three-dimensional environment is visible at a time when a first user input was detected, and forgoing displaying the first user interface object, in response to detecting the air gesture, in accordance with a determination that the attention of the user was not directed to the respective portion of the respective view of the three-dimensional environment at the time when the first user input was detected, reduces the number of inputs needed to access system functions of the computer system without cluttering the user interface with additional displayed controls, user interfaces, and/or user interface objects (e.g., the first user interface object and/or a control for displaying the first user interface object, do not need to be permanently displayed in order to enable access to the system functions of the computer system).

In some embodiments, while displaying the first user interface object in the first view of the three-dimensional environment (e.g., in response to detecting the first user input, and/or in response to another user input that meets the selection criteria while the attention of the user is directed to a portion of the current view of the three-dimensional environment that has the first spatial relationship to the viewport), the computer system detects a fourth user input that meets dismissal criteria, wherein the dismissal criteria require that the fourth user input includes a first type of air gesture (e.g., an air pinch gesture, an air tap gesture, a gesture that meets the selection criteria, and/or another type of gesture) in order for the dismissal criteria to be met. In some embodiments, in response to detecting the fourth user input that meets the dismissal criteria, the computer system ceases to display the first user interface object in the three-dimensional environment (e.g., ceases to display the first user interface object in the first view of the three-dimensional environment, and forgoes display of the first user interface object in the three-dimensional environment until the first user interface object is redisplayed in response to detecting another user input that meets the selection criteria and that is detected while the attention of the user is directed to a portion of the current view of the three-dimensional environment that has the first spatial relationship to the viewport). For example, as described with reference to FIG. 7N, in some embodiments, the computer system 101 ceases to display the system function menu 7046 if the user's attention 7010 is directed to a location in the view of the three-dimensional environment other than the system function menu 7046 and/or the indicator 7042 and the user performs a predefined gesture (e.g., an air tap, an air pinch, and/or another air gesture). Ceasing to display the first user interface object in the three-dimensional environment, in response to detecting the fourth user input that includes a first type of air gesture, provides additional control options without cluttering the UI with additional displayed controls (e.g., a permanently displayed control for ceasing to display the first user interface object).

In some embodiments, the dismissal criteria require that the fourth user input was detected at a time when the attention (e.g., based on gaze, or based on a gaze substitute such as a hand pointing gesture that indicates a portion of the three-dimensional environment with which the user intends to interact) of the user is directed to a close affordance corresponding to the first user interface object in order for the dismissal criteria to be met. If the user's attention is not directed to the close affordance when the fourth user input was detected, the computer system does not cease to display the first user interface object in the three-dimensional environment, in accordance with some embodiments. For example, in FIG. 7N, the portable multifunction device 100 detects that the user's attention 7010 is directed to the affordance 7058 and that the user 7002 performs a predefined gesture, and in response, the computer system 101 cease to display the system function menu 7046 (e.g., and optionally, any system space that was displayed concurrently with the system function menu 7046), in accordance with some embodiments. Ceasing to display the first user interface object in the three-dimensional environment, in response to detecting the fourth user input at a time when the attention of the user is directed to a close affordance corresponding to the first user interface object, minimizes the risk of accidentally ceasing to display the first user interface object (e.g., as the user attempts to interact with other user interfaces and/or user interface objects, and/or when the user's attention moves between different user interfaces and/or user interface objects) and forcing the user to perform additional user inputs to redisplay the first user interface object.

In some embodiments, the dismissal criteria require that the fourth user input was detected at a time when the attention (e.g., based on gaze, or based on a gaze substitute such as a hand pointing gesture that indicates a portion of the three-dimensional environment with which the user intends to interact) of the user is directed to a region of the fourth view that is not occupied by a respective affordance that is responsive to the first type of air gesture (e.g., the region is unoccupied by an affordance, and/or the region is empty space). If the user's attention is not directed to a region of the fourth view that is not occupied by a respective affordance that is responsive to the first type of air gesture, and/or that is empty, the computer system does not cease to display the first user interface object in the three-dimensional environment, in accordance with some embodiments. For example, as described with reference to FIG. 7N, in some embodiments, the computer system 101 ceases to display the system function menu 7046 if the user's attention 7010 is directed to a location in the view of the three-dimensional environment other than the system function menu 7046 and/or the indicator 7042 (e.g., optionally, and any other user interface or user interface object that responds to user inputs) and the user performs a predefined gesture (e.g., an air tap, an air pinch, and/or another air gesture). Ceasing to display the first user interface object in the three-dimensional environment, in response to detecting the fourth user input that includes a first type of air gesture, provides additional control options without cluttering the UI with additional displayed controls (e.g., a permanently displayed control for ceasing to display the first user interface object).

In some embodiments, the dismissal criteria require that the fourth user input was detected at a time when the attention (e.g., based on gaze, or based on a gaze substitute such as a hand pointing gesture that indicates a portion of the three-dimensional environment with which the user intends to interact) of the user is directed to a location outside of the first user interface object (e.g., even if the location is occupied by a window or another user interface object that does not currently have input focus) in order for the dismissal criteria to be met. If the user's attention is not directed to a location outside of the first user interface object when the fourth user input was detected, the computer system does not cease to display the first user interface object in the three-dimensional environment, in accordance with some embodiments. For example, as described with reference to FIG. 7N, the computer system 101 ceases to display the system function menu 7046 if the user's attention 7010 is directed to a location in the view of the three-dimensional environment other than the system function menu 7046 and/or the indicator 7042 (e.g., regardless of where that location is, such as to another user interface such as the user interface 7032 in FIG. 7A), and optionally the user 7002 performs a predefined gesture, in accordance with some embodiments. Ceasing to display the first user interface object in the three-dimensional environment, in response to detecting the fourth user input that includes a first type of air gesture, provides additional control options without cluttering the UI with additional displayed controls (e.g., a permanently displayed control for ceasing to display the first user interface object).

In some embodiments, while detecting the attention of the user, displaying the first indicator corresponding to the first user interface object in the first view of the three-dimensional environment includes: in accordance with a determination that the attention (e.g., based on gaze, or based on a gaze substitute such as a hand pointing gesture that indicates a portion of the three-dimensional environment with which the user intends to interact) of the user is within a first region of the first view (e.g., the large reactive region for triggering display of the first indicator, and/or the respective region of the first view that has the second spatial relationship to the viewport) and outside of a second region of the first view (e.g., the smaller reactive region for triggering display of the first user interface object, and/or first portion of the first view that has the first spatial relationship to the viewport), wherein the second region is enclosed within the first region of the first view, displaying a first appearance of the first indicator in the first view of the three-dimensional environment (e.g., a transient, small indicator that disappears when the attention of the user moves out of the first region of the first view, or moves out of a third region that is bigger than the first region in one or more dimensions, and/or that encloses the first region); and in accordance with a determination that the attention (e.g., based on gaze, or based on a gaze substitute such as a hand pointing gesture that indicates a portion of the three-dimensional environment with which the user intends to interact) of the user is within the second region of the first view, displaying a second appearance of the first indicator (e.g., a steady state appearance of the first indicator, a more prominent appearance of the first indicator), wherein the second appearance of the first indicator has a greater visual prominence than the first appearance of the first indicator. For example, in FIG. 7B, the user's attention 7010 is directed to a location in the region 7028 but outside the region 7030 and the portable multifunction device 100 displays the indicator 7042 with a first appearance (e.g., first size and first color/pattern), in accordance with some embodiments. In FIG. 7D, the user's attention 7010 is directed to a location in the region 7030, but not within a region occupied by the indicator 7042, and the portable multifunction device 100 displays the indicator 7042 with a second appearance (e.g., a second size larger than the first size, but with the same first color/pattern), in accordance with some embodiments. In FIGS. 7F, the user's attention 7010 is directed to a location occupied by the indicator 7042, and the portable multifunction device 100 displays the indicator 7042 with a third appearance (e.g., the same second size, but with a second color/pattern that is different from the first color/pattern), in accordance with some embodiments. Displaying a first appearance of the first indicator in accordance with a determination that the attention of the user is within a first region of the first view and outside of a second region of the first view (e.g., and wherein the second region is enclosed within the first region), and displaying a second appearance of the first indicator that has a greater visual prominence than the first appearance of the first indicator, in accordance with a determination that the attention of the user is within the second region, enables the computer system to provide improved visual feedback and guidance to the user regarding accessing different functions of the computer system without needing to permanently display controls and/or user interfaces (e.g., the respective portion of the first view of the three-dimensional environment can be used to trigger display of hints or other visual indicators that guide the user to directing the user's attention to the smaller first region, which can be used to trigger display of the first user interface object for accessing system functions of the computer system).

In some embodiments, while displaying the first indicator in the first view of the three-dimensional environment (e.g., without displaying the first user interface object, or displaying the first user interface object at a different environment-locked location due to a prior interaction with the computer system), the computer system detects a fifth user input (e.g., an air pinch input, an air tap input, a pinch input, a tap input, an air pinch and drag input, an air drag input, a drag input, a click and drag input, a gaze input, and/or other input) that meets the selection criteria. In some embodiments, in response to detecting the fifth user input that meets the selection criteria: in accordance with the determination that the attention (e.g., based on gaze, or based on a gaze substitute such as a hand pointing gesture that indicates a portion of the three-dimensional environment with which the user intends to interact) of the user is within the first region of the first view and outside of the second region of the first view, the computer system forgoes displaying the first user interface object in the first view of the three-dimensional environment (e.g., while continuing to display the initial appearance of the first indicator, and/or a transient, small indicator); and in accordance with a determination that the attention (e.g., based on gaze, or based on a gaze substitute such as a hand pointing gesture that indicates a portion of the three-dimensional environment with which the user intends to interact) of the user is within the second region of the first view, the computer system displays the first user interface object in the first view of the three-dimensional environment. For example, in FIG. 7B, the portable multifunction device 100 does not display the system function menu 7046 in response to detecting a predefined gesture (e.g., selection gesture, such as an air tap, an air pinch, and/or another air gesture), since the user's attention 7010 is directed to a location that is not within the region 7030 (and/or a region occupied by the indicator 7042). In contrast, in FIG. 7G, the portable multifunction device 100 displays the system function menu 7046 in response to detecting the predefined gesture, since the user's attention 7010 was directed to the indicator 7042 (e.g., which is within the region 7030, as shown in FIGS. 7F), in accordance with some embodiments. Forgoing displaying the first user interface object in response to detecting a fifth user input that meets the selection criteria, and in accordance with a determination that the attention of the user is within the first region of the first view and outside of the second region of the first view, and displaying the first user interface object in response to detecting the fifth user input, and in accordance with a determination that the attention of the user is within the second region of the first view, provides improved visual feedback and guidance to the user (e.g., improved visual feedback and guidance regarding progress of the user towards displaying the first user interface object, and/or improved visual feedback and guidance regarding how close the current location that the user's attention is directed to is from a necessary location in order to display the first user interface object).

In some embodiments, in accordance with a determination that the attention (e.g., based on gaze, or based on a gaze substitute such as a hand pointing gesture that indicates a portion of the three-dimensional environment with which the user intends to interact) of the user is within the first region of the first view and outside of the second region of the first view, the computer system forgoes displaying an indication of a current location of the attention of the user within the first appearance of the first indicator in the first view of the three-dimensional environment. In some embodiments, in accordance with a determination that the attention (e.g., based on gaze, or based on a gaze substitute such as a hand pointing gesture that indicates a portion of the three-dimensional environment with which the user intends to interact) of the user is within the second region of the first view, the computer system displays the indication of the current location of the attention of the user within the second appearance of the first indicator (e.g., displaying a gaze glow within the first indicator, where the gaze glow modifies the display parameter of at least a portion of the first indicator based on the location of the user's attention (e.g., gaze, or a gaze substitute such as a hand pointing gesture that indicates a portion of the three-dimensional environment with which the user intends to interact) relative to the first indicator, or displaying another type of indication of the location of the user's attention on the first indicator). For example, as described with reference to FIG. 7D, in some embodiments, when the user's attention 7010 is directed to a location that is near (e.g., within a threshold distance from) the indicator 7042 (e.g., and optionally, the user's attention 7010 is directed to a location that is within the threshold distance from the indicator 7042 as long as the user's attention 7010 is directed to any location within the region 7030), the computer system 101 applies a visual effect to the indicator 7042. For example, the computer system 101 applies a lighting effect (e.g., an illuminated circle, centered on the location to which the user's attention 7010 is directed) to the indicator 7042. Forgoing displaying an indication of a current location of the attention of the user within the first appearance of the first indicator, in accordance with a determination that the attention of the user is within the first region of the first view and outside the second region of the first view, and displaying the indication of the current location of the attention of the user within the second appearance of the first indicator, in accordance with a determination that the attention of the user is within the second region, provides improved visual feedback to the user (e.g., improved visual feedback regarding a currently detected location of the user's attention, and/or improved visual feedback regarding the currently detected location of the user's attention relative to the first indicator).

In some embodiments, while displaying the second appearance of the first indicator, the computer system detects that the attention (e.g., based on gaze, or based on a gaze substitute such as a hand pointing gesture that indicates a portion of the three-dimensional environment with which the user intends to interact) of the user has exited the second region (e.g., is no longer detected within the second region or has been detected moving outside of the second region) while remaining within the first region of the first view (e.g., the large reactive region for triggering display of the first indicator, and/or the respective region of the first view that has the second spatial relationship to the viewport). In some embodiments, in response to detecting that the attention (e.g., based on gaze, or based on a gaze substitute such as a hand pointing gesture that indicates a portion of the three-dimensional environment with which the user intends to interact) of the user has exited the second region while remaining within the first region of the first view, the computer system transitions from displaying the second appearance of the first indicator to displaying the first appearance of the first indicator in the first view of the three-dimensional environment (e.g., a transient, small indicator that disappears when the attention of the user moves out of the first region of the first view, or moves out of a third region that is bigger than the first region in one or more dimensions, and/or that encloses the first region). For example, in FIG. 7E, the user's attention 7010 moves to a location that is outside the region 7030, and the portable multifunction device 100 displays the indicator 7042 with a smaller size as compared to FIG. 7D, where the user's attention is directed to a location within the region 7030. Transitioning from displaying the second appearance of the first indicator to displaying the first appearance of the first indicator, in response to detecting that the attention of the user has exited the second region while remaining in the first region of the first view, provides improved visual feedback to the user (e.g., improved visual feedback that the user's attention has moved in a way that is not conducive to enabling display of and/or access to the first user interface object and/or the system functions of the computer system).

In some embodiments, while displaying the first appearance of the first indicator, the computer system detects that the attention (e.g., based on gaze, or based on a gaze substitute such as a hand pointing gesture that indicates a portion of the three-dimensional environment with which the user intends to interact) of the user has exited the first region (e.g., is no longer detected within the first region or has been detected moving outside of the first region) of the first view (e.g., the large reactive region for triggering display of the first indicator, and/or the respective region of the first view that has the second spatial relationship to the viewport). In some embodiments, in response to detecting that the attention of the user has exited the first region of the first view, the computer system ceases display of the first indicator in the first view of the three-dimensional environment. For example, as described with reference to FIG. 7E, if the user's attention 7044 moves to a location that is outside both the region 7030 and the region 7028, the computer system 101 ceases to display the indicator 7042, in accordance with some embodiments. Ceasing display of the first indicator in the first view of the three-dimensional environment, in response to detecting that the attention of the user has exited the first region of the first view, provides improved visual feedback to the user (e.g., improved visual feedback regarding the detected location of attention, and/or improved visual feedback that the user's attention has moved in a way that is not conducive to enabling display of and/or access to the first user interface object and/or the system functions of the computer system).

In some embodiments, while a fifth view of the three-dimensional environment (e.g., the same view as the first, second, third, or fourth view of the three-dimensional environment mentioned above, or another view of the three-dimensional environment that corresponds to the current viewpoint of the user at and/or near the time that the sixth user input is detected) is visible, via the display generation component, from a fifth viewpoint (e.g., the current viewpoint of the user at and/or near the time that the sixth user input is detected), the computer system detects a sixth user input that corresponds to a request to display the first user interface object in the fifth view of the three-dimensional environment. In some embodiments, the sixth user input includes a user input that meets the selection criteria that is detected at a time when the attention of the user was directed to a respective portion of the fifth view of the three-dimensional environment that has the first spatial relationship to the viewport through which the three-dimensional environment is visible. In some embodiments, the sixth user input includes another type of input (e.g., an activation of a hardware button of the HMD, a control input provided via a controller device, and/or another type of air gesture that is different from the gesture that meets the selection criteria, optionally, in conjunction with detecting the attention of the user directed to the first indicator that corresponds to the first user interface object or a portion of the three-dimensional environment that has the first spatial relationship to the viewport through which the three-dimensional environment is visible). In some embodiments, the sixth user input is configured to trigger display of the first user interface object in the fifth view of the three-dimensional environment and/or to move the first user interface object from another portion of the three-dimensional environment that is not visible in the fifth view of the three-dimensional environment into a portion of the three-dimensional environment that is visible in the fifth view of the three-dimensional environment. In some embodiments, the sixth user input is detected while the first user interface object is not visible in the fifth view of the three-dimensional environment (e.g., not present in the three-dimensional environment at the moment, or present in a portion of the three-dimensional environment (e.g., locked to its initial location when invoked in a different view of the three-dimensional environment, or dragged to another location by a subsequent user input) that is not visible in the fifth view of the three-dimensional environment). In some embodiments, the sixth user input is detected while the first user interface object is visible in the fifth view of the three-dimensional environment, but at a location that is different from a default display location for the first user interface object for the fifth view of the three-dimensional environment (e.g., locked to its initial location when invoked in a different view of the three-dimensional environment, or dragged to another location by a subsequent user input). More details of how the display, redisplay (e.g., relocating the first user interface object from a portion of the environment that is not visible in the current view to a portion of the environment that is visible in the current view, closing the first user interface object in a portion of the environment that is not visible in the current view and redisplaying the first user interface object in a portion of the environment that is visible in the current view, and/or ceasing to display the first user interface object in a portion of the environment that is visible in the current view and redisplaying the first user interface object in another portion of the environment that is visible in the current view), and/or movement of the first user interface object (e.g., moving the first user interface object from a portion of the environment that is not visible in the current view to a portion of the environment that is visible in the current view, and/or moving the first user interface object from a portion of the environment that is visible in the current view to another portion of the environment that is visible in the current view) are described in other parts of this disclosure, and are not repeated herein. In response to detecting the sixth user input that corresponds to a request to display the first user interface object in the fifth view of the three-dimensional environment, the computer system displays the first user interface object at a first position in the three-dimensional environment that is visible in the fifth view of the three-dimensional environment (optionally, after ceasing to display or closing the first user interface object at another position in the three-dimensional environment, or moving the first user interface object from another position in the three-dimensional environment toward the first position). In some embodiments, the first position is a position that is chosen relative to the viewport through which the three-dimensional environment is visible (e.g., has a fourth spatial relationship to the viewport, has a fifth spatial relationship to the first indicator, and/or has a sixth relationship to the location of the user's gaze at the time of the sixth user input). In response to detecting the sixth user input that corresponds to a request to display the first user interface object in the fifth view of the three-dimensional environment, the computer system moves a second user interface object from a second position in the three-dimensional environment that is visible in the fifth view of the three-dimensional environment to an updated second position in the three-dimensional environment that is farther away from the fifth viewpoint than the second position in the three-dimensional environment (e.g., pushing the second user interface object farther away from the fifth viewpoint (optionally, with animated movement between the second position and the updated second position, or without the animation), increasing a distance between the fifth viewpoint and the second user interface object in the depth dimension relative to the fifth viewpoint (optionally, with animated movement between the second position and the updated second position, or without the animation), and/or ceasing display of the second user interface object at the second position and then redisplaying the second user interface at the updated second position (optionally, fading out or not displaying the second user interface object between the second position and the updated second position)). In some embodiments, the second user interface object is redisplayed at the updated second position before displaying the first user interface object at the first position, and/or within a time window of displaying the first user interface object at the first position. In some embodiments, in response to detecting the sixth user input, in accordance with a determination that the second user interface object that is located at the second position in the three-dimensional environment is not visible in the fifth view of the three-dimensional environment, the computer system maintains the second user interface object at the second position in the three-dimensional environment while displaying the first user interface object at the first position in the three-dimensional environment (e.g., the movement of an existing user interface object in the three-dimensional environment in response to the display of the first user interface object is conditioned upon the second user interface object being visible in the view of the three-dimensional environment that corresponds to the current viewpoint at and/or near the time that the sixth user input is detected). In some embodiments, the behavior described with respect to displaying the first user interface object and pushing back some or all other user interface objects that are visible in the same view of the three-dimensional environment also applies to displaying other system user interface objects, such as displaying the home user interface in response to detecting a user input that corresponds to a request to display the home user interface, displaying a control user interface in response to detecting a user input that corresponds to a request to display the control user interface, displaying a notification user interface in response to detecting a user input that corresponds to a request to display the notification user interface, and/or displaying another system user interface in response to detecting a user input that corresponds to a request to display the system user interface (e.g., a selection of an activation affordance corresponding to the system user interface in a menu or the first user interface object, a system gesture, such as an air gesture or touch gesture that meet system gesture criteria, and/or another type of system input (e.g., activation of a home button, activation of another hardware control on the device or controller)). In some embodiments, the behavior described with respect to displaying the first user interface object and/or other system user interfaces and pushing back some or all other user interface objects that are visible in the same view of the three-dimensional environment does not apply to system alerts, such as status alerts, alerts for error conditions, and/or alerts triggered based on conditions established at a different time in the past via one or more user applications and/or system applications, and/or other alerts that are not generated in response to a user input but satisfaction of some previously established conditions other than a currently detected user input, so that events that cause system alerts to be displayed do not also cause other user interface elements to be pushed away from a current viewpoint of the user. In some embodiments, after the first user interface object is dismissed, either by explicit user inputs and/or by movement of the viewpoint beyond a threshold spatial range of the original viewpoint (e.g., the fifth viewpoint, or another viewpoint) that corresponds to the initial invocation of the first user interface object in the three-dimensional environment, the user interface objects that were pushed back away from the viewpoint (e.g., the second user interface object, and/or one or more other objects that are visible in the fifth view of the three-dimensional environment) are moved back (optionally with an animation, or without an animation) to their respective positions before the display of the first user interface object. For example, in FIG. 7U, the computer system 101 displays the system function menu 7046, and the user interface 7032 and the user interface 7122 are displayed at updated locations that are farther away from the viewpoint of the user 7002 (e.g., with the original locations shown by the outline 7128 and the outline 7130, respectively). In some embodiments, if the system function menu 7046 is dismissed by selection of the closing affordance 7058 associated with the system function menu 7046, or by the user moving outside of the threshold range 7116 of the viewpoint (e.g., in the manners as shown in FIGS. 7P and 7R) at the time that the system function menu 7046 was initially displayed, the user interface object 7032 and the user interface object 7122 would move back to their respective original positions relative to the viewpoint (e.g., to the positions shown in FIG. 7S). Moving the second user interface object at an updated second position in the three-dimensional environment that is farther away from the fifth viewpoint than a second position in the three-dimensional environment where the second user interface object was originally displayed, and displaying the first user interface object at a first position in the three-dimensional environment that is visible in the fifth view of the three-dimensional environment, improves the visibility of the first user interface object (e.g., by allowing the first user interface object to be displayed closer to the viewpoint of the user, and by moving the second user interface object further from the user) and assists the user in locating the first user interface object (e.g., the specific user interface object that the user requested display of via the sixth user input).

In some embodiments, a first set of one or more user interface objects, including the second user interface object, were visible in the fifth view of the three-dimensional environment at a time when the sixth user input was detected. In response to detecting the sixth user input, in accordance with a determination that the first set of one or more user interface objects meet push-back criteria (e.g., criteria for determining that the one or more user interface objects displayed at their respective original locations in the fifth view would intersect the first user interface object displayed at the first position, that the one or more user interface objects displayed at their respective original positions would obscure the view of the first user interface object displayed at the first position, and/or that the one or more user interface objects are of a first type of user interface objects (e.g., windows, floating virtual objects that are in contact with a surface of the virtual or physical environment, and/or objects that meet a first set of criteria)), the computer system moves the first set of one or more user interface objects, including the second user interface object, away from the fifth viewpoint (e.g., from respective original positions of the first set of one or more user interface objects to respective updated positions in the three-dimensional environment) in the three-dimensional environment (e.g., pushing the first set of one or more user interface objects farther away from the fifth viewpoint (optionally, with animated movement between the second position and the updated second position, or without the animation), increasing respective distances between the fifth viewpoint and the first set of one or more user interface objects in the depth dimension relative to the fifth viewpoint (optionally, with animated movement between the second position and the updated second position, or without the animation), and/or ceasing display of the first set of one or more user interface objects at their respective original positions and then redisplaying them at their respective updated positions (optionally, fading out or not displaying the one or more user interface objects between their respective original position and their respective updated positions)). In some embodiments, the first set of one or more user interface objects are redisplayed at their respective updated positions before displaying the first user interface object at the first position, and/or within a time window of displaying the first user interface object at the first position. In some embodiments, in response to detecting the sixth user input, in accordance with a determination that a respective user interface object that is visible in the fifth view and does not meet the push back criteria, the computer system maintains the respective user interface object at its original position in the three-dimensional environment while displaying the first user interface object at the first position in the three-dimensional environment. In some embodiments, after the first user interface object is dismissed, either by explicit user inputs and/or by movement of the viewpoint beyond a threshold spatial range of the original viewpoint (e.g., the fifth viewpoint, or another viewpoint) that corresponds to the initial invocation of the first user interface object in the three-dimensional environment, the user interface objects that were pushed back away from the viewpoint (e.g., the second user interface object, and/or one or more other objects that are visible in the fifth view of the three-dimensional environment) are moved back (optionally with an animation, or without an animation) to their respective positions before the display of the first user interface object. For example, in FIG. 7U, the computer system 101 displays the system function menu 7046, and because the user interface 7032 and the user interface 7122 meet the push-back criteria, the computer system 101 displays the user interface 7032 and the user interface 7122 at updated locations that are farther away from the viewpoint of the user 7002. In contrast, the representation 7014′ of the physical object 7014 and the virtual object 7012 do not meet the push-back criteria and are not redisplayed at updated positions (e.g., the computer system 101 maintains display of the representation 7014′ of the physical object 7014 and the virtual object 7012 at the same/original location). In some embodiments, after the system function menu 7046 is dismissed by selection of the closing affordance 7058 associated with the system function menu 7046, or by the user moving outside of the threshold range 7116 of the viewpoint (e.g., in the manners as shown in FIGS. 7P and 7R) at the time that the system function menu 7046 was initially displayed, the user interface object 7032 and the user interface object 7122 would move back to their respective original positions relative to the viewpoint (e.g., to the positions shown in FIG. 7S). Moving a first set of one or more user interface objects that meet push-back criteria, in response to detecting the sixth user input, away from the current viewpoint of the user, improves the visibility of the first user interface object (e.g., by allowing the first user interface object to be displayed closer to the viewpoint of the user, and by moving the first set of one or more user interface objects further from the user) and assists the user in locating the first user interface object (e.g., the specific user interface object that the user requested display of via the sixth user input), while also maintaining at least some level of consistency in the appearance of the three-dimensional environment (e.g., representations of the physical environment do not meet push-back criteria, and so are not redisplayed at updated positions).

In some embodiments, the first set of one or more user interface objects that meet the push back criteria include one or more windows that correspond to one or more applications (e.g., user interfaces of one or more applications, such as a messaging application, a browser application, a media player application, a settings application, an address book application, and/or other applications). In some embodiments, a window includes a content displaying region that has a finite size and boundary (e.g., with a visible or invisible outline, platter, and/or background), and that optionally includes one or more window control objects (e.g., closing affordance, resizing affordance, title, move affordance, minimizing affordance, optionally faded out when not in use for a period of time and can be redisplayed upon user request), where the content display region displays application content, such as text, graphics, and controls for interacting with the application. In some embodiments a window is a region where an application can draw content, and the user can instruct the system to move the window to a different location the three-dimensional environment. For example, in FIG. 7U, the computer system 101 displays the system function menu 7046, and because the user interface 7032 and the user interface 7122 are applications windows that meet the push-back criteria, the computer system 101 displays the user interface 7032 and the user interface 7122 at updated locations that are farther away from the viewpoint of the user 7002. In contrast, the representation 7014′ of the physical object 7014 and the virtual object 7012 do not meet the push-back criteria and are not redisplayed at updated positions (e.g., the computer system 101 maintains display of the representation 7014′ of the physical object 7014 and the virtual object 7012 at the same/original location). Moving a first set of one or more windows that correspond to one or more applications and that meet push-back criteria, in response to detecting the sixth user input, away from the viewpoint in the three-dimensional environment, improves the visibility of the first user interface object (e.g., by allowing the first user interface object to be displayed closer to the viewpoint of the user, and by moving the first set of one or more user interface objects further from the viewpoint of the user) and assists the user in locating the first user interface object (e.g., the specific user interface object that the user requested display of via the sixth user input), while also maintaining at least some level of consistency in the appearance of the three-dimensional environment (e.g., representations of the physical environment do not meet push-back criteria, and so are not redisplayed at updated positions).

In some embodiments, a second set of one or more user interface objects, different from the first set of one or more user interface objects were visible in the fifth view of the three-dimensional environment at the time when the sixth user input was detected. In response to detecting the sixth user input, in accordance with a determination that the second set of one or more user interface objects does not meet the push-back criteria, the computer system maintains display of the second set of one or more user interface objects at their respective positions in the three-dimensional environment, without moving the second set of one or more user interface objects farther away from the fifth viewpoint. For example, in FIG. 7U, the computer system 101 displays the system function menu 7046, and because the user interface 7032 and the user interface 7122 are applications windows that meet the push-back criteria, the computer system 101 moves the user interface 7032 and the user interface 7122 to updated locations that are farther away from the viewpoint of the user 7002. In contrast, the representation 7014′ of the physical object 7014 and the virtual object 7012 do not meet the push-back criteria and are not moved to updated positions (e.g., the computer system 101 maintains display of the representation 7014′ of the physical object 7014 and the virtual object 7012 at the same/original location, without moving the representation 7014′ of the physical object 7014 or the virtual object 7012 farther from the viewpoint of the user 7002). Displaying the first user interface object, and maintaining display of the second set of one or more user interface objects at their respective positions in the three-dimensional environment, without moving the second set of one or more user interface objects farther away from the fifth viewpoint, in response to detecting a sixth user input that corresponds to the request to display the first user interface object (and moving a first set of one or more windows that correspond to one or more applications and that meet push-back criteria, away from the viewpoint), improves the visibility of the first user interface object (e.g., by allowing the first user interface object to be displayed closer to the viewpoint of the user, and by moving the first set of one or more user interface objects further from the user) and assists the user in locating the first user interface object (e.g., the specific user interface object that the user requested display of via the sixth user input), while also maintaining at least some level of consistency in the appearance of the three-dimensional environment (e.g., representations of the physical environment do not meet push-back criteria, and so are moved away from the viewpoint).

In some embodiments, the second set of one or more user interface objects that does not meet the push back criteria includes a representation of a participant (e.g., an avatar, a three-dimensional model, an image, and/or a representation of a participant in the real-time communication session other than the user of the computer system) in a real-time communication session (e.g., a shared three-dimensional virtual and/or augmented reality experience, a video call, a voice call, a gaming session, a mixed modality communication session in which participants uses different modes of communication means (e.g., video, voice, and/or AR/VR devices) and are represented by respective representations in the three-dimensional environment). In some embodiments, the push back criteria include a requirement that the user interface object is visible in the currently displayed view of the three-dimensional environment and that the user interface object does not fall within one or more classes of user interface objects, such as representations of participants in a real-time communication session, system user interfaces such as the home user interface, the environment selection menu, the control user interface, or another system user interface, in order for the push back criteria to be met by the user interface object. In some embodiments, the push back criteria include a requirement that the user interface object is visible in the currently displayed view of the three-dimensional environment and that the user interface object is a world-locked and/or environment-locked object, in order for the push-back criteria to be met by the user interface object. For example, as described with reference to FIG. 7U, in some embodiments, some user interface object types do not meet the push-back criteria (e.g., representations of the physical environment, representation of the virtual space in which user interface objects are positioned, and/or representations of other users (e.g., other participants in a shared virtual and/or augmented reality experience, users of other computer systems in an active communication session that includes the computer system 101)). Displaying the first user interface object, and maintaining display of a representation of a participant in a real-time communication session (e.g., at a respective positions in the three-dimensional environment), without moving the representation of the participant in a real-time communication session farther away from the fifth viewpoint, in response to detecting a sixth user input that corresponds to the request to display the first user interface object (e.g., and moving a first set of one or more windows that correspond to one or more applications and that meet push-back criteria away from the fifth viewpoint), improves the visibility of the first user interface object (e.g., by allowing the first user interface object to be displayed closer to the viewpoint of the user, and by moving the first set of one or more user interface objects further from the user) and assists the user in locating the first user interface object, while also maintaining at least some level of consistency in the appearance of the three-dimensional environment (e.g., representations of participants in the real-time communication session are not moved, providing a consistent visual corresponding to the real-time communication session).

In some embodiments, the second set of one or more user interface objects that does not meet the push back criteria includes a representation of an environment (e.g., virtual overlays on the physical surfaces, a representation of the physical environment in the three-dimensional environment, amorphous virtual materials or scenes in the three-dimensional environment (e.g., virtual cloud, virtual sky, virtual ambient lighting, virtual mist or fog, virtual ocean, forest, mountain, or other scenery), a boundary surface (e.g., floor, walls, or other stationary surfaces) of the three-dimensional environment) in the three-dimensional environment. In some embodiments, the push back criteria include a requirement that the user interface object is visible in the currently displayed view of the three-dimensional environment and that the user interface object does not fall within one or more classes of user interface objects, such as objects that represent the environment portion (e.g., the space that holds other user interface objects that can be moved or manipulated in the environment) of the three-dimensional environment, in order for the push back criteria to be met by the user interface object. In some embodiments, the push back criteria include a requirement that the user interface object is visible in the currently displayed view of the three-dimensional environment and that the user interface object is not a world-locked and/or environment-locked object (e.g., the environment to which world-locked and/or environment-locked object is anchored, and user interface object that are floating in the environment and not anchored to the environment), in order for the push-back criteria to be met by the user interface object. For example, as described with reference to FIG. 7U, in some embodiments, some user interface object types do not meet the push-back criteria (e.g., representations of physical environment, representation of the virtual environment in which user interface objects are positioned, and/or representations of other users (e.g., other participants in a shared virtual and/or augmented reality experience, and/or other users of other computer systems in an active communication session that includes the computer system 101)). Displaying the first user interface object, and maintaining display of a representation of an environment in the three-dimensional environment (e.g., at a respective position in the three-dimensional environment), without moving the representation of the environment farther away from the fifth viewpoint, in response to detecting a sixth user input that corresponds to the request to display the first user interface object (e.g., and moving a first set of one or more windows that correspond to one or more applications and that meet push-back criteria, in response to detecting the sixth user input), improves the visibility of the first user interface object (e.g., by allowing the first user interface object to be displayed closer to the viewpoint of the user, and by moving the first set of one or more user interface objects further from the user) and assists the user in locating the first user interface object (e.g., the specific user interface object that the user requested display of via the sixth user input), while also maintaining at least some level of consistency in the appearance of the three-dimensional environment (e.g., representations of the environment does not meet push-back criteria, and so is not moved away from the viewpoint).

In some embodiments, while the fifth view of the three-dimensional environment (e.g., the same view as the first, second, third, or fourth view of the three-dimensional environment mentioned above, or another view of the three-dimensional environment), including the second user interface object displayed at the second position, is visible, via the display generation component, from the fifth viewpoint, the computer system detects a seventh user input that corresponds to a request to display a first indicator that corresponds to the first user interface object, in the fifth view of the three-dimensional environment. In some embodiments, detecting the seventh user input includes detecting an attention of the user (e.g., gaze, or a gaze substitute such as a hand pointing gesture that indicates a portion of the three-dimensional environment with which the user intends to interact) at a respective portion of the three-dimensional environment that has the second spatial relationship to the viewport through which the three-dimensional environment is visible. In some embodiments, the seventh user input is configured to trigger display of the first indicator in the fifth view of the three-dimensional environment, optionally, while the first user interface object is not currently present in the three-dimensional environment, located in a portion of the environment that is not current visible in the fifth view, or located in a portion of the environment that is visible in the fifth view. In response to detecting the seventh user input that corresponds to a request to display the first indicator that corresponds to the first user interface object, in the fifth view of the three-dimensional environment, the computer system displays the first indicator that corresponds to the first user interface object at a third position in the three-dimensional environment that is visible in the fifth view of the three-dimensional environment; and In some embodiments, the third position is a position that is chosen relative to the viewport through which the three-dimensional environment is visible (e.g., has a seventh spatial relationship to the viewport, and/or has a eighth spatial relationship to the location of the user's gaze at the time of the seventh user input), while maintaining display of the second user interface object at the second position in the three-dimensional environment (e.g., without moving the second user interface object to an updated second position in the three-dimensional environment that is farther away from the fifth viewpoint than the second position in the three-dimensional environment, without pushing the second user interface object farther away from the fifth viewpoint, without increasing a distance between the fifth viewpoint and the second user interface object in the depth dimension relative to the fifth viewpoint, and/or without ceasing display of the second user interface object at the second position and then redisplaying the second user interface at the updated second position (optionally, fading out or not displaying the second user interface object between the second position and the updated second position)). For example, in FIG. 7T following FIG. 7S, the computer system 101 displays the indicator 7042 in response to detecting the user's attention 7010 in a region 7030 of the viewport through which the three-dimensional environment is visible, but the computer system maintains display of the user interface 7032, the user interface 7122, the representation 7014′ of the physical object 7014, and the virtual object 7012 at their respective positions in the three-dimensional environment (e.g., as shown via the top-down views of FIGS. 7S and 7T), without pushing them back away from the viewpoint of the user, in accordance with some embodiments. Displaying the first indicator that corresponds to the first user interface object at a third position in the three-dimensional environment, while maintaining display of the second user interface object at a second position in the three-dimensional environment, in response to detecting a seventh user input that corresponds to a request to display the first indicator that corresponds to the first user interface object, automatically displays user interface objects (e.g., the second user interface object) at appropriate locations without requiring further user input (e.g., the computer system can ensure visibility of the first indicator without moving the second user interface object, and so the user does not need to perform additional user inputs to reposition the second user interface object (e.g., to increase visibility of the first indicator, or to return the second user interface object to a previous location if the computer system incorrectly moves the second user interface object when displaying the first indicator).

In some embodiments, while displaying the first indicator corresponding to the first user interface object in the first view of the three-dimensional environment (or the second view, third view, fourth view, fifth view, or another currently displayed view of the three-dimensional environment), the computer system changes respective values of one or more display properties (e.g., changing to a different color, making more translucent, and/or ceasing to display) of at least a portion of a third user interface object that is visible in the first view of the three-dimensional environment (or the second view, third view, fourth view, fifth view, or another currently displayed view of the three-dimensional environment) and is within a first region surrounding the first indicator in the first view of the three-dimensional environment (or the second view, third view, fourth view, fifth view, or another currently displayed view of the three-dimensional environment). In some embodiments, while displaying the first indicator corresponding to the first user interface object in the first view of the three-dimensional environment (or the second view, third view, fourth view, fifth view, or another currently displayed view of the three-dimensional environment), the computer system forgoes changing respective values of the one or more display properties of a second portion of the third user interface object and/or a fourth user interface object that are visible in the first view of the three-dimensional environment (or the second view, third view, fourth view, fifth view, or another currently displayed view of the three-dimensional environment), where the second portion of the third user interface object and/or the fourth user interface object are not within the first region surrounding the first indicator in the first view of the three-dimensional environment (or the second view, third view, fourth view, fifth view, or another currently displayed view of the three-dimensional environment). In some embodiments, the computer system determines that a portion of a user interface object is within the first region surrounding the first indicator in the first view of the three-dimensional environment (or another currently visible view of the three-dimensional environment) in accordance with a determination that the portion of the user interface object overlaps with the first indicator, or is within a threshold distance of the first indicator as viewed from the first viewpoint (or another current viewpoint), optionally when the portion of the user interface object has a smaller depth, a larger depth, and/or the same depth as the first indicator. In some embodiments, respective portions of multiple user interface objects that fall within the first region surrounding the first indicator are modified to ensure the visual saliency of the first indicator. In some embodiments, the environment portion of the three-dimensional environment are not modified even if they are within the first region surrounding the first indicator. For example, in FIG. 7T, while displaying the indicator 7042 in response to the user's attention being detected within the region 7030 of the viewport, the portion of the user interface 7122 that is within the region 7126 surrounding the indicator 7042, is displayed with a different appearance (e.g., is dimmed, blurred, and/or faded out; and/or a respective value of a brightness, opacity, sharpness, and/or color is changed for the portion of the user interface 7122 that is within the region 7126), while optionally, another region of the user interface 7122 that is not within the region 7126 maintains its original appearance, in accordance with some embodiments. Changing respective values of one or more display properties of at least a portion of a third user interface object, in accordance with a determination that the portion of the third user interface object is within a first region surrounding the first indicator, while displaying the first indicator corresponding to the first user interface object, improves visibility of the first indicator (e.g., the respective values of the one or more display properties are changed to ensure visibility of the first indicator, such as decreasing a brightness of the portion of the third user interface to ensure visibility of the first indicator (e.g., which is displayed over, or near, the portion of the third user interface)).

In some embodiments, while displaying the first indicator (e.g., the indicator 7042 in FIG. 7AH, and/or other indicators that indicate the reactive region for triggering display of the first user interface object via attention, air gesture, and/or other inputs that meet selection criteria) that is associated with the first user interface object (e.g., a system user interface object that includes one or more affordances for invoking various functions of the operating system and/or computer system, such as the system function menu 7046 shown in FIGS. 7G-7R, 7Y-7AA, and 7AE-7AF, or other system function menus, control function menus, application launchers, docks, and/or system user interface objects)) in a respective view of the three-dimensional environment (e.g., a first view shown in FIG. 7AG and FIGS. 7AH, a second view shown in FIG. 8A, or another currently displayed view of the three-dimensional environment), the computer system detects that a first set of conditions for displaying first content in the three-dimensional environment is met. In some embodiments, detecting that the first set of conditions for displaying the first content in the three-dimensional environment is met includes detecting a system event and/or a user input that, trigger display of a pop-up window, an alert, an application window, a three-dimensional application volume, virtual objects, virtual scene, virtual experience, augmented reality experience, extended reality experience, bringing a faded or dormant window into the foreground, and/or display of content that was not displayed before the conditions are met. In some embodiments, detecting the system event and/or user input includes detecting selection of an application icon corresponding to an application or three-dimensional experience, detecting selection of a user interface object that corresponds to a system function that changes the level of immersion, or detecting other user input and/or system events. In response to detecting that the first set of conditions for displaying the first content in the three-dimensional environment is met, the computer system displays the first content (e.g., a pop-up window, an alert, an application window, a three-dimensional application volume, virtual objects, virtual scene, virtual experience, augmented reality experience, extended reality experience) in the three-dimensional environment; and in accordance with a determination that displaying the first content meets immersion criteria, the computer system reduces visual prominence of the first indicator (e.g., increasing translucency, reducing size, reducing brightness or color saturation, and/or ceasing to display the first indicator, such that the first indicator does not distract the user from immersive experience provided by the first content and subsequent evolution of the first content). In some embodiments, displaying the first content meets the immersion criteria (e.g., and/or is determined by the computer system to meet the immersion criteria) when, the first content is an application designated by the developer of the application as an immersive application (e.g., the application is allowed to generate and cause display of content without a definite spatial boundary of the application in the three-dimensional environment), the first content is an immersive experience, and/or the first content has spatial extent that extends beyond a finite and/or visible spatial boundary, and/or the first content is not permitted to be displayed concurrently with content from other applications and/or is not permitted to be repositioned relative to content from other applications using system provided gestures and/or user interface elements or controls. In some embodiments, displaying the first content includes increasing the currently level of immersion of an application that is already displayed in the three-dimensional environment to at least a threshold level of immersion, and the computer system determines that displaying the first content meets the immersion criteria when the current level of immersion reaches the threshold level of immersion and remains at or above the current level of immersion for at least a threshold amount of time. In an example, as described with reference to FIGS. 7AH and 7AJ, the indicator 7042 in FIG. 7AH is displayed while the application content in the application user interface 7140 is not displayed as an immersive experience (e.g., confined in a window, and/or displayed with a low level of immersion concurrently with other windows and view of the physical environment). In FIG. 7AJ, the application content is displayed as an immersive experience (e.g., expanded beyond any discernable boundary and surrounds the viewpoint in a three-dimensional region that spans beyond that visible in the current viewport), and the indicator 7042 ceases to be displayed (e.g., is displayed with reduced visual prominence) when the computer system 101 transitions to displaying the application content as an immersive experience. Reducing visual prominent of a first indicator, in response to detecting that a first set of conditions for displaying first content in a three-dimensional environment is met, and in accordance with a determination that displaying the first content meets immersion criteria, reduces the number of user inputs needed to display user interfaces with the appropriate visual prominence when certain criteria are met (e.g., the user does not need to manually disable display of, or reduce visual prominence of, the first indicator when immersion criteria is met).

In some embodiments, in response to detecting that the first set of conditions for displaying the first content in the three-dimensional environment is met: in accordance with a determination that displaying the first content does not meet the immersion criteria, the computer system maintains display of the first indicator with display of the first content (e.g., without reducing the visual prominence of the first indicator). In some embodiments, displaying the first content does not meet the immersion criteria (e.g., and/or is determined by the computer system to fail to meet the immersion criteria) when, the first content is an application that has not been designated by the developer of the application as an immersive application (e.g., the first content is not allowed to be displayed without a definite spatial boundary of the application in the three-dimensional environment), the first content is not an immersive experience, and/or the first content has a spatial extent that does not extend beyond a finite and/or visible spatial boundary, and/or the first content is permitted to be displayed concurrently with content from other applications and/or is permitted to be repositioned relative to content from other applications using system provided gestures and/or user interface elements or controls. In some embodiments, displaying the first content includes increasing or decreasing the currently level of immersion of an application that is already displayed in the three-dimensional environment without reaching at least a threshold level of immersion, and the computer system determines that displaying the first content does not meet the immersion criteria when the current level of immersion has not reached the threshold level of immersion. In some embodiments, content that meets the immersion criteria has a greater spatial extent than content that does not meet the immersion criteria, and the immersion criteria is a threshold spatial extent. In some embodiments, some content that meets the immersion criteria does not necessarily have a greater spatial extent compared to some other content that does not meet the immersion criteria, at the time that the content is displayed; however the content that meets the immersion criteria has the possibility of extending outside of a definite spatial boundary due to its operation over time. In an example, as described with reference to FIG. 7AH, in some embodiments, if the indicator 7042 was already displayed prior to displaying the application user interface 7140 (e.g., as in FIGS. 7AD and 7AE), the computer system 101 maintains display of the indicator 7042 when the application user interface 7140 is displayed (e.g., as shown in FIG. 7AH) (e.g., the application corresponding to the application user interface 7140 is launched or is otherwise triggered to display application content), as long as the application content displayed (e.g., in the application user interface 7140) is not displayed as an immersive experience that meets the immersion criteria. Maintaining display of the first indicator with display of the first content, in response to detecting that the first set of conditions for displaying first content in a three-dimensional environment is met, and in accordance with a determination that displaying the first content does not meet the immersion criteria, reduces the number of user inputs needed to display user interfaces with the appropriate visual prominence when certain criteria are met (e.g., the user does not need to perform additional user inputs to maintain display of, re-enable display of, and/or redisplay the first indicator visual prominence of, the first indicator when immersion criteria is not met).

In some embodiments, while displaying the first content in the three-dimensional environment after reducing the visual prominence of the first indicator in accordance with the determination that displaying the first content meets the immersion criteria (e.g., when the first indicator is faded out, made translucent, and/or ceased to be displayed due to the display of the first content), the computer system detects a request to cease display of the first content (e.g., detecting activation of a home button, a crown, and/or other affordances of the computer system, an air gesture and/or voice command that correspond to a request to exit the application that provided the first content, a request to exit the currently displayed immersive experience, and/or a request to reduce the level of immersion by which the first content is provided, and/or an event that meets the condition established by the computer system for existing the currently displayed immersive experience or immersive application). In response to detecting the request to cease display of the first content: the computer system ceases to display the first content in the three-dimensional environment (e.g., ceasing to display the immersive experience, immersive application and/or reducing the immersive experience or application into a finite and bounded window of the experience and application); and in accordance with a determination that the immersion criteria are no longer met as a result of ceasing to display the first content in the three-dimensional environment, the computer system restores the visual prominence of the first indicator in a current view of the three-dimensional environment (e.g., if the criteria for displaying the first indicator (e.g., the user's attention is currently directed to the region of the currently displayed view for triggering display of the first indicator) are otherwise met at the time). In an example described in FIG. 7AK, following Figure AI and/or FIG. 7AJ, the computer system 101 is no longer displaying an immersive experience (e.g., because the user exits the immersive experience via a button activation of the digital crown 703 in FIG. 7AJ, because the user has adjusted the level of immersion using the digital crown 703 in FIG. 7AJ to a level below a threshold level of immersion (e.g., as described in FIGS. 8A-8AX and accompany descriptions) for the first content, or because the user exits the immersive experience by activating the close affordance 7142 in FIG. 7AJ), and the computer system 101 redisplays the indicator 7042 (e.g., because the user's attention 7010 remains directed to a location within the region 7132, and because an immersive experience is no longer being displayed). Restoring the visual prominence of the first indicator in a current view of the three-dimensional environment, in response to detecting the request to cease display of the first content, and in accordance with a determination that the immersion criteria are no longer met as a result of creasing to display the first content, automatically displays the first indicator with an appropriate visual prominence without requiring additional user inputs (e.g., the user does not need to manually adjust the visual prominence of the first indicator when the first content cease to be displayed).

In some embodiments, while displaying a respective view of the three-dimensional environment, the computer system detects that a first set of conditions are met. In some embodiments, the first set of conditions are met when the user's attention is detected in a region of the respective view that corresponds to the region for triggering display of the first indicator (e.g., as described with respect to FIG. 7D followed by the state shown in FIG. 7G), FIG. 7Y, and/or FIG. 7AE), and/or immersive content is not currently displayed in the three-dimensional environment (e.g., as described with respect to FIGS. 7AK and 7AL), and/or other conditions for triggering display of the first indicator if first indicator is permitted to be displayed by a user-configurable setting). In response to detecting that the first set of conditions are met: in accordance with a determination that a first setting (e.g., the “Show Indicator in Immersive Experience” setting 8031 in FIG. 8AM) is enabled, the computer system displays the first indicator (e.g., indicator 7042, or another analogous system indicator) in the respective view of the three-dimensional environment; and in accordance with a determination that the first setting (e.g., the “Show Indicator in Immersive Experience” setting 8031 in FIG. 8AM) is disabled, the computer system forgoes displaying the first indicator in the respective view of the three-dimensional environment. For example, in FIG. 8AM, the “Show Indicator in Immersive Experience” setting 8031 controls whether or not the indicator 7042 is displayed (e.g., and/or can be displayed) while the computer system 101 displays an immersive experience. In FIG. 7AJ, the indicator 7042 is not displayed (e.g., due to the “Show Indicator in Immersive Experience” setting 8031 not being enabled) even when the user's attention 7010 is directed to a location within the region 7132. As described with reference to FIG. 8AM, if the “Show Indicator in Immersive Experience” setting 8031 was instead enabled, the indicator 7042 would be displayed in FIG. 7AJ. Displaying the first indicator in the respective view of the three-dimensional environment in accordance with a determination that a first setting is enabled, and forgoing displaying the first indicator in the respective view of the three-dimensional environment in accordance with a determination that the first setting is disabled, reduces the number of user inputs to display, or not display, the first indicator when appropriate (e.g., the user does not need to manually display, or cease to display, the first indicator in all scenarios, and can instead configure the first setting to automatically enable or disable display of the first indicator when appropriate).

In some embodiments, while displaying the first user interface object in the first view of the three-dimensional environment (or another currently displayed view) at a fourth position (e.g., upper center portion of the viewport, center of the viewport, upper left corner of the viewport, or another portion of the viewport that is a default display position of the first user interface object when initially invoked or redisplayed in response to user inputs) in the three-dimensional environment, the computer system detects movement of a viewpoint of the user from the first viewpoint (or another viewpoint that corresponds to the currently displayed view in which the first user interface object was invoked) to a new viewpoint different from the first viewpoint, wherein the fourth position is visible from the new viewpoint. In some embodiments, at the time when the movement of the viewpoint was initiated, the first user interface object was displayed at a fourth position in the three-dimensional environment that is a world-locked and/or environment-locked position of the first user interface object that was chosen for the first user interface object when the first user interface was initially displayed in response to a user input, or a position that was chosen for the first user interface object when the first user interface was redisplayed due to another user input that corresponds to a request to display the first user interface object after the view of the three-dimensional environment has changed due to movement of the viewpoint. In some embodiments, the fourth position has a respective spatial relationship to the viewport through which the three-dimensional environment is visible, where the respective spatial relationship remains the same or substantially the same (e.g., remains in the center of the view, remains in the upper center portion of the view, remains in the upper left corner of the view, or another default display location of the first user interface object relative to the viewport) irrespective of which view of the three-dimensional environment is visible at the time that the request for displaying and/or redisplaying the first user interface object is detected. In some embodiments, the first user interface object is world-locked and/or environment-locked relative to the three-dimensional environment after it is displayed at the position that has the respective spatial relationship to the viewport, unless another user input is detected to cause the first user interface object to be relocated to another world-locked and/or environment-locked position in the three-dimensional environment that has the respective spatial relationship to the viewport. In response to detecting the movement of the viewpoint of the user from the first viewpoint to the new viewpoint: in accordance with a determination that the new viewpoint is outside of a respective spatial range of the first viewpoint in the three-dimensional environment, the computer system ceases to display the first user interface object in the three-dimensional environment; and in accordance with a determination that the new viewpoint is within the respective spatial range of the first viewpoint in the three-dimensional environment, the computer system updates a view of the three-dimensional environment from the first view to an updated view of the three-dimensional environment that corresponds to the new viewpoint, while maintaining display of the first user interface object at the fourth position in the three-dimensional environment. In some embodiments, the behavior described with respect to dismissing the first user interface object from the three-dimensional environment in response to movement of the viewpoint outside of the respective spatial range of the initial display position of the first user interface object also applies to other system user interface objects, such as the home user interface, the control user interface, the notification user interface, a virtual keyboard, a virtual assistant, and/or another system user interface that is displayed in response to user request (e.g., a selection of an activation affordance corresponding to the system user interface in a menu or the first user interface object, a system gesture, such as an air gesture or touch gesture that meet system gesture criteria, and/or another type of system input (e.g., activation of a home button, activation of another hardware control on the device or controller, a voice command)). In some embodiments, the behavior described with respect to dismissing the first user interface object and/or other system user interfaces does not apply to system alerts, such as status alerts, alerts for error conditions, and/or alerts triggered based on conditions established at a different time in the past via one or more user applications and/or system applications, and/or other alerts that are not generated in response to a user input but satisfaction of some previously established conditions other than a currently detected user input. In some embodiments, the system alerts are dismissed by an explicit user input that corresponds to a request to dismiss the system alerts, user input providing information requested by the system alerts, and/or are automatically dismissed in accordance with elapse of time and/or other conditions being met. In some embodiments, after the first user interface object is dismissed, either by explicit user inputs and/or by movement of the viewpoint beyond the respective spatial range of the original viewpoint that corresponds to the initial invocation of the first user interface object in the three-dimensional environment, the user interface objects that were pushed back away from the viewpoint are moved back to their respective positions before the display of the first user interface object. For example, in FIG. 7P following FIG. 7N and/or FIG. 7O, the user 7002 has moved to a new position 7026-d (e.g., from position 7026-b in FIG. 7N, and/or position 7026-c in FIG. 7O, which changes the viewpoint of the user and the current view of the three-dimensional environment). The computer system 101 updates the displayed view (e.g., as compared to FIGS. 7N and/or 70, the representation 7014′ of the physical object 7014, and the virtual object 7012, appear further away in FIG. 7P). Because at least a portion of the user 7002 is outside of the boundary 7116 when the user 7002 is at the new position 7026-d (e.g., as shown in the top-down view of FIG. 7P), the computer system 101 ceases to display the system function menu 7046. In contrast, in FIG. 7O, the user 7002 is still within the boundary 7116 at the new position 7026-c, and the computer system maintains display of the system function menu 7046 (e.g., at the same location as in FIG. 7N, but, optionally, with a modified visual appearance), in accordance with some embodiments. In another example, in FIG. 7R following FIG. 7N and/or FIG. 7Q, the user 7002 has moved to a new position 7026-f (e.g., from position 7026-b in FIG. 7N, and/or position 7026-e in FIG. 7Q, which changes the viewpoint of the user and the current view of the three-dimensional environment). The computer system 101 updates the displayed view (e.g., as compared to FIGS. 7N and/or 7Q, the representation 7014′ of the physical object 7014, and the virtual object 7012, appear closer to the center in FIG. 7R). Because at least a portion of the user 7002 is outside of the boundary 7116 when the user 7002 is at the new position 7026-f (e.g., as shown in the top-down view of FIG. 7R), the computer system 101 ceases to display the system function menu 7046. In contrast, in FIG. 7Q, the user 7002 is still within the boundary 7116 at the new position 7026-e, and the computer system maintains display of the system function menu 7046 (e.g., at the same or substantially the same location as in FIG. 7N, but, optionally, with a modified visual appearance), in accordance with some embodiments. Ceasing to display the first user interface object in accordance with a determination that a new viewpoint is outside of a respective spatial range of the first viewpoint; and updating a view of the three-dimensional environment to an updated view of the three-dimensional environment that corresponds to the new viewpoint, while maintaining display of the first user interface object at the fourth position in the three-dimensional environment, in accordance with a determination that the new viewpoint is within the respective spatial range of the first viewpoint, in response to detecting movement of the viewpoint of the user from a first viewpoint to the new viewpoint, provides additional control options without cluttering the UI with additional displayed controls (e.g., the user is able to quickly and efficiently cause the computer system to cease to display the system function menu by moving a sufficient distance from the system function menu).

In some embodiments, the respective spatial range has a greater size in a first direction relative to the first viewpoint than a second direction relative the first viewpoint in the three-dimensional environment. In some embodiments, the respective spatial range has shorter threshold distance(s) from the first viewpoint in a transverse direction of the viewport (e.g., the direction pointing to the left and right sides of the viewport, and/or a direction that is pointing from the center toward the peripheral regions of the viewport), and longer threshold distance(s) toward the first user interface object (e.g., the direction that is in the z-dimension, and/or depth dimension of the three-dimensional environment). For example, it takes a smaller movement of the viewpoint in the leftward and/or rightward directions than a movement of the viewpoint toward the first user interface object to cause the dismissal of the first user interface object from the three-dimensional environment. For example, in FIGS. 7P and 7R, the boundary 7116 indicates the respective spatial range relative to the viewpoint of the user at a time when the system function menu 7046 was first displayed (e.g., indicated by the position 7026-b of the user in FIG. 7N), and the respective spatial range is narrower in the horizontal direction relative to the viewport, and wider in the vertical direction relative to the viewport (and optionally, is longer in front of the viewpoint and shorter behind the viewpoint), in accordance with some embodiments. Having different sizes for the respective spatial range in the first and second directions relative to the viewpoint when determining whether to cease to display the first user interface object in the three-dimensional environment in response to the movement of the viewport of the user, provides additional control options without cluttering the UI with additional displayed controls (e.g., the user is able to quickly and efficiently cause the computer system to cease to display the system function menu by moving a sufficient distance from the system function menu), and makes the responsiveness of this behavior more appropriate and intuitive (e.g., by making the behavior more responsive when the user is moving sideways, and less responsive when the user is moving toward the first user interface object) and thereby reducing inadvertently ceasing to display the first user interface object when the user moves in the environment (e.g., to get closer or father away from the first user interface object to view the first user interface object more clearly).

In some embodiments, in response to detecting the movement of the viewpoint of the user from the first viewpoint to the new viewpoint and in accordance with a determination that the new viewpoint is within the respective spatial range of the first viewpoint in the three-dimensional environment and that the new viewpoint is within a threshold distance of a boundary of the respective spatial range of the first viewpoint, the computer system changes one or more respective values of one or more display properties of the first user interface object to reduce visual prominence of the first user interface object (e.g., reducing opacity, size, color saturation, brightness, and/or other changes in display properties that result in a reduction of visual prominence of the first user interface object) in an updated view of the three-dimensional environment that corresponds to the new viewpoint. In some embodiments, in response to detecting the movement of the viewpoint to the new viewpoint, in accordance with a determination that the new viewpoint is within the respective spatial range of the first viewpoint in the three-dimensional environment and outside of the threshold distance of the boundary of the respective spatial range of the first viewpoint, the computer system updates the view of the three-dimensional environment from the first view to the updated view of the three-dimensional environment that corresponds to the new viewpoint, while maintaining the visual prominence of the first user interface object in the updated view of the three-dimensional environment (e.g., without changing the values of the one or more display parameters of the first user interface object). For example, in FIG. 7O and FIG. 7Q, the user 7002's new position (e.g., the position 7026-c in FIG. 70 and the position 7026-e in FIG. 7Q) is still within the boundary 7116 (e.g., the respective spatial range of the first viewpoint), but is within a threshold distance of the boundary 7116 (e.g., at least a portion of the user 7002 is close to the boundary 7116 in both FIG. 7O and FIG. 7Q), and the computer system 101 displays the system function menu 7046 with a different appearance (e.g., changes respective values of one or more display properties such as a brightness, opacity, sharpness, and/or color of the system function menu 7046). Changing respective values of one or more display properties of the first user interface object to reduce visual prominence of the first user interface object in an updated view of the three-dimensional environment that corresponds to a new viewpoint, in response to detecting movement of the viewpoint of the user from the first viewpoint to the new viewpoint, and in accordance with a determination that the new viewpoint is within the respective spatial range of the first viewpoint and that the new viewpoint is within a threshold distance of a boundary of the respective spatial range of the first viewpoint, provides improved visual feedback to the user (e.g., improved visual feedback that the movement of the viewpoint of the user is approaching a point where the viewpoint of the user will no longer be within the second spatial range of the first viewpoint, at which point the computer system will cease to display the first user interface object).

In some embodiments, after changing the one or more respective values of the one or more display properties of the first user interface object in response to detecting the movement of the viewpoint of the user within the threshold distance of the boundary of the respective spatial range of the first viewpoint, the computer system detects further movement of the viewpoint relative to the respective spatial range of the first viewpoint. In response to detecting the further movement of the viewpoint of the user relative to the respective spatial range of the first viewpoint and in accordance with a determination that the viewpoint of the user is within the respective spatial range of the first viewpoint and has moved further away from the boundary of the respective spatial range (e.g., toward the interior region of the respective spatial range of the first viewpoint, and optionally still within a peripheral region of the first viewpoint where, if viewpoint is detected within the peripheral region, the first user interface object has a modified appearance with reduced visual prominence as compared to its original appearance), the computer system changes the one or more values of the one or more display properties of the first user interface object to increase the visual prominence of the first user interface object in a currently displayed view of the three-dimensional environment (e.g., to increase the visual prominence relative to the earlier modified visual appearance, and optionally to increase the visual prominence back to its original level of visual prominence before the initial movement of the viewpoint into the threshold distance of the boundary of the respective spatial region). In some embodiments, in response to detecting the further movement of the viewpoint of the user relative to the respective spatial range of the first viewpoint: in accordance with a determination that the viewpoint of the user is within the respective spatial range of the first viewpoint and is outside of the threshold distance of the boundary of the respective spatial range, the computer system displays the first user interface object with its original visual prominence, and with the original values of the one or more display properties of the first user interface object. For example, in FIG. 7O and FIG. 7Q, where the user 7002's new position (e.g., the position 7026-c in FIG. 7O and the position 7026-e in FIG. 7Q) is still within the boundary 7116 (e.g., the second spatial range of the first viewpoint), if the user 7002's viewpoint were to move away from the boundary 7116 within the boundary 7116 toward the original location of the viewpoint in FIG. 7N, and the computer system 101 would display the system function menu 7046 with less change in the one or more display properties and increases the visual prominence of the system function menu 7046. If the user 7002's viewpoint were to move away from the boundary 7116 toward the original location of the viewpoint in FIG. 7N, to a point outside of the threshold distance from the boundary 7116, the computer system 101 would displays the system function menu 7046 with its original appearance shown in FIG. 7N, in accordance with some embodiments. If the user 7002's viewpoint were to move even closer to the boundary 7116, the computer system 101 optionally further decreases the visual prominence of the first user interface object, in accordance with some embodiments. Changing respective values of one or more display properties of the first user interface object to increase visual prominence of the first user interface object in an updated view of the three-dimensional environment that corresponds to a new viewpoint, in response to detecting movement of the viewpoint of the user from the first viewpoint to the new viewpoint, and in accordance with a determination that the new viewpoint is within the respective spatial range of the first viewpoint and that the new viewpoint has moved farther away from the boundary of the respective spatial range of the first viewpoint, provides improved visual feedback to the user (e.g., improved visual feedback that the movement of the viewpoint of the user is approaching or moving away from a point where the viewpoint of the user will no longer be within the respective spatial range of the first viewpoint, at which point the computer system will cease to display the first user interface object).

In some embodiments, after changing the one or more respective values of the one or more display properties of the first user interface object in response to detecting the movement of the viewpoint of the user within the threshold distance of the boundary of the respective spatial range of the first viewpoint, the computer system detects further movement of the viewpoint relative to the respective spatial range of the first viewpoint. In response to detecting the further movement of the viewpoint of the user relative to the respective spatial range of the first viewpoint and in accordance with a determination that the viewpoint of the user is outside of the respective spatial range of the first viewpoint, the computer system ceases to display the first user interface object in the three-dimensional environment. In some embodiments, the first user interface object can be redisplayed (e.g., with its original visual prominence, or a reduced visual prominence) before the viewpoint moves out of the respective spatial range of the first viewpoint if the viewpoint moves back toward the first viewpoint before it exits the respective spatial range of the first viewpoint, and reduction in visual prominence of the first user interface object before the viewpoint exits the respective spatial range serves as an alert to the user that the first user interface object would be dismissed if the movement of the viewpoint continues in the same direction away from the first viewpoint. For example, as described with reference to FIG. 7P and FIG. 7R, in some embodiments, after the appearance of the system function menu 7046 (e.g., and/or a system space) is changed (e.g., as shown in FIGS. 70 and 7Q), if the user 7002's viewpoint exists the boundary 7116, the computer system 101 ceases to display the system function menu 7046, in accordance with some embodiments. Ceasing to display the first user interface object in the three-dimensional environment, in response to detecting the movement of the viewpoint of the user to outside of the respective spatial range, provides improved visual feedback to the user (e.g., improved visual feedback that the viewpoint of the user has left the respective spatial range of the first viewpoint) and dismisses the first user interface object without requiring additional user inputs.

In some embodiments, aspects/operations of methods 10000, 11000, 12000, and/or 13000 may be interchanged, substituted, and/or added between these methods. For example, the progress indicators for settings of the computer system in the method 9000 can be concurrently displayed with the first user interface object for accessing system functions of the computer system in the method 10000, 11000, 12000, or 13000. For brevity, these details are not repeated here.

FIG. 10 is a flow diagram of an exemplary method 10000 for automatically adjusting a relevant setting of the computer system based on a state of the computer system when a user input is detected, in accordance with some embodiments. In some embodiments, method 10000 is performed at a computer system (e.g., computer system 101 in FIG. 1A) that is in communication with a first display generation component (e.g., display generation component 120 in FIGS. 1A, 3, and 4, and/or display generation component 7100 in FIGS. 7A and 8A, and/or the display generation component 7100a in FIGS. 7V and 8S) (e.g., a heads-up display, a display, a touchscreen, a projector, a head mounted display (HMD), an inner display of a two-sided display generation component, a display on a handheld device, a display on a wearable device, or another type of display) and one or more input devices (e.g., cameras (e.g., color sensors, infrared sensors, and other depth-sensing cameras) (e.g., that point downward at a user's hand and/or forward from the user's head), touch-sensors, touch-sensitive surfaces, proximity sensors, motion sensors, buttons, joysticks, and/or other sensors and input devices). In some embodiments, the method 10000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 10000 are, optionally, combined and/or the order of some operations is, optionally, changed.

Method 10000 is a method of adjusting audio output parameters for audio outputs in accordance with some embodiments. Adjusting a first audio output parameter for audio outputs in accordance with a first user input that meets adjustment criteria (e.g., while maintaining a first level of immersion of a plurality of levels of immersion), and in accordance with a determination that the computer system was generating audio outputs at a time when the start of the first user input was detected, and adjusting a current level of immersion in accordance with the first user input, and in accordance with a determination that the computer system was not generating audio outputs at a time when the start of the first user input was detected, automatically adjusts a contextually-relevant setting of the computer system without requiring additional user input (e.g., additional user inputs to find and/or select a relevant setting of the computer system for adjustment).

While a respective view of a three-dimensional environment is visible, via the first display generation component, with a virtual environment corresponding to the three-dimensional environment having a first level of immersion of a plurality of levels of immersion, the computer system detects (10002), via the one or more input devices, a start of a first user input (e.g., manipulation of a hardware control, movement of a virtual control, and/or other user input that can be continued after the start of the user input) that meets adjustment criteria (e.g., the input rotates a dial, slides a slider, and/or otherwise changes a value of a controller associated with the computer system) (e.g., in FIG. 8B and in FIG. 8I, the portable multifunction device 100 detects activation of the button 8008 by the hand 7020; and in some embodiments, the computer system is capable of displaying the three-dimensional environment with different levels of immersion, includes a low level of immersion in which passthrough content dominates the view of the three-dimensional environment with minimal virtual content, one or more intermediate levels of immersion in which virtual content and passthrough content are both displayed and virtual objects are displayed with three-dimensional spatial relationships to the representations of physical objects and surfaces in the passthrough view of the physical environment, and a high level of immersion in which virtual content dominates the view of the three-dimensional environment with little to no representation of the physical object and surfaces in the physical environment. In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency or reduced opacity) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, reduced in opacity, and/or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, and/or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency or reduced opacity) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, and/or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

In response to detecting (10004) the start of the first user input that meets the adjustment criteria: in accordance with a determination that the computer system was generating audio outputs (e.g., audio or audiovisual media) at a time when the start of the first user input was detected (e.g., in FIG. 8I, the illustrated sound waves show that audio is playing), the computer system adjusts (10006) (e.g., via the operating system and/or an application that generates the audio outputs) a first audio output parameter (e.g., volume, frequency, and/or other audio output parameter) for the audio outputs in accordance with (e.g., a magnitude of, movement of, and/or a direction of movement of) the first user input (e.g., in accordance with the start and continuation of the first user input, and/or adjusting by an amount, a rate of change, and/or in a direction that is based on the value(s) of one or more characteristics (e.g., movement speed, movement direction, movement distance, duration, intensity, and/or other characteristics) of the first user input) (e.g., in FIG. 8I, the portable multifunction device 100 defaults to adjusting the audio level of the portable multifunction device 100, as shown by the larger size of the user interface 8016 in comparison to the user interface 8014 that corresponds to the level of immersion of the portable multifunction device 100), while the respective view of the three-dimensional environment continues to be visible, via the first display generation component, with the virtual environment corresponding to the three-dimensional environment maintained at the first level of immersion of a plurality of levels of immersion (e.g., the virtual content region 8000 is the same or substantially the same size in FIGS. 8H-8J, indicating that the level of immersion does not change in those figures).

In accordance with a determination that the computer system was not generating audio outputs at the time when the start of the first user input was detected (e.g., in FIG. 8B and in FIG. 8O, there are no sound waves illustrated, indicating that no sound is playing), the computer system adjusts (10008) (e.g., increasing, or decreasing) a current level of immersion of the virtual environment in the three-dimensional environment from the first level of immersion to a second level of immersion of the plurality of levels of immersion that is different from the first level of immersion (e.g., in FIGS. 8B-8D, the content region 8000 changes in size, to indicate that the level of immersion is adjusted), in accordance with the first user input (e.g., in accordance with the start and the continuation of the first user input, and/or adjusting by an amount, a rate of change, and/or in a direction that is based on the value(s) of one or more characteristics (e.g., movement speed, movement direction, movement distance, duration, intensity, and/or other characteristics) of the first user input).

In some embodiments, in response to detecting the start of the first user input that meets the adjustment criteria, the computer system displays a respective progress indicator (e.g., a dial, a slider, a progress bar, and/or another type of progress indicator that indicates a current value and a value range of a respective control parameter) in the respective view of the three-dimensional environment, wherein the respective progress indicator indicates a respective current value (e.g., absolute value and/or a value relative to a respective allowed value range) for at least one of the first audio output parameter and the level of immersion (e.g., a volume control and/or indicator that shows the current volume level and updates in accordance with changes to the current volume level, an immersion level control and/or indicator that shows the current level of immersion for the virtual environment in the three-dimensional environment and updates in accordance with changes to the current level of immersion, or both). In some embodiments, the computer system displays the progress indicators of both the first audio output parameter and the progress indicator of the level of immersion concurrently in the respective view of the three-dimensional environment, the computer system displays a respective one of the progress indicators with an enhanced visual prominence relative to the other progress indicator, depending on whether the computer system was generating audio outputs (e.g., progress indicator for audio output parameter is visually emphasized (e.g., increased in size, increased in opacity, increased in brightness, increased in color saturation, animated, highlighted, and/or otherwise enhanced in visual prominence) relative to the progress indicator for level of immersion, and/or progress indicator for level of immersion is visually deemphasized (e.g., reduced in size, reduced in opacity, dimmed, and/or otherwise reduced in visual prominence) relative to the progress indicator for audio output parameter) or not generating audio outputs (e.g., progress indicator for audio output parameter is visually deemphasized relative to the progress indicator for level of immersion, and/or progress indicator for level of immersion is visually emphasized relative to the progress indicator for audio output parameter). In some embodiments, when the progress indicators for both types of adjustable parameters (e.g., the first audio output parameter, the level of immersion, or another type of adjustable parameter that is controllable by the first user input that meets the adjustment criteria), the computer system displays a user interface object (e.g., an icon, a simplified version of the progress indicator that shows the current value of the corresponding parameter) for the parameter that is currently not selected or defaulted for adjustment by the first user input, without displaying the current value of the parameter (e.g., when volume is defaulted and/or selected for adjustment, the progress indicator for the level of immersion is displayed as a first icon that does not indicate the current level of immersion; and when the level of immersion is defaulted and/or selected for adjustment, the progress indicator for volume is displayed as a second icon that does not indicate the current volume level). In some embodiments, the computer system maintains display of the progress indicator as long as the first user input is still detected (e.g., while the user's hand is still touching the hardware control that corresponds to the audio and immersion level controls, and/or while the user's gaze is still detected as being directed to one of the progress indicators). For example, in FIG. 8B, the user interface 8014 includes the visual indicator 8015, which indicates the current level of immersion of the portable multifunction device 100, and the user interface 8014 and the visual indicator 8015 are displayed in response to detecting activation of the button 8008 by the hand 7020, in accordance with some embodiments. Displaying a respective progress indicator that indicates a respective current value for at least one of the first audio output parameter and the level of immersion, in response to detecting the start of the first user input that meets the adjustment criteria, provides improved visual feedback to the user (e.g., improved visual feedback regarding which setting is being adjusted by the user, and improved visual feedback regarding the current value of the setting that is being adjusted by the user).

In some embodiments, in response to detecting the start of the first user input that meets the adjustment criteria, displaying the respective progress indicator in the respective view of the three-dimensional environment, includes: in accordance with a determination that the computer system is generating audio outputs at the time when the start of the first user input was detected, displaying, in the respective view of the three-dimensional environment, a first progress indicator that indicates a current value for the first audio output parameter (e.g., without displaying a second progress indicator that indicates a current value for the level of immersion, or while concurrently displaying the second progress indicator that indicates the current value for the level of immersion (optionally, with a visual appearance that indicates that the first progress indicator has priority over the second progress indicator to be adjusted by the first user input)). For example, in FIG. 8I, audio is playing when the portable multifunction device 100 detects activation of the button 8008 by the hand 7020, and in response, the portable multifunction device 100 displays the user interface 8016 and the visual indicator 8017, which indicates a current value for the audio level of the portable multifunction device 100, in accordance with some embodiments. Displaying a first progress indicator that indicates a current value for the first audio parameter, in response to detecting the start of the first user input that meets the adjustment criteria, and in accordance with a determination that the computer system is generating audio outputs at the time when the start of the first user input was detected, provides improved visual feedback to the user (e.g., improved visual feedback that the first audio output parameter is being adjusted, and improved visual feedback regarding the current value for the first audio output parameter).

In some embodiments, in response to detecting the start of the first user input that meets the adjustment criteria, displaying the respective progress indicator in the respective view of the three-dimensional environment, includes: in accordance with a determination that the computer system was not generating audio outputs at the time when the start of the first user input was detected, displaying, in the respective view of the three-dimensional environment, a second progress indicator that indicates a current value for the level of immersion (e.g., without displaying the first progress indicator that indicates a current value for the first audio output parameter, or while concurrently displaying the first progress indicator that indicates the current value for the first audio output parameter (optionally, with a visual appearance that indicates that the second progress indicator has priority over the first progress indicator to be adjusted by the first user input)). For example, in FIG. 8O, audio is not playing when the portable multifunction device 100 detects activation of the button 8008 by the hand 7020, and in response, the portable multifunction device 100 displays the user interface 8014 and the visual indicator 8015, which indicates a current value for the level of immersion, in accordance with some embodiments. Displaying a second progress indicator that indicates a current value for the level of immersion, in response to detecting the start of the first user input that meets the adjustment criteria, and in accordance with a determination that the computer system was not generating audio outputs at the time when the start of the first user input was detected, provides improved visual feedback to the user (e.g., improved visual feedback that the level of immersion is being adjusted, and improved visual feedback regarding the current value for the level of immersion).

In some embodiments, in response to detecting the start of the first user input that meets the adjustment criteria, displaying the respective progress indicator in the respective view of the three-dimensional environment, includes: in accordance with a determination that the computer system is generating audio outputs (e.g., audio outputs of a respective type of audio such as media or real-time communication session audio as opposed to transient audio such as system alerts or user interaction feedback) at the time when the start of the first user input was detected, concurrently displaying a first progress indicator that indicates the current value for the first audio output parameter and a second progress indicator that indicates a current value for the level of immersion (optionally, with a visual appearance that indicates that the first progress indicator has priority over the second progress indicator to be adjusted by the first user input)) in the respective view of the three-dimensional environment. For example, in FIG. 8I, audio is playing when the portable multifunction device 100 detects activation of the button 8008 by the hand 7020, and in response, the portable multifunction device 100 displays the user interface 8016 and the visual indicator 8017, which indicates a current value for the audio level of the portable multifunction device 100, and the portable multifunction device 100 also displays user interface object 8014 that corresponds to a progress indicator of the level of immersion without indicating the current value of the level of immersion, in accordance with some embodiments. Displaying both a first progress indicator that corresponds to a first audio output parameter and a second progress indicator that corresponds to a level of immersion, in response to detecting the start of the first user input that meets the adjustment criteria, and in accordance with a determination that the computer system was generating audio outputs at the time when the start of the first user input was detected, provides improved visual feedback to the user (e.g., improved visual feedback that the first user input can be used to adjust multiple types of outputs, and improved visual feedback regarding which type of outputs is currently the target for the adjustment).

In some embodiments, while concurrently displaying the first progress indicator and the second progress indicator in accordance with the determination that the computer system is generating audio outputs at the time when the start of the first user input was detected, the computer system detects that an attention (e.g., based on gaze, or based on a gaze substitute such as a hand pointing gesture that indicates a portion of the three-dimensional environment with which the user intends to interact) of a user is directed to the second progress indicator that indicates the current value for the level of immersion; and in response to detecting that the attention of the user is directed to the second progress indicator, in accordance with a determination that continuation of the first user input is detected while the attention of the use is directed to the second progress indicator, the computer system adjusts the current level of immersion of the virtual environment in the three-dimensional environment in accordance with the continuation of the first user input (e.g., adjusting by an amount, a rate of change, and/or in a direction that is based on the value(s) of one or more characteristics (e.g., movement speed, movement direction, movement distance, duration, intensity, and/or other characteristics) of the first user input), while maintaining the current value for the first audio output parameter (e.g., while updating the value of the current level of immersion in the second progress indicator in accordance with the change in the level of immersion as a result of the continuation of the first user input, and maintaining the value of the first display parameter in the first progress indicator). In some embodiments, adjusting the current level of immersion of the virtual environment includes increasing the pixel occupancy, spatial extent of the virtual environment in the three-dimensional environment, and/or other parameters that affect the level of immersion, by a first amount in accordance with continuation of the first user input by a first magnitude in a first direction, and decreasing the pixel occupancy, spatial extent of the virtual environment in the three-dimensional environment, and/or other parameters that affect the level of immersion, by a second amount in accordance with continuation of the first user input by a second magnitude in a second direction different from the first direction. For example, in FIGS. 8I-8K, audio is playing and the portable multifunction device 100 defaults to adjusting an audio level of the portable multifunction device 100 in response to detecting activation of the button 8018, the button 8012, and/or the button 8010. In FIG. 8L, the portable multifunction device 100 enables adjusting the level of immersion of the portable multifunction device 100, in response to detecting the user's attention 7010 directed to the user interface 8014 (e.g., in conjunction with activation of the button 8008 by the hand 7020), and maintains the current audio level for the portable multifunction device 100 (e.g., as illustrated by the same size and thickness of the sound waves in FIG. 8K and FIG. 8L), in accordance with some embodiments. Adjusting the current level of immersion of the virtual environment in accordance with continuation of the first user input (e.g., while maintaining the current value for the first audio output parameter), in response to detecting that the attention of the user is directed to the second indicator, provides additional control options and allows for increased flexibility for adjusting multiple settings of the computer system (e.g., the user can switch from adjusting the first audio parameter to adjusting the level of immersion, even though audio is playing, without needing to perform additional user inputs to pause or stop the playing audio, and without needing to perform a different input or different type of input, in order to access functionality of adjusting the level of immersion while audio is playing).

In some embodiments, while concurrently displaying the first progress indicator and the second progress indicator in the respective view of the three-dimensional environment, in response to detecting that the attention of the user is directed to the second progress indicator, the computer system visually emphasizes the second progress indicator relative to the first progress indicator (e.g., increasing the opacity, brightness, color saturation, size, and/or other display parameters that promotes visual prominence of the second progress indicator, for at least a portion of the second progress indicator; and/or decrease the opacity, brightness, color saturation, size, and/or other display parameters that promotes visual prominence of the first progress indicator, for at least a portion of the first progress indicator). For example, in FIG. 8L, the portable multifunction device 100 visually emphasizes the user interface 8014 by displaying the user interface 8014 at a larger size than in FIG. 8K (e.g., where the current audio level of the portable multifunction device 100, represented by the user interface 8016, was being adjusted). This indicates that the portable multifunction device 100 has now enables adjustment of the current level of immersion (e.g., which is represented by the user interface 8016), in accordance with some embodiments. Visually emphasizing the second progress indicator relative to the first progress indicator, in response to detecting that the attention of the user is directed to the second progress indicator, provides improved visual feedback to the user (e.g., improved visual feedback regarding which setting is currently being adjusted, and improved visual feedback that the computer system has switched to adjusting a different setting).

In some embodiments, in accordance with the determination that the computer system is generating audio outputs at the time when the start of the first user input was detected, concurrently displaying the first progress indicator that indicates the current value for the first audio output parameter and the second progress indicator that indicates a current value for the level of immersion in the respective view of the three-dimensional environment, includes: in accordance with a determination that first criteria are met, wherein the first criteria are met when the current value for the first audio output parameter is adjusted in accordance with the first user input (e.g., adjusted by an amount, a rate of change, and/or in a direction that is based on the value(s) of one or more characteristics (e.g., movement speed, movement direction, movement distance, duration, intensity, and/or other characteristics) of the first user input), displaying a first progress bar (e.g., in the shape of a slider, a dial, and/or another form) in the first progress indicator that indicates the current value of the first audio output parameter relative to a first value range (e.g., continuous values, or discrete levels) of the first audio output parameter, without displaying a second progress bar (e.g., in the shape of a slider, a dial, and/or another form) in the second progress indicator that indicates the current value of the level of immersion relative to a second value range of the level of immersion (e.g., continuous values, or discrete levels); and in accordance with a determination that second criteria are met, wherein the second criteria are met when the current value for the level of immersion is adjusted in accordance with the first user input (e.g., adjusting by an amount, a rate of change, and/or in a direction that is based on the value(s) of one or more characteristics (e.g., movement speed, movement direction, movement distance, duration, intensity, and/or other characteristics) of the first user input), displaying the second progress bar in the second progress indicator, without displaying the first progress bar in the first progress indicator. For example, in FIG. 8B, the level of immersion is being adjusted, and the portable multifunction device 100 displays the visual indicator 8015 with the user interface 8014, but does not display a progress bar (e.g., the visual indicator 8017 in FIG. 8I) for the user interface 8016. In contrast, in FIG. 8I, the current audio level is being adjusted, and the portable multifunction device 100 displays the visual indicator 8017 with the user interface 8016, but does not display a progress bar (e.g., the visual indicator 8015 in FIG. 8B) with the user interface 8014, in accordance with some embodiments. Displaying a first progress bar in the first progress indicator that indicates the current value of the first audio output parameter relative to a first value range of the first audio output parameter, without displaying a second progress bar in the second progress indicator that indicates the current value of the level of immersion relative to a second value range of the level of immersion, in accordance with a determination that the first audio output parameter is adjusted in accordance with the first user input, and displaying the second progress bar in the second progress indicator without displaying the first progress bar in the first progress indicatory, in accordance with a determination that the level of immersion is adjusted in accordance with the first user input, provides improved visual feedback to the user (e.g., improved visual feedback regarding the current level of a setting that is being adjusted, and improved visual feedback regarding which setting is currently being adjusted).

In some embodiments, while concurrently displaying the first progress indicator and the second progress indicator in the respective view of the three-dimensional environment, the computer system detects that third criteria are met, wherein the third criteria are met when the computer system is switching between adjusting the first audio output parameter to adjusting the level of immersion in accordance with the first user input (e.g., in response to detecting that the user's attention is directed to the second progress indicator, in response to detecting selection of the second progress indicator by a gesture or other selection input, and/or in response to detecting stoppage of audio output by the computer system (e.g., due to end of media playback, and/or other events other than the adjustment by the first user input)); and in response to detecting that the third criteria are met, the computer system ceases to display the first progress bar in the first progress indicator, and the computer system displays the second progress bar in the second progress indicator. In some embodiments, while concurrently displaying the first progress indicator and the second progress indicator in the respective view of the three-dimensional environment, detecting that fourth criteria are met, wherein the fourth criteria are met when the computer system is switching between adjusting the level of immersion to adjusting the first audio output parameter in accordance with the first user input (e.g., in response to detecting that the user's attention is directed to the first progress indicator, in response to detecting selection of the first progress indicator by a gesture or other selection input, and/or in response to detecting stoppage of an immersive experience by the computer system (e.g., due to end of the immersive experience, and/or other events other than the adjustment by the first user input)); and in response to detecting that the fourth criteria are met, the computer system ceases to display the second progress bar in the second progress indicator, and displays the first progress bar in the first progress indicator. For example, in FIG. 8K, the current audio level is being adjusted and the portable multifunction device 100 displays the visual indicator 8017 with the user interface 8016 (e.g., and does not display the visual indicator 8015 with the user interface 8014). In FIG. 8L, the portable multifunction device 100 switches to adjusting the level of immersion, and displays the visual indicator 8015 with the user interface 8014, and ceases to display the visual indicator 8017 with the user interface 8016, in accordance with some embodiments. Ceasing to display the first progress bar in the first progress indicator and displaying the second progress bar in the second progress indicator, in response to detecting that the computer system is switching between adjusting the first audio output (e.g., corresponding to the first progress indicator) to adjusting the level of immersion (e.g., corresponding to the second progress indicator), provides improved visual feedback to the user (e.g., improved visual feedback regarding the current level of a setting that is being adjusted, and improved visual feedback regarding which setting is currently being adjusted).

In some embodiments, displaying the respective progress indicator in response to detecting the start of the first user input that meets the adjustment criteria, includes: in response to detecting an initial portion of the first user input (e.g., a button press, crown rotation, an air pinch input, an air tap input, a pinch input, a tap input, an air pinch and drag input, an air drag input, a drag input, a click and drag input, a gaze input, and/or other input), displaying the respective progress indicator (e.g., an icon, a progress bar, and/or another type of indication of the type of parameter that is adjustable by the first user input) without changing the respective current value indicated by the respective progress indicator in accordance with the initial portion of the first user input. For example, the initial appearance of the respective progress indicator is displayed to indicate to the user what type of parameter(s) can be adjusted by the first user input, without actually adjusting any parameter based on the initial portion of the first user input, in accordance with some embodiments. For example, in FIG. 8B, in response to detecting activation of the button 8008 by the hand 7020 (e.g., and without changing a current value of a setting of the portable multifunction device 100), the portable multifunction device 100 displays the user interface 8014 and the user interface 8016 (e.g., without changing a current value for either the level of immersion which corresponds to the user interface 8014, or the current audio level which corresponds to the user interface 8016), in accordance with some embodiments. Displaying a respective progress indicator without changing the respective current value indicated by the respective progress indicator, in accordance with an initial portion of a first user input, provides additional control options without cluttering the UI with additional displayed controls (e.g., additional displayed controls for checking and/or displaying a current value of a respective setting of the computer system, and/or additional displayed controls for enabling and/or adjusting the respective setting of the computer system).

In some embodiments, displaying the respective progress indicator in response to detecting the start of the first user input that meets the adjustment criteria, includes: in response to detecting an initial portion of the first user input, displaying the respective progress indicator with a respective progress bar that indicates a respective current value of a respective parameter corresponding to the respective progress indicator, without changing the respective current value of the respective parameter in accordance with the initial portion of the first user input. For example, the initial appearance of the respective progress indicator is displayed to indicate to the user both the type of parameter(s) can be adjusted by the first user input and the current value of the type of parameter that is currently controlled by the first user input, without actually adjusting the type of parameter based on the initial portion of the first user input, in accordance with some embodiments. For example, in FIG. 8B, in response to detecting activation of the button 8008 by the hand 7020 (e.g., and without changing a current value of a setting of the portable multifunction device 100), the portable multifunction device 100 displays the visual indicator 8015 with the user interface 8014 (e.g., which displays the current value for the level of immersion), and the user interface 8016 (e.g., without changing a current value for either the level of immersion which corresponds to the user interface 8014, or the current audio level which corresponds to the user interface 8016), in accordance with some embodiments. Displaying a respective progress indicator with a respective progress bar that indicates a respective current value of a respective parameter corresponding to the respective progress indicator, without changing the respective current value indicated by the respective progress indicator, in accordance with an initial portion of a first user input, provides additional control options without cluttering the UI with additional displayed controls (e.g., additional displayed controls for checking and/or displaying a current value of a respective setting of the computer system, and/or additional displayed controls for enabling and/or adjusting the respective setting of the computer system).

In some embodiments, while displaying the respective progress indicator with the respective progress bar that indicates the respective current value of the respective parameter corresponding to the respective progress indicator, the computer system detects a subsequent portion of the first user input (e.g., a button press, crown rotation, an air pinch input, an air tap input, a pinch input, a tap input, an air pinch and drag input, an air drag input, a drag input, a click and drag input, a gaze input, and/or other input) that follows the initial portion of the first user input; and in response to detecting the subsequent portion of the first user input, the computer system adjusts the respective current value of the respective parameter corresponding to the respective progress indicator in accordance with the subsequent portion of the first user input (e.g., adjusting by an amount, a rate of change, and/or in a direction that is based on the value(s) of one or more characteristics (e.g., movement speed, movement direction, movement distance, duration, intensity, and/or other characteristics) of the subsequent portion of the first user input). For example, if the respective progress indicator corresponds to the first audio output parameter, the computer adjusts the current value of the first audio output parameter in accordance with the magnitude and direction of the subsequent portion of the first user input; and if the respective progress indicator corresponds to the level of immersion, the computer system adjusts the current level of immersion in accordance with the magnitude and direction of the subsequent portion of the first user input. For example, in FIG. 8C, the portable multifunction device 100 detects activation of the button 8010 by the hand 7020 (e.g., a second portion of an input, with the first portion of the input including activation of the button 8008 in FIG. 8B), and in response, the portable multifunction device 100 adjusts (e.g., reduces) the current value for the level of immersion, in accordance with some embodiments. Adjusting the respective current value of the respective parameter corresponding to the respective progress indicator in accordance with a subsequent portion of the first user input, in response to detecting the subsequent portion of the first user input, and displaying the respective progress indicator (e.g., with a respective progress bar that indicates a respective current value of a respective parameter corresponding to the respective progress indicator), without changing the respective current value indicated by the respective progress indicator, in accordance with an initial portion of a first user input, in response to detecting an initial portion of the first user input, provides additional control options without cluttering the UI with additional displayed controls (e.g., additional displayed controls for checking and/or displaying a current value of a respective setting of the computer system, and/or additional displayed controls for enabling and/or adjusting the respective setting of the computer system).

In some embodiments, while displaying the respective progress indicator in the respective view of the three-dimensional environment, the computer system detects a change in viewpoint of the respective view of the three-dimensional environment from a first viewpoint to a second viewpoint different from the first viewpoint (e.g., due to movement of the user, and/or movement of the first display generation component in the physical environment); and in response to detecting the change in viewpoint of the respective view of the three-dimensional environment from the first viewpoint to the second viewpoint, the computer system ceases to display the respective progress indicator at a first position in the three-dimensional environment and displaying the respective progress indicator at a second position in the three-dimensional environment, wherein: the first position in the three-dimensional environment is visible in a first portion of a first view of the three-dimensional environment that corresponds to the first viewpoint, the second position in the three-dimensional environment is visible in a second portion of a second view of the three-dimensional environment that corresponds to the second viewpoint, and the first portion of the first view and the second portion of the second view both have a first spatial relationship to a viewport through which the three-dimensional environment is visible (e.g., the respective progress indicator is viewpoint locked after it is displayed). For example, as described with reference to FIG. 8C, in some embodiments, the user interface 8014 (e.g., corresponding to the level of immersion of the portable multifunction device 100) and the user interface 8016 (e.g., corresponding to the audio level of the portable multifunction device 100) are viewpoint-locked/head-locked such that the user interface 8014 and the user interface 8016 are always displayed with the same or substantially the same spatial relationship to a viewport (e.g., the display generation component 7100) of the computer system 101. Displaying the respective progress indicator at a second position in the three-dimensional environment that has the first spatial relationship to the viewport through which the three-dimensional environment is visible, in response to detecting a change in viewpoint of the three-dimensional environment (e.g., and the respective progress indicator has the same first spatial relationship to the viewport both before and after the change in viewpoint), automatically displays the respective progress indicator at an appropriate (e.g., and consistent) location (e.g., relative to the viewport) without requiring additional user inputs (e.g., additional user inputs to reposition the respective progress indicator, each time the viewpoint changes).

In some embodiments, displaying the respective progress indicator in the respective view of the three-dimensional environment includes displaying the respective progress indicator in proximity to (e.g., adjacent to, above, below, in front of, behind, with a preconfigured spatial relationship to, and/or within a threshold distance of) a first system indicator (e.g., the first indicator as described with respect to FIGS. 7A-7U, and with reference to FIG. 7B and FIG. 7F) that is associated with a first user interface object (e.g., the system function menu 7046 described with respect to FIGS. 7A-7U, or another system user interface or control user interface) that provides access to a first set of functions of the computer system (e.g., one or more system functions accessed through corresponding system spaces, as described above with reference to FIGS. 7G-71). In some embodiments, the first system indicator is viewpoint locked, and/or the first user interface object is environment-locked. In some embodiments, the first system indicator is displayed in response to detecting an attention of a user in a portion of the current view of the three-dimensional environment that has a first spatial relationship to the viewport. In some embodiments, the first user interface object is displayed in response to detecting a selection input while the user's attention is directed to the region in which the first system indicator is displayed. For example, in FIG. 8E, the user interface 8014 and the user interface 8016 are displayed in proximity to (e.g., below) the indicator 7042 (e.g., which is associated with the system function menu 7046, which is displayed immediately below the indicator 7042), in accordance with some embodiments. Displaying the respective progress indicator in the respective view of the three-dimensional environment and in proximity to a first system indicator that is associated with a first user interface object that provides access to a first set of functions of the computer system, automatically displays the respective progress indicator at an appropriate (e.g., and consistent) location (e.g., relative to the viewport, and/or alongside the first system indicator and/or the first user interface object) without requiring additional user inputs (e.g., additional user inputs to reposition the respective progress indicator, each time the viewpoint changes).

In some embodiments, the computer system displays, concurrently with the respective progress indicator, at least one of a first user interface object (e.g., the first user interface object described with respect to FIG. 7M, or another system user interface or control user interface) that provides access to a first set of functions of the computer system, and a first system indicator (e.g., the first indicator as described with respect to FIG. 7B and Figure F) that is associated with the first user interface object, in the respective view of the three-dimensional environment, wherein: the respective progress indicator is displayed at a first simulated depth relative to a viewpoint (e.g., the viewpoint of the user) corresponding to the respective view of the three-dimensional environment, the at least one of the first user interface object and the first system indicator is displayed at a second simulated depth relative to the viewpoint (e.g., the viewpoint of the user) corresponding to the respective view of the three-dimensional environment, and the first simulated depth is smaller than the second simulated depth (e.g., the respective progress indicator is displayed closer to the viewpoint than the first user interface object and/or the first system indicator). In some embodiments, the first user interface object and the first system indicator are displayed at different simulated depths that are both larger than the first simulated depth. In some embodiments, the first user interface object is displayed at a larger simulated depth than the first system indicator (e.g., the first user interface object is further away from the viewpoint of the user than the first system indicator). In some embodiments, the first user interface object is displayed at a smaller simulated depth than the first system indicator (e.g., the first user interface object is closer to the viewpoint of the user than the first system indicator). For example, as described with reference to FIG. 8E, in some embodiments, the user interface 8014 and the user 8016 are displayed overlapping the system function menu 7046 (e.g., between the viewpoint of the user 7002 and the system function menu 7046, such that the user interface 8014 and the user interface 8016 appear closer to the viewpoint of the user 7002, than the system function menu 7046), and/or in some embodiments, the user interface 8014 and the user interface 8016 are displayed closer to the viewpoint of the user 7002, but the user interface 8014 and the user interface 8016 do not overlap or occlude the system function menu 7046 and/or the indicator 7042. Concurrently displaying the respective progress indicator with at least one of a first user interface object and a first system indicator, wherein the respective progress indicator is displayed at a first simulated depth relative to a viewpoint, and the first user interface object and/or the first system indicator are displayed with a second simulated depth that is larger than the first simulated depth, visually emphasizes appropriate content automatically, without requiring additional user inputs (e.g., additional user inputs to bring the respective progress indicator to a position at which it is not obscured, occluded, and/or overlaid by the first user interface object and/or the first system indicator, when the user is adjusting a setting of the computer system (e.g., via, and/or corresponding to, the respective progress indicator)).

In some embodiments, the computer system displays, concurrently with the respective progress indicator, a first user interface object (e.g., the first user interface object 7046 and/or the indicator 7042 associated with the first user interface object 7046, described with respect to FIG. 7G, or another system user interface or control user interface) that provides access to a first set of functions of the computer system, in the respective view of the three-dimensional environment. In some embodiments, the respective progress indicator is displayed at a first simulated depth relative to a viewpoint corresponding to the respective view of the three-dimensional environment, and the first user interface object is displayed at a second simulated depth relative to the viewpoint corresponding to the respective view of the three-dimensional environment, where the first simulated depth is smaller than the second simulated depth (e.g., the first user interface object is further away from the viewpoint of the user than the respective progress indicator, optionally, visually obscured by the respective progress indicator, or not visually obscured by the respective progress indicator). While concurrently displaying the respective progress indicator and the first user interface object, the computer system disables interaction with the first user interface object using one or more types of user inputs (e.g., gaze, air gesture, direct manipulation input, and/or other selection input, activation input, and/or other types of inputs), wherein one or more types of user inputs are configured to interact with the first user interface object when the first user interface object is displayed without the respective progress indicator. For example, in FIG. 8G, the portable multifunction device 100 does not display the system function menu 7046 (e.g., even though the user's attention 7010 is directed to the indicator 7042), since the portable multifunction device 100 is already displaying the user interface 8014 and the user interface 8016 (e.g., and the user is already adjusting, or preparing to adjust, the level of immersion of the portable multifunction device 100). In another example, if the system function menu 7406 is already displayed (e.g., at a position that is farther away from the viewpoint than the respective progress indicator), the portable multifunction device 100 does not respond to user input and/or gaze directed to the system function menu 7406, since the portable multifunction device 100 is already displaying the user interface 8014 and the user interface 8016 (e.g., and the user is already adjusting, or preparing to adjust, the level of immersion of the portable multifunction device 100), in accordance with some embodiments. Disabling interaction with the first user interface object using one or more types of user inputs, while concurrently displaying the respective progress indicator with the first user interface object, automatically disables specific functions of the computer system to avoid accidental inputs and/or changes to settings of the computer system (e.g., such that a user that is adjusting a respective setting of the computer system via, and/or corresponding to, the respective progress indicator, does not accidentally adjusting other settings accessible via the first user interface object, and/or accidentally perform other functions corresponding to the first user interface object).

In some embodiments, while displaying the respective progress indicator in the respective view of the three-dimensional environment, the computer system detects that dismissal criteria are met, wherein the dismissal criteria are met without requiring detection of a user input that corresponds to a request to dismiss the respective progress indicator (e.g., the dismissal criteria are met when there has been a period of inactivity with respect to the respective progress indicator after the first user input is no longer detected, when the user's attention is not directed to the respective progress indicator for at least a threshold amount of time, and/or other indications that the user is finished with interacting with the respective progress indicator); and in response to detecting that the dismissal criteria are met, the computer system ceases to display the respective progress indicator in the respective view of the three-dimensional environment (e.g., automatically, without requiring detection of a user's input that corresponds to a request to close or otherwise dismiss the respective progress indicator from the respective view of the three-dimensional environment). For example, as described with reference to FIG. 8R, in some embodiments, the user interface 8014 and the user interface 8016 cease to be displayed after the user 7002 ceases to adjust the respective setting (e.g., regardless of whether the respective setting is the level of immersion or the audio level for the computer system 101), the user interface 8014 and the user interface 8016 cease to be displayed after a threshold amount of time (e.g., 1 second, 2 seconds, 5 seconds, 10 seconds, or 15 seconds) has elapsed since the user 7002 last adjusted the respective setting, and/or the user interface 8014 and the user interface 8016 cease to be displayed if the user's attention 7010 is not directed to either the user interface 8014 or the user interface 8016 (e.g., or a combination of two or more of the listed possibilities). Ceasing to display the respective progress indicator in the respective view of the three-dimensional environment, in response to detecting that the dismissal criteria are met (e.g., without detecting a user input that corresponds to a request to dismiss the respective progress indicator), automatically ceases to display the respective progress indicator when appropriate, without requiring additional user inputs (e.g., a user input that corresponds to a request to dismiss the respective progress indicator).

In some embodiments, detecting that the dismissal criteria are met includes detecting that the first user input is no longer detected for at least a threshold amount of time (e.g., the actuation or movement of the first user input has stopped for more than a threshold amount of time, and/or the hand that provided the first user input is no longer detected on the input device of the computer system). For example, as described with reference to FIG. 8R, in some embodiments, the user interface 8014 and the user interface 8016 cease to be displayed after a threshold amount of time (e.g., 1 second, 2 seconds, 5 seconds, 10 seconds, or 15 seconds) has elapsed since the user 7002 last adjusted the respective setting. Ceasing to display the respective progress indicator in the respective view of the three-dimensional environment, in response to detecting that the first input is no longer detected for at least a threshold amount of time (e.g., without detecting a user input that corresponds to a request to dismiss the respective progress indicator), automatically ceases to display the respective progress indicator when appropriate, without requiring additional user inputs (e.g., a user input that corresponds to a request to dismiss the respective progress indicator).

In some embodiments, detecting that the dismissal criteria are met includes detecting that user's attention (e.g., gaze, or a gaze substitute such as a hand pointing gesture that indicates a portion of the three-dimensional environment with which the user intends to interact) is no longer directed to the respective progress indicator for at least a threshold amount of time (e.g., the attention of the user has moved away from the respective progress indicator for at least a threshold amount of time, the user's attention is directed to another user interface object in the respective view, and/or the user is interacting with another user interface object in the respective view). For example, as described with reference to FIG. 8R, in some embodiments, the user interface 8014 and the user interface 8016 cease to be displayed if the user's attention 7010 is not directed to either the user interface 8014 or the user interface 8016 (e.g., or a combination of two or more of the listed possibilities). Ceasing to display the respective progress indicator in the respective view of the three-dimensional environment, in response to detecting that the user's attention is no longer directed to the respective progress indicator for at least a threshold amount of time (e.g., and without detecting a user input that corresponds to a request to dismiss the respective progress indicator), automatically ceases to display the respective progress indicator when appropriate, without requiring additional user inputs (e.g., a user input that corresponds to a request to dismiss the respective progress indicator).

In some embodiments, detecting that the dismissal criteria are met includes detecting that the first user input is no longer detected for at least a first threshold amount of time (e.g., the actuation or movement of the first user input has stopped for more than a first threshold amount of time, and/or the hand that provided the first user input is no longer detected on the input device of the computer system) and detecting that user's attention (e.g., gaze, or a gaze substitute such as a hand pointing gesture that indicates a portion of the three-dimensional environment with which the user intends to interact) is no longer directed to the respective progress indicator for at least a second threshold amount of time. In some embodiments, the dismissal criteria are not met if the first user input is still detected and/or the user's attention is still directed to the respective progress indicator; and in accordance with a determination that the dismissal criteria are not met, the computer system continues to display the respective progress indicator in the respective view of the three-dimensional environment. For example, as described with reference to FIG. 8R, in some embodiments, the user interface 8014 and the user interface 8016 cease to be displayed after (e.g., a first threshold amount of time has elapsed since) the user 7002 ceases to adjust the respective setting and the user's attention 7010 is no longer directed to the user interface 8014 or the user interface 8016 (e.g., for at least a second threshold amount of time, which is optionally the same as, or different from, the first threshold amount of time) (e.g., but not if the user 7002 continues to adjust the respective setting while the user's attention 7010 is no longer directed to the user interface 8014 or the user interface 8016, and not if the user 7002 ceases to adjust the respective setting but the user's attention 7010 is still directed to the user interface 8014 or the user interface 8016). Ceasing to display the respective progress indicator in the respective view of the three-dimensional environment, in response to detecting that the first user input is no longer detected for at least a first threshold amount of time and that the user's attention is no longer directed to the respective progress indicator for at least a second threshold amount of time (e.g., without detecting a user input that corresponds to a request to dismiss the respective progress indicator), automatically ceases to display the respective progress indicator when appropriate, without requiring additional user inputs (e.g., a user input that corresponds to a request to dismiss the respective progress indicator).

In some embodiments, while displaying the respective progress indicator in the respective view of the three-dimensional environment and adjusting the respective current value for at least one of the first audio output parameter and the level of immersion in accordance with a first portion of the first user input (e.g., adjusting by an amount, a rate of change, and/or in a direction that is based on the value(s) of one or more characteristics (e.g., movement speed, movement direction, movement distance, duration, intensity, and/or other characteristics) of the first portion of the first user input), the computer system detects that an attention (e.g., based on gaze, or based on a gaze substitute such as a hand pointing gesture that indicates a portion of the three-dimensional environment with which the user intends to interact) of the user has moved away from the respective progress indicator; after the attention of the user has moved away from the respective progress indicator and while the attention of the user remains away from the respective progress indicator, the computer system detects a second portion of the first user input (e.g., a button press, crown rotation, an air pinch input, an air tap input, a pinch input, a tap input, an air pinch and drag input, an air drag input, a drag input, a click and drag input, a gaze input, and/or other input) following the first portion of the first user input; and in response to detecting the second portion of the first user input, the computer system continues to adjust the respective current value for the at least one of the first audio output parameter and the level of immersion in accordance with the second portion of the first user input (e.g., adjusting by an amount, a rate of change, and/or in a direction that is based on the value(s) of one or more characteristics (e.g., movement speed, movement direction, movement distance, duration, intensity, and/or other characteristics) of the second portion of the first user input). For example, in some embodiments, after the computer system has started adjusting one of the first audio output parameter or the level of immersion in response to a portion of the first user input, the computer system continues to adjust the same parameter in accordance with subsequent portions of the first user input without requiring the user to maintain the user's attention on the respective progress indicator. For example, in 8K, the portable multifunction device 100 continues to adjust the current audio level of the portable multifunction device 100, even though the user's attention 7010 is no longer directed to the user interface 8016 and instead is directed to the user affordance 8014 (e.g., which corresponds to the level of immersion of the portable multifunction device 100), in accordance with some embodiments. Continuing to adjust the respective current value for the at least one of the first audio parameter and the level of immersion, in accordance with a second portion of the first user input, and in response to detecting the second portion of the first user input, after the attention of the user has moved away from the respective progress indicator and while the attention of the user remains away from the respective progress indicator, minimizes the risk of unintentional adjustment of settings other than the respective current setting being adjusted (e.g., in case the user's attention is diverted and/or wanders while the user is making adjustments to the respective setting), which eliminates the need for the user to perform additional user inputs to undo or reverse the unintentional adjustments.

In some embodiments, while adjusting a respective current value for a first progress indicator in accordance with the first user input (e.g., adjusting by an amount, a rate of change, and/or in a direction that is based on the value(s) of one or more characteristics (e.g., movement speed, movement direction, movement distance, duration, intensity, and/or other characteristics) of the first user input), while concurrently displaying the first progress indicator and a second progress indicator in the respective view of the three-dimensional environment, wherein the first progress indicator and the second progress indicator respectively correspond to respective ones of the first audio output parameter and the level of immersion, the computer system detects that an attention (e.g., based on gaze, or based on a gaze substitute such as a hand pointing gesture that indicates a portion of the three-dimensional environment with which the user intends to interact) of a user has moved to the second progress indicator (e.g., after having moved away from the first progress indicator, and/or while the adjustment to the value corresponding to the first progress indicator is continuing in accordance with the first user input without the attention of the user being maintained on the first progress indicator); and in response to detecting that the attention of the user has moved to the second progress indicator, the computer system continues to adjust the respective current value for the first progress indicator in accordance with the first user input (e.g., adjusting by an amount, a rate of change, and/or in a direction that is based on the value(s) of one or more characteristics (e.g., movement speed, movement direction, movement distance, duration, intensity, and/or other characteristics) of the first user input), until a pause in the first user input is detected (e.g., the current value for the first progress indicator is not changed and/or adjusted for a threshold period of time, such as 1 second, 2 seconds, 5 seconds, 10 seconds, or 15 seconds); and in response to detecting the pause in the first user input, the computer system ceases to adjust the respective current value for the first progress indicator in accordance with the first user input (e.g., ceasing to change the respective current value, and/or ceasing to adjust the respective current value by an amount and/or in a direction that is based on the value(s) of one or more characteristics (e.g., movement speed, movement direction, movement distance, duration, intensity, and/or other characteristics) of the first user input). In some embodiments, the computer system switches input focus from the first progress indicator to the second progress indicator, and adjusts the respective current value for the second progress indicator in accordance with a subsequent portion of the first user input if and when the first user input continues. In some embodiments, the computer system does not require that the user's attention is maintained on the second progress indicator in order to continue adjustment of the respective current value for the second progress indicator in accordance with subsequent portions of the first user input. For example, in FIG. 8L, the current audio level of the portable multifunction device 100 is no longer being adjusted (e.g., as it was in FIG. 8K), as shown by the buttons 8010 and 8012, which are not activated by the hand 7020. The portable multifunction device 100 ceases to adjust the current audio level of the portable multifunction device 100, and enables the current level of immersion for adjustment (e.g., because the user's attention 7010 is directed to the user interface 8014), in accordance with some embodiments. Continuing to adjust the respective current value for the first progress indicator in accordance with the first user input, until a pause in the first user input is detected, and ceasing to adjust the respective current value for the first progress indicator in accordance with the first user input, in response to detecting a pause in the first user input, minimizes the risk of unintentional adjustment of settings other than the respective current setting being adjusted (e.g., in case the user's attention is diverted and/or wanders while the user is making adjustments to the respective setting), which eliminates the need for the user to perform additional user inputs to undo or reverse the unintentional adjustments.

In some embodiments, detecting the first user input includes detecting a movement associated with a hardware control of the computer system (e.g., rotation of a digital crown, movement of a slider control, and/or other movement of a hardware control or movement relative to a position and/or touch sensor). In some embodiments, the movement associated with the hardware control includes movement that is detected via physical contact with the hardware control and exertion of force by a portion of a body (e.g., hand, finger, or other body parts) of a user on the hardware control. For example, in FIGS. 8A-8R, the first user input includes activation of hardware controls (e.g., the buttons 8008, 8010, and/or 8012) of the portable multifunction device 100, in accordance with some embodiments. Adjusting a first audio output parameter for audio outputs in accordance with a first user input that includes movement associated with a hardware control and meets adjustment criteria (e.g., while maintaining a first level of immersion of a plurality of levels of immersion), and in accordance with a determination that the computer system was generating audio outputs at a time when the start of the first user input was detected, and adjusting a current level of immersion in accordance with the first user input, and in accordance with a determination that the computer system was not generating audio outputs at a time when the start of the first user input was detected, automatically adjusts a contextually-relevant setting of the computer system without requiring additional user input (e.g., additional user inputs to find and/or select a relevant setting of the computer system for adjustment).

In some embodiments, adjusting a current value of a respective parameter (e.g., one of the current level of immersion and the current value for the first audio output parameter) in accordance with the first user input includes: in accordance with a determination that the first user input includes movement in a first movement direction (e.g., that includes a first amount of movement associated with the hardware control in the first movement direction, and/or that includes a first amount of movement relative to a reference point or surface by the user's hand or input object), adjusting the current value of the respective parameter (e.g., one of the current level of immersion and the current value for the first audio output parameter) in a first adjustment direction that corresponds to the first direction (e.g., and by a first adjustment amount that corresponds to the first amount of movement, and/or that corresponds to the value of another characteristic (e.g., speed, or duration) of the movement); and in accordance with a determination that the first user input includes movement in a second movement direction that is different from the first movement direction (e.g., a second amount of movement associated with the hardware control, and/or that includes a second amount of movement relative to a reference point or surface by the user's hand or input object, in the second movement direction), adjusting the current value of the respective parameter (e.g., one of the current level of immersion and the current value for the first audio output parameter) in a second adjustment direction that corresponds to the second movement direction (e.g., and by a second adjustment amount that corresponds to the second amount of movement, and/or that corresponds to the value of another characteristic (e.g., speed, or duration) of the movement), wherein the second adjustment direction is different from the first adjustment direction (e.g., the first direction is an increasing direction, and the second direction is a decreasing direction, or vice versa). For example, as described with reference to FIG. 8B, in some embodiments, the computer system 101 includes a rotatable input mechanism (e.g., a physical crown), and the functionality of the button 8010 and the button 8012 illustrated in FIGS. 8A-8R is instead determined by a direction of rotation of the rotatable input mechanism (e.g., rotating the rotatable input mechanism in a first direction increases a value for the setting, and rotating the rotatable input mechanism in an opposite direction decreases the value for the setting). Optionally, a speed and/or magnitude of the rotation controls by how much the value for the setting is increased and/or decreased (e.g., faster and/or larger rotations increase and/or decrease the value by a larger amount, and slower and/or smaller rotations increase and/or decrease the value by a smaller amount). Adjusting the current value of the respective parameter in a first adjustment direction that correspond to a first direction, in accordance with a determination that the first user input includes movement in the first movement direction, and adjusting the current value of the respective parameter in a second adjustment direction, different from the first adjustment direction, that corresponds to a second movement direction that is different from the first movement direction, in accordance with a determination that the first user input includes movement in the second movement direction, provides additional control options without cluttering the UI with additional displayed controls (e.g., additional displayed controls for increasing and/or decreasing a current value for the respective parameter).

In some embodiments, adjusting the current value of a respective parameter (e.g., one of the current level of immersion and the current value for the first audio output parameter) in accordance with the first user input includes: in accordance with a determination that the first user input includes a first magnitude for a first characteristic of movement (e.g., speed, distance, and/or duration) associated with the hardware control, adjusting the current value of the respective parameter (e.g., one of the current level of immersion and the current value for the first audio output parameter) by a first adjustment amount that corresponds to the first magnitude for the first characteristic of movement (e.g., in a respective adjustment direction that corresponds to the direction of the movement, or in a system selected direction); and in accordance with a determination that the first user input includes a second magnitude for the first characteristic of movement associated with the hardware control that is different from the first magnitude for the first characteristic of movement associated with the hardware control, adjusting the current value of the respective parameter (e.g., one of the current level of immersion and the current value for the first audio output parameter) by a second adjustment amount that corresponds to the second magnitude for the first characteristic of movement, wherein the second adjustment amount is different from the first adjustment amount (e.g., in a respective adjustment direction that corresponds to the direction of the movement, or in a system selected direction). For example, as described with reference to FIG. 8B, in some embodiments, the computer system 101 includes a rotatable input mechanism (e.g., a physical crown), and the functionality of the button 8010 and the button 8012 illustrated in FIGS. 8A-8R is instead determined by a direction of rotation of the rotatable input mechanism (e.g., rotating the rotatable input mechanism in a first direction increases a value for the setting, and rotating the rotatable input mechanism in an opposite direction decreases the value for the setting). Optionally, a speed and/or magnitude of the rotation controls by how much the value for the setting is increased and/or decreased (e.g., faster and/or larger rotations increase and/or decrease the value by a larger amount, and slower and/or smaller rotations increase and/or decrease the value by a smaller amount). Adjusting the current value of the respective parameter by a first adjustment amount that corresponds to the first magnitude for the first characteristic of movement, in accordance with a determination that the first user input includes a first magnitude for a first characteristic of movement associated with the hardware control, and adjusting the current value of the respective parameter by a second adjustment amount, different from the first adjustment amount, that corresponds to the second magnitude for the first characteristic of movement, in accordance with a determination that the first user input includes a second magnitude for the first characteristic of movement associated with the hardware control that is different from the first magnitude for the first characteristic of movement associated with the hardware control, provides additional control options without cluttering the UI with additional displayed controls (e.g., additional displayed controls for increasing and/or decreasing a current value for the respective parameter).

In some embodiments, adjusting the current value of a respective parameter (e.g., one of the current level of immersion and the current value for the first audio output parameter) in accordance with the first user input includes: in accordance with a determination that the first user input includes a first magnitude for a first characteristic of movement (e.g., speed, distance, and/or duration) associated with the hardware control, the computer system adjusts the current value of the respective parameter (e.g., one of the current level of immersion and the current value for the first audio output parameter) at a first adjustment speed that corresponds to the first magnitude for the first characteristic of movement (e.g., in a respective adjustment direction that corresponds to the direction of the movement, or in a system selected direction); and in accordance with a determination that the first user input includes a second magnitude for the first characteristic of movement associated with the hardware control that is different from the first magnitude for the first characteristic of movement, the computer system adjusts the current value of the respective parameter (e.g., one of the current level of immersion and the current value for the first audio output parameter) at a second adjustment speed that corresponds to the second magnitude for the first characteristic of movement, wherein the second adjustment speed is different from the first adjustment speed (e.g., in a respective adjustment direction that corresponds to the direction of the movement, or in a system selected direction). For example, as described with reference to FIG. 8B, in some embodiments, the computer system 101 includes a rotatable input mechanism (e.g., a physical crown), and the functionality of the button 8010 and the button 8012 illustrated in FIGS. 8A-8R is instead determined by a direction of rotation of the rotatable input mechanism (e.g., rotating the rotatable input mechanism in a first direction increases a value for the setting, and rotating the rotatable input mechanism in an opposite direction decreases the value for the setting). Optionally, a speed and/or magnitude of the rotation controls by how fast the value for the setting is increased and/or decreased (e.g., faster and/or larger rotations increase and/or decrease the value with a faster rate of change, and slower and/or smaller rotations increase and/or decrease the value by a slower rate of change). Adjusting the current value of the respective parameter by a first adjustment amount that corresponds to the first magnitude for the first characteristic of movement, in accordance with a determination that the first user input includes a first magnitude for a first characteristic of movement associated with the hardware control, and adjusting the current value of the respective parameter by a second adjustment amount, different from the first adjustment amount, that corresponds to the second magnitude for the first characteristic of movement, in accordance with a determination that the first user input includes a second magnitude for the first characteristic of movement associated with the hardware control that is different from the first magnitude for the first characteristic of movement associated with the hardware control, provides additional control options without cluttering the UI with additional displayed controls (e.g., additional displayed controls for increasing and/or decreasing a current value for the respective parameter).

In some embodiments, when adjusting a respective parameter of the current level of immersion and the current value for the first audio output parameter in accordance with the first user input (e.g., adjusting by an amount, a rate of change, and/or in a direction that is based on the value(s) of one or more characteristics (e.g., movement speed, movement direction, movement distance, duration, intensity, and/or other characteristics) of the first user input) and after an end value (e.g., a steady state maximum value or a steady state minimum value) of a respective value range (e.g., the full allowable range, or a sub-range of multiple discrete sub-ranges in which adjustment is can be continuous) of the respective parameter (e.g., one of the level of immersion and the first audio output parameter) has been reached, the computer system detects a respective input (e.g., a button press, crown rotation, an air pinch input, an air tap input, a pinch input, a tap input, an air pinch and drag input, an air drag input, a drag input, a click and drag input, a gaze input, and/or other input) corresponding to a request for continued adjustment of the current value of the respective parameter; and in response to detecting the respective input corresponding to the request for continued adjustment of the current value of the respective parameter after the end value of the respective value range of the respective parameter (e.g., one of the level of immersion and the first audio output parameter) has been reached, the computer system provides feedback responsive to the respective input (e.g., responsive to a direction, speed, and/or magnitude of the respective input) (e.g., visual feedback or non-visual feedback such as audio and or tactile or haptic feedback indicating that permanently setting the current value of the respective parameter (one of the level of immersion and the first audio output parameter) beyond the respective value range is not possible, is not available, and/or is not permitted) (e.g., for example, as described with reference to FIG. 8B, if the portable multifunction device 100 detects a user input attempting to increase a current level of immersion beyond the maximum level of immersion, the portable multifunction device 100 displays visual feedback (e.g., the black bar of the visual indicator 8015 expanding beyond the boundaries of the visual indicator 8015, around the edge of the user interface 8014, and towards the bottom of the user interface 8014), but once the user input terminates (e.g., the user ceases to attempt to increase the level of immersion), the portable multifunction device 100 ceases to display the visual indicator (e.g., the black bar returns to the bounds of the visual indicator 8015, where it completely occupies the entirety of the visual indicator 8015 to indicate that the current level of immersion is the maximum level of immersion) and the portable multifunction device 100 maintains the maximum level of immersion); and after providing the feedback responsive to the respective input detecting an end of the respective input (e.g., an end of rotation of the digital crown, a slowing of rotation of the digital crown below a threshold speed that is greater than zero, a liftoff of a finger from the digital crown, a lift off from a button, a depinch input, or a predetermined time period where further inputs are no longer received); and in response to detecting the end of the respective input, the computer system ceases to provide the feedback (e.g., ceasing to display the visual feedback, ending audio feedback, and/or ending haptic or tactile output) responsive to the respective input and the computer system sets the current value of the respective parameter to the end value of the respective value range of the respective parameter (e.g., restoring the current value of the respective parameter to the end value of the respective value range if the current value of the parameter was adjusted above the end value, or forgoing changing the current value of the respective parameter beyond the end value of the respective value range). In some embodiments, the visual effect corresponding to feedback responsive to the respective input includes a visual change applied to the respective progress indicator of the value that is being adjusted (e.g., increasing the size of the progress indicator above its normal steady state size, and/or extending the progress bar beyond its normal steady state dimension), as the first user input corresponds to a request to change the value beyond the end value of the respective value range. After the end of the first user input is detected, the computer system removes the visual changes applied during the portion of the first user input that is detected after the end value of the respective parameter has been reached (e.g., restores the increased size, restores the length of the progress bar, and/or removes other visual changes and ceases to generate other types of non-visual feedback regarding that the end value has been reached), and optionally, displays the progress indicator showing the current value of the respective parameter at the end value of the respective value range, in accordance with some embodiments. In some embodiments, the visual effect includes a visual change applied to the three-dimensional environment (e.g., spatial extent of the virtual environment is expanded beyond its steady state maximum extent, and/or the spatial extent of the passthrough content is expanded beyond its steady state maximum extent) when the value that is being adjusted is the level of immersion, as the first user input corresponds to a request to change the value beyond the end value of the respective value range. After the end of the first user input is detected, the computer system removes the visual changes applied during the portion of the first user input that is detected after the end value of the respective parameter has been reached (e.g., restores the spatial extent of the virtual environment and/or the spatial extent of the passthrough content to its steady state maximum or minimum extent, and ceases to generate other types of non-visual feedback regarding that the end value has been reached), and, optionally, displays the progress indicator showing the current value of the respective parameter at the end value of the respective value range, in accordance with some embodiments. In some embodiments, the computer system provides a tactile output to indicate that the end value of the value range has been reached. In some embodiments, the respective range of the respective parameter has a first end value (e.g., a maximum value) and a second end value (e.g., a minimum value), and the computer system provides a first type of feedback responsive to the respective input when the respective input is detected when the first end value of the respective range has been reached, and the computer system provides a second type of feedback (e.g., optionally different from the first type of feedback) responsive to the respective input when the respective input is detected when the second end value of the respective range has been reached. For example, with reference to FIG. 8B, if the portable multifunction device 100 detects a user input attempting to increase a current level of immersion beyond the maximum level of immersion, the portable multifunction device 100 displays visual feedback (e.g., the visual indicator 8015 is displayed with a first color). If the portable multifunction device 100 detects a user input attempting to decrease a current level of immersion beyond the minimum level of immersion, the portable multifunction device 100 displays different visual feedback (e.g., the visual indicator is displayed with a second color, different from the first color). In some embodiments, the computer system forgoes providing feedback responsive to the respective input, if the respective input is detected before (e.g., and/or while) an end value of the respective range of the respective parameter is reached. For example, as described with reference to FIG. 8B, in some embodiments, the portable multifunction device 100 provides feedback (e.g., visual feedback, audio feedback, and/or haptic feedback) when the portable multifunction device 100 detects that a current value for a setting is the maximum (e.g., or minimum) value for that setting, and the portable multifunction device 100 detects a user input to further increase (e.g., or decrease) the current value for the setting. Providing feedback responsive to a respective input corresponding to a request for continued adjustment of the current value of a respective parameter, and after an end value of a respective value range of the respective parameter has been reached, and ceasing to provide the feedback responsive to the respective input and setting the current value for the respective parameter to the end value of the respective value range of the respective parameter, in response to detecting the end of the respective input, provides improved visual feedback to the user (e.g., improved visual feedback that the respective parameter has been adjusted to a maximum or minimum value and that further adjustment beyond the maximum/minimum value is not possible).

In some embodiments, aspects/operations of methods 9000, 11000, 12000, and/or 13000 may be interchanged, substituted, and/or added between these methods. For example, the first user interface object (e.g., system function menu) of method 10000 is also available for display and interaction, while (or in place of) adjusting a relevant setting in the method 9000, 11000, 12000, or 13000. For brevity, these details are not repeated here.

FIG. 11 is a flow diagram of an exemplary method 11000 for displaying a menu that includes plurality of options for adjusting settings of a computer system and selecting between options of the plurality of options, in accordance with some embodiments. In some embodiments, method 11000 is performed at a computer system (e.g., computer system 101 in FIG. 1A) that is in communication with a display generation component (e.g., display generation component 120 in FIGS. 1A, 3, and 4, and/or display generation component 7100 in FIGS. 7A and 8A, and/or display generation component 7100a in FIG. 7V) (e.g., a heads-up display, a display, a touchscreen, a projector, a head mounted display (HMD), an inner display of a two-sided display generation component, a display on a handheld device, a display on a wearable device, or another type of display) and a rotatable input device (e.g., a button, a crown, or another physical input mechanism) and optionally one or more input devices (e.g., cameras (e.g., color sensors, infrared sensors, and other depth-sensing cameras) (e.g., that point downward at a user's hand and/or forward from the user's head), touch-sensors, touch-sensitive surfaces, proximity sensors, motion sensors, buttons, joysticks, and/or other sensors and input devices). In some embodiments, the method 11000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 11000 are, optionally, combined and/or the order of some operations is, optionally, changed.

The method 11000 is a method of displaying a menu that includes a plurality of options for adjusting settings of a computer system and selecting between options of the plurality of options, in accordance with some embodiments, Displaying a menu that includes a plurality of options for adjusting settings of the computer system and selecting a first option of the plurality of options for adjusting settings of the computer system, in response to detecting a first user input of a first type, and selecting a second option, different from the first option, of the plurality of options for adjusting settings of the computer system, in response to detecting a second user input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

While a respective view of an environment (e.g., a two dimensional environment or user interface or a three-dimensional environment that includes one or more virtual objects and optionally a representation of a virtual environment or a representation of a physical environment) is visible (e.g., with a virtual environment corresponding to the three-dimensional environment having a first level of immersion of a plurality of levels of immersion) (e.g., to a user), via the display generation component (e.g., the view that is visible via the display generation component 7100a in FIG. 8T), the computer system detects (11002), via the rotatable input device, a first user input of a first type (e.g., a user input that rotates the rotatable input device, a user input that activates a button of the rotatable input device, or a user input that activates another physical mechanism of the rotatable input device) (e.g., the rotation of the digital crown 703 in FIG. 8T). In response to detecting the first user input of the first type, the computer system displays (11004) a menu that includes a plurality of options for adjusting settings (e.g., a volume, a level of immersion, a level of zoom, and/or a display brightness) of the computer system, and selects a first option of the plurality of options for adjusting settings of the computer system (e.g., the first option of the plurality of options is a default option that is enabled for adjustment when the menu is initially displayed); In some embodiments, the plurality of options includes a plurality of user interface elements, wherein a respective user interface element corresponds to (e.g., is activatable to adjust) a respective setting of the computer system (e.g., the computer system 101 displays a menu that includes the user interface 8014, the user interface 8038, and the user interface 8016 in FIG. 8T). While displaying the menu that includes the plurality of options for adjusting settings of the computer system, the computer system detects (11006), via the rotatable input device, a second user input of a second type (e.g., activation of a button of the digital crown 703 in FIG. 8W), wherein the second type is different from the first type (e.g., the first user input is a user input that rotates the rotatable input device, and the second user input is a user input that activates a button of the rotatable input device such as with a press, long press, multiple press or other input, or vice versa). In response to detecting the second user input of the second type, the computer system selects (11008) a second option, different from the first option, of the plurality of options for adjusting settings of the computer system (e.g., and maintaining display of the menu that includes the plurality of options for adjusting settings of the computer system) (e.g., in FIG. 8W, the computer system 101 selects the user interface 8038, which is different from the user interface 8014 which was previously selected in FIG. 8V, prior to detecting the activation of the button of the digital crown 703 in FIG. 8W). In some embodiments, after selecting the second option of the plurality of options for adjusting settings of the computer system, and while displaying or continuing to display \the menu that includes the plurality of options for adjusting settings of the computer system, the computer system detects a third user input of the second type. In response to detecting the third user input of the second type, the computer system selects a third option, different from the first option and the second option, of the plurality of options for adjusting settings of the computer system.

In some embodiments, the plurality of options for adjusting settings of the computer system includes an option for adjusting a volume of the computer system. In some embodiments, in accordance with a determination that the computer system is generating audio outputs (e.g., when the first user input is detected), the displayed plurality of options for adjusting settings of the computer system includes the option for adjusting the volume, and in accordance with a determination that the computer system is not generating audio outputs (e.g., when the first user input is detected), the displayed plurality of options for adjusting settings of the computer system does not include the option for adjusting the volume. In some embodiments, as described above with reference to FIGS. 8A-8R, in response to detecting the first user input and in accordance with a determination that the computer system was generating audio outputs at the time when (e.g., a start of) the first user input was detected, the computer system displays the menu that includes the plurality of options for adjusting settings of the computer system, including the option for adjusting the volume, and the computer system selects the option for adjusting the volume of the computer system (e.g., the option for adjusting the volume of the computer system is the first option of the plurality of options for adjusting settings of the computer system). In some embodiments, in response to detecting the first user input and in accordance with a determination that the computer system was not generating audio outputs at the time when the first user input was detected, the computer system displays the menu that includes the plurality of options for adjusting settings of the computer system, including the option for adjusting the volume, but the computer system does not select the option for adjusting the volume of the computer system (e.g., the option for adjusting the volume of the computer system is not the first option of the plurality of options for adjusting settings of the computer system).

For example, in FIGS. 8AJ-8AH, the computer system 101 displays the user interface 8016 (e.g., corresponding to a volume setting of the computer system 101), and a volume setting of the computer system 101 is adjusted while the user interface 8016 is selected. Displaying a menu that includes a plurality of options for adjusting settings of the computer system, including an option for adjusting a volume of the computer system, and selecting a first option of the plurality of options for adjusting settings of the computer system, in response to detecting a first user input of a first type, and selecting a second option, different from the first option, of the plurality of options for adjusting settings of the computer system, in response to detecting a second user input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, the plurality of options for adjusting settings of the computer system includes an option for adjusting a level of immersion (e.g., a level of immersion that includes an associated degree to which virtual content is displayed by the computer system, as described herein with reference to different levels of immersion) of the computer system. In some embodiments, the environment is a virtual environment that corresponds to the three-dimensional environment, and the virtual environment has a first level of immersion, of a plurality of levels of immersion. Adjusting the level of immersion of the computer system includes adjusting the level of immersion from the first level of immersion to a second level of immersion, of the plurality of levels of immersion, that is different from the first level of immersion. In some embodiments, as described above with reference to FIGS. 8A-8R, in response to detecting the first user input and in accordance with a determination that the computer system was not generating audio outputs at the time when (e.g., a start of) the first user input was detected, the computer system displays the menu that includes the plurality of options for adjusting settings of the computer system, and the computer system selects the option for adjusting the level of immersion of the computer system (e.g., the option for adjusting the level of immersion of the computer system is the first option of the plurality of options for adjusting settings of the computer system).

For example, in FIGS. 8T-8V, the computer system 101 displays the user interface 8014 (e.g., corresponding to a level of immersion setting of the computer system 101), and a level of immersion of the computer system 101 is adjusted while the user interface 8014 is selected. Displaying a menu that includes a plurality of options for adjusting settings of the computer system, including an option for adjusting a level of immersion of the computer system, and selecting a first option of the plurality of options for adjusting settings of the computer system, in response to detecting a first user input of a first type, and selecting a second option, different from the first option, of the plurality of options for adjusting settings of the computer system, in response to detecting a second user input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, the plurality of options for adjusting settings of the computer system includes an option for adjusting a level of zoom (e.g., of a magnification function) of the computer system. In some embodiments, adjusting the level of zoom of the computer system includes selectively adjusting the level of zoom for a subset of user interface elements. For example, the computer system displays a plurality of virtual objects displayed concurrently with passthrough elements that are visible via the display generation component, and the level of zoom is adjusted for the plurality of virtual objects but the level of zoom is not adjusted for the passthrough elements. In another example, the level of zoom is adjusted for passthrough elements and not for virtual objects. In some embodiments, adjusting the level of zoom of the computer system includes adjusting the level of zoom for all user interface elements (e.g., regardless of the type of user interface elements). For example, the computer system displays a plurality of virtual objects displayed with concurrently with passthrough elements, and the level of zoom is adjusted for both the plurality of virtual objects and for the passthrough elements.

For example, in FIGS. 8W-8AA, the computer system 101 displays the user interface 8038 (e.g., corresponding to a zoom setting and/or zoom level of the computer system 101), and a level of zoom of the computer system 101 is adjusted while the user interface 8038 is selected (e.g., and the zoom user interface 8042 is displayed in FIGS. 8X-8Z). Displaying a menu that includes a plurality of options for adjusting settings of the computer system, including an option for adjusting a level of zoom of the computer system, and selecting a first option of the plurality of options for adjusting settings of the computer system, in response to detecting a first user input of a first type, and selecting a second option, different from the first option, of the plurality of options for adjusting settings of the computer system, in response to detecting a second user input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, a respective option, of the first option of the plurality of options for adjusting settings of the computer system and the second option of the plurality of options for adjusting settings of the computer system, is the option for adjusting the level of zoom of the computer system. While the option for adjusting the level of zoom of the computer system is selected, the computer system displays a zoom user interface, wherein the zoom user interface includes a portion of the respective view of the environment displayed at an increased scale (e.g., relative to other portions of the respective view of the environment that are visible outside of the zoom user interface). In some embodiments, the portion of the respective view of the environment that is displayed at the increased scale corresponds to (e.g., only) a viewport portion of a viewport through which the respective view of the environment is visible (e.g., portions of the respective view of the environment that are displayed outside of the viewport portion of the viewport are not displayed at an increased scale).

For example, in FIG. 8X-8Z, the computer system 101 displays the zoom user interface 8042, which includes a portion of the respective view of the environment displayed at an increased scale (e.g., the virtual object 7012 in the zoom user interface 8042 of FIGS. 8Y and 8Z is displayed at an increased scale (e.g., as compared to a normal or default size of the virtual object 7012 shown in FIG. 8X, when the virtual object 7012 is not displayed in the zoom user interface 8042) relative to other portions of the view of the three-dimensional environment (e.g., the user interface 8014, the representation 8014′ of the physical object 8014, and the user interface 8038). Displaying a zoom user interface that includes a portion of the respective view of the environment displayed at an increased scale while an option for adjusting the level of zoom of the computer system is selected, provides additional control options without cluttering the UI with permanently displayed user interfaces (e.g., the zoom user interface does not need to be permanently displayed, and can instead be displayed only when the option for adjusting the level of zoom of the computer system is selected) and makes using the computer system more accessible to and ergonomic for a wider variety of users (e.g., including low vision users who would benefit from user interface zoom capabilities).

In some embodiments, displaying the menu that includes the plurality of options for adjusting settings includes: in accordance with a determination that a setting for enabling zoom functionality is enabled for the computer system, displaying an option for adjusting a level of zoom of the computer system. In some embodiments, in accordance with a determination that the setting for enabling zoom functionality is not enabled for the computer system, the computer system forgoes displaying the option for adjusting the level of zoom of the computer system.

For example, as described above with reference to FIGS. 8T, in some embodiments, the user interface 8038 (e.g., corresponding to a zoom setting and/or zoom level of the computer system 101) is displayed if a corresponding zoom function is enabled for the computer system 101. Displaying an option for adjusting a level of zoom of the computer system in accordance with a determination that a setting for enabling zoom functionality is enabled for the computer system allows the computer system to conditionally enable functionality only when appropriate, which allows the computer system to display relevant options (e.g., for adjusting relevant settings of the computer system) without cluttering the UI with unnecessary options (e.g., options which are not relevant in a particular context), and reduces the number of user inputs needed to adjust relevant settings of the computer system (e.g., relevant settings of the computer system are displayed concurrently, allowing for efficient access to the relevant settings without needing to perform additional user inputs to navigate through different menus and/or user interfaces for accessing different settings of the computer system).

In some embodiments, after selecting the second option of the plurality of options for adjusting settings of the computer system, the computer system ceases to display the menu that includes the plurality of options for adjusting settings of the computer system. The computer system detects a third user input of the first type, and in response to detecting the third user input: in accordance with a determination that a zoom setting of the computer system is not enabled for adjusting settings of the computer system and that the computer system was not generating audio output at a time when the third user input was detected, the computer system changes a current level of immersion of a virtual environment from a first level of immersion to a second level of immersion (e.g., of a plurality of levels of immersion) that is different from the first level of immersion. In some embodiments, in accordance with a determination that the menu would include a single option (e.g., the zoom setting, which would correspond to another respective option of the plurality of options, is not enabled, and audio output is not being generated, which would correspond to a volume setting being included as another respective option of the plurality of options), then an operation corresponding to the single option (e.g., changing a setting associated with the single option) is performed in response to detecting the first user input (e.g., without displaying the menu). In some embodiments, the menu that includes the plurality of options is also conditionally displayed in response to the first user input (e.g., the menu is displayed in some scenarios in response to the first user input and not displayed in other scenarios in response to the first user input). For example, the menu that includes the plurality of options for adjusting settings of the computer system is displayed in response to detecting the first user input, and in accordance with a determination that a zoom setting of the computer system is enabled for adjusting settings of the computer system or that the computer system was generating audio output at a time when the first user input was detected. In response to detecting the first user input, and in accordance with a determination that the zoom setting of the computer system is not enabled and that the computer system was not generating audio output at the time when the first user input was detected, the computer system forgoes displaying the menu that includes the plurality of options (e.g., and changes a current level of immersion of the virtual environment from the first level of immersion to the second level of immersion that is different from the first level of immersion).

For example, as described above with reference to FIG. 8T, in some embodiments, if no audio is being generated by the computer system 101 (e.g., if the video in the user interface 8022 of FIG. 8AB were paused (and/or if the user interface 8022 was not displayed at all, as in FIG. 8T) and if a zoom function is not enabled for the computer system 101, the computer system 101 adjusts the current level of immersion of the computer system 101 (e.g., because the level of immersion is the only available setting for adjustment (e.g., as the user interface 8038 is not displayed and a level of zoom is not enabled for adjustment because the zoom function is not enabled for the computer system 101; and the user interface 8016 is not displayed and a volume setting is not enabled for adjustment because the computer system 101 was not generating audio output at the time when the third user input was detected). Changing a current level of immersion of a virtual environment from a first level of immersion to a second level of immersion that is different from the first level of immersion, in accordance with a determination that the zoom setting of the computer system is not enabled for adjusting settings of the computer system and that the computer system was not generating audio output at the time when a third user input is detected, automatically changes the value for a relevant setting of the computer system (e.g., based on context) without requiring additional user input (e.g., additional user inputs to navigate to and/or select an option for adjusting the current level of immersion, when other options for adjusting other settings of the computer system are not applicable or available for adjustment).

In some embodiments, detecting the first user input includes detecting a first portion of the first user input followed by a second portion of the first user input, and displaying the menu that includes the plurality of options for adjusting settings of the computer system and selecting the first option of the plurality of options for adjusting settings of the computer system are performed in response to detecting the first portion of the first user input without adjusting a first setting corresponding to the first option of the plurality of options. In response to detecting the second portion of the first user input, the computer system adjusts the first setting corresponding to the first option of the plurality of options, in accordance with the second portion of the first user input (e.g., the first setting is increased/decreased (e.g., by rotating the rotatable input device clockwise or counterclockwise) by an amount that is based on an amount (e.g., magnitude) of rotation of the rotatable input device during the second portion of the first user input) where a larger amount of rotation causes a larger amount of change in the first setting and a smaller amount of rotation causes a smaller amount of change in the first setting and rotation in a first direction causes an increase in the first setting while rotation in a second direction different from the first direction causes a decrease in the first setting. In some embodiments, while the second option of the plurality of options is selected, the computer system detects a fourth user input of the first type. In response to detecting the fourth user input of the first type, the computer system adjusts the second setting corresponding to a second setting corresponding to the second option, in accordance with the fourth user input of the first type (e.g., the second setting is increased/decreased (e.g., by rotating the rotatable input device clockwise or counterclockwise) by an amount that is based on an amount (e.g., magnitude) of rotation of the rotatable input device during the fourth user input) where a larger amount of rotation causes a larger amount of change in the second setting and a smaller amount of rotation causes a smaller amount of change in the second setting and rotation in the first direction causes an increase in the second setting while rotation in the second direction causes a decrease in the second setting.

For example, as shown in FIG. 8T and as further described above with reference to FIG. 8U, in some embodiments, an initial amount of rotation (e.g., the initial amount of rotation shown in FIG. 8T, and/or an initial amount of rotation up to the first threshold amount of rotation needed to display the user interface 8014, the user interface 8038, and the user interface 8016) does not result in adjustment of the current level of immersion (e.g., is ignored and/or not processed by the computer system 101 for purposes of adjusting the current level of immersion). Further rotation of the digital crown 703 in FIGS. 8U-8V, however, does result in adjustment of the current level of immersion. Adjusting the first setting corresponding to the first option of the plurality of options, in accordance with the second portion of the first user input, without adjusting the first setting corresponding to the first option of the plurality of options in response to detecting the first portion of the first user input, reduces the risk of accidental and/or incorrect adjustments to the first setting, which reduces the number of user inputs needed to adjust the first setting to an appropriate value or level (e.g., the user does not need to perform additional user inputs to undo and/or reverse unintentional adjustments to the first setting caused by the first portion of the first user input).

In some embodiments, selecting the first option of the plurality of options for adjusting settings of the computer system includes displaying the first option of the plurality of options with an appearance (e.g., a color, size, and/or opacity) that is visually emphasized relative to respective appearances (e.g., default appearances) of other options of the plurality of options; and selecting the second option of the plurality of options for adjusting settings of the computer system includes displaying the second option of the plurality of options with an appearance that is visually emphasized relative to respective appearances of other options of the plurality of options. In some embodiments, each option of the plurality of options that is not selected is displayed with the same (e.g., default) appearance (e.g., the same color, the same size, and/or the same opacity) as other options of the plurality of options that are not selected, and the currently selected option is displayed with an appearance different from that (e.g., default) appearance (e.g., such that the selected option is visually emphasized, such as using a different color or highlighting, increased brightness, increased contrast, and/or other way of increasing visual prominence of the selected option). This provides improved visual feedback to the user regarding the currently selected option, and also assists the user is easily and quickly identifying which option of the plurality of options is currently selected.

For example, in FIG. 8T, the user interface 8014 is selected and is displayed with a different appearance than (e.g., visually emphasized relative to) the user interface 8038 and the user interface 8016 (e.g., the user interface 8014 is displayed with a white background and black outline, while the user interface 8038 and the user interface 8016 are displayed with gray backgrounds and white outlines). In FIG. 8W, the user interface 8014 is no longer selected and the user interface 8038 is selected. The user interface 8038 is displayed with a different appearance than (e.g., visually emphasized relative to), the user interface 8014 and the user interface 8016 (e.g., the user interface 8038 is displayed with a white background and black outline, while the user interface 8014 and the user interface 8016 are displayed with gray backgrounds and white outlines). Selecting the first option of the plurality of options for adjusting settings of the computer system, including displaying the first option of the plurality of options with an appearance that is visually emphasized relative to respective appearances of other options of the plurality of options, and selecting the second option of the plurality of options for adjusting settings of the computer system, including displaying the second option of the plurality of options with an appearance that is visually emphasized relative to respective appearances of other options of the plurality of options, provides improved visual feedback to the user (e.g., improved visual feedback regarding which option of the plurality of options is currently selected).

In some embodiments, selecting the first option of the plurality of options for adjusting settings of the computer system includes displaying a first visual indication of a value for a first setting corresponding to the first option of the plurality of options for adjusting settings of the computer system; selecting the second option of the plurality of options for adjusting settings of the computer system includes displaying a second visual indication of a value for a second setting corresponding to the second option of the plurality of options for adjusting settings of the computer system; the first visual indication is not displayed when the first option of the plurality of options for adjusting settings of the computer system is not selected; and the second visual indication is not displayed when the second option of the plurality of options for adjusting settings of the computer system is not selected. In some embodiments, (e.g., only) the currently selected option of the plurality of options for adjusting settings of the computer system is displayed with a visual indication of a value for a setting corresponding to the currently selected option of the plurality of options for adjusting settings of the computer system. In some embodiments, the respective visual indication of the value of the respective setting corresponding to the selected option changes as the value of the respective setting is changed (e.g., a smaller amount of change in the respective visual indication for a smaller amount of change in the value of the first setting, and a larger amount of change in the respective visual indication for a larger amount of change in the value of the first setting). This assists the user in easily identifying which option of the plurality of options is currently selected, and also provides improved visual feedback to the user regarding the current value of a setting corresponding to the currently selected option, without having to clutter the display with permanently displayed visual indications for all options of the plurality of options.

For example, in FIG. 8T, the user interface 8014 is selected and the visual indication 8015 (e.g., that indicates a current level of immersion) is also displayed. Similarly, in FIG. 8W, the user interface 8038 is selected and the visual indication 8040 (e.g., that indicates a current level of zoom) is also displayed. Displaying a first visual indication of a value for a first setting corresponding to the first option of the plurality of options for adjusting settings of the computer system (e.g., while the first option of the plurality of options is selected), and displaying a second visual indication of a value for a second setting corresponding to the second option of the plurality of options for adjusting settings of the computer system (e.g., while the second option of the plurality of options is selected), provides improved visual feedback to the user (e.g., improved visual feedback regarding the currently selected option of the plurality of options, and improved visual feedback regarding the value (e.g., the current value) for a setting corresponding to the currently selected setting).

In some embodiments, after selecting a respective option of the plurality of options (e.g., the first option, the second option, or another option of the plurality of options) for adjusting settings of the computer system, the computer system detects a fourth user input. In response to detecting the fourth user input, the computer system adjusts a respective setting corresponding to the respective option based on the fourth user input.

For example, in FIG. 8U, after selecting the user interface 8014 (e.g., after the computer system automatically selects the user interface 8014), the computer system detects further rotation of the digital crown 703, and in response, adjusts a level of immersion of the computer system. For example, in FIG. 8I, after selecting the user interface 8016 (e.g., via a head-based pointer, as shown in FIGS. 8AE-8AH), the computer system detects movement of the user's hand 7020 (e.g., an air pinch and drag gesture performed by the hand 7020), and in response, adjusts a current audio level (e.g., for video playing in the user interface 8022 and/or for the computer system 101). Adjusting a respective setting corresponding to the respective option based on a fourth user input, in response to detecting the fourth user input, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, the fourth user input is a user input of the first type (e.g., in some embodiments, the fourth user input is a continuation of the first user input; in some embodiments, the fourth user input is a subsequent user input that is detected after detecting the first user input and the second user input), and adjusting the respective setting corresponding to the respective option includes: in accordance with a determination that the respective option is the first option, adjusting (e.g., increasing or decreasing) a first setting (e.g., a volume, a level of immersion, a level of zoom, and/or a display brightness) corresponding to the first option in accordance with the fourth user input of the first type (e.g., the first setting is increased/decreased (e.g., by rotating the rotatable input device clockwise or counterclockwise) by an amount that is s determined based an amount (e.g., magnitude and/or speed) of rotation of the rotatable input device during the fourth user input of the first type), where a larger amount of rotation causes a larger amount of change in the first setting and a smaller amount of rotation causes a smaller amount of change in the first setting and rotation in a first direction causes an increase In the first setting while rotation in a second direction different from the first direction causes a decrease in the first setting; and in accordance with a determination that the respective option is the second option, adjusting (e.g., increasing or decreasing) a second setting (e.g., a volume, a level of immersion, a level of zoom, and/or a display brightness) corresponding to the second option in accordance with the fourth user input of the first type (e.g., the second setting is increased/decreased (e.g., by rotating the rotatable input device clockwise or counterclockwise) by an amount that is based on an amount (e.g., magnitude) of rotation of the rotatable input device during the fourth user input of the first type) where a larger amount of rotation causes a larger amount of change in the second setting and a smaller amount of rotation causes a smaller amount of change in the second setting and rotation in the first direction causes an increase in the second setting while rotation in the second direction causes a decrease in the second setting. In some embodiments, in accordance with a determination that the respective option is another option of the plurality of options, such as a third option different from the first option and from the second option, a third setting corresponding to the third option is adjusted in response to detecting the fourth user input of the first type where a larger amount of rotation causes a larger amount of change in the third setting and a smaller amount of rotation causes a smaller amount of change in the third setting and rotation in the first direction causes an increase in the third setting while rotation in the second direction causes a decrease in the third setting.

For example, in FIG. 8U, the computer system 101 detects further rotation of the digital crown 703 (e.g., a subsequent user input of the same type as in FIG. 8T, or a continuation of the user input that starts in FIG. 8T), and in response, the computer system 101 adjusts the level of immersion (e.g., corresponding to the user interface 8014, which is the currently selected option) in accordance with the rotation of the digital crown 703 . . . . Similarly, in FIG. 8X, the computer system 101 detects rotation of the digital crown 703 (e.g., a user input of the same type as in FIG. 8T and/or FIG. 8U), and in response, the computer system 101 adjusts the level of zoom (e.g., corresponding to the user interface 8038, which is the currently selected option) in accordance with the rotation of the digital crown 703. Adjusting a first setting corresponding to a first option in accordance with a fourth user input of a first type, in response to detecting the fourth user input and in accordance with a determination that the respective option is the first option, and adjusting a second setting corresponding to a second option in accordance with the fourth user input of the first type, in response to detecting the fourth user input and in accordance with a determination that the respective option is the second option, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, the fourth user input includes movement of a user's hand (e.g., the fourth user input is an air pinch and drag gesture, or another hand gesture that includes translational and/or rotational movement of the user's hand), and adjusting the respective setting corresponding to the respective option includes: in accordance with a determination that the respective option is the first option, adjusting (e.g., increasing or decreasing) a first setting (e.g., a volume, a level of immersion, a level of zoom, and/or a display brightness) corresponding to the first option in accordance with the movement of the user's hand during the fourth user input (e.g., the first setting is increased/decreased (e.g., by movement of the user's hand in a first and/or second direction during the fourth user input) by an amount that is determined based on an amount (e.g., magnitude and/or speed) of movement of the user's hand during the fourth user input, where a larger amount of movement causes a larger amount of change in the first setting and a smaller amount of movement causes a smaller amount of change in the first setting, and movement in a first direction causes an increase in the first setting while movement in a second direction different from (e.g., opposite) the first direction causes a decrease in the first setting); and in accordance with a determination that the respective option is the second option, adjusting (e.g., increasing or decreasing) a second setting (e.g., a volume, a level of immersion, a level of zoom, and/or a display brightness) corresponding to the second option in accordance with the movement of the user's hand during the fourth user input (e.g., the second setting is increased/decreased (e.g., by movement of the user's hand in a first and/or second direction during the fourth user input) by an amount that is proportionate to an amount (e.g., magnitude) of movement of the user's hand during the fourth user input, where a larger amount of movement causes a larger amount of change in the second setting and a smaller amount of movement causes a smaller amount of change in the second setting and movement in the first direction causes an increase in the second setting while movement in the second direction causes a decrease in the second setting). In some embodiments, in accordance with a determination that the respective option is another option of the plurality of options, such as a third option different from the first option and from the second option, a third setting corresponding to the third option is adjusted in response to detecting the fourth user input, where a larger amount of movement causes a larger amount of change in the third setting and a smaller amount of movement causes a smaller amount of change in the third setting, and movement in the first direction causes an increase in the third setting while movement in the second direction causes a decrease in the third setting.

For example, in FIGS. 8AI-8AJ, the computer system 101 detects movement of the user's hand 7020, and in response, the computer system adjusts the audio level of the computer system 101 (e.g., corresponding to the user interface 8016, which is the currently selected option) in accordance with the movement of the user's hand 7020 (e.g., increasing as the user's hand moves to the right in FIG. 8AI, and decreasing as the user's hand moves to the left in FIG. 8AJ). As described with reference to FIG. 8AI, in some embodiments, other options (e.g., corresponding to the current level of immersion or the current level of zoom) can be similarly adjusted by an analogous air pinch and drag gesture (e.g., movement of the user's hand 7020) to the movement of the user's hand 7020 shown in FIGS. 8AI-8AJ. Adjusting a first setting corresponding to a first option in accordance with movement of a user's hand, in response to detecting a fourth user input that includes movement of the user's hand and in accordance with a determination that the respective option is the first option, and adjusting a second setting corresponding to a second option in accordance with the movement of the user's hand, in response to detecting the fourth user input that includes the movement of the user's hand and in accordance with a determination that the respective option is the second option, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, the respective option is an option of the plurality of options to which a user's attention was directed when (e.g., a beginning of) the fourth user input was detected. In some embodiments, (e.g., while continuing to detect the fourth user input) the computer system continues to adjust the respective setting corresponding to the respective option (e.g., in accordance with the movement of the user's hand during the fourth user input) regardless of where the attention of the user is directed (e.g., regardless of where the attention of the user moves after being directed to the respective option when the fourth user input is detected) (e.g., the user's attention does not need to be continuously directed to the respective option in order to continue to adjust the respective setting corresponding to the respective option). In some embodiments, while detecting the fourth user input, the computer system detects a pause in the movement of the user's hand (e.g., for at least a threshold amount of time, such as 0.1, 0.2, 0.5, 1, 2, 5, or 10 seconds), followed by continued movement of the user's hand. The computer system adjusts a second option of the plurality of options in accordance with the continued movement of the user's hand, wherein the second option of the plurality of options is the option to which the user's attention was directed when the continued movement of the user's hand is detected. For example, the computer system initially detects movement of the user's hand during the fourth user input, and the attention of the user is directed to a volume option during the initial movement of the user's hand. The computer system adjusts a volume of the computer system in accordance with the initial movement of the user's hand. The computer system then detects a pause in the movement of the user's hand. The attention of the user shifts to a zoom option during the pause. The computer system then detects continued movement of the user's hand, and the computer system adjusts a level of zoom in accordance with the continued movement of the user's hand. In some embodiments, if the attention of the user does not change (e.g., remains on the volume option), or is otherwise directed (e.g., leaves and subsequently returns) to the respective option of the plurality of options at a time when the continued movement of the user's hand is detected, the computer system continues to adjust the respective setting corresponding to the respective option in accordance with the continued movement of the user's hand.

For example, in FIG. 8AH, the attention of the user 7002 (e.g., based on a head-based pointer) is directed to the user interface 8016, which is the selected user interface when the computer system 101 detects the movement of the user hand 7020 (e.g., an air pinch and drag gesture) in FIGS. 8AI-8AJ. In FIGS. 8AI-8AJ, the computer system 101 adjusts the current audio level (e.g., the setting corresponding to the currently selected user interface 8016) for the video playing in the user interface 8022 and/or the current audio level for the computer system 101 in accordance with the movement of the user's hand 7020. This is also described with reference to FIG. 8AI, where in response to detecting the air pinch and drag with the hand 7020, the computer system 101 adjusts a setting corresponding to a user interface to which the user's attention (e.g., based on the head-based pointer) is directed when the (e.g., beginning of the) air pinch and drag is detected. Adjusting a respective setting corresponding to a respective option to which the user's attention was directed when a fourth user input is detected, in response to detecting the fourth user input, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, detecting the second user input of the second type includes detecting activation (e.g., press and release or press) of a button of the rotatable input device (e.g., for less than a threshold period of time).

For example, as described with reference to FIG. 8AB, in some embodiments, the user input of the second type (e.g., the different type of input) includes activating a button of the digital crown 703 (e.g., a press and release of a button of the digital crown 703). Displaying a menu that includes a plurality of options for adjusting settings of the computer system and selecting a first option of the plurality of options for adjusting settings of the computer system, in response to detecting a first user input of a first type, and selecting a second option, different from the first option, of the plurality of options for adjusting settings of the computer system, in response to detecting a second user input that includes activation of a button of a rotatable input device and is a different type of input than the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, detecting the second user input of the second type includes detecting activation of a button of the rotatable input device for at least a threshold amount of time (e.g., 0.25, 0.5, 1, 2, 3, 5, or 10 seconds) (e.g., the second user input of the second type includes pressing and holding the button of the rotatable input device, for at least the threshold period of time).

For example, as described with reference to FIG. 8AB, in some embodiments, the user input of the second type (e.g., the different type of input) includes holding a button of the digital crown 703 (e.g., pressing a button of the digital crown 703 for at least a threshold amount of time such as 0.5, 1, 2, 5, or 10 seconds). Displaying a menu that includes a plurality of options for adjusting settings of the computer system and selecting a first option of the plurality of options for adjusting settings of the computer system, in response to detecting a first user input of a first type, and selecting a second option, different from the first option, of the plurality of options for adjusting settings of the computer system, in response to detecting a second user input that includes activation of a button of a rotatable input device for at least a threshold amount of time and is a different type of input than the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, the second option of the plurality of options for adjusting settings of the computer system is selected in accordance with a determination that attention of a user is directed to the second option of the plurality of options (e.g., based on a location to which the user's gaze (e.g., based on the user's eyes) is directed at the time the second user input of the second type is detected, based on a location to which a user's finger, hand, or other body part is pointing (e.g., with a predetermined hand gesture or hand posture), and/or based on a location to which a user's head (e.g., independent of where the user's eyes are directed) is directed (e.g., the computer system is a head mounted display, and the user moves (e.g., rotates) the user's head to change the location to which the user's attention is directed).

For example, in FIG. 8AF, the computer system 101 selects the user interface 8038 in accordance with the attention of the user 7002 (e.g., in accordance with a head-based pointer that points to the user interface 8038), and in FIG. 8AG, the computer system 101 selects the user interface 8014 in accordance with a change in the attention of the user (e.g., the head-based pointer moves from the user interface 8038 to the user interface 8014, causing the computer system 101 to select the user interface 8014). Displaying a menu that includes a plurality of options for adjusting settings of the computer system and selecting a first option of the plurality of options for adjusting settings of the computer system, in response to detecting a first user input of a first type, and selecting a second option, different from the first option, of the plurality of options for adjusting settings of the computer system, in response to detecting a second user input of a second type that is different from the first type and in accordance with a determination that attention of a user is directed to the second option of the plurality of options, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, while displaying the menu that includes the plurality of options for adjusting settings of the computer system and while the second option of the plurality of options is selected, the computer system detects that attention of a user is directed to a third option, different from the second option (e.g., and the same as or different from the first option), of the plurality of options for adjusting settings of the computer system. In response to detecting that the attention of the user is directed to the third option (optionally without detecting a user input via the rotatable input device), the computer system selects the third option (e.g., displaying the third option with a selection indicator and/or visual emphasis relative to other options not displayed with a selection indicator nor visually emphasized). In some embodiments, after selecting the third option (e.g., and while the third option remains selected), the computer system detects one or more additional user inputs. In response to detecting the one or more additional user inputs, the computer system adjusts a setting of the computer system corresponding to the third option.

For example, in FIG. 8AG, the computer system 101 selects the user interface 8016 in accordance with the attention of the user 7002 (e.g., in accordance with a head-based pointer that points to the user interface 8016), and in FIG. 8AH, the computer system 101 selects the user interface 8016 in accordance with a change in the attention of the user (e.g., the head-based pointer moves from the user interface 8014 to the user interface 8016, causing the computer system 101 to select the user interface 8016). Selecting a third option, different from the second option, of the plurality of options for adjusting settings of the computer system, in response to detecting that the attention of a user is directed to the third option, provides additional control options without cluttering the UI with additional displayed controls (e.g., additional displayed controls for navigating between different options of the plurality of options for adjusting settings of the computer system and/or selecting a respective option of the plurality of options for adjusting settings of the computer system).

In some embodiments, prior to detecting the first user input of the first type, the computer system enables user inputs corresponding to a first portion of a user (e.g., user inputs including wrist and/or head-based gestures and/or pointers). In response to detecting the first user input of the first type, the computer system disables (e.g., ignoring and/or ceasing to detect and/or process) user inputs corresponding to the first portion of the user and enabling user inputs corresponding to a second portion of the user that is different from the first portion of the user. For example, user inputs corresponding to the first portion of the user include wrist-based gestures and/or pointers, and user inputs corresponding to the second portion of the user include head-based gestures and/or pointers. Before detecting the first user input of the first type (e.g., and displaying the menu that includes the plurality of options for adjusting settings of the computer system), wrist-based gestures and/or pointers are enabled (e.g., for interacting with one or more virtual elements of the environment). In response to detecting the first user input of the first type, wrist-based gestures and/or pointers are disabled (e.g., no longer enabled, and no longer available for interacting with the virtual elements of the environments and/or displayed user interface elements), and head-based gestures and/or points are enabled (e.g., in lieu of the wrist-based gestures and/or pointers) (e.g., to interact with (e.g., select and/or adjust options displayed in) the menu that includes the plurality of options for adjusting settings of the computer system).

For example, in FIG. 8AC-8AD, a wrist-based pointer is enabled for the computer system 101 (e.g., prior to detecting the rotation of the digital crown 703 in FIG. 8AE). In FIGS. 8AE-8AJ, the wrist-based pointer is disabled for the computer system 101 (e.g., after and/or in response to detecting the rotation of the digital crown 703 in FIG. 8AE) and a head-based pointer is enabled for the computer system 101 (e.g., which was not enabled in FIGS. 8AC-8AD). Disabling user inputs corresponding to the first portion of the user and enabling user inputs corresponding to a second portion of the user that is different from the first portion of the user, in response to detecting the first user input of the first type, reduces the risk of accidental inputs selecting and/or adjusting settings corresponding to a respective option of the plurality of options for adjusting settings of the computer system (e.g., user inputs of the first type may involve and/or include movement of the first portion of the user, increasing the risk of performing accidental user inputs that correspond to the first portion of the user while the user performs the first user input of the first type) and makes user interaction with the menu that includes the plurality of options for adjusting settings of the computer system more efficient (e.g., the first portion of the user may not be in a position to easily perform subsequent user inputs to interact with the menu that includes the plurality of options for adjusting settings of the computer system, while and/or (e.g., immediately) after performing the first user input of the first type, and enabling user inputs corresponding to a second portion of the user allows for seamless transition to interacting with the menu after performing the first user input of the first type).

In some embodiments, in response to detecting the first user input of the first type, the computer system generates an audio output corresponding to the first option of the plurality of options for adjusting settings of the computer system (e.g., an audio output that describes a first setting and/or value of the first setting corresponding to the first option of the plurality of options for adjusting settings of the computer system) (e.g., in conjunction with selecting the first option). In response to detecting the second user input of the second type, the computer system generates an audio output corresponding to the second option of the plurality of options for adjusting settings of the computer system (e.g., an audio output that describes a second setting and/or value of the second setting corresponding to the second option of the plurality of options for adjusting settings of the computer system) (e.g., in conjunction with selecting the second option).

For example, as described with reference to FIG. 8AT, in some embodiments, the computer system 101 provides audio feedback regarding the automatically selected user interface (e.g., a voiceover or narration that describes the currently selected user interface). For example, in FIG. 8T, the computer system 101 outputs audio that announces “immersion,” “level of immersion,” or a similar phrase and/or description for the setting corresponding to the user interface 8014. Generating an audio output corresponding to the first option of the plurality of options for adjusting settings of the computer system in response to detecting the first user input of the first type, and generating an audio output corresponding to the second option of the plurality of options for adjusting settings of the computer system in response to detecting the second user input of the second type, provides improved audio feedback to the user (e.g., improved audio feedback regarding the currently selected option of the plurality of options), which allows for more efficient interaction with the menu that includes the plurality of options (e.g., allows for user interface with the menu that includes the plurality of options even if the user's attention is directed elsewhere, and/or in scenarios where tracking the attention of the user is difficult due to environmental factors or physical characteristics of the user) and makes using the computer system more accessible to and ergonomic for a wider variety of users (e.g., including low vision users who would benefit from audio narration).

In some embodiments, aspects/operations of methods 9000, 10000, 12000, and/or 13000 may be interchanged, substituted, and/or added between these methods. For example, the progress indicators for settings of the computer system in the method 11000 can be concurrently displayed with the first user interface object for accessing system functions of the computer system in the method 9000, 10000, 12000, or 13000. For brevity, these details are not repeated here.

FIG. 12 is a flow diagram of an exemplary method 12000 for conditionally displaying user interface elements for accessing settings of a computer system based on the location of foreground content, in accordance with some embodiments. In some embodiments, method 12000 is performed at a computer system (e.g., computer system 101 in FIG. 1A) that is in communication with a display generation component (e.g., display generation component 120 in FIGS. 1A, 3, and 4, and/or display generation component 7100 in FIGS. 7A and 8A, and/or the display generation component 7100a in FIG. 8S) (e.g., a heads-up display, a display, a touchscreen, a projector, a head mounted display (HMD), an inner display of a two-sided display generation component, a display on a handheld device, a display on a wearable device, or another type of display) and one or more input devices (e.g., cameras (e.g., color sensors, infrared sensors, and other depth-sensing cameras) (e.g., that point downward at a user's hand and/or forward from the user's head), touch-sensors, touch-sensitive surfaces, proximity sensors, motion sensors, buttons, joysticks, and/or other sensors and input devices). In some embodiments, the method 12000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 12000 are, optionally, combined and/or the order of some operations is, optionally, changed.

The method 12000 is a method of conditionally displaying user interface elements for accessing settings of a computer system based on the location of foreground content, in accordance with some embodiments. Displaying an indication of a system user interface in accordance with a determination that attention of a user is directed to a first portion of a viewport into the three-dimensional environment during a first user input and that foreground content of a first view of the three-dimensional environment is not within the first portion of the viewport into the three-dimensional environment, and forgoing displaying the indication of the system user interface in accordance with a determination that the attention of the user is directed to the first portion of the viewport into the three-dimensional environment during the first user input and that foreground content of the first view of the three-dimensional environment is within the first portion of the viewport into the three-dimensional environment, reduces the number of user inputs needed to display user interface elements at appropriate and/or visible locations (e.g., the user does not need to perform additional user inputs to reposition and/or cease to display some user interface elements in order to avoid collision or overlap of user interface elements, and to facilitate clear visibility and/or access to (e.g., all displayed) user interface elements).

While a first view of a three-dimensional environment (e.g., a three-dimensional environment that includes a passthrough view of the physical environment of the display generation component, a mixed reality view that includes both virtual content and a representation of the physical environment surrounding the display generation component, or a fully virtual three-dimensional environment) is visible (e.g., visible in a passthrough mode that corresponds to a lowest level of immersion, a mixed reality mode that corresponds to one or more intermediate levels of immersion, or a virtual reality mode that corresponds to a maximum level of immersion), via the display generation component (e.g., the view that is visible via the display generation component 7100a in FIG. 7V), the computer system detects (12002), via the one or more input devices, a first user input (e.g., the user's attention 7010 directed to a location within the region 7030, in FIG. 7V, optionally in conjunction with a user input such as an air gesture) (e.g., a predefined hand gesture, a predefined body posture or pose, a predefined movement of one or more body parts of a user, and/or a user input detected via a hardware input device such as a button, dial, or other physical input mechanism, a gaze of a user directed to a respective location in the three-dimensional environment or portion of a viewport into the three-dimensional environment, optionally for a threshold amount of time); In some embodiments, the first view of the three-dimensional environment includes content (e.g., foreground elements such as application user interfaces, system spaces, and/or virtual objects (e.g., that a user can interact with) and/or background elements (e.g., passthrough elements, wallpapers, and/or portions of a virtual environment (e.g., a virtual background that a user cannot directly interact with)). In response to detecting (12004) the first user input: in accordance with a determination that attention (e.g., based on a gaze) of a user is directed to a first portion of a viewport (e.g., the region 7132 in FIG. 7AD) into the three-dimensional environment during the first user input and that foreground content (e.g., user interface elements, such as foreground elements, and optionally excluding background elements such as passthrough elements) of the first view of the three-dimensional environment is not within the first portion of the viewport into the three-dimensional environment (e.g., while the attention of the user is directed to the first portion of the three-dimensional environment), the computer system displays (12006) an indication of a system user interface (e.g., the indicator 7042 (e.g., of the system function menu 7046) in FIG. 7G or system function menu 7046) (e.g., in FIG. 7AD, the user interface 7122 is not within the region 7132 and the computer system 101 displays the indicator 7042); and in accordance with a determination that the attention (e.g., based on a gaze) of the user is directed to the first portion of the viewport into the three-dimensional environment during the first user input and that foreground content of the first view of the three-dimensional environment is within the first portion of the viewport into the three-dimensional environment (e.g., while the attention of the user is directed to the first portion of the three-dimensional environment), the computer system forgoes (12008) displaying the indication of the system user interface (e.g., in FIG. 7AF, the user interface 7122 is within the region 7132 and the computer system 101 does not display the indicator 7042). In some embodiments, in accordance with a determination that the attention (e.g., based on a gaze) of the user is not directed to the first portion of the viewport into the three-dimensional environment during the first user input, the computer system forgoes displaying the indication of the system user interface (e.g., whether or not foreground content of the first view is within the first portion).

In some embodiments, detecting the first user input includes determining that the attention of the user is directed to the first portion of the viewport into the three-dimensional environment for (e.g., at least) a threshold amount of time (e.g., 0.1, 0.2, 0.3, 0.5, 1, 2, 5, or 10 seconds). In some embodiments, the indication of the system user interface is a position indicator. (e.g., a visual indicator or other placeholder that indicates a location at which the system user interface will be displayed if additional input is detected) (e.g., a dot, an icon, a unitary user interface object that does not have internal affordances for performing different operations, a user interface object that optionally has one or more visual characteristics that are indicative of status information associated with the computer system and/or the three-dimensional environment). In some embodiments, foreground content of the first view of the three-dimensional environment is not within (e.g., and/or does not move into) the first portion of the three-dimensional environment while the attention of the user is directed to the first portion of the viewport during the threshold amount of time (e.g., for the entirety of the threshold amount of time, or during a relevant portion of the threshold amount of time such as at the end of the threshold amount of time). In some embodiments, in accordance with a determination that the attention of the user is not directed to the first portion of the viewport for the threshold amount of time during the first user input, the computer system forgoes displaying the indication of the system user interface. In some embodiments, in accordance with a determination that the attention of a user has been (e.g., continuously) directed to the first portion of the viewport for less than the threshold amount of time during the first user input, and that foreground content of the first view of the three-dimensional environment is not within the first portion of the viewport (e.g., and that foreground content of the first view of the three-dimensional environment is not (e.g., and/or does not move) within the first portion of the viewport while the attention of the user is directed to the first portion of the viewport), the computer system displays the indication of the system user interface with a first appearance (e.g., a first size, a first color, and/or a first shape), and in accordance with a determination that the attention of the user has been (e.g., continuously) directed to the first portion of the viewport for (e.g., at least) the threshold amount of time during the first user input, and that foreground content of the first view of the three-dimensional environment is not within the first portion of the viewport (e.g., and that content of the first view of the three-dimensional environment is not (e.g., and/or does not move) within the first portion of the viewport while the attention of the user is directed to the first portion of the viewport), the computer system displays the indication of the system user interface with a second appearance different from the first appearance (e.g., a second size different from the first size, a second color different from the first color, and/or a second shape different from the first shape).

For example, as described with reference to FIG. 7V, in some embodiments, in response to detecting the user's attention 7010 directed to the location within the region 7030 (e.g., for a threshold amount of time, such as 0.1, 0.2, 0.3, 0.5, 1, 2, 5, or 10 seconds), and in accordance with a determination that foreground content (e.g., the user interface 7122, the user interface 7032, the representation 7014′ of the physical object 7014, and/or the virtual object 7012) is not within the region 7132 (e.g., or the region 7030, another exemplary first portion of the viewport and/or of the display generation component 7100a with analogous behavior to the region 7132), the computer system displays (e.g., via the head-mounted display 7100a or display generation component 7100 more generally) the indicator 7042. Displaying an indication of a system user interface that is a position indicator, in accordance with a determination that attention of a user is directed to a first portion of a viewport into the three-dimensional environment for a threshold amount of time during a first user input and that foreground content of a first view of the three-dimensional environment is not within the first portion of the viewport into the three-dimensional environment, and forgoing displaying the indication of the system user interface that is a position indicator, in accordance with a determination that the attention of the user is directed to the first portion of the viewport into the three-dimensional environment for the threshold amount of time during the first user input and that foreground content of the first view of the three-dimensional environment is within the first portion of the viewport into the three-dimensional environment, reduces the number of user inputs needed to display user interface elements at appropriate and/or visible locations (e.g., the user does not need to perform additional user inputs to reposition and/or cease to display some user interface elements in order to avoid collision or overlap of user interface elements, and to facilitate clear visibility and/or access to (e.g., all displayed) user interface elements).

In some embodiments, while the attention of the user is directed to the first portion of the viewport into the three-dimensional environment (e.g., for the threshold amount of time), the computer system detects a second user input (e.g., a predefined hand gesture, a predefined body posture or pose, a predefined movement of one or more body parts of a user, and/or a user input detected via a hardware input device such as a button, dial, or other physical input mechanism). In response to detecting the second user input: in accordance with a determination that foreground content of the first view of the three-dimensional environment is not within the first portion of the viewport into the three-dimensional environment (e.g., because foreground content that was previously within the first portion of the viewport is no longer within the first portion of the viewport and/or because foreground content was not already visible within the first portion of the viewport and no new foreground content has become visible within (e.g., been displayed within and/or moved into) the first portion of the viewport) (e.g., while the attention of the user is directed to the first portion of the viewport, optionally for the threshold amount of time), the computer system displays a system user interface that includes a set of affordances for accessing a set of functions of the computer system (e.g., replacing display of the indicator of the system user interface with the system user interface or displaying the system user interface concurrently with the indicator of the system user interface) (e.g., the system user interface indicated by the indication of the system user interface includes the set of affordances for accessing the set of functions of the computer system); and in accordance with a determination that foreground content of the first view of the three-dimensional environment is within the first portion of the viewport into the three-dimensional environment (e.g., because foreground content that was already visible within the first portion of the viewport is still visible within the first portion of the viewport and/or new foreground content has become visible within (e.g., been displayed within and/or moved into) the first portion of the viewport, optionally at a time when the attention of the user is directed to the first portion of the viewport or during the threshold amount of time), the computer system forgoes display of the system user interface that includes the set of affordances for accessing the set of functions of the computer system. In some embodiments, forgoing displaying the indicator of the system user interface provides an indication that the system user interface will not be displayed in response to detecting the second user input (e.g., because foreground content is within the first portion of the viewport into the three-dimensional environment).

For example, as described above with reference to FIG. 7V, in some embodiments, in response to detecting the user's attention 7010 directed to the location within the region 7030 (e.g., optionally, in conjunction with another user input such as an air tap, an air pinch, or another air gesture that is detected while the user's attention 7010 is directed to the location within the region 7030), and in accordance with a determination that foreground content (e.g., the user interface 7122, the user interface 7032, the representation 7014′ of the physical object 7014, and/or the virtual object 7012) is not within the region 7132 (e.g., or the region 7030, another exemplary first portion of the display generation component 7100a with analogous behavior to the region 7132), the computer system displays (e.g., via the head-mounted display 7100a or display generation component 7100 more generally) the indicator 7042. In FIG. 7W, foreground content is within the region 7132, and the computer system forgoes displaying (e.g., ceases to display) the indicator 7042 (e.g., and does not respond to user inputs corresponding to requests to display the indicator 7042 or the system function menu 7046). Displaying a system user interface that includes a set of affordances for accessing a set of functions of the computer system in response to detecting a second user input, and in accordance with a determination that foreground content of the first view of the three-dimensional environment is not within the first portion of the viewport into the three-dimensional environment, and forgoing display of the system user interface that includes the set of affordances for accessing the set of functions of the computer system in response to detecting the second user input, and in accordance with a determination that foreground content of the first view of the three-dimensional environment is within the first portion of the viewport into the three-dimensional environment, reduces the number of inputs needed to access system functions of the computer system without cluttering the user interface with additional displayed controls, user interfaces, and/or user interface objects (e.g., the system user interface that includes the set of affordances for accessing the set of functions of the computer system does not need to be permanently displayed in order to enable access to the system functions of the computer system).

In some embodiments, the first user input includes a gesture detected while attention of the user is directed toward the first portion of the viewport (e.g., while a visual indicator or other placeholder that indicates a location at which the system user interface will be displayed if additional input is detected is displayed), and displaying the indication of the system user interface includes displaying the system user interface; and forgoing displaying the indication of the system user interface includes forgoing displaying the system user interface.

For example, as described with reference to FIG. 7Y, in some embodiments, the system function menu 7046 is displayed in response to detecting the attention of the user 7010 directed to a location in the region 7030 (e.g., optionally, in conjunction with a user input such as an air gesture), and the system function menu 7046 can be displayed without first displaying the indicator 7046 (e.g., or at the same time as the indicator 7046 is initially displayed). Displaying an indication of a system user interface and displaying a system user interface, in response to detecting a first user input that includes a gesture detected while attention of the user is directed toward the first portion of the viewport, and in accordance with a determination that attention of a user is directed to a first portion of a viewport into the three-dimensional environment for a threshold amount of time during a first user input and that foreground content of a first view of the three-dimensional environment is not within the first portion of the viewport into the three-dimensional environment, and forgoing displaying the indication of the system user interface and forgoing displaying the system user interface, in response to detecting the first user input that includes a gesture detected while attention of the user is directed toward the first portion of the viewport, and in accordance with a determination that the attention of the user is directed to the first portion of the viewport into the three-dimensional environment for the threshold amount of time during the first user input and that foreground content of the first view of the three-dimensional environment is within the first portion of the viewport into the three-dimensional environment, reduces the number of user inputs needed to display user interface elements at appropriate and/or visible locations (e.g., the user does not need to perform additional user inputs to reposition and/or cease to display some user interface elements in order to avoid collision or overlap of user interface elements, and to facilitate clear visibility and/or access to (e.g., all displayed) user interface elements).

In some embodiments, the first user input includes an air gesture (e.g., an air pinch gesture, an air tap gesture, or another air gesture as described herein) (e.g., the gesture detected while the attention of the user of the user is directed toward the first portion of the viewport includes (e.g., or is) an air gesture).

For example, as described with reference to FIG. 7Y, the system function menu 7046 is displayed in response to detecting the attention of the user 7010 directed to a location in the region 7030 (e.g., optionally, in conjunction with a user input such as an air gesture), and the system function menu 7046 can be displayed without first displaying the indicator 7046 (e.g., or at the same time as the indicator 7046 is initially displayed). Displaying an indication of a system user interface and displaying a system user interface, in response to detecting the first user input that includes an air gesture detected while attention of the user is directed toward the first portion of the viewport, and in accordance with a determination that attention of a user is directed to a first portion of a viewport into the three-dimensional environment for a threshold amount of time during a first user input and that foreground content of a first view of the three-dimensional environment is not within the first portion of the viewport into the three-dimensional environment, and forgoing displaying the indication of the system user interface and forgoing displaying the system user interface, in response to detecting the first user input that includes a gesture detected while attention of the user is directed toward the first portion of the viewport, and in accordance with a determination that the attention of the user is directed to the first portion of the viewport into the three-dimensional environment for the threshold amount of time during the first user input and that foreground content of the first view of the three-dimensional environment is within the first portion of the viewport into the three-dimensional environment, reduces the number of user inputs needed to display user interface elements at appropriate and/or visible locations (e.g., the user does not need to perform additional user inputs to reposition and/or cease to display some user interface elements in order to avoid collision or overlap of user interface elements, and to facilitate clear visibility and/or access to (e.g., all displayed) user interface elements).

In some embodiments, the system user interface includes a set of affordances for accessing a set of functions of the computer system. While displaying the system user interface that includes the set of affordances for accessing the set of functions of the computer system, the computer system detects a respective user input that meets activation criteria (e.g., the respective user input includes directing the attention of the user to a respective affordance in the set of affordances for accessing the set of functions of the computer system, optionally, in conjunction with an activation input such as an air pinch or other air gesture); and in response to detecting the respective user input that meets activation criteria, the computer system performs a function of the computer system (e.g., performing a respective function (e.g., a system function described above with reference to FIGS. 7G-7J) corresponding to the respective affordance in the set of affordances).

For example, in FIGS. 7Y (and 7G), the system function menu 7046 includes affordances for accessing one or more system functions of the computer system 101 (e.g., the affordance 7048, the affordance 7052, the affordance 7054, the affordance 7056, and the affordance 7058 in FIG. 7G, which are also illustrated in FIG. 7Y). Performing a function of the computer system in response to detecting a respective user input that meets activation criteria while displaying a system user interface that includes a set of affordances for accessing a set of functions of the computer system, reduces the number of inputs needed to perform functions of the computer system without cluttering the user interface with additional displayed controls, user interfaces, and/or user interface objects (e.g., the system user interface that includes the set of affordances for accessing the set of functions of the computer system do not need to be permanently displayed in order to enable access to the system functions of the computer system).

In some embodiments, while displaying the indication of the system user interface (e.g., in response to detecting the first user input and in accordance with a determination that foreground content of the three-dimensional environment is not within the first portion of the viewport and optionally that the attention of the user is directed to the first portion of the viewport or to a larger second portion of the viewport that encompasses the first portion of the viewport), the computer system detects movement of foreground content of the three-dimensional environment into the first portion of the viewport (e.g., due automatic movement of the foreground content, due to an input corresponding to a request to move the foreground content, or due to movement of a viewpoint of the user that moves the viewport such that the foreground content is displayed in the first portion of the viewport). In response to detecting the movement of foreground content into the first portion of the viewport, the computer system ceases to display (e.g., hiding) the indication of the system user interface (e.g., even if the attention of the user remains directed to a portion of the viewport, such as the first portion or another portion, to trigger display of the indication of the system user interface).

For example, in FIG. 7W, the user interface 7122 moves into the region 7132, and the computer system 101 ceases to display the indicator 7042 (e.g., that was displayed in FIG. 7V, prior to movement of the user interface 7122, and while the user interface 7122 (and other foreground content) was not within the region 7132). Ceasing to display the indication of the system user interface, in response to detecting movement of foreground content into the first portion of the viewport, reduces the number of user inputs needed to display the appropriate user interface elements (e.g., for accessibility and/or visibility) (e.g., the indication of the system user interface would overlap with and/or otherwise reduce accessibility to or visibility of the foreground content that moves into the first portion of the viewport, and the user does not need to perform additional user inputs to reposition and/or cease to display the indication of the system user interface to maintain access to and/or visibility of the foreground content moves into the first portion of the viewport).

In some embodiments, while the attention of the user is directed to the first portion of the viewport: while the indication of the system user interface is not displayed (e.g., in accordance with a determination that foreground content of the three-dimensional environment is within the first portion of the viewport), the computer system detects a change in state of the first view of the three-dimensional environment such that the first portion of the viewport no longer includes foreground content of the three-dimensional environment (e.g., including by detecting movement (e.g., and/or change in size and/or shape) of one or more displayed foreground user interface elements that are visible in the first view of the three-dimensional environment so as to no longer be within the first portion of the viewport either automatically or in response to user input; ceasing to display one or more previously displayed foreground user interface elements in the first view of the three-dimensional environment that were within the first portion of the viewport either automatically or in response to user input; and/or detecting a change in viewpoint of the user relative to the three-dimensional environment such that foreground user interface elements that were within the first portion of the viewport are no longer within the first portion of the viewport from the perspective of the changed viewpoint). In response to detecting the change in state of the first view of the three-dimensional environment such that the first portion of the viewport no longer includes foreground content of the three-dimensional environment, the computer system displays the indication of the system user interface (e.g., wherein the indication of the system user interface is a position indicator for the system user interface). In some embodiments, the computer system detects that the first portion of the viewport no longer includes foreground content of the three-dimensional environment while initially forgoing displaying the indication of the system user interface in response to a user input detected while foreground content of the three-dimensional environment is within the first portion of the viewport, and/or after having ceased to display the indication of the system user interface because foreground content of the three-dimensional environment moved into the first portion of the viewport, and in response displays (e.g., or redisplays) the indication of the system user interface.

For example, in FIG. 7AC, the user interface 7122 moves out of the region 7132 (e.g., after being displayed within the region 7132 in FIG. 7W) while the user's attention 7010 is directed to a location within the region 7132, and the computer system 101 displays the indicator 7042. Displaying the indication of the system user interface in response to detecting a change in state of the first view of the three-dimensional environment such that the first portion of the viewport no longer includes foreground content of the three-dimensional environment, automatically displays (e.g., or redisplays) the indication of the system user interface without requiring further user inputs (e.g., the user does not need to perform user inputs in order to redisplay the indication of the system user interface when foreground content of the three-dimensional environment moves out of, or otherwise ceases to be displayed in, the first portion of the viewport).

In some embodiments, while the attention of the user is directed to the first portion of the viewport: while displaying the indication of the system user interface (e.g., in accordance with a determination that foreground content of the three-dimensional environment is not within the first portion of the viewport, such as while initially displaying the indication of the system user interface in response to a user input detected while foreground content of the three-dimensional environment is not within the first portion of the viewport, and/or after having redisplayed the indication of the system user interface because foreground content of the three-dimensional environment moved out of the first portion of the viewport), the computer system detects a change in state of the first view of the three-dimensional environment that includes movement of foreground content of the three-dimensional environment into the first portion of the viewport (e.g., including by detecting movement (e.g., and/or change in size and/or shape) of one or more displayed foreground user interface elements into the first portion of the viewport either automatically or in response to user input; displaying a foreground user interface element that was not previously displayed and that is at least partially in the first portion of the viewport either automatically or in response to user input; and/or detecting a change in viewpoint of the user relative to the three-dimensional environment such that foreground user interface elements that were not within the first portion of the viewport are visible in the first portion of the viewport from the perspective of the changed viewpoint). In response to detecting the change in state of the first view of the three-dimensional environment that includes movement of foreground content of the three-dimensional environment into the first portion of the viewport, the computer system ceases to display the indication of the system user interface. In some embodiments, in response to detecting the change in state of the first view of the three-dimensional environment, and in accordance with a determination that (e.g., as a result of the change in state of the first view of the three-dimensional environment) foreground content of the first view of the three-dimensional environment is (e.g., still) not within the first portion of the viewport into the three-dimensional environment, the computer system maintains display of the indication of the system user interface. In some embodiments, the indication of the system user interface is displayed in response to detecting that the attention of the user is directed to a second portion of the viewport into the three-dimensional environment (e.g., optionally in conjunction with a user input such as an air gesture), wherein the second portion is larger than (e.g., and optionally includes) the first portion (e.g., such that the first portion is a sub-portion of the second portion), and wherein the user's attention is directed to a location that is not within (e.g., outside of) the first portion of the viewport into the three-dimensional environment. While displaying the indication of the system user interface, the computer system detects the change in state of the first view of the three-dimensional environment. In response to detecting the change in state of the three-dimensional environment: in accordance with a determination that foreground content of the first view of the three-dimensional environment is within (e.g., has appeared within) the first portion of the viewport into the three-dimensional environment, the computer system ceases to display the indication of the system user interface (e.g., even though the user's attention is not directed to the first portion of the viewport but optionally rather to somewhere in the second portion of the viewport outside of the first portion of the viewport); and in accordance with a determination that foreground content of the first view of the three-dimensional environment is not within the first portion of the viewport into the three-dimensional environment, the computer system maintains display of the indication of the system user interface.

For example, in FIG. 7W, while the user's attention 7010 is directed to a location within the region 7030, the user interface 7122 moves into the region 7130 (and the region 7132), and the computer system 101 ceases to display the indicator 7042 (e.g., that was displayed in FIG. 7V, prior to movement of the user interface 7122, and while the user interface 7122 (and other foreground content) was not within the region 7132). Ceasing to display the indication of the system user interface in response to detecting a change in state of the first view of the three-dimensional environment that includes movement of foreground content of the three-dimensional environment into the first portion of the viewport reduces the number of user inputs needed to display the appropriate user interface elements (e.g., for accessibility and/or visibility) (e.g., the indication of the system user interface would overlap with and/or otherwise reduce accessibility to or visibility of the foreground content that moves into the first portion of the viewport, and the user does not need to perform additional user inputs to reposition and/or cease to display the indication of the system user interface to maintain access to and/or visibility of the foreground content moves into the first portion of the viewport).

In some embodiments, the system user interface includes a set of affordances for accessing a set of functions of the computer system. While displaying the system user interface that includes the set of affordances for accessing the set of functions of the computer system, the computer system detects a change in state of the first view of the three-dimensional environment (e.g., including detecting movement (e.g., and/or change in size and/or shape) of some foreground content in the first view of the three-dimensional environment into the first portion of the viewport in response to a user input and/or due to movement of the viewpoint of the user relative to the foreground content; and/or displaying foreground content that was not previously displayed, in the first view of the three-dimensional environment, within the first portion of the viewport) that includes movement of foreground content into the first portion of the viewport into the three-dimensional environment (e.g., foreground content entering and/or appearing within the first portion of the viewport). In response to detecting the change in state of the first view of the three-dimensional environment that includes the movement of foreground content into the first portion of the viewport into the three-dimensional environment, the computer system maintains display of the system user interface that includes the set of affordances for accessing the set of functions of the computer system (e.g., the computer system maintains display of the system user interface even though (e.g., regardless of the fact that) foreground content of the first view of the three-dimensional environment is now within the first portion of the viewport into the three-dimensional environment).

For example, in FIG. 7Y, the system function menu 7046 is displayed (e.g., concurrently with the indicator 7042) while the user interface 7122 (e.g., and other foreground content) is not within the region 7132. In FIG. 7Z, the user interface 7122 moves into the region 7132, and the computer system 101 maintains display of the system function menu 7046 (e.g., despite the movement of the user interface 7122 into the region 7132). Maintaining display of the system user interface that includes a set of affordances for accessing the set of functions of the computer system, in response to detecting the change in state of the first view of the three-dimensional environment that includes movement of foreground content into the first portion of the viewport into the three-dimensional environment, maintains display of relevant user interface elements without requiring further user inputs (e.g., the computer system does not cease to display the system user interface when foreground content moves into the first portion of the viewport, which eliminates the need for the user to perform further user inputs in order to redisplay the system user interface).

In some embodiments, the system user interface includes a set of affordances for accessing a set of functions of the computer system, and while displaying the system user interface that includes the set of affordances for accessing the set of functions of the computer system (e.g., while maintaining display of the system user interface even while foreground content of the three-dimensional environment is within the first portion of the viewport), the computer system detects a change in state of the first view of the three-dimensional environment that includes movement of foreground content such that foreground content of the first view of the three-dimensional environment is not (e.g., no longer) within the first portion of the viewport into the three-dimensional environment (e.g., including foreground content ceasing to be displayed within the first portion of the viewport); In some embodiments, the system user interface that includes the set of affordances for accessing the set of functions of the computer system is itself displayed in response to detecting the first user input or is displayed in response to detecting a user input detected while displaying an indication of the system user interface (e.g., a position indicator) that is distinct from the system user interface. In some embodiments, the change in state such that foreground content of the first view of the three-dimensional environment is no longer within the first portion of the viewport is detected subsequent to detecting foreground content of the first view of the three-dimensional environment entering the first portion of the viewport (e.g., during which display of the system user interface was maintained). In response to detecting the change in state of the first view of the three-dimensional environment that includes the movement of foreground content such that foreground content of the first view of the three-dimensional environment is not (e.g., no longer) within the first portion of the viewport into the three-dimensional environment, the computer system maintains display of the system user interface that includes the set of affordances for accessing the set of functions of the computer system (e.g., the computer system maintains display of the system user interface in front of the foreground content when the foreground content is in the first portion of the viewport or optionally regardless of how or where content moves in the first view of the three-dimensional environment).

For example, in FIG. 7AA, the user interface 7122 moves out of the region 7132, and the computer system 101 maintains display of the system function menu 7046 (e.g., and redisplays the indicator 7042). The computer system 101 maintains display of the system function menu 7046 continuously in FIGS. 7Y-7AA (e.g., the computer system 101 maintains display of the system function menu 7046 regardless of where and/or how foreground content such as the user interface 7122 moves, and whether or not foreground content is within the region 7132 or not). Maintaining display of a system user interface that includes a set of affordances for accessing a set of functions of the computer system, in response to detecting a change in state of the first view of the three-dimensional environment that includes movement of foreground content such that foreground content of the first view of the three-dimensional environment is not within the first portion of the viewport into the three-dimensional environment, maintains display of relevant user interface elements without requiring further user inputs (e.g., the computer system does not cease to display the system user interface when foreground content moves into the first portion of the viewport, which eliminates the need for the user to perform further user inputs in order to redisplay the system user interface).

In some embodiments, the foreground content includes a respective user interface (e.g., a system space, such as the system spaces described above with reference to FIGS. 7G-7J) that corresponds to (e.g., at least) a respective function of the computer system (e.g., a search function, a notification history function, a volume control function, a virtual environment selection function, a virtual assistant function, one or more functions corresponding to a home menu user interface, and/or one or more functions corresponding to a settings user interface, as described above with reference to FIGS. 7G-7J).

For example, as described with reference to FIG. 7V, in some embodiments, foreground content includes system spaces, such as a home menu user interface (e.g., the system space 7060 described with reference to FIG. 7H), a settings user interface (e.g., the system space 7084 described with reference to FIG. 7J), or another user interface corresponding to a function of the computer system 101 (e.g., one or more system spaces corresponding to a search function, a notification history function, a volume control function, a virtual environment selection function, and/or a virtual assistant function, as described above with reference to FIGS. 7G-7J). Displaying an indication of a system user interface in accordance with a determination that attention of a user is directed to a first portion of a viewport into the three-dimensional environment during a first user input and that foreground content that includes a respective user interface that corresponds to a respective function of the computer system is not within the first portion of the viewport into the three-dimensional environment, and forgoing displaying the indication of the system user interface in accordance with a determination that the attention of the user is directed to the first portion of the viewport into the three-dimensional environment during the first user input and that foreground content that includes a respective user interface that corresponds to a respective function of the computer system is within the first portion of the viewport into the three-dimensional environment, reduces the number of user inputs needed to display user interface elements at appropriate and/or visible locations (e.g., the user does not need to perform additional user inputs to reposition and/or cease to display some user interface elements in order to avoid collision or overlap of user interface elements, and to facilitate clear visibility and/or access to (e.g., all displayed) user interface elements).

In some embodiments, the first view of the three-dimensional environment that is visible via the display generation component includes one or more background elements (e.g., background content such as a virtual environment, a wallpaper, and/or a background image); and displaying the indication of the system user interface in accordance with a determination that the attention (e.g., based on a gaze) of the user is directed to the first portion of the viewport into the three-dimensional environment and that foreground content (e.g., user interface elements, such as foreground elements, and optionally excluding background elements such as passthrough elements) of the first view of the three-dimensional environment is not within the first portion of the viewport into the three-dimensional environment (e.g., while the attention of the user is directed to the first portion of the viewport into the three-dimensional environment) includes displaying the indication of the system user interface without regard to positions of the one or more background elements (e.g., without regard to whether any background elements of the one or more background elements are within the first portion of the viewport into the three-dimensional environment). In some embodiments, forgoing display of the indication of the system user interface in accordance with a determination that the attention (e.g., based on a gaze) of the user is directed to the first portion of the viewport during the first user input and that content is within the first portion of the viewport (e.g., while the attention of the user is directed to the first portion of the viewport) includes forgoing displaying the indication of the system user interface without regard to positions of the one or more background elements (e.g., without regard to whether any background elements of the one or more background elements are within the first portion of the viewport).

For example, in FIG. 7V, the indicator 7042 is displayed in accordance with a determination that the user's attention 7010 is directed to a location within the region 7030 (e.g., the first portion of the display generation component 7100a is the region 7030), regardless of the cloud 7138 (e.g., background content) that is within the region 7130 (and the region 7132). Displaying the indication of the system user interface without regard to positions of one or more background elements, in accordance with a determination that the attention of the user is directed to the first portion of the viewport into the three-dimensional environment and that foreground content of the first view of the three-dimensional environment is not within the first portion of the viewport into the three-dimensional environment, reduces the number of user inputs needed to display user interface elements at appropriate and/or visible locations (e.g., the user does not need to perform additional user inputs to reposition and/or cease to display background elements to enable display of the indication of the system user interface (e.g., the indication of the system user interface can displayed on top of and/or in front of the background elements, which does not reduce visibility and/or accessibility of the indication of the system user interface)).

In some embodiments, a first application identifies a first foreground element as foreground content. In some embodiments, determining that foreground content is within the first portion of the viewport (e.g., while the attention of the user is directed to the first portion of the viewport) includes determining that the first foreground element identified by the first application is within the first portion of the viewport.

For example, as described with reference to FIG. 7V, in some embodiments, a respective application (e.g., installed on and/or stored in memory) of the computer system 101 identifies (e.g., defines) one or more foreground elements (e.g., that are associated with the respective application) as foreground content. Displaying an indication of a system user interface in accordance with a determination that attention of a user is directed to a first portion of a viewport into the three-dimensional environment during a first user input and that foreground content that includes foreground content identified as a first foreground element by a first application is not within the first portion of the viewport into the three-dimensional environment, and forgoing displaying the indication of the system user interface in accordance with a determination that the attention of the user is directed to the first portion of the viewport into the three-dimensional environment during the first user input and that foreground content that includes foreground content identified as a first foreground element by a first application is not within the first portion of the viewport into the three-dimensional environment is within the first portion of the viewport into the three-dimensional environment, reduces the number of user inputs needed to display user interface elements at appropriate and/or visible locations (e.g., the user does not need to perform additional user inputs to reposition and/or cease to display some user interface elements in order to avoid collision or overlap of user interface elements, and to facilitate clear visibility and/or access to (e.g., all displayed) user interface elements).

In some embodiments, while a second view of the three-dimensional environment, different from the first view of the three-dimensional environment, is visible (e.g., including one or more user interface elements, optionally including at least some of the one or more user interface elements that were visible in the first view of the three-dimensional environment), via the display generation component: in accordance with a determination that the attention (e.g., based on a gaze) of the user is directed to the first portion of the viewport into the three-dimensional environment and that foreground content of the second view of the three-dimensional environment is not within the first portion of the viewport into the three-dimensional environment (e.g., while the attention of the user is directed to the first portion of the viewport), the computer system displays the indication of the system user interface (e.g., the indicator 7042 (e.g., of the system function menu 7046) in FIG. 7G or system function menu 7046); and in accordance with a determination that the attention (e.g., based on a gaze) of the user is directed to the first portion of the viewport into the three-dimensional environment and that foreground content of the second view of the three-dimensional environment is within the first portion of the viewport into the three-dimensional environment (e.g., while the attention of the user is directed to the first portion of the viewport), the computer system forgoes displaying the indication of the system user interface. In some embodiments, the first portion of the viewport into the three-dimensional environment has a respective spatial relationship to the first view of the three-dimensional environment, and the first portion of the viewport into the three-dimensional environment has the respective spatial relationship to the second view of the three-dimensional environment. For example, if the first portion of the viewport into the three-dimensional environment occupies a top-center (or top-right, bottom-center, bottom-right, left-center, or other) region of the first view of the three-dimensional environment, the first portion of the viewport into the three-dimensional environment occupies the same top-center (or top-right, bottom-center, bottom-right, left-center, or other, respectively) region of the second view of the three-dimensional environment. In some embodiments, the first portion of the viewport into the three-dimensional environment has a respective spatial relationship to a respective portion of a body of the user (e.g., a head or eyes of the user) while the first view of the three-dimensional environment is visible via the one or more display generation components, and the first portion of the viewport into the three-dimensional environment has the respective spatial relationship to the respective portion of a body of the user (e.g., a head or eyes of the user) while the second view of the three-dimensional environment is visible via the one or more display generation components.

For example, in FIG. 7AA, the user 7002 moves to a new position, changing the view that is visible via the display generation component 7100a. The computer system 101 displays the indicator 7042 in accordance with a determination that the user's attention 7010 is directed to a location within the region 7132 (e.g., the same first portion of the viewport into the three-dimensional environment as in FIG. 7Y, prior to the movement of the user 7002) and that foreground content of the second view of the three-dimensional environment is not within the first portion of the viewport into the three-dimensional environment (e.g., the user interface 7122 is not within the region 7132). Displaying the indication of the system user interface in accordance with a determination that the attention of the user is directed to the first portion of the viewport into the three-dimensional environment and that foreground content of a second view of the three-dimensional environment, different from the first view of the three-dimensional environment, is not within the first portion of the viewport into the three-dimensional environment, and forgoing displaying the indication of the system user interface in accordance with a determination that the attention of the user is directed to the first portion of the viewport into the three-dimensional environment and that foreground content of the second view of the three-dimensional environment is within the first portion of the viewport into the three-dimensional environment, reduces the number of user inputs needed to display the indication of the system user interface (e.g., the user does not need to perform additional user inputs to reposition and/or resize the first portion of the viewport into the three-dimensional environment each time the viewpoint of the user changes and/or a different view of the three-dimensional environment is visible).

In some embodiments, in response to detecting the first user input: in accordance with a determination that the attention of the user is directed to a second portion of the viewport into the three-dimensional environment and is not located within the first portion of the viewport into the three-dimensional environment, wherein the first portion of the viewport into the three-dimensional environment is at least partially within the second portion of the viewport into the three-dimensional environment (e.g., the first portion is encompassed by or in some embodiments entirely within the second portion, or at least some of the first portion overlaps with the second portion) and wherein the first portion of the viewport into the three-dimensional environment is smaller than the second portion of the viewport into the three-dimensional environment (e.g., the first portion is a sub-portion of the second portion), and that foreground content of the three-dimensional environment is not within the first portion of the viewport (e.g., regardless of whether foreground content of the first view is within the second portion of the viewport), the computer system displays the indication of the system user interface. In some embodiments, in accordance with a determination that the attention of the user is directed to the second portion of the viewport and that foreground content (e.g., of the first view) of the three-dimensional environment is within the second portion of the viewport but is not within the first portion of the viewport, the computer system displays the indication of the system user interface ISE in accordance with a determination that the attention of the user is directed to the second portion of the viewport and that foreground content (e.g., of the first view) of the three-dimensional environment is within the first portion of the viewport, the computer system forgoes displaying the indication of the system user interface (e.g., regardless of whether content of the first view of the three-dimensional environment is within the second portion of the viewport).

For example, in FIG. 7V, the region 7132 is smaller than the region 7030 (e.g., is a sub-region of the region 7030). The computer system 101 displays the indicator 7042 in accordance with a determination that the user's attention is directed to a location within the region 7030, and that foreground content (e.g., the user interface 7122) is not within the smaller region 7132. Displaying an indication of a system user interface in accordance with a determination that the attention of the user is directed to a second portion of the viewport into the three-dimensional environment and is not located within the first portion of the viewport into the three-dimensional environment, wherein the first portion of the viewport into the three-dimensional environment is at least partially within the second portion of the viewport into the three-dimensional environment, and wherein the first portion of the viewport into the three-dimensional environment is smaller than the second portion of the viewport into the three-dimensional environment, and that foreground content of the three-dimensional environment is not within the first portion of the viewport, reduces the number of user inputs needed to display user interface elements at appropriate and/or visible locations (e.g., the user does not need to perform additional user inputs to reposition and/or cease to display foreground content in order to avoid collision or overlap with the indication of the system user interface, and to facilitate clear visibility and/or access to the indication of the system user interface).

In some embodiments, a first characteristic (e.g., a size, shape, and/or size) of the first portion of the viewport into the three-dimensional environment is (e.g., user) adjustable (e.g., configurable, via a settings user interface).

For example, in FIG. 7AB, the user 7002 adjusts a first characteristic (e.g., a location of) the region 7132 (and the region 7028, and the region 7030) (e.g., to be further from a top edge of the display generation component 7100a, as compared to FIG. 7AA). Displaying an indication of a system user interface in accordance with a determination that attention of a user is directed to a first portion of a viewport into the three-dimensional environment during a first user input and that foreground content of a first view of the three-dimensional environment is not within a first portion of the viewport into the three-dimensional environment that has an adjustable first characteristic, and forgoing displaying the indication of the system user interface in accordance with a determination that the attention of the user is directed to the first portion of the viewport into the three-dimensional environment during the first user input and that foreground content of the first view of the three-dimensional environment is within the first portion of the viewport into the three-dimensional environment that has the adjustable first characteristic, reduces the number of user inputs needed to display user interface elements at appropriate and/or visible locations that may be more ergonomic for the user (e.g., the user does not need to perform additional user inputs to reposition and/or cease to display some user interface elements in order to avoid collision or overlap of user interface elements, and to facilitate clear visibility and/or access to (e.g., all displayed) user interface elements).

In some embodiments, the indication of the system user interface is displayed at a first position in the three-dimensional environment (e.g., while the first characteristic of the first portion is set to a first option or value, such that the first portion of the viewport has a first spatial relationship to a current view of the three-dimensional environment). The computer system detects one or more user inputs selecting a different portion of the viewport as an updated first portion of the viewport into the three-dimensional environment (e.g., with a different size, shape, and/or location from the first portion of the viewport). After selecting the different portion of the viewport as the updated first portion of the viewport into the three-dimensional environment, the computer system detects a third user input, and in response to detecting the third user input: in accordance with a determination that the attention of the user is directed to the updated first portion of the viewport into the three-dimensional environment and that foreground content of the first view of the three-dimensional environment is not within the updated first portion of the viewport into the three-dimensional environment (e.g., and that no foreground content is (e.g., and/or moves) within the first portion of the viewport while the attention of the user is directed to the first portion of the viewport), the computer system displays the indication of the system user interface at a second position in the three-dimensional environment that is different from the first position in the three-dimensional environment; and in accordance with a determination that the attention of the user is directed to the updated first portion of the viewport into the three-dimensional environment and that foreground content of the first view of the viewport into the three-dimensional environment is within the updated first portion of the viewport into the three-dimensional environment (e.g., and/or at least one foreground user interface element is (e.g., and/or moves) within the updated first portion of the viewport during the time that the attention of the user is directed to the updated firs portion of the viewport), the computer system forgoes displaying the indication of the system user interface.

For example, in FIG. 7AD, after the user 7002 adjusts the first characteristic (e.g., the location of) the region 7132 (and the region 7028, and the region 7030), the computer system 101 displays the indicator 7042 in accordance with a determination that the user's attention 7010 is directed to a location within (e.g., the updated location of) the region 7132 and that foreground content of the first view of the three-dimensional environment is not within the region 7132. In contrast, in FIG. 7AC, the computer system 101 forgoes displaying the indicator 7042, in accordance with a determination that the user's attention 7010 is directed to the location within (e.g., the updated location of) the region 7132 and that foreground content (e.g., the user interface 7122) is within the region 7132. Displaying the indication of the system user interface at a second position, different from the first position, in the three-dimensional environment, after selecting a different portion of the viewport as an updated first portion of the viewport into the three-dimensional environment, and in accordance with a determination that the attention of the user is directed to the updated first portion of the viewport into the three-dimensional environment and that foreground content of the first view of the three-dimensional environment is not within the updated first portion of the viewport into the three-dimensional environment, and forgoing displaying the indication of the system user interface, after selecting the different portion of the viewport as the updated first portion of the viewport into the three-dimensional environment, and in accordance with a determination that the attention of the user is directed to the updated first portion of the viewport into the three-dimensional environment and that foreground content of the first view of the viewport into the three-dimensional environment is within the updated first portion of the viewport into the three-dimensional environment, automatically displays the indication of the system user interface at an appropriate location that may be more ergonomic for the user (e.g., and under appropriate circumstances) without requiring further user input (e.g., the user does not need to perform additional user inputs to adjust and/or reposition the indication of the system user interface each time a different portion of the viewport is selected as an updated first portion of the viewport).

In some embodiments, prior to detecting the one or more user inputs selecting the different portion of the viewport as the updated first portion, and while displaying the indication of the system user interface (e.g., at the first position in the three-dimensional environment), the computer system detects a fourth user input. In some embodiments, the indication of the system user interface is a position indicator. In response to detecting the fourth user input (e.g., and in accordance with a determination that content of the first view of the three-dimensional environment is not within the first portion of the three-dimensional environment), the computer system displays, at a third position in the three-dimensional environment, a system user interface that includes a set of affordances for accessing a set of functions of the computer system (e.g., the system user interface indicated by the indication of the system user interface includes the set of affordances for accessing the set of functions of the computer system). After selecting the different portion of the viewport as the updated first portion, and while displaying the indication of the system user interface (e.g., at the second position in the three-dimensional environment), the computer system detects a fifth user input. In response to detecting the fifth user input (e.g., and in accordance with a determination that foreground content of the first view of the three-dimensional environment is not within the updated first portion of the viewport into the three-dimensional environment), the computer system displays, at a fourth position in the three-dimensional environment that is different from the third position in the three-dimensional environment, the system user interface that includes the set of affordances for accessing the set of functions of the computer system.

For example, in FIG. 7AE, the computer system 101 detects the user's attention 7010 directed to the indicator 7042 (e.g., displayed at an updated/adjusted location to reflect the adjustment to the location of the region 7132, the region 7030, and the region 7028 in FIG. 7AB), optionally in conjunction with a user input such as an air gesture, and in response, displays the system function menu 7046 (e.g., at an updated/adjusted location that also reflects the adjustment to the location of the region 7132, the region 7030, and the region 7028 in FIG. 7AB). Displaying a system user interface that includes a set of affordances for accessing the set of functions of the computer system at a fourth position, different from the third position in the three-dimensional environment, in response to detecting a fifth user input after selecting a different portion of the viewport as an updated first portion and while displaying the indication of the system user interface, automatically displays the system user interface at an appropriate location that may be more ergonomic for the user without requiring further user input (e.g., the user does not need to perform additional user inputs to configure, adjust, and/or reposition the system user interface each time a different portion of the viewport is selected as an updated first portion of the viewport).

In some embodiments, the updated first portion of the viewport can be changed (e.g., updated) more (e.g., by a larger magnitude) in a first dimension (e.g., a vertical dimension) relative to the first portion of the viewport than the updated first portion of the viewport can be changed (e.g., updated) in a second dimension (e.g., a horizontal direction) relative to the first portion of the viewport. In some embodiments, changing the updated first portion of the viewport in the first and/or second dimension includes changing (e.g., configuring) a first characteristic (e.g., size, shape, or location) of the updated first portion of the viewport. In some embodiments, the first characteristic can be configured relative to the first dimension, and the first characteristic cannot be configured relative to the second dimension. For example, the first characteristic is a size or position of the first portion, and the first portion can be expanded (e.g., and/or shrunk) or shifted in a vertical direction (e.g., first dimension) but not in a horizontal direction (e.g., second dimension). This allows the first portion to be adjusted in the vertical direction to control how much the user's attention (optionally based on gaze) must be shifted in the vertical direction to be directed to the first portion (e.g., and trigger display of the first user interface object), but the first portion cannot be adjusted along the horizontal direction so that the first portion is always centered horizontally relative to the display generation component (e.g., the first portion is always located in a top center (e.g., or bottom center) of the display generation component).

For example, in FIG. 7AB, the location of the region 7132 is adjusted in a vertical direction (e.g., to be further from the top edge of the display generation component 7100a) but is not (e.g., and optionally, cannot be) adjusted in a horizontal direction. Enabling an updated first portion of the viewport to be changed more in a first dimension relative to the first portion of the viewport than in a second dimension relative to the first portion of the viewport, balances user comfort and customization (e.g., by allowing a user to customize a height by which the user's gaze must be elevated to reach the first portion of the viewport, if the first portion of the viewport is closer to the top edge of the viewport, which allows for faster and/or more comfortable user interaction the first portion of the viewport) while ensuring the first portion of the viewport is in substantially the same position with respect to the second dimension (e.g., which assists the user in identifying/locating the first portion of the viewport, by narrowing the possible dimensions and/or locations of the first portion of the viewport), and also balances user comfort and customization with efficiency of sensors of the computer system (e.g., the first and second dimensions are defined to maximize the accuracy of the sensors of the computer system, which are used to detect the user's attention and/or user inputs performed by the user).

In some embodiments, aspects/operations of methods 9000, 10000, 11000, and/or 13000 may be interchanged, substituted, and/or added between these methods. For example, the progress indicators for settings of the computer system in the method 12000 can be concurrently displayed with the first user interface object for accessing system functions of the computer system in the method 9000, 10000, 11000, or 13000. For brevity, these details are not repeated here.

Method 13000 is a method of adjusting a first parameter or a second parameter, based on whether first or second criteria are met, based on a magnitude of a user input, in accordance with some embodiments. Adjusting a first parameter of the computer system in response to detecting the start of the first user input that meets the adjustment criteria, and in accordance with a determination that first criteria are met, and adjusting a second parameter of the computer system in response to detecting the start of the first user input that meets the adjustment criteria, and in accordance with a determination that second criteria different from the first criteria are met, automatically adjusts a relevant parameter of the computer system without requiring additional user input (e.g., additional user inputs to find and/or select a relevant parameter of the computer system for adjustment).

In some embodiments, the method 13000 is performed at a computer system that is in communication with a first display generation component and one or more input devices (e.g., including a crown such as the digital crown 703 in FIGS. 8S-8AX, hardware button such as the button 8008, 8010, or 8012 in FIGS. 8A-8R, digital crown 703, button 701, button 702 in FIG. 7F2, 7O-7AL, solid state button, switch, dial, or other input element that a user input is directed to and/or used to manipulate, actuate, and/or activate, as well as cameras, touch sensors, motion sensors, and/or other sensors and devices for detecting and measuring user inputs).

The computer system detects (13002), via the one or more input devices (e.g., a crown such as the digital crown 703 in FIGS. 8S-8AX, hardware button such as the button 8008, 8010, or 8012 in FIGS. 8A-8R, digital crown 703, button 701, button 702 in FIG. 7F2, 7O-7AL, solid state button, switch, dial, or other input element that a user input is directed to and/or used to manipulate, actuate, and/or activate), a start of a first user input that meets adjustment criteria; and In some embodiments, the computer system detects the start of the first user input that meets the adjustment criteria, while a respective view of a three-dimensional environment is visible, via the first display generation component, with a virtual environment corresponding to the three-dimensional environment having a first level of immersion of a plurality of levels of immersion, and/or while another function of the computer system is being performed and displayed. In some embodiments, detecting the first user input that meets the adjustment criteria includes detecting a user input that presses on the input element, rotates the input element, swipes on the input element, or otherwise interacts with the input element in a manner sufficient to activate a function associated with the input element (e.g., meets duration, distance, intensity, speed, patter, and/or other criteria for activation) (e.g., activation of the button 8008 in FIG. 8B, rotation of the digital crown 703 in FIG. 8T, rotation of the digital crown 703 in FIG. 8AT, rotation of the digital crown 703 in FIG. 8AV, and/or rotation or activation of other input devices analogous to digital crown 703 and button 701, 702, or 8008, described herein).

In response to detecting (13004) the start of the first user input that meets the adjustment criteria, and in accordance with a determination that first criteria are met, the computer system adjusts (13006) a first parameter of the computer system in accordance with one or more first characteristic values (e.g., direction, distance, speed, acceleration, and/or magnitude) of the first user input. In some embodiments, the first criteria are met when the computer system was generating audio outputs at a time when the start of the first user input was detected, when the computer system has enabled audio output to be played at the time when the start of the first user input was detected, and/or when other criteria related to a first operating state of the computer system (e.g., the first parameter is enabled as the default parameter to be controlled by input directed to the input device (e.g., crown, hardware button, solid state button, switch, dial, or other input device to which the first user input is directed)) are met. In some embodiments, adjusting the first parameter in accordance with the one or more first characteristic values of the first user input includes adjusting a first audio output parameter for the audio outputs in accordance with a distance, speed, and/or direction of the first user input, without adjusting a second parameter (e.g., the level of immersion, the zoom level, or another parameter different from the first parameter) of the computer system (e.g., while the respective view of the three-dimensional environment continues to be visible, via the first display generation component, with the virtual environment corresponding to the three-dimensional environment maintained at the first level of immersion of a plurality of levels of immersion). In an example in accordance with some embodiments, in FIG. 8B, no audio is playing (e.g., an optionally, the “Contextual” option 8037 is selected for the “Default Selection” setting 8026 of the computer system 101, as shown in FIG. 8AM), so the computer system adjusts the level of immersion of the computer system. In another example in accordance with some embodiments, in FIG. 8AT, the “Volume” option is selected for the “Default Selection” setting 8026 of the computer system 101 (e.g., as shown in FIG. 8AS), and the computer system adjusts the audio level in response to rotation of the digital crown 703 (e.g., in accordance with a direction, speed, and/or magnitude of the rotation of the digital crown 703) in FIG. 8AT.

In response to detecting (13004) the start of the first user input that meets the adjustment criteria, and in accordance with a determination that second criteria different from the first criteria are met, the computer system adjusts (13008) a second parameter of the computer system, different from the first parameter of the computer system (e.g., adjusting a current level of immersion of the virtual environment in the three-dimensional environment from the first level of immersion to a second level of immersion of the plurality of levels of immersion that is different from the first level of immersion, or), in accordance with the one or more first characteristic values of the first user input (e.g., adjusting a level of immersion in accordance with a distance, speed, and/or direction of the first user input, without adjusting the first parameter (e.g., the audio volume, the zoom level, or another parameter different from the second parameter) of the computer system). In some embodiments, the second criteria are met when the computer system was not generating audio outputs at the time when the start of the first user input was detected, when the computer system has not enabled audio output to be played at the time when the start of the first user input was detected, and/or when criteria related to the first operating state of the computer system are not met (e.g., the first parameter is not enabled as the default parameter to be controlled by input directed to the input device (e.g., crown, hardware button, solid state button, switch, dial, or other input device to which the first user input is directed), and/or when the second parameter is enabled as the default parameter to be controlled by input directed to the input element). In an example in accordance with some embodiments, in contrast to FIG. 8B, in FIG. 8I, audio is playing (e.g., an optionally, the “Contextual” option 8037 is selected for the “Default Selection” setting 8026 of the computer system 101, as shown in FIG. 8AM), so the computer system adjusts the audio level of the computer system in response to the characteristics of the user input detected on button 8008. In an example in accordance with some embodiments, in contrast to FIG. 8AT, in Figure AV, the “Immersion” option 8039 is selected for the “Default Selection” setting 8026 of the computer system 101 (e.g., as shown in FIG. 8AU), and the computer system adjusts the level of immersion in response to rotation of the digital crown 703 (e.g., in accordance with a direction, speed, and/or magnitude of the rotation of the digital crown 703) in FIG. 8AV.

In some embodiments, the first parameter is an audio output parameter for audio outputs of the computer system (e.g., volume and/or pitch of the audio outputs of the computer system, such as audio for media playback, gaming, communication session, audio alerts, and/or other types of audio outputs). For example, in FIG. 8I, audio is playing (e.g., first criteria are met as a result) and the computer system 101 adjusts a current audio level for the computer system 101 in accordance with the characteristics of the first user input, in accordance with some embodiments. In another example, in FIG. 8AT, the “volume” option is selected for the “Default Selection” setting 8026 (e.g., in FIG. 8AS) (e.g., first criteria are met as a result of the default selection being “volume”), and the computer system 101 adjusts a current audio level for the computer system 101 in response to the characteristics of the first user input, in accordance with some embodiments. Adjusting an audio output of the computer system in response to detecting the start of the first user input that meets the adjustment criteria, and in accordance with a determination that first criteria are met, and adjusting a second parameter of the computer system in response to detecting the start of the first user input that meets the adjustment criteria, and in accordance with a determination that second criteria different from the first criteria are met, automatically adjusts a relevant parameter of the computer system without requiring additional user input (e.g., additional user inputs to find and/or select a relevant parameter of the computer system for adjustment).

In some embodiments, the second parameter is a level of immersion for three-dimensional content (e.g., a three-dimensional virtual experience, a three-dimensional application environment, an extended reality communication session or shared experience, and/or a three-dimensional background environment in which applications and system user interfaces are or may be presented) that is displayed in the three-dimensional environment. In some embodiments, the level of immersion for a respective piece of three-dimensional content is adjustable continuously, or through a plurality of discrete levels of immersion, in accordance with the one or more first characteristic values of the first user input, such that more or fewer elements of the physical environment are presented to the user while the three-dimensional content is displayed to the user. In one example, in FIG. 8B, audio is not playing (e.g., second criteria are met as the audio is not playing) and the computer system 101 adjusts a level of immersion for the computer system 101 in accordance with the characteristics of the first user input, in accordance with some embodiments. In another example, in FIG. 8AV, the “immersion” option 8039 is selected for the “Default Selection” setting 8026 (e.g., in FIG. 8AU) (e.g., second criteria are met as a result of default selection being immersion), and the computer system 101 adjusts a level of immersion for the computer system 101 in accordance with the characteristics of the first user input, in accordance with some embodiments. Adjusting a first parameter of the computer system in response to detecting the start of the first user input that meets the adjustment criteria, and in accordance with a determination that first criteria are met, and adjusting a level of immersion of the computer system in response to detecting the start of the first user input that meets the adjustment criteria, and in accordance with a determination that second criteria different from the first criteria are met, automatically adjusts a relevant parameter of the computer system without requiring additional user input (e.g., additional user inputs to find and/or select a relevant parameter of the computer system for adjustment).

In some embodiments, detecting the first user input that meets the adjustment criteria includes detecting the first user input directed to a first input device (e.g., a digital crown, a dial, a press button, and/or other types of input devices) of the one or more input devices; and before detecting the first user input, the computer system detects a user input that sets a default parameter corresponding to the first input device to the first parameter (e.g., and causes one or more other parameters, such as the second parameter, to not be the default parameter corresponding to the first input device) (e.g., in a settings user interface for the first input device, as illustrated in FIG. 8AU, the default parameter is set to level of immersion by the user (e.g., in the case where the first parameter is the level of immersion), and in FIG. 8AS, the default parameter is set to volume by the user (e.g., in the case where the first parameter is the volume)), wherein the first criteria are met as a result of the default parameter being set to the first parameter at a time of the first user input. In an example in accordance with some embodiments, as shown in FIG. 8AS, the “volume” option is selected for the “Default Selection” setting 8026, and in FIG. 8AT, since the first criteria are met (e.g., the “volume” option is selected as the default parameter by the setting 8026), and the computer system 101 adjusts a current audio level for the computer system 101 in accordance with the first user input (e.g., irrespective of whether audio is currently playing). Adjusting a first parameter of the computer system in response to detecting the start of the first user input that meets the adjustment criteria, and in accordance with a determination that first criteria are met, including a criterion that is met when a default parameter is set to the first parameter at the time of the first user input, and adjusting a second parameter of the computer system in response to detecting the start of the first user input that meets the adjustment criteria, and in accordance with a determination that second criteria different from the first criteria are met, automatically adjusts a relevant parameter of the computer system without requiring additional user input (e.g., additional user inputs to find and/or select a relevant parameter of the computer system for adjustment).

In some embodiments, detecting the first user input that meets the adjustment criteria includes detecting the first user input directed to a first input device (e.g., a digital crown, a dial, a press button, and/or other types of input devices) of the one or more input devices; and before detecting the first user input, the computer system detects a user input that sets a default parameter corresponding to the first input device to the second parameter (e.g., and causes one or more other parameters, such as the first parameter, to not be the default parameter corresponding to the first input device) (e.g., in a settings user interface for the first input device, as illustrated in FIG. 8AU, the default parameter is set to level of immersion by the user, and in FIG. 8AS, the default parameter is set to level of immersion by the user), wherein the second criteria are met as a result of the default parameter being set to the second parameter at a time of the first user input. For example, in FIG. 8AU, the “immersion” option 8039 is selected for the “Default Selection” setting 8026, and in FIG. 8AV, since second criteria are met (e.g., the “immersion” option 8039 is selected, instead of the “volume” option as in FIG. 8AS), and the computer system 101 adjusts a level of immersion for the computer system 101. Adjusting a first parameter of the computer system in response to detecting the start of the first user input that meets the adjustment criteria, and in accordance with a determination that first criteria are met, and adjusting a second parameter of the computer system in response to detecting the start of the first user input that meets the adjustment criteria, and in accordance with a determination that second criteria different from the first criteria are met, including a criterion that is met when the default parameter is set to the second parameter at the time of the first user input, automatically adjusts a relevant parameter of the computer system without requiring additional user input (e.g., additional user inputs to find and/or select a relevant parameter of the computer system for adjustment).

the first criteria are met as a result of satisfaction of a first set of conditions (e.g., including that parameter adjustment using the first input device is set to be contextual, such as whether audio is playing, audio is not playing, immersive content is displayed, and/or immersive content is not displayed; and/or that level of immersion, zoom, or other parameters are not set as the default parameter for the first input device), including a first condition that the computer system was generating audio outputs at a time when the first user input (e.g., the start of the first user input) was detected. In some embodiments, when the first criteria are met, the first parameter that is adjusted in accordance with the first user input is a first audio output parameter for the audio outputs, such as volume of the audio outputs. In an example in accordance with some embodiments, in FIG. 8I, audio is playing (e.g., the first condition is met as a result of the audio playing at the time when the first user input is detected) when the computer system 101 detects a user input (e.g., activation of the button 8008 in FIG. 8I), and the computer system 101 adjusts a current audio level for the computer system 101 in accordance with the input detected on the button 8008. Adjusting a first parameter of the computer system in response to detecting the start of the first user input that meets the adjustment criteria, and in accordance with a determination that a first set of conditions are met, including a condition that is met when the computer system is generating audio outputs at a time when the first user input is detected, and adjusting a second parameter of the computer system in response to detecting the start of the first user input that meets the adjustment criteria, and in accordance with a determination that second criteria different from the first criteria are met, automatically adjusts a relevant parameter of the computer system without requiring additional user input (e.g., additional user inputs to find and/or select a relevant parameter of the computer system for adjustment).

In some embodiments, the second criteria are met as a result of satisfaction of a second set of conditions (e.g., including that parameter adjustment using the first input device is set to be contextual, such as whether audio is playing, audio is not playing, immersive content is displayed, and/or immersive content is not displayed; and/or that volume, zoom, or other parameters are not set as the default parameter for the first input device), including a second condition that the computer system was not generating audio outputs at the time when the first user input (e.g., the start of the first user input) was detected. In some embodiments, when the second criteria are met, the second parameter that is adjusted in accordance with the first user input is a current level of immersion of a virtual environment that is displayed in the three-dimensional environment. In an example in accordance with some embodiments, in FIG. 8B, audio is not playing (e.g., a second condition is met as a result of the audio not playing at the time when the first user input is detected) when the computer system 101 detects a user input (e.g., activation of the button 8008 in FIG. 8B), and the computer system 101 adjusts a level of immersion for the computer system 101 in accordance with the input detected on the button 8008. Adjusting a first parameter of the computer system in response to detecting the start of the first user input that meets the adjustment criteria, and in accordance with a determination that first criteria are met, and adjusting a second parameter of the computer system in response to detecting the start of the first user input that meets the adjustment criteria, and in accordance with a determination that a second set of conditions are met, including a condition that is met when the computer system is not generating audio outputs at a time when the first user input is detected, automatically adjusts a relevant parameter of the computer system without requiring additional user input (e.g., additional user inputs to find and/or select a relevant parameter of the computer system for adjustment).

In some embodiments, in response to detecting the start of the first user input that meets the adjustment criteria: in accordance with a determination that third criteria, different from the first criteria and the second criteria, are met (e.g., the computer system was not generating audio outputs at a time when the start of the first user input was detected, or a third parameter is enabled as the default parameter to be controlled by input directed to the input device (e.g., crown, hardware button, solid state button, switch, dial, or other input device to which the first user input is directed)), the computer system adjusts a third parameter, different from the first parameter and the second parameter, of the computer system in accordance with the one or more first characteristic values (e.g., direction, distance, speed, acceleration, and/or magnitude) of the first user input (e.g., adjusting a zoom level of visual content in a window, zoom level of an object, and/or position of viewpoint (e.g., virtual locomotion), in accordance with a distance, speed, and/or direction of the first user input, without adjusting the first parameter and the second parameter (e.g., the level of immersion, the volume, or another parameter different from the third parameter) of the computer system). In some embodiments, detecting the first user input that meets the adjustment criteria includes detecting the first user input directed to a first input device (e.g., a digital crown, a dial, a press button, and/or other types of input devices) of the one or more input devices, and wherein the method includes: before detecting the first user input, detecting a user input that sets a default parameter corresponding to the first input device to the third parameter (e.g., and causes one or more other parameters, such as the first parameter and the second parameter, to not be the default parameter corresponding to the first input device) (e.g., in a settings user interface for the first input device, as illustrated in FIG. 8S, the default parameter is set to zoom by the user, and in FIG. 8AP, where the “zoom” option 8044 is selectable as the default parameter), wherein the third criteria are met as a result of the default parameter being set to the third parameter at a time of the first user input. For example, as described with reference to FIG. 8T, in some embodiments, the user interface 8038 (e.g., for adjusting a level of zoom of the computer system) is automatically selected by the computer system 101 in response to detecting the rotation of the digital crown 703, and zoom level is adjusted in accordance with the characteristic values of the rotation of digital crown 703, in accordance with some embodiments. As described with reference to FIG. 8AP, the “Zoom” option 8044 can be selected for the “Default Selection” setting 8026, which configures the computer system 101 to automatically select the level of zoom for adjustment as a default setting to adjust in accordance with the characteristics of the rotation of the digital crown 703 (e.g., as described with reference to FIG. 8T), in accordance with some embodiments. Adjusting a first parameter of the computer system in response to detecting the start of the first user input that meets the adjustment criteria, and in accordance with a determination that first criteria are met; adjusting a second parameter of the computer system in response to detecting the start of the first user input that meets the adjustment criteria, and in accordance with a determination that second criteria different from the first criteria are met; and adjusting a third parameter of the computer system in response to detecting the start of the first user input that meets the adjustment criteria, and in accordance with a determination that third criteria different from the first and second criteria are met, automatically adjusts a relevant parameter of the computer system without requiring additional user input (e.g., additional user inputs to find and/or select a relevant parameter of the computer system for adjustment).

In some embodiments, in response to detecting the start of the first user input that meets the adjustment criteria, the computer system displays a respective progress indicator (e.g., in the respective view of the three-dimensional environment that is currently displayed, and/or overlaid on the respective view of the three-dimensional environment), wherein the respective progress indicator indicates a respective current value for at least one of the first parameter and the second parameter (e.g., the volume, the level of immersion). In some embodiments, the respective progress indicator indicates a respective current value for the third parameter (e.g., zoom level) along with the at least one of the first parameter and the second parameter. For example, in FIG. 8B, the user interface 8014 includes the visual indicator 8015, which indicates the current level of immersion (e.g., a possible first or second parameter) of the portable multifunction device 100, and the user interface 8014 and the visual indicator 8015 are displayed in response to detecting activation of the button 8008 by the hand 7020, in accordance with some embodiments. Displaying a respective progress indicator that indicates a respective current value for at least one of the first parameter and the second parameter, in response to detecting the start of the first user input that meets the adjustment criteria, provides improved visual feedback to the user (e.g., improved visual feedback regarding which setting is being adjusted by the user, and improved visual feedback regarding the current value of the setting that is being adjusted by the user).

In some embodiments, in response to detecting the start of the first user input that meets the adjustment criteria, displaying the respective progress indicator includes: in accordance with a determination that the first criteria are met (e.g., the computer system was generating audio outputs at a time when the start of the first user input was detected, the computer system has enabled audio output to be played at the time when the start of the first user input was detected, and/or other criteria related to a first operating state of the computer system (e.g., the first parameter is enabled as the default parameter to be controlled by input directed to the input device (e.g., crown, hardware button, solid state button, switch, dial, or other input device to which the first user input is directed))), displaying a first progress indicator that indicates a current value for the first parameter (e.g., the volume, or another parameter that is set as default for the first input device). For example, in FIG. 8B, the user interface 8014 includes the visual indicator 8015, which indicates the current level of immersion (e.g., a possible first parameter) of the portable multifunction device 100, and the user interface 8014 and the visual indicator 8015 are displayed in response to detecting activation of the button 8008 by the hand 7020, in accordance with some embodiments. Displaying a respective progress indicator that indicates a respective current value for at least one of the first parameter and the second parameter, in response to detecting the start of the first user input that meets the adjustment criteria, provides improved visual feedback to the user (e.g., improved visual feedback regarding which setting is being adjusted by the user, and improved visual feedback regarding the current value of the setting that is being adjusted by the user).

In some embodiments, in response to detecting the start of the first user input that meets the adjustment criteria, displaying the respective progress indicator includes: in accordance with a determination that the second criteria are met, displaying a second progress indicator that indicates a current value for the second parameter (e.g., the level of immersion, or another parameter that is set as default for the first input device). In some embodiments, the second criteria are met when the computer system was not generating audio outputs at the time when the start of the first user input was detected, when the computer system has not enabled audio output to be played at the time when the start of the first user input was detected, and/or when criteria related to the first operating state of the computer system are not met (e.g., the first parameter is not enabled as the default parameter to be controlled by input directed to the input device (e.g., crown, hardware button, solid state button, switch, dial, or other input device to which the first user input is directed), and/or the second parameter is enabled as the default parameter to be controlled by input directed to the input element). In an example in accordance with some embodiments, in FIG. 8O, audio is not playing when the portable multifunction device 100 detects activation of the button 8008 by the hand 7020, and in response, the portable multifunction device 100 displays the user interface 8014 and the visual indicator 8015, which indicates a current value for the level of immersion (e.g., the second parameter in this example), in accordance with some embodiments. Displaying a second progress indicator that indicates a current value for the second parameter immersion, in response to detecting the start of the first user input that meets the adjustment criteria, provides improved visual feedback to the user (e.g., improved visual feedback that the second parameter is being adjusted, and improved visual feedback regarding the current value for the second parameter).

In some embodiments, in response to detecting the start of the first user input that meets the adjustment criteria, displaying the respective progress indicator includes: in accordance with a determination that the first criteria are met at the time when the start of the first user input was detected, concurrently displaying a first progress indicator that indicates the current value for the first parameter (e.g., the audio output parameter, or another parameter that is set as default) and a second progress indicator that indicates a current value for the second parameter (e.g., the level of immersion, or another parameter that is not set as default). For example, in FIG. 8I, audio is playing when the portable multifunction device 100 detects activation of the button 8008 by the hand 7020, and in response, the portable multifunction device 100 displays the user interface 8016 and the visual indicator 8017, which indicates a current value for the audio level (e.g., the first parameter in this example) of the portable multifunction device 100, and the portable multifunction device 100 also displays user interface object 8014 that corresponds to a progress indicator of the level of immersion (e.g., the second parameter in this example), where the progress indicator, optionally, indicates the current value of the level of immersion, in accordance with some embodiments. Displaying both a first progress indicator that corresponds to a first audio output parameter and a second progress indicator that corresponds to a level of immersion, in response to detecting the start of the first user input that meets the adjustment criteria, and in accordance with a determination that the computer system was generating audio outputs at the time when the start of the first user input was detected, provides improved visual feedback to the user (e.g., improved visual feedback that the first user input can be used to adjust multiple types of outputs, and improved visual feedback regarding which type of outputs is currently the target for the adjustment).

In some embodiments, while concurrently displaying the first progress indicator and the second progress indicator in accordance with the determination that first criteria are met at the time when the start of the first user input was detected, the computer system detects that an attention of a user is directed to the second progress indicator that indicates the current value for the second parameter. In response to detecting that the attention of the user is directed to the second progress indicator, in accordance with a determination that continuation of the first user input is detected while the attention of the use is directed to the second progress indicator, the computer system adjusts the second parameter (e.g., the level of immersion, or another parameter that is not set as the default parameter) in accordance with the continuation of the first user input, while maintaining the current value for the first parameter (e.g., the volume, or another parameter that is set as the default parameter). For example, as illustrated in the example in FIGS. 8I-8K, audio is playing and the portable multifunction device 100 defaults to adjusting an audio level of the portable multifunction device 100 in response to detecting activation of the button 8018, the button 8012, and/or the button 8010, initially. In FIGS. 8K-8L, the portable multifunction device 100 enables adjusting the level of immersion of the portable multifunction device 100, in response to detecting the user's attention 7010 directed to the user interface 8014 (e.g., in conjunction with activation of the button 8008 by the hand 7020, or another confirmatory user input), and maintains the current audio level for the portable multifunction device 100 (e.g., as illustrated by the same size and thickness of the sound waves in FIG. 8K and FIG. 8L), in accordance with some embodiments. As the user input continues, the level of immersion is adjusted in accordance with the characteristics of the user input, and the volume of the audio output is not adjusted, as shown in FIGS. 7L-7M, in accordance with some embodiments. Adjusting the second parameter in accordance with continuation of the first user input, in response to detecting that the attention of the user is directed to the second progress indicator, provides additional control options and allows for increased flexibility for adjusting multiple settings of the computer system (e.g., the user can switch from adjusting the first parameter such as a current audio level, to adjusting the second parameter such as a level of immersion, without needing to perform additional user inputs to pause or stop the playing audio, and without needing to perform a different input or different type of input, in order to access functionality of adjusting the level of immersion while audio is playing).

In some embodiments, while concurrently displaying the first progress indicator and the second progress indicator, in response to detecting that the attention of the user is directed to the second progress indicator, the computer system visually emphasizes the second progress indicator relative to the first progress indicator. For example, in FIG. 8L, the portable multifunction device 100 visually emphasizes the user interface 8014 by displaying the user interface 8014 (e.g., the second progress indicator in this example) at a larger size than that in FIG. 8K (e.g., where the current audio level (e.g., a second parameter in this example) of the portable multifunction device 100, represented by the user interface 8016, was being adjusted), in accordance with some embodiments. This indicates that the portable multifunction device 100 has now enables adjustment of the current level of immersion (e.g., which is represented by the user interface 8016 in this example), in accordance with some embodiments. Visually emphasizing the second progress indicator relative to the first progress indicator, in response to detecting that the attention of the user is directed to the second progress indicator, provides improved visual feedback to the user (e.g., improved visual feedback regarding which setting is currently being adjusted, and improved visual feedback that the computer system has switched to adjusting a different setting).

In some embodiments, concurrently displaying the first progress indicator that indicates the current value for the first parameter and the second progress indicator that indicates the current value for the second parameter, includes: in accordance with a determination that the current value for the first parameter is adjusted in accordance with the first user input, displaying a first progress bar in the first progress indicator that indicates the current value of the first parameter relative to a first value range of the first parameter, without displaying a second progress bar in the second progress indicator that indicates the current value of the second parameter relative to a second value range of the second parameter; and in accordance with a determination that the current value for the second parameter is adjusted in accordance with the first user input, displaying the second progress bar in the second progress indicator, without displaying the first progress bar in the first progress indicator. For example, in FIG. 8B, the level of immersion (e.g., the first parameter in this example) is being adjusted, and the portable multifunction device 100 displays the visual indicator 8015 (e.g., the first progress bar in this example) with the user interface 8014 (e.g., the first progress indicator in this example), but does not display a progress bar (e.g., the visual indicator 8017 in FIG. 8I (e.g., the second progress bar in this example)) for the user interface 8016 (e.g., the second progress indicator in this example), in accordance with some embodiments. In contrast, in FIG. 8I, the current audio level is being adjusted (e.g., the second parameter in this example), and the portable multifunction device 100 displays the visual indicator 8017 (e.g., the second progress bar in this example) with the user interface 8016 (e.g., the second progress indicator in this example), but does not display a progress bar (e.g., the visual indicator 8015 (e.g., the first progress bar in this example) in FIG. 8B) with the user interface 8014 (e.g., the first progress indicator in this example), in accordance with some embodiments. In some examples, the volume is the first parameter, and the level of immersion is the second parameter, in accordance with some embodiments. In some embodiments, the term “first,” “second,” and “third” may refer to different instances of an element or entity in different examples. Displaying a first progress bar in the first progress indicator that indicates the current value of the first parameter relative to a first value range of the first parameter, without displaying a second progress bar in the second progress indicator that indicates the current value of the second parameter, in accordance with a determination that the first parameter is adjusted in accordance with the first user input, and displaying the second progress bar in the second progress indicator without displaying the first progress bar in the first progress indicator, in accordance with a determination that the current value for the second parameter is adjusted in accordance with the first user input, provides improved visual feedback to the user (e.g., improved visual feedback regarding the current level of a setting that is being adjusted, and improved visual feedback regarding which setting is currently being adjusted).

In some embodiments, while concurrently displaying the first progress indicator and the second progress indicator, the computer system detects that the computer system is switching between adjusting the first parameter to adjusting the second parameter in accordance with the first user input. In response to detecting that the computer system is switching between adjusting the first parameter to adjusting the second parameter in accordance with the first user input, the computer system ceases to display the first progress bar in the first progress indicator, and the computer system displays the second progress bar in the second progress indicator. For example, as shown in the example in FIG. 8K, the current audio level is being adjusted and the portable multifunction device 100 displays the visual indicator 8017 with the user interface 8016 (e.g., and does not display the visual indicator 8015 with the user interface 8014). In FIG. 8L following FIG. 8K, the portable multifunction device 100 switches to adjusting the level of immersion (e.g., the second parameter), and displays the visual indicator 8015 with the user interface 8014 (e.g., the second progress bar in the second progress indicator), and ceases to display the visual indicator 8017 with the user interface 8016 (e.g., the first progress bar in the first progress indicator), in accordance with some embodiments. Ceasing to display the first progress bar in the first progress indicator and displaying the second progress bar in the second progress indicator, in response to detecting that the computer system is switching between adjusting the first parameter (e.g., corresponding to the first progress indicator) to adjusting the second parameter (e.g., corresponding to the second progress indicator), provides improved visual feedback to the user (e.g., improved visual feedback regarding the current level of a setting that is being adjusted, and improved visual feedback regarding which setting is currently being adjusted).

In some embodiments, displaying the respective progress indicator in response to detecting the start of the first user input that meets the adjustment criteria, includes: in response to detecting an initial portion of the first user input, displaying the respective progress indicator without changing the respective current value indicated by the respective progress indicator (e.g., the current value for the first parameter or the current value for the second parameter) in accordance with the initial portion of the first user input. For example, in FIG. 8B, in response to detecting initial activation of the button 8008 by the hand 7020 (e.g., and without changing a current value of a setting of the portable multifunction device 100), the portable multifunction device 100 displays the user interface 8014 and the user interface 8016 (e.g., without changing a current value for either the level of immersion which corresponds to the user interface 8014, or the current audio level which corresponds to the user interface 8016), in accordance with some embodiments. Displaying a respective progress indicator without changing the respective current value indicated by the respective progress indicator, in accordance with an initial portion of a first user input, provides additional control options without cluttering the UI with additional displayed controls (e.g., additional displayed controls for checking and/or displaying a current value of a respective setting of the computer system, and/or additional displayed controls for enabling and/or adjusting the respective setting of the computer system).

In some embodiments, displaying the respective progress indicator in response to detecting the start of the first user input that meets the adjustment criteria, includes: in response to detecting an initial portion of the first user input, displaying the respective progress indicator (e.g., the first progress indicator for the first parameter or the second progress indicator for the second parameter) with a respective progress bar (e.g., first progress bar for the first progress indicator, or second progress bar for the second progress indicator) that indicates a respective current value of a respective parameter corresponding to the respective progress indicator (e.g., the first parameter corresponding to the first progress indicator, or the second parameter corresponding the second progress indicator), without changing the respective current value of the respective parameter in accordance with the initial portion of the first user input. For example, in FIG. 8B, in response to detecting activation of the button 8008 by the hand 7020 (e.g., and without changing a current value of a setting of the portable multifunction device 100), the portable multifunction device 100 displays the visual indicator 8015 with the user interface 8014 (e.g., which displays the current value for the level of immersion (e.g., a respective parameter)), and the user interface 8016 (e.g., without changing a current value for either the level of immersion which corresponds to the user interface 8014, or the current audio level which corresponds to the user interface 8016), in accordance with some embodiments. Displaying a respective progress indicator with a respective progress bar that indicates a respective current value of a respective parameter corresponding to the respective progress indicator, without changing the respective current value indicated by the respective progress indicator, in response to detecting an initial portion of a first user input that meets adjustment criteria, provides additional control options without cluttering the UI with additional displayed controls (e.g., additional displayed controls for checking and/or displaying a current value of a respective setting of the computer system, and/or additional displayed controls for enabling and/or adjusting the respective setting of the computer system).

In some embodiments, while displaying the respective progress indicator with the respective progress bar that indicates the respective current value of the respective parameter corresponding to the respective progress indicator (e.g., the first progress bar that indicates the current value of the first parameter, or the second progress bar that indicates the current value of the second parameter), the computer system detects a subsequent portion of the first user input that follows the initial portion of the first user input. In response to detecting the subsequent portion of the first user input, the computer system adjusts the respective current value of the respective parameter corresponding to the respective progress indicator (e.g., the current value for the first parameter, or the current value for the second parameter) in accordance with the subsequent portion of the first user input. For example, in FIG. 8C, the portable multifunction device 100 detects another activation of continued interaction with the button 8008, or activation of the button 8010 by the hand 7020 (e.g., a second portion of the input, with the first portion of the input including the initial activation of the button 8008 in FIG. 8B), and in response, the portable multifunction device 100 adjusts (e.g., reduces, and/or otherwise changes) the current value for the level of immersion (e.g., a respective parameter in this example) in accordance with the second portion of the input (e.g., the activation of the button 8010 in FIG. 8B, or continued activation of the button 8008), in accordance with some embodiments. Adjusting the respective current value of the respective parameter corresponding to the respective progress indicator in accordance with a subsequent portion of the first user input, in response to detecting the subsequent portion of the first user input, and displaying the respective progress indicator (e.g., with a respective progress bar that indicates a respective current value of a respective parameter corresponding to the respective progress indicator), without changing the respective current value indicated by the respective progress indicator, in accordance with an initial portion of a first user input, in response to detecting an initial portion of the first user input, provides additional control options without cluttering the UI with additional displayed controls (e.g., additional displayed controls for checking and/or displaying a current value of a respective setting of the computer system, and/or additional displayed controls for enabling and/or adjusting the respective setting of the computer system).

In some embodiments, while displaying the respective progress indicator in a respective view of a three-dimensional environment, the computer system detects a change in viewpoint of the respective view of the three-dimensional environment from a first viewpoint to a second viewpoint different from the first viewpoint. In response to detecting the change in viewpoint of the respective view of the three-dimensional environment from the first viewpoint to the second viewpoint, the computer system ceases to display the respective progress indicator at a first position in the three-dimensional environment and displaying the respective progress indicator at a second position in the three-dimensional environment, wherein: the first position in the three-dimensional environment is visible in a first portion of a first view of the three-dimensional environment that corresponds to the first viewpoint; the second position in the three-dimensional environment is visible in a second portion of a second view of the three-dimensional environment that corresponds to the second viewpoint; and the first portion of the first view and the second portion of the second view both have a first spatial relationship to a viewport through which the three-dimensional environment is visible. For example, as described with reference to FIG. 8C, in some embodiments, the user interface 8014 (e.g., a respective progress indicator corresponding to the level of immersion (e.g., a respective parameter) of the portable multifunction device 100) and the user interface 8016 (e.g., a different progress indicator corresponding to the audio level of the portable multifunction device 100 (e.g., a different parameter)) are viewpoint-locked/head-locked such that the user interface 8014 and the user interface 8016 are always displayed with the same or substantially the same spatial relationship (e.g., in the upper central region, the middle region, or another predefined spatial region) to a viewport through which the three-dimensional environment is made visible (e.g., the display region and/or pass-through region of the display generation component 7100) of the computer system 101. Ceasing to display the respective progress indicator at a first position in the three-dimensional environment, and displaying the respective progress indicator at a second position in the three-dimensional environment that has the first spatial relationship to the viewport through which the three-dimensional environment is visible, in response to detecting a change in viewpoint of the three-dimensional environment (e.g., and the respective progress indicator has the same first spatial relationship to the viewport both before and after the change in viewpoint), automatically displays the respective progress indicator at an appropriate (e.g., and consistent) location (e.g., relative to the viewport) without requiring additional user inputs (e.g., additional user inputs to reposition the respective progress indicator, each time the viewpoint changes).

In some embodiments, displaying the respective progress indicator in the respective view of the three-dimensional environment includes displaying the respective progress indicator in proximity to a first system indicator (e.g., indicator 7042 of system function menu in FIG. 8E and other Figures including an indicator 7042, or another system indicator) that is associated with a first user interface object that provides access to a first set of functions of the computer system (e.g., system function menu 7046 in FIG. 8E and other Figures including a system function menu 7046, or another system function menu). For example, in FIG. 8E, the user interface 8014 and the user interface 8016 (e.g., a first progress indicator and a second progress indicator) are displayed in proximity to (e.g., below, and/or centered below) the indicator 7042 (e.g., which is associated with the system function menu 7046, which is, optionally, displayed immediately below the indicator 7042), in accordance with some embodiments. Displaying the respective progress indicator in the respective view of the three-dimensional environment and in proximity to a first system indicator that is associated with a first user interface object that provides access to a first set of functions of the computer system, automatically displays the respective progress indicator at an appropriate (e.g., and consistent) location (e.g., relative to the viewport, and/or alongside the first system indicator and/or the first user interface object) without requiring additional user inputs (e.g., additional user inputs to reposition the respective progress indicator, each time the viewpoint changes).

In some embodiments, the computer system concurrently displays the respective progress indicator with at least one of the first user interface object that provides access to the first set of functions of the computer system, and the first system indicator that is associated with the first user interface object, in the respective view of the three-dimensional environment. In some embodiments, the respective progress indicator is displayed at a first simulated depth relative to a viewpoint corresponding to the respective view of the three-dimensional environment, the at least one of the first user interface object and the first system indicator is displayed at a second simulated depth relative to the viewpoint corresponding to the respective view of the three-dimensional environment, and the first simulated depth is smaller than the second simulated depth. For example, as described with reference to FIG. 8E, in some embodiments, the user interface 8014 and the user interface 8016 (e.g., a first progress indicator and a second progress indicator) are displayed overlapping the system function menu 7046 (e.g., the first user interface object that that provides access to the first set of functions of the computer system, in this example) (e.g., between the viewpoint of the user 7002 and the system function menu 7046, as the user interface 8014 and the user interface 8016 appear closer to the viewpoint of the user 7002, than the system function menu 7046 and/or the indicator 7042); and/or in some embodiments, the user interface 8014 and the user interface 8016 are displayed closer to the viewpoint of the user 7002, but the user interface 8014 and the user interface 8016 do not overlap or occlude the system function menu 7046 and/or the indicator 7042. Concurrently displaying the respective progress indicator with at least one of a first user interface object and a first system indicator, wherein the respective progress indicator is displayed at a first simulated depth relative to a viewpoint, and the first user interface object and/or the first system indicator are displayed with a second simulated depth that is larger than the first simulated depth, visually emphasizes appropriate content automatically, without requiring additional user inputs (e.g., additional user inputs to bring the respective progress indicator to a position at which it is not obscured, occluded, and/or overlaid by the first user interface object and/or the first system indicator, when the user is adjusting a setting of the computer system (e.g., via, and/or corresponding to, the respective progress indicator)).

In some embodiments, while concurrently displaying the respective progress indicator and the first user interface object, the computer system disables interaction with the first user interface object using one or more types of user inputs, wherein the one or more types of user inputs are configured to interact with the first user interface object when the first user interface object is displayed without the respective progress indicator. For example, in FIG. 8G, the portable multifunction device 100 does not display the system function menu 7046 (e.g., the first user interface object in this example) (e.g., even though the user's attention 7010 is directed to the indicator 7042), since the portable multifunction device 100 is already displaying the user interface 8014 and the user interface 8016 (e.g., a first and a second progress indicator) (e.g., and the user is already adjusting, or preparing to adjust, a respective parameter such as the level of immersion of the portable multifunction device 100). In another example, if the system function menu 7406 is already displayed (e.g., at a position that is farther away from the viewpoint than the respective progress indicator), the portable multifunction device 100 does not respond to user input and/or gaze directed to the system function menu 7406, since the portable multifunction device 100 is already displaying the user interface 8014 and the user interface 8016 (e.g., and the user is already adjusting, or preparing to adjust, the level of immersion of the portable multifunction device 100), in accordance with some embodiments. In some embodiments, the computer system also disables displaying the indicator 7042 that corresponds to the system function menu 7406 in response to gaze input or other inputs that normally trigger display of the indicator or the system function menu, when the progress indicator(s) are displayed and/or their corresponding parameters being adjusted in accordance with user inputs. Disabling interaction with the first user interface object using one or more types of user inputs, automatically disables specific functions of the computer system to avoid accidental inputs and/or changes to settings of the computer system (e.g., such that a user that is adjusting a respective setting of the computer system via, and/or corresponding to, the respective progress indicator, does not accidentally adjusting other settings accessible via the first user interface object, and/or accidentally perform other functions corresponding to the first user interface object).

In some embodiments, while displaying the respective progress indicator (e.g., in a respective view of the three-dimensional environment, optionally with the first user interface object that provides access to the first set of functions of the computer system, and the first system indicator that is associated with the first user interface object), the computer system detects that dismissal criteria are met, wherein the dismissal criteria are met without requiring detection of a user input that corresponds to a request to dismiss the respective progress indicator (e.g., detecting that the user's attention and/or gaze has moved away from the respective progress indicator, and/or detecting that the user is no longer interacting with the input device that detected the first user input, without requiring the user to explicitly activate an affordance and/or providing an air gesture or control input to dismiss the respective progress indicator). In response to detecting that the dismissal criteria are met, the computer system ceases to display the respective progress indicator (e.g., automatically, without explicit user request). For example, as described with reference to FIG. 8R, in some embodiments, the user interface 8014 and the user interface 8016 (e.g., a first progress indicator and second progress indicator) cease to be displayed after the user 7002 ceases to adjust the respective setting (e.g., regardless of whether the respective setting is the level of immersion or the audio level for the computer system 101). In some embodiments, the user interface 8014 and the user interface 8016 cease to be displayed after a threshold amount of time (e.g., 1 second, 2 seconds, 5 seconds, 10 seconds, or 15 seconds) has elapsed since the user 7002 last adjusted the respective setting, and/or the user interface 8014 and the user interface 8016 cease to be displayed if the user's attention 7010 is not directed to either the user interface 8014 or the user interface 8016 (e.g., or a combination of two or more of the listed possibilities) for at least a threshold amount of time. Ceasing to display the respective progress indicator in response to detecting that the dismissal criteria are met, automatically ceases to display the respective progress indicator when appropriate, without requiring additional user inputs (e.g., a user input that corresponds to a request to dismiss the respective progress indicator).

In some embodiments, detecting that the dismissal criteria are met includes detecting that the first user input is no longer detected for at least a threshold amount of time. For example, as described with reference to FIG. 8R, in some embodiments, the user interface 8014 and the user interface 8016 (e.g., a first and second progress indicator) cease to be displayed after a threshold amount of time (e.g., 1 second, 2 seconds, 5 seconds, 10 seconds, or 15 seconds) has elapsed since the user 7002 last adjusted the respective setting (e.g., when the rotation of the digital crown has stopped for at least a threshold amount of time, or button activation has stopped for at least a threshold amount of time, or lift-off from the digital crown or button has been detected). Ceasing to display the respective progress indicator in response to detecting that the first input is no longer detected for at least a threshold amount of time (e.g., without detecting a user input that corresponds to a request to dismiss the respective progress indicator), automatically ceases to display the respective progress indicator when appropriate, without requiring additional user inputs (e.g., a user input that corresponds to a request to dismiss the respective progress indicator).

In some embodiments, detecting that the dismissal criteria are met includes detecting that user's attention is no longer directed to the respective progress indicator for at least a threshold amount of time (e.g., and optionally, that the first user input is no longer detected on the first input device, and a subsequent user input (e.g., an initial portion of the subsequent user input, or a continuation of the subsequent user input that meets the adjustment criteria) is not detected on the first input device, for at least the threshold amount of time). For example, as described with reference to FIG. 8R, in some embodiments, the user interface 8014 and the user interface 8016 (e.g., a first and second progress indicator) cease to be displayed if the user's attention 7010 is not directed to either the user interface 8014 or the user interface 8016 (e.g., or a combination of two or more of the listed possibilities, such as inputs for adjusting the parameter have stopped for at least a threshold amount of time). Ceasing to display the respective progress indicator in response to detecting that the user's attention is no longer directed to the respective progress indicator for at least a threshold amount of time (e.g., and without detecting a user input that corresponds to a request to dismiss the respective progress indicator), automatically ceases to display the respective progress indicator when appropriate, without requiring additional user inputs (e.g., a user input that corresponds to a request to dismiss the respective progress indicator).

In some embodiments, detecting that the dismissal criteria are met includes detecting that the first user input is no longer detected for at least a first threshold amount of time and detecting that user's attention is no longer directed to the respective progress indicator for at least a second threshold amount of time (e.g., the amount of time that the first user input is not detected and the user's attention is not directed to the respective progress indicator is greater than a third threshold amount of time, where the third amount of time may be less than the first amount of time and the second amount of time, respectively). In some embodiments, the dismissal criteria are not met when either the first user input (optionally, including a continuation of the first user input after a brief pause or break) is still detected, or the user's attention is still directed to the respective progress indicator (e.g., either one of the first progress indicator or the second progress indicator). In an example, as described with reference to FIG. 8R, in some embodiments, the user interface 8014 and the user interface 8016 (e.g., a first and second progress indicator) cease to be displayed after (e.g., a first threshold amount of time has elapsed since) the user 7002 ceases to adjust the respective setting and the user's attention 7010 is no longer directed to the user interface 8014 or the user interface 8016 (e.g., for at least a second threshold amount of time, which is optionally the same as, or different from, the first threshold amount of time) (e.g., but not if the user 7002 continues to adjust the respective setting while the user's attention 7010 is no longer directed to the user interface 8014 or the user interface 8016, and not if the user 7002 ceases to adjust the respective setting but the user's attention 7010 is still directed to the user interface 8014 or the user interface 8016). Ceasing to display the respective progress indicator in response to detecting that the first user input is no longer detected for at least a first threshold amount of time and that the user's attention is no longer directed to the respective progress indicator for at least a second threshold amount of time (e.g., without detecting a user input that corresponds to a request to dismiss the respective progress indicator), automatically ceases to display the respective progress indicator when appropriate, without requiring additional user inputs (e.g., a user input that corresponds to a request to dismiss the respective progress indicator).

In some embodiments, while displaying the respective progress indicator (e.g., in the respective view of the three-dimensional environment) and adjusting the respective current value for at least one of the first parameter and the second parameter in accordance with a first portion of the first user input, the computer system detects that an attention of the user has moved away from the respective progress indicator. After the attention of the user has moved away from the respective progress indicator and while the attention of the user remains away from the respective progress indicator, the computer system detects a second portion of the first user input following the first portion of the first user input. In response to detecting the second portion of the first user input, the computer system continues to adjust the respective current value for the at least one of the first parameter and the second parameter in accordance with the second portion of the first user input. For example, in 8K, the portable multifunction device 100 continues to adjust the current audio level of the portable multifunction device 100 (e.g., the first parameter in this example), even though the user's attention 7010 is no longer directed to the user interface 8016 and instead is directed to the user affordance 8014 (e.g., which corresponds to a second parameter that is the level of immersion of the portable multifunction device 100, in this example), in accordance with some embodiments. In some embodiments, the user's attention can be moved away from the user interface 8016 while the adjustment of the volume continues in accordance with the first user input, without the attention being on any portion of the environment in particular. Continuing to adjust the respective current value for the at least one of the first parameter and the second parameter, in accordance with a second portion of the first user input, and in response to detecting the second portion of the first user input, after the attention of the user has moved away from the respective progress indicator and while the attention of the user remains away from the respective progress indicator, minimizes the risk of unintentional adjustment of settings other than the respective current setting being adjusted (e.g., in case the user's attention is diverted and/or wanders while the user is making adjustments to the respective setting), which eliminates the need for the user to perform additional user inputs to undo or reverse the unintentional adjustments.

In some embodiments, displaying the respective progress indicator includes displaying a first progress indicator indicating a current value of the first parameter concurrently with a second progress indicator indicating a current value of the second parameter. In some embodiments, while concurrently displaying the first progress indicator and the second progress indicator and adjusting the current value for the first progress indicator in accordance with a third portion of the first user input, the computer system detects that an attention of a user has moved to the second progress indicator (e.g., from the first progress indicator, or from another location different from the first progress indicator or the second progress indicator). In response to detecting that the attention of the user has moved to the second progress indicator, the computer system continues to adjust the current value for the first progress indicator (e.g., and the first parameter) in accordance with a fourth portion of the first user input following the third portion of the first user input, until a pause in the first user input is detected (e.g., a pause in rotation or movement of the first user input, a lift-off from the first input device that detects the first user input, or other indication of a break in the first user input for at least a threshold amount of time). In response to detecting the pause in the first user input, the computer system ceases to adjust the current value for the first progress indicator in accordance with the first user input (and, optionally, in response to detecting resumption of the first user input and/or a subsequent user input that meets the adjustment criteria, adjusting the current value for the second parameter and the second progress indicator in accordance with the first user input and/or the subsequent user input). For example, in FIG. 8L, the current audio level of the portable multifunction device 100 (e.g., a first parameter) is no longer being adjusted by the first user input (e.g., as it was in FIG. 8K), as shown by the buttons 8010 and 8012, which are not activated by the hand 7020. After the first user input has stopped adjusting the audio level, the portable multifunction device 100 disables adjustment of the current audio level of the portable multifunction device 100, and enables adjustment of the current level of immersion (e.g., a second parameter) based on subsequent continuation of the first user input or another user input that meets the adjustment criteria (e.g., because the user's attention 7010 is directed to the user interface 8014), in accordance with some embodiments. Continuing to adjust the respective current value for the first progress indicator in accordance with the first user input, until a pause in the first user input is detected, and ceasing to adjust the respective current value for the first progress indicator in accordance with the first user input, in response to detecting a pause in the first user input, minimizes the risk of unintentional adjustment of settings other than the respective current setting being adjusted (e.g., in case the user's attention is diverted and/or wanders while the user is making adjustments to the respective setting), which eliminates the need for the user to perform additional user inputs to undo or reverse the unintentional adjustments.

In some embodiments, detecting the first user input includes detecting a movement associated with a hardware control of the computer system (e.g., a digital crown, a push button, a dial, a slider, a lever, and/or other types of hardware controls). For example, in FIGS. 8A-8R, the first user input includes activation of hardware controls (e.g., the buttons 8008, 8010, and/or 8012) of the portable multifunction device 100, in accordance with some embodiments. In another example, in FIG. 8S-8AE, the first user input includes rotation of the digital crown 703, in accordance with some embodiments. Adjusting a first parameter in accordance with a first user input that includes movement associated with a hardware control and meets adjustment criteria, and adjusting a second parameter in accordance with the first user input that includes movement associated with the hardware control and meets adjustment criteria, automatically adjusts a-relevant setting of the computer system without requiring additional user input (e.g., additional user inputs to find and/or select a relevant setting of the computer system for adjustment).

In some embodiments, adjusting a current value of a respective parameter (e.g., the first parameter, the second parameter, and/or the third parameter) in accordance with the first user input (e.g., in accordance with the one or more first characteristic values of the first user input) includes: in accordance with a determination that the first user input includes movement in a first movement direction, adjusting the current value of the respective parameter in a first adjustment direction that corresponds to the first direction; and in accordance with a determination that the first user input includes movement in a second movement direction that is different from the first movement direction, adjusting the current value of the respective parameter in a second adjustment direction that corresponds to the second movement direction, wherein the second adjustment direction is different from the first adjustment direction (e.g., rotation in the clockwise direction corresponds to an increase in value, and rotation in a counterclockwise direction corresponds to a decrease in value; movement in a first direction corresponds to an increase in value, and movement in an orthogonal direction or opposite direction corresponds to a decrease in value; and/or some other correspondence between movement direction and value change). For example, as described with reference to FIG. 8B, in some embodiments, the computer system 101 includes a rotatable input mechanism (e.g., a physical crown, or another type of rotatable input device such as a dial or a joystick), and the functionality of the button 8010 and the button 8012 described with respect to FIGS. 8A-8R, is instead determined by a direction of rotation of the rotatable input mechanism (e.g., rotating the rotatable input mechanism in a first direction increases a value for the setting, and rotating the rotatable input mechanism in an opposite direction decreases the value for the setting), in accordance with some embodiments. Optionally, a speed and/or magnitude of the rotation controls by how much the value for the setting is increased and/or decreased (e.g., faster and/or larger rotations increase and/or decrease the value by a larger amount, and slower and/or smaller rotations increase and/or decrease the value by a smaller amount), in accordance with some embodiments. This is also shown in FIG. 8U where the digital crown 703 is rotated in a first direction and the level of immersion is increased (e.g., relative to FIG. 8T); and in FIG. 8V where the digital crown 703 is rotated in an opposite direction, and the level of immersion is decreased (e.g., relative to FIG. 8U), in accordance with some embodiments. Adjusting the current value of the respective parameter in a first adjustment direction that correspond to a first direction, in accordance with a determination that the first user input includes movement in the first movement direction, and adjusting the current value of the respective parameter in a second adjustment direction, different from the first adjustment direction, that corresponds to a second movement direction that is different from the first movement direction, in accordance with a determination that the first user input includes movement in the second movement direction, provides additional control options without cluttering the UI with additional displayed controls (e.g., additional displayed controls for increasing and/or decreasing a current value for the respective parameter).

In some embodiments, adjusting the current value of the respective parameter in accordance with the first user input includes: in accordance with a determination that the first user input includes a first magnitude for a first characteristic of movement associated with the hardware control, adjusting the current value of the respective parameter by a first adjustment amount that corresponds to the first magnitude for the first characteristic of movement; and in accordance with a determination that the first user input includes a second magnitude for the first characteristic of movement associated with the hardware control that is different from the first magnitude for the first characteristic of movement associated with the hardware control, adjusting the current value of the respective parameter by a second adjustment amount that corresponds to the second magnitude for the first characteristic of movement, wherein the second adjustment amount is different from the first adjustment amount. For example, as described with reference to FIG. 8B, in some embodiments, the computer system 101 includes a rotatable input mechanism (e.g., a physical crown, or another type of input device that has rotatable mechanism), and the functionality of the button 8010 and the button 8012 illustrated in FIGS. 8A-8R is instead determined by a direction of rotation of the rotatable input mechanism (e.g., rotating the rotatable input mechanism in a first direction increases a value for the setting, and rotating the rotatable input mechanism in an opposite direction decreases the value for the setting). Optionally, a speed and/or magnitude of the rotation controls by how much the value for the setting is increased and/or decreased (e.g., faster and/or larger rotations increase and/or decrease the value by a larger amount, and slower and/or smaller rotations increase and/or decrease the value by a smaller amount), in accordance with some embodiments. Adjusting the current value of the respective parameter by a first adjustment amount that corresponds to the first magnitude for the first characteristic of movement, in accordance with a determination that the first user input includes a first magnitude for a first characteristic of movement associated with the hardware control, and adjusting the current value of the respective parameter by a second adjustment amount, different from the first adjustment amount, that corresponds to the second magnitude for the first characteristic of movement, in accordance with a determination that the first user input includes a second magnitude for the first characteristic of movement associated with the hardware control that is different from the first magnitude for the first characteristic of movement associated with the hardware control, provides additional control options without cluttering the UI with additional displayed controls (e.g., additional displayed controls for increasing and/or decreasing a current value for the respective parameter).

In some embodiments, adjusting the current value of the respective parameter in accordance with the first user input includes: in accordance with a determination that the first user input includes a first magnitude for a first characteristic of movement associated with the hardware control, adjusting the current value of the respective parameter at a first adjustment speed that corresponds to the first magnitude for the first characteristic of movement; and in accordance with a determination that the first user input includes a second magnitude for the first characteristic of movement associated with the hardware control that is different from the first magnitude for the first characteristic of movement, adjusting the current value of the respective parameter at a second adjustment speed that corresponds to the second magnitude for the first characteristic of movement, wherein the second adjustment speed is different from the first adjustment speed. For example, as described with reference to FIG. 8B, in some embodiments, the computer system 101 includes a rotatable input mechanism (e.g., a physical crown, or another type of input device that has rotatable mechanism), and the functionality of the button 8010 and the button 8012 illustrated in FIGS. 8A-8R is instead determined by a direction of rotation of the rotatable input mechanism (e.g., rotating the rotatable input mechanism in a first direction increases a value for the setting, and rotating the rotatable input mechanism in an opposite direction decreases the value for the setting). Optionally, a speed and/or magnitude of the rotation controls by how fast the value for the setting is increased and/or decreased (e.g., faster and/or larger rotations increase and/or decrease the value with a faster rate of change, and slower and/or smaller rotations increase and/or decrease the value by a slower rate of change). Adjusting the current value of the respective parameter by a first adjustment speed that corresponds to the first magnitude for the first characteristic of movement, in accordance with a determination that the first user input includes a first magnitude for a first characteristic of movement associated with the hardware control, and adjusting the current value of the respective parameter by a second adjustment speed, different from the first adjustment speed, that corresponds to the second magnitude for the first characteristic of movement, in accordance with a determination that the first user input includes a second magnitude for the first characteristic of movement associated with the hardware control that is different from the first magnitude for the first characteristic of movement associated with the hardware control, provides additional control options without cluttering the UI with additional displayed controls (e.g., additional displayed controls for increasing and/or decreasing a current value for the respective parameter).

In some embodiments, when adjusting a respective parameter of the first parameter and the second parameter (and, optionally, the third parameter) in accordance with the first user input and after an end value of a respective value range of the respective parameter has been reached (e.g., a maximum volume, a highest level of immersion, a minimum volume, a lowest level of immersion, a highest zoom level, a lowest zoom level, and/or other end values of the parameters that can be adjusted by the first input device and the first user input), the computer system detects a respective input corresponding to a request for continued adjustment of the current value of the respective parameter (e.g., continuation of the first user input, or a subsequent input that meets the adjustment criteria). In response to detecting the respective input corresponding to the request for continued adjustment of the current value of the respective parameter after the end value of the respective value range of the respective parameter has been reached, the computer system provides feedback responsive to the respective input (e.g., visual feedback on the respective progress indicator of the respective parameter, and/or other visual indication or alerts on the environment surrounding the respective progress indicator). After providing the feedback responsive to the respective input, the computer system detects an end of the respective input. In response to detecting the end of the respective input, the computer system ceases to provide the feedback responsive to the respective input and setting the current value of the respective parameter to the end value of the respective value range of the respective parameter. For example, with reference to FIG. 8B, if the portable multifunction device 100 detects a user input attempting to increase a current level of immersion beyond the maximum level of immersion, the portable multifunction device 100 displays visual feedback (e.g., the visual indicator 8015 is displayed with a first color, and/or expands in size without changing the value shown in the progress bar). If the portable multifunction device 100 detects a user input attempting to decrease a current level of immersion beyond the minimum level of immersion, the portable multifunction device 100 displays different visual feedback (e.g., the visual indicator is displayed with a second color, different from the first color, and/or shrinks in size without changing the value shown in the progress bar). In some embodiments, the visual feedback ceases to be displayed (e.g., the color, and/or change in size of the visual indicator 8015 is restored) once the input that attempts to change the value beyond the maximum or minimum value of the adjusted parameter ceases to be detected. In some embodiments, the computer system forgoes providing feedback responsive to the respective input, if the respective input is detected before (e.g., and/or while) an end value of the respective range of the respective parameter is reached. For example, as described with reference to FIG. 8B, in some embodiments, the portable multifunction device 100 provides feedback (e.g., visual feedback, audio feedback, and/or haptic feedback) when the portable multifunction device 100 detects that a current value for a setting is the maximum (e.g., or minimum) value for that setting, and the portable multifunction device 100 detects a user input to further increase (e.g., or decrease) the current value for the setting. Providing feedback responsive to a respective input corresponding to a request for continued adjustment of the current value of a respective parameter, and after an end value of a respective value range of the respective parameter has been reached, and ceasing to provide the feedback responsive to the respective input and setting the current value for the respective parameter to the end value of the respective value range of the respective parameter, in response to detecting the end of the respective input, provides improved visual feedback to the user (e.g., improved visual feedback that the respective parameter has been adjusted to a maximum or minimum value and that further adjustment beyond the maximum/minimum value is not possible).

In some embodiments, the one or more input devices includes a rotatable input device (e.g., a digital crown or dial that is rotatable and is able to detect a press input, and/or a button that is rotatable and is able to detect a press input). In some embodiments, before detecting the start of the first user input that meets the adjustment criteria, the computer system detects, via the rotatable input device, a first activation input of a first type (e.g., an initial rotation of the rotatable input device without a preceding press on the rotatable input device, or a press input on the rotatable input device without a preceding rotation of the rotatable input device). In response to detecting the first activation input of the first type, the computer system displays a menu that includes a plurality of options for adjusting settings of the computer system, and the computer system selects a first option (e.g., the first parameter, a default parameter associated with the rotatable input device, the volume, the level of immersion, the zoom level, and/or another parameter associated with the rotatable input device and/or that is adjustable in accordance with input that meets the adjustment criteria and the first criteria) of the plurality of options for adjusting settings of the computer system. While displaying the menu that includes the plurality of options for adjusting settings of the computer system, the computer system detects, via the rotatable input device, a second activation input of a second type that is different from the first type (e.g., a press and release input, a long press input, a double press input, or another input of a type that is different from the first type). In response to detecting the second activation input of the second type, the computer system selects a second option (e.g., the second parameter, an non-default parameter associated with the rotatable input device, the volume, the level of immersion, the zoom level, and/or another parameter associated with the rotatable input device and/or that is adjustable in accordance with input that meets the adjustment criteria and the second criteria or the third criteria), different from the first option, of the plurality of options for adjusting settings of the computer system. In some embodiments, it is not necessary to provide an activation input to trigger display of the menu and/or selecting an option in the menu, before a parameter or setting of the computer system (e.g., the first parameter, the second parameter, or the third parameter) can be adjusted. In some embodiments, the first criteria for adjusting the first parameter, the second criteria for adjusting the second parameter, and the third criteria for adjusting the third criteria can be met without first displaying the menu and/or the options that corresponds to the first parameter, the second parameter, and/or the third parameter. In an example, in FIGS. 8T, in response to detecting a first activation input of a first type (e.g., rotation of the digital crow 703, or another activation input of a first type), the computer system 101 displays the user interface 8014, the user interface 8038, and the user interface 8016 (e.g., a menu that includes a plurality of options for adjusting settings, such as a level of immersion, a level of zoom, and an audio level, respectively, of the computer system 101), and selects the user interface 8014 (e.g., by default, based on settings of the computer system 101) (e.g., for adjusting the current level of immersion based on subsequent user inputs), in accordance with some embodiments. In FIG. 8X, in response to detecting a second activation input of a second type (e.g., activation of a button of the digital crown 703, or another activation input of a second type different from the first type), the computer system 101 selects the user interface 8038 (e.g., for adjusting a zoom level based on subsequent user inputs), in accordance with some embodiments. Displaying a menu that includes a plurality of options for adjusting settings of the computer system and selecting a first option of the plurality of options for adjusting settings of the computer system, in response to detecting a first activation input of a first type, and selecting a second option, different from the first option, of the plurality of options for adjusting settings of the computer system, in response to detecting a second activation input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, the plurality of options for adjusting settings of the computer system includes an option for adjusting a volume of the computer system (e.g., as the first parameter, the second parameter, or the third parameter). For example, in FIGS. 8AH-8AJ, the computer system 101 displays the user interface 8016 (e.g., corresponding to a volume setting of the computer system 101), and a volume setting of the computer system 101 is adjusted in accordance with user input (e.g., pinch and drag input by the hand 7020, or another type of user input that meets adjustment criteria, such as a rotation of the crown 703, or a button press on button 701 or 702) while the user interface 8016 is selected, in accordance with some embodiments. Displaying a menu that includes a plurality of options for adjusting settings of the computer system, including an option for adjusting a volume of the computer system, and selecting a first option of the plurality of options for adjusting settings of the computer system, in response to detecting a first activation input of a first type, and selecting a second option, different from the first option, of the plurality of options for adjusting settings of the computer system, in response to detecting a second activation input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, the plurality of options for adjusting settings of the computer system includes an option for adjusting a level of immersion of the computer system (e.g., as the first parameter, the second parameter, or the third parameter). For example, in FIGS. 8T-8V, the computer system 101 displays the user interface 8014 (e.g., corresponding to a level of immersion setting of the computer system 101), and a level of immersion of the computer system 101 is adjusted in accordance with user inputs (e.g., rotation of crown 703, or another type of user input that meets adjustment criteria, such as a pinch and drag input by the hand 7020, or button press input on button 701 or 702), while the user interface 8014 is selected, in accordance with some embodiments. Displaying a menu that includes a plurality of options for adjusting settings of the computer system, including an option for adjusting a level of immersion of the computer system, and selecting a first option of the plurality of options for adjusting settings of the computer system, in response to detecting a first activation input of a first type, and selecting a second option, different from the first option, of the plurality of options for adjusting settings of the computer system, in response to detecting a second activation input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, the plurality of options for adjusting settings of the computer system includes an option for adjusting a level of zoom of the computer system (e.g., as the first parameter, the second parameter, or the third parameter). For example, in FIGS. 8W-8AA, the computer system 101 displays the user interface 8038 (e.g., corresponding to a zoom setting and/or zoom level of the computer system 101), and a level of zoom of the computer system 101 is adjusted in accordance with user input (e.g., rotation of crown 703, or another type of user input that meets adjustment criteria, such as a pinch and drag input by the hand 7020, or press input on button 701 or 702), while the user interface 8038 is selected (e.g., and the zoom user interface 8042 is displayed in FIGS. 8X-8Z), in accordance with some embodiments. Displaying a menu that includes a plurality of options for adjusting settings of the computer system, including an option for adjusting a level of zoom of the computer system, and selecting a first option of the plurality of options for adjusting settings of the computer system, in response to detecting a first activation input of a first type, and selecting a second option, different from the first option, of the plurality of options for adjusting settings of the computer system, in response to detecting a second activation input of a second type that is different from the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, a respective option of the first option and the second option of the plurality of options for adjusting settings of the computer system, is the option for adjusting the level of zoom of the computer system. In some embodiments, while the option for adjusting the level of zoom of the computer system is selected, the computer system displays a zoom user interface, including displaying, within the zoom user interface, a portion of a respective view of a three-dimensional environment that includes the zoom user interface, at an increased scale (e.g., a central portion of the viewport through which the three-dimensional environment is visible to the user is displayed with an increased scale, as if seen through a zoom lens). For example, in FIGS. 8X-8Z, the computer system 101 displays the zoom user interface 8042, which includes a portion of the respective view of the environment displayed at an increased scale relative to other portions of the view of the three-dimensional environment (e.g., the user interface 8014, the representation 8014′ of the physical object 8014, and the user interface 8038) (e.g., the virtual object 7012 in the zoom user interface 8042 of FIGS. 8Y and 8Z is displayed at increased scales (e.g., as compared to a normal or default size of the virtual object 7012 shown in FIG. 8X, when the virtual object 7012 is not displayed in the zoom user interface 8042) (e.g., and compared to the user interface 8014, the representation 8014′ of the physical object 8014, and the user interface 8038), in accordance with some embodiments. Displaying a zoom user interface that includes a portion of the respective view of the environment displayed at an increased scale while an option for adjusting the level of zoom of the computer system is selected, provides additional control options without cluttering the UI with permanently displayed user interfaces (e.g., the zoom user interface does not need to be permanently displayed, and can instead be displayed only when the option for adjusting the level of zoom of the computer system is selected) and makes using the computer system more accessible to and ergonomic for a wider variety of users (e.g., including low vision users who would benefit from user interface zoom capabilities.

In some embodiments, displaying the menu that includes the plurality of options for adjusting settings includes: in accordance with a determination that a setting for enabling zoom functionality is enabled for the computer system, displaying the option for adjusting the level of zoom of the computer system. For example, as described above with reference to FIGS. 8T, in some embodiments, the user interface 8038 (e.g., corresponding to a zoom setting and/or zoom level of the computer system 101 in this example) is displayed if a corresponding zoom function is enabled for the computer system 101. In FIG. 8AM, the settings user interface 8024 includes a “Show Zoom” setting 8028 that controls whether or not a level of zoom can be adjusted for the computer system 101, in accordance with some embodiments. Displaying an option for adjusting a level of zoom of the computer system in accordance with a determination that a setting for enabling zoom functionality is enabled for the computer system allows the computer system to conditionally enable functionality only when appropriate, which allows the computer system to display relevant options (e.g., for adjusting relevant settings of the computer system) without cluttering the UI with unnecessary options (e.g., options which are not relevant in a particular context), and reduces the number of user inputs needed to adjust relevant settings of the computer system (e.g., relevant settings of the computer system are displayed concurrently, allowing for efficient access to the relevant settings without needing to perform additional user inputs to navigate through different menus and/or user interfaces for accessing different settings of the computer system).

In some embodiments, while the menu is not displayed, the computer system detects a third activation input of the first type. In response to detecting the third activation input of the first type: in accordance with a determination that the setting for enabling zoom functionality is not enabled for the computer system (e.g., adjustment of the third parameter is not enabled for the first input device, such as the digital crown that is used to detect the first activation input of the first type and the second activation input of the second type) and that the first criteria are not met (e.g., the computer system was not generating audio output at a time when the third activation input was detected), the computer system changes the second parameter (e.g., changing a current level of immersion of a virtual environment from a first level of immersion to a second level of immersion that is different from the first level of immersion) in accordance with the third activation input of the first type (e.g., a rotation input, a movement input, or another input of the first type) (e.g., the third input of the first type is an input that meets adjustment criteria and the second criteria are met in accordance with a determination that the setting for enabling zoom functionality is not enabled and audio is not playing at the time of the third activation input of the first type). For example, in FIG. 8B, the “Show Zoom” setting 8028 is not enabled (e.g., as shown in FIG. 8AS) at the time when the input on button 8008 is detected, and the computer system 101 defaults to adjusting the level of immersion (e.g., because a level of zoom is not enabled for adjustment, and because no audio is playing (e.g., first criteria are not met)), in accordance with some embodiments. In an example in accordance with some embodiments, in FIGS. 8AS and 8AT, the “Show Zoom” setting 8028 is not enabled (e.g., in FIG. 8AS), and in FIG. 8AT, the computer system 101 defaults to adjusting a current audio level (e.g., because first criteria are met when the “Volume” option 8041 is selected for the “Default Selection” setting 8026, as shown in FIG. 8AS), in accordance with some embodiments. Changing the second parameter in accordance with a third activation input of the first type, and in accordance with a determination that the setting for enabling zoom functionality is not enabled for the computer system, automatically changes the second parameter without requiring additional user input (e.g., additional user inputs to navigate to and/or select an option for adjusting the second parameter, when other options for adjusting other settings of the computer system are not applicable or available for adjustment).

In some embodiments, detecting the first activation input of the first type includes detecting a first portion of the first activation input followed by a second portion of the first activation input (e.g., detecting an initial rotation of the rotatable input device followed by a subsequent rotation of the rotatable input device in a same input or a sequence of consecutive rotations that are separated by less than a threshold amount of time); and displaying the menu that includes the plurality of options for adjusting settings of the computer system and selecting the first option of the plurality of options for adjusting settings of the computer system are performed in response to detecting the first portion of the first activation input without adjusting a first setting corresponding to the first option of the plurality of options (e.g., the initial rotation of the rotatable input device causes display of the menu and selection of a first option or default option, e.g., volume, level of immersion, or another parameter associated with the rotatable input device). In some embodiments, in response to detecting the second portion of the first activation input, the computer system adjusts the first setting corresponding to the first option of the plurality of options, in accordance with the second portion of the first activation input (e.g., after the initial rotation of the rotatable input device and the display of the menu, if an activation input of the second type is not detected before a subsequent rotation is detected, the first option or default option (e.g., volume, level of immersion, or another parameter associated with the rotatable input device) continues to be selected and is adjusted in accordance with the continued rotation of the rotatable input device). For example, as shown in FIGS. 8S-8T and as further described above with reference to FIG. 8U, in some embodiments, an initial amount of rotation (e.g., the initial amount of rotation shown in FIG. 8T, and/or an initial amount of rotation up to the first threshold amount of rotation needed to display the user interface 8014, the user interface 8038, and the user interface 8016) does not result in adjustment of the current level of immersion (e.g., is ignored and/or not processed by the computer system 101 for purposes of adjusting the current level of immersion, or other currently selected parameter for adjustment). Further rotation of the digital crown 703 in FIGS. 8U-8V, however, does result in adjustment of the current level of immersion (e.g., or another currently selected parameter for adjustment), in accordance with some embodiments. Adjusting the first setting corresponding to the first option of the plurality of options, in accordance with the second portion of the first activation input, without adjusting the first setting corresponding to the first option of the plurality of options in response to detecting the first portion of the first activation input, reduces the risk of accidental and/or incorrect adjustments to the first setting, which reduces the number of user inputs needed to adjust the first setting to an appropriate value or level (e.g., the user does not need to perform additional user inputs to undo and/or reverse unintentional adjustments to the first setting caused by the first portion of the first activation input).

In some embodiments, selecting the first option of the plurality of options for adjusting settings of the computer system includes displaying the first option of the plurality of options with an appearance that is visually emphasized (e.g., displayed with a greater size, stronger color saturation, highlighted, greater opacity, enhanced with animation, and/or other visual effects) relative to respective appearances of other options of the plurality of options; and selecting the second option of the plurality of options for adjusting settings of the computer system includes displaying the second option of the plurality of options with an appearance that is visually emphasized relative to respective appearances of other options of the plurality of options. For example, in FIG. 8T, the user interface 8014 is selected and is displayed with a different appearance than (e.g., visually emphasized relative to) the user interface 8038 and the user interface 8016 (e.g., the user interface 8014 is displayed with a white background and black outline, while the user interface 8038 and the user interface 8016 are displayed with gray backgrounds and white outlines), in accordance with some embodiments. In FIG. 8W, the user interface 8014 is no longer selected and the user interface 8038 is selected; and as a result, the user interface 8038 is displayed with a different appearance than (e.g., visually emphasized relative to), the user interface 8014 and the user interface 8016 (e.g., the user interface 8038 is displayed with a white background and black outline, while the user interface 8014 and the user interface 8016 are displayed with gray backgrounds and white outlines), in accordance with some embodiments. Selecting the first option of the plurality of options for adjusting settings of the computer system, including displaying the first option of the plurality of options with an appearance that is visually emphasized relative to respective appearances of other options of the plurality of options, and selecting the second option of the plurality of options for adjusting settings of the computer system, including displaying the second option of the plurality of options with an appearance that is visually emphasized relative to respective appearances of other options of the plurality of options, provides improved visual feedback to the user (e.g., improved visual feedback regarding which option of the plurality of options is currently selected).

In some embodiments, selecting the first option of the plurality of options for adjusting settings of the computer system includes displaying a first progress indicator that indicates a current value for a first setting corresponding to the first option of the plurality of options for adjusting settings of the computer system (e.g., the first progress indicator that indicates the current value for the first parameter); selecting the second option of the plurality of options for adjusting settings of the computer system includes displaying a second progress indicator that indicates a current value for a second setting corresponding to the second option of the plurality of options for adjusting settings of the computer system (e.g., the second progress indicator that indicates the current value for the second parameter); the first progress indicator is not displayed when the first option of the plurality of options for adjusting settings of the computer system is not selected; and the second progress indicator is not displayed when the second option of the plurality of options for adjusting settings of the computer system is not selected. For example, in FIG. 8T, the user interface 8014 is selected and the visual indication 8015 (e.g., a progress indicator that indicates a current value for the level of immersion) is also displayed, while the user interface 8038 and 8016 corresponding to unselected parameters (e.g., zoom level, and volume, in this example) are not displayed with corresponding progress bars indicating the current values of the unselected parameters, in accordance with some embodiments. Similarly, in FIG. 8W, the user interface 8038 is selected and the visual indication 8040 (e.g., a progress indicator that indicates the current value of the level of zoom) is also displayed, while the user interface 8014 and 8016 corresponding to unselected parameters (e.g., level of immersion, and volume, in this example) are not displayed with corresponding progress bars indicating the current values of the unselected parameters, in accordance with some embodiments. Displaying a first progress indicator that indicates a current value for a first setting corresponding to the first option of the plurality of options for adjusting settings of the computer system (e.g., while the first option of the plurality of options is selected), and displaying a second progress indicator that indicates a current value for a second setting corresponding to the second option of the plurality of options for adjusting settings of the computer system (e.g., while the second option of the plurality of options is selected), provides improved visual feedback to the user (e.g., improved visual feedback regarding the currently selected option of the plurality of options, and improved visual feedback regarding the value (e.g., the current value) for a setting corresponding to the currently selected setting).

In some embodiments, after selecting a respective option of the plurality of options for adjusting settings of the computer system, the computer system detects a fourth activation input (e.g., an input that meets the adjustment criteria, and/or an activation input of the first type) (e.g., a rotational input detected on the rotational input device, an air gesture (e.g., twist, swipe, drag) that is, optionally, detected in conjunction with a gaze input that is directed to a progress indicator for a respective adjustable and/or selected parameter). In response to detecting the fourth activation input, the computer system adjusts a respective setting corresponding to the respective option based on the fourth activation input. For example, in FIG. 8U, after selecting the user interface 8014 (e.g., after the computer system automatically selects the user interface 8014 for adjustment according to the settings and/or the current context, or in response to other selection inputs), the computer system detects further rotation of the digital crown 703, and in response, adjusts a level of immersion of the computer system in accordance with the rotation of the digital crown 703. In another example, in FIG. 8I, after selecting the user interface 8016 (e.g., via a head-based pointer, as shown in FIGS. 8AE-8AH, or according to other types of selection inputs), the computer system detects movement of the user's hand 7020 (e.g., an air pinch and drag gesture performed by the hand 7020), and in response, adjusts a current audio level (e.g., for video playing in the user interface 8022 and/or for the computer system 101) in accordance with the movement of the user's hand, in accordance with some embodiments. Adjusting a respective setting corresponding to the respective option based on a fourth activation input, in response to detecting the fourth activation input, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, the fourth activation input is an activation input of the first type; and adjusting the respective setting corresponding to the respective option includes: in accordance with a determination that the respective option is the first option, adjusting a first setting corresponding to the first option in (e.g., adjusting the first parameter, and/or a default parameter) accordance with the fourth user input of the first type; and in accordance with a determination that the respective option is the second option, adjusting a second setting corresponding to the second option (e.g., adjusting the second parameter, and/or a non-default parameter) in accordance with the fourth activation input of the first type. For example, in FIG. 8U, the computer system 101 detects further rotation of the digital crown 703 (e.g., a subsequent user input of the same type as in FIG. 8T, or a continuation of the user input that starts in FIG. 8T), and in response, the computer system 101 adjusts the level of immersion (e.g., corresponding to the user interface 8014, which is the currently selected option) in accordance with the rotation of the digital crown 703, in accordance with some embodiments. Similarly, in FIG. 8X, the computer system 101 detects rotation of the digital crown 703 (e.g., a user input of the same type as in FIG. 8T and/or FIG. 8U), and in response, the computer system 101 adjusts the level of zoom (e.g., corresponding to the user interface 8038, which is the currently selected option) in accordance with the rotation of the digital crown 703, in accordance with some embodiments. Adjusting a first setting corresponding to a first option in accordance with a fourth activation input of the first type, in response to detecting the fourth activation input and in accordance with a determination that the respective option is the first option, and adjusting a second setting corresponding to a second option in accordance with the fourth activation input of the first type, in response to detecting the fourth activation input and in accordance with a determination that the respective option is the second option, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, the fourth activation input includes movement of a user's hand (e.g., a pinch and drag movement of the user's hand, a pinch and twist gesture, a tap and drag gesture, or another air gesture or touch gesture); and adjusting the respective setting corresponding to the respective option includes: in accordance with a determination that the respective option is the first option (e.g., while the first option is selected, and/or while the user's attention is directed to the first progress indicator that corresponds to the first parameter), adjusting a first setting corresponding to the first option (e.g., adjusting the first parameter, and/or a default parameter) in accordance with the movement of the user's hand during the fourth activation input; and in accordance with a determination that the respective option is the second option (e.g., while the second option is selected, and/or while the user's attention is directed to the second progress indicator that corresponds to the second parameter), adjusting a second setting corresponding to the second option (e.g., adjusting the second parameter, and/or a non-default parameter) in accordance with the movement of the user's hand during the fourth activation input. For example, in FIGS. 8AI-8AJ, the computer system 101 detects movement of the user's hand 7020, and in response, the computer system adjusts the audio level of the computer system 101 (e.g., corresponding to the user interface 8016, which is the currently selected option) in accordance with the movement of the user's hand 7020 (e.g., increasing as the user's hand moves to the right in FIG. 8AI, and decreasing as the user's hand moves to the left in FIG. 8AJ), in accordance with some embodiments. As described with reference to FIG. 8AI, in some embodiments, another option (e.g., corresponding to the current level of immersion or the current level of zoom) can be similarly adjusted by an analogous air pinch and drag gesture (e.g., movement of the user's hand 7020) to the movement of the user's hand 7020 shown in FIGS. 8AI-8AJ, if the option is the currently selected option. Adjusting a first setting corresponding to a first option in accordance with movement of a user's hand, in response to detecting a fourth activation input that includes movement of the user's hand and in accordance with a determination that the respective option is the first option, and adjusting a second setting corresponding to a second option in accordance with the movement of the user's hand, in response to detecting the fourth activation input that includes the movement of the user's hand and in accordance with a determination that the respective option is the second option, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, the respective option is an option of the plurality of options to which a user's attention was directed when the fourth activation input was detected. For example, in FIG. 8AH, the attention of the user 7002 (e.g., based on a head-based pointer, and/or another indication of the user's attention) is directed to the user interface 8016, which is the selected user interface when the computer system 101 detects the movement of the user hand 7020 (e.g., an air pinch and drag gesture) in FIGS. 8AI-8AJ. In FIGS. 8AI-8AJ, the computer system 101 adjusts the current audio level (e.g., the setting corresponding to the currently selected user interface 8016) for the video playing in the user interface 8022 and/or the current audio level for the computer system 101 in accordance with the movement of the user's hand 7020, in accordance with some embodiments. This is also described with reference to FIG. 8AI, for example, where in response to detecting the air pinch and drag with the hand 7020, the computer system 101 adjusts a setting corresponding to a user interface to which the user's attention (e.g., based on the head-based pointer, and/or other indications of the user's attention) is directed when the (e.g., at least the beginning of the) air pinch and drag is detected, in accordance with some embodiments. Adjusting a respective setting corresponding to a respective option to which the user's attention was directed when a fourth activation input is detected, in response to detecting the fourth activation input, provides additional control options without cluttering the UI with additional displayed controls (e.g., additional displayed controls for increasing, decreasing, and/or otherwise adjusting the respective setting) and without cluttering the UI with permanently displayed control options (e.g., the computer system does not need to permanently display the plurality of options for adjusting settings of the computer system at all times).

In some embodiments, detecting the second activation input of the second type includes detecting activation of a button of the rotatable input device (e.g., a press and release of the button, a press followed by a release within a threshold amount of the press, a tap on the button, or another activation of the button that is performed with less than a threshold duration). For example, as described with reference to FIG. 8AB, in some embodiments, the activation input of the second type (e.g., the different type of input from rotation of the crown 703) includes activating a button of the digital crown 703 (e.g., a press and release of a button of the digital crown 703), and the activation input of the second type changes the currently selected option from zoom level adjustment to volume adjustment, in accordance with some embodiments. Displaying a menu that includes a plurality of options for adjusting settings of the computer system and selecting a first option of the plurality of options for adjusting settings of the computer system, in response to detecting a first activation input of a first type, and selecting a second option, different from the first option, of the plurality of options for adjusting settings of the computer system, in response to detecting a second activation input that includes activation of a button of a rotatable input device and is a different type of input than the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, detecting the second activation input of the second type includes detecting activation of a button of the rotatable input device for at least a threshold amount of time (e.g., a touch and hold input on the button, a press for at least the threshold amount of time followed by releasing the button, a press for at least the threshold amount of time without releasing the button, or another type of sustained activation of the button with at least a threshold duration). For example, as described with reference to FIG. 8AB, in some embodiments, the user input of the second type (e.g., the different type of input from rotation of the crown 703) includes holding a button of the digital crown 703 (e.g., pressing a button of the digital crown 703 for at least a threshold amount of time such as 0.5, 1, 2, 5, or 10 seconds), the activation input of the second type changes the currently selected option from zoom level adjustment to volume adjustment, in accordance with some embodiments. Displaying a menu that includes a plurality of options for adjusting settings of the computer system and selecting a first option of the plurality of options for adjusting settings of the computer system, in response to detecting a first activation of a first type, and selecting a second option, different from the first option, of the plurality of options for adjusting settings of the computer system, in response to detecting a second activation input that includes activation of a button of a rotatable input device for at least a threshold amount of time and is a different type of input than the first type, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, while displaying the menu that includes the plurality of options for adjusting settings of the computer system, the computer system selects a respective option (e.g., an option that is not currently selected) of the plurality of options for adjusting settings of the computer system in accordance with a determination that attention of a user (e.g., gaze, or a gaze substitute such as a hand pointing gesture that indicates a portion of the three-dimensional environment with which the user intends to interact) is directed to the respective option of the plurality of options. For example, in FIG. 8AF, the computer system 101 selects the user interface 8038 and the corresponding zoom level parameter for adjustment, in accordance with the attention of the user 7002 (e.g., in accordance with a head-based pointer that points to the user interface 8038, and/or other indications of the user's attention) being directed to the user interface 8038; and in FIG. 8AG, the computer system 101 selects the user interface 8014 and the corresponding level of immersion parameter for adjustment, in accordance with a change in the attention of the user (e.g., the head-based pointer moves from the user interface 8038 to the user interface 8014, causing the computer system 101 to select the user interface 8014), in accordance with some embodiments. Displaying a menu that includes a plurality of options for adjusting settings of the computer system and selecting a first option of the plurality of options for adjusting settings of the computer system, in response to detecting a first activation input of a first type, and selecting a respective option of the plurality of options for adjusting settings of the computer system, in accordance with a determination that attention of a user is directed to the respective option of the plurality of options, provides additional control options without cluttering the UI with additional displayed controls (e.g., a first displayed control for displaying the menu that includes the plurality of options for adjusting settings of the computer system and a second displayed control for navigating between different options of the plurality of options for adjusting settings of the computer system and/or selecting a respective option of the plurality of options for adjusting settings of the computer system).

In some embodiments, prior to detecting the first activation input of the first type, the computer system enables user inputs corresponding to a first portion of a user (e.g., the user's wrist, the user's hand, the user's index finger, the user's palm, or another portion of the user that is movable relative to the user's head or the user's torso). In response to detecting the first activation input of the first type, the computer system disables user inputs corresponding to the first portion of the user and enabling user inputs corresponding to a second portion of the user (e.g., the user's head, the user's face, the user's forehead, the user's torso, or another portion of the user's body that is relatively stationary to the user's head as compared to the user's hand) that is different from the first portion of the user. For example, in FIGS. 8AC-8AD, a wrist-based pointer is enabled for the computer system 101 (e.g., prior to detecting the rotation of the digital crown 703 in FIG. 8AE) to indicate the location of the user's attention, in accordance with some embodiments. In FIGS. 8AE-8AJ, the wrist-based pointer is disabled for the computer system 101 (e.g., after and/or in response to detecting the rotation of the digital crown 703 in FIG. 8AE) and a head-based pointer is enabled for the computer system 101 (e.g., which was not enabled in FIGS. 8AC-8AD), to indicate the location of the user's attention, in accordance with some embodiments. Disabling user inputs corresponding to the first portion of the user and enabling user inputs corresponding to a second portion of the user that is different from the first portion of the user, in response to detecting the first activation input of the first type, reduces the risk of accidental inputs selecting and/or adjusting settings corresponding to a respective option of the plurality of options for adjusting settings of the computer system (e.g., activation inputs of the first type may involve and/or include movement of the first portion of the user, increasing the risk of performing accidental user inputs that correspond to the first portion of the user while the user performs the first activation input of the first type) and makes user interaction with the menu that includes the plurality of options for adjusting settings of the computer system more efficient (e.g., the first portion of the user may not be in a position to easily perform subsequent user inputs to interact with the menu that includes the plurality of options for adjusting settings of the computer system, while and/or (e.g., immediately) after performing the first activation input of the first type, and enabling user inputs corresponding to a second portion of the user allows for seamless transition to interacting with the menu after performing the first activation input of the first type).

In some embodiments, in accordance with a determination that the first criteria are met (e.g., in response to detecting the first activation input of the first type and the first option is selected), the computer system generates a first audio output corresponding to the first parameter (e.g., the first audio output announces the name of the first parameter, or the first option that corresponds to the first setting in the menu), and the computer system generates a second audio output indicating a current value of the first parameter in conjunction with adjusting the first parameter in accordance with the first user input (e.g., announcing the percentage value of the first parameter relative to its value range as the first parameter is adjusted in accordance with the first user input; and/or as the first option is adjusted in accordance with an activation input of the first type while the first option is selected). In accordance with a determination that the second criteria are met (e.g., in response to detecting the second activation input of the second type and the second option is selected), the computer system generates a third audio output corresponding to the second parameter (e.g., the third audio output announces the name of the second parameter, or the second option that corresponds to the second setting in the menu), and the computer system generates a fourth audio output indicating a current value of the second parameter in conjunction with adjusting the second parameter in accordance with the first user input (e.g., announcing the percentage value of the second parameter relative to its value range as the second parameter is adjusted in accordance with the first user input; and/or as the second option is adjusted in accordance with an activation input of the first type while the second option is selected). For example, as described with reference to FIG. 8AT, in some embodiments, the computer system 101 provides audio feedback regarding the automatically selected user interface (e.g., a voiceover or narration that describes the currently selected user interface). For example, in FIG. 8T, the computer system 101 outputs audio that announces “immersion,” “level of immersion,” or a similar phrase and/or description for the setting corresponding to the currently selected option (e.g., user interface 8014), in accordance with some embodiments. In some embodiments, in addition to announcing the selected option, the computer system announces the current value of the currently selected option as well. In some embodiments, as the currently selected option is adjusted (e.g., by the user pressing on the button of the digital crown 703, or other selection input), the computer system optionally outputs audio to announce the newly selected option and/or the current value of the parameter that corresponds to the newly selected option. Generating a first audio output corresponding to the first parameter and generating a second audio output indicating a current value of the first parameter in conjunction with adjusting the first parameter in accordance with the first user input, in accordance with a determination that the first criteria are met, and generating a third audio output corresponding to the second parameter and generating a fourth audio output indicating a current value of the second parameter in conjunction with adjusting the second parameter in accordance with the first user input, provides improved audio feedback to the user (e.g., improved audio feedback regarding the currently selected option of the plurality of options), which allows for more efficient interaction with the menu that includes the plurality of options (e.g., allows for user interface with the menu that includes the plurality of options even if the user's attention is directed elsewhere, and/or in scenarios where tracking the attention of the user is difficult due to environmental factors or physical characteristics of the user) and makes using the computer system more accessible to and ergonomic for a wider variety of users (e.g., including low vision users who would benefit from audio narration).

In some embodiments, aspects/operations of methods 9000, 10000, 11000, and/or 12000 may be interchanged, substituted, and/or added between these methods. For example, the progress indicators for settings of the computer system in the method 13000 can be concurrently displayed with the first user interface object for accessing system functions of the computer system in the method 9000, 10000, 11000, or 12000. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

1-85. (canceled)

86. A method, comprising:
at a computer system that is in communication with a first display generation component and one or more input devices:
detecting, via the one or more input devices, a start of a first user input that meets adjustment criteria; and
in response to detecting the start of the first user input that meets the adjustment criteria:
in accordance with a determination that first criteria are met, adjusting a first parameter of the computer system in accordance with one or more first characteristic values of the first user input; and
in accordance with a determination that second criteria different from the first criteria are met, adjusting a second parameter of the computer system, different from the first parameter of the computer system, in accordance with the one or more first characteristic values of the first user input.

87. The method of claim 86, wherein the first parameter is an audio output parameter for audio outputs of the computer system.

88. The method of claim 86, wherein the second parameter is a level of immersion for three-dimensional content that is displayed in a three-dimensional environment.

89. The method of claim 86, wherein detecting the first user input that meets the adjustment criteria includes detecting the first user input directed to a first input device of the one or more input devices, and wherein the method includes:
before detecting the first user input, detecting a user input that sets a default parameter corresponding to the first input device to the first parameter, wherein the first criteria are met as a result of the default parameter being set to the first parameter at a time of the first user input.

90. The method of claim 86, wherein detecting the first user input that meets the adjustment criteria includes detecting the first user input directed to a first input device of the one or more input devices, and wherein the method includes:
before detecting the first user input, detecting a user input that sets a default parameter corresponding to the first input device to the second parameter, wherein the second criteria are met as a result of the default parameter being set to the second parameter at a time of the first user input.

91. The method of claim 86, wherein the first criteria are met as a result of satisfaction of a first set of conditions, including a first condition that the computer system was generating audio outputs at a time when the first user input was detected.

92. The method of claim 91, wherein the second criteria are met as a result of satisfaction of a second set of conditions, including a second condition that the computer system was not generating audio outputs at the time when the first user input was detected.

93. The method of claim 86, including:
in response to detecting the start of the first user input that meets the adjustment criteria:
in accordance with a determination that third criteria, different from the first criteria and the second criteria, are met, adjusting a third parameter, different from the first parameter and the second parameter, of the computer system in accordance with the one or more first characteristic values of the first user input.

94. The method of claim 86, including:
in response to detecting the start of the first user input that meets the adjustment criteria, displaying a respective progress indicator, wherein the respective progress indicator indicates a respective current value for at least one of the first parameter and the second parameter.

95. The method of claim 94, wherein, in response to detecting the start of the first user input that meets the adjustment criteria, displaying the respective progress indicator includes:
in accordance with a determination that the first criteria are met, displaying a first progress indicator that indicates a current value for the first parameter.

96. The method of claim 94, wherein, in response to detecting the start of the first user input that meets the adjustment criteria, displaying the respective progress indicator includes:
in accordance with a determination that the second criteria are met, displaying a second progress indicator that indicates a current value for the second parameter.

97. The method of claim 94, wherein, in response to detecting the start of the first user input that meets the adjustment criteria, displaying the respective progress indicator includes:
in accordance with a determination that the first criteria are met at the time when the start of the first user input was detected, concurrently displaying a first progress indicator that indicates a current value for the first parameter and a second progress indicator that indicates a current value for the second parameter.

98. The method of claim 97, including:
while concurrently displaying the first progress indicator and the second progress indicator in accordance with the determination that first criteria are met at the time when the start of the first user input was detected, detecting that an attention of a user is directed to the second progress indicator that indicates the current value for the second parameter; and
in response to detecting that the attention of the user is directed to the second progress indicator, in accordance with a determination that continuation of the first user input is detected while the attention of the use is directed to the second progress indicator, adjusting the second parameter in accordance with the continuation of the first user input, while maintaining the current value for the first parameter.

99. The method of claim 98, including:
while concurrently displaying the first progress indicator and the second progress indicator, in response to detecting that the attention of the user is directed to the second progress indicator, visually emphasize the second progress indicator relative to the first progress indicator.

100. The method of claim 94, wherein concurrently displaying the first progress indicator that indicates the current value for the first parameter and the second progress indicator that indicates the current value for the second parameter, includes:
in accordance with a determination that the current value for the first parameter is adjusted in accordance with the first user input, displaying a first progress bar in the first progress indicator that indicates the current value of the first parameter relative to a first value range of the first parameter, without displaying a second progress bar in the second progress indicator that indicates the current value of the second parameter relative to a second value range of the second parameter; and
in accordance with a determination that the current value for the second parameter is adjusted in accordance with the first user input, displaying the second progress bar in the second progress indicator, without displaying the first progress bar in the first progress indicator.

101. The method of claim 100, including:
while concurrently displaying the first progress indicator and the second progress indicator, detecting that the computer system is switching between adjusting the first parameter to adjusting the second parameter in accordance with the first user input; and
in response to detecting that the computer system is switching between adjusting the first parameter to adjusting the second parameter in accordance with the first user input, ceasing to display the first progress bar in the first progress indicator, and displaying the second progress bar in the second progress indicator.

102. The method of claim 94, wherein displaying the respective progress indicator in response to detecting the start of the first user input that meets the adjustment criteria, includes:
in response to detecting an initial portion of the first user input, displaying the respective progress indicator without changing the respective current value indicated by the respective progress indicator in accordance with the initial portion of the first user input.

103. The method of claim 94, wherein displaying the respective progress indicator in response to detecting the start of the first user input that meets the adjustment criteria, includes:
in response to detecting an initial portion of the first user input, displaying the respective progress indicator with a respective progress bar that indicates a respective current value of a respective parameter corresponding to the respective progress indicator, without changing the respective current value of the respective parameter in accordance with the initial portion of the first user input.

104. The method of claim 103, including:
while displaying the respective progress indicator with the respective progress bar that indicates the respective current value of the respective parameter corresponding to the respective progress indicator, detecting a subsequent portion of the first user input that follows the initial portion of the first user input; and
in response to detecting the subsequent portion of the first user input, adjusting the respective current value of the respective parameter corresponding to the respective progress indicator in accordance with the subsequent portion of the first user input.

105. The method of claim 94, including:
while displaying the respective progress indicator in a respective view of a three-dimensional environment, detecting a change in viewpoint of the respective view of the three-dimensional environment from a first viewpoint to a second viewpoint different from the first viewpoint; and
in response to detecting the change in viewpoint of the respective view of the three-dimensional environment from the first viewpoint to the second viewpoint, ceasing to display the respective progress indicator at a first position in the three-dimensional environment and displaying the respective progress indicator at a second position in the three-dimensional environment, wherein:
the first position in the three-dimensional environment is visible in a first portion of a first view of the three-dimensional environment that corresponds to the first viewpoint,
the second position in the three-dimensional environment is visible in a second portion of a second view of the three-dimensional environment that corresponds to the second viewpoint, and
the first portion of the first view and the second portion of the second view both have a first spatial relationship to a viewport through which the three-dimensional environment is visible.

106. The method of claim 105, wherein displaying the respective progress indicator in the respective view of the three-dimensional environment includes displaying the respective progress indicator in proximity to a first system indicator that is associated with a first user interface object that provides access to a first set of functions of the computer system.

107. The method of claim 106, including:
displaying, concurrently with the respective progress indicator, at least one of the first user interface object that provides access to the first set of functions of the computer system, and the first system indicator that is associated with the first user interface object, in the respective view of the three-dimensional environment, wherein:
the respective progress indicator is displayed at a first simulated depth relative to a viewpoint corresponding to the respective view of the three-dimensional environment,
the at least one of the first user interface object and the first system indicator is displayed at a second simulated depth relative to the viewpoint corresponding to the respective view of the three-dimensional environment, and
the first simulated depth is smaller than the second simulated depth.

108. The method of claim 106, including:
while concurrently displaying the respective progress indicator and the first user interface object, disabling interaction with the first user interface object using one or more types of user inputs, wherein the one or more types of user inputs are configured to interact with the first user interface object when the first user interface object is displayed without the respective progress indicator.

109. The method of claim 94, including:
while displaying the respective progress indicator, detecting that dismissal criteria are met, wherein the dismissal criteria are met without requiring detection of a user input that corresponds to a request to dismiss the respective progress indicator; and
in response to detecting that the dismissal criteria are met, ceasing to display the respective progress indicator.

110. The method of claim 109, wherein detecting that the dismissal criteria are met includes detecting that the first user input is no longer detected for at least a threshold amount of time.

111. The method of claim 109, wherein detecting that the dismissal criteria are met includes detecting that user's attention is no longer directed to the respective progress indicator for at least a threshold amount of time.

112. The method of claim 111, wherein detecting that the dismissal criteria are met includes detecting that the first user input is no longer detected for at least a first threshold amount of time and detecting that user's attention is no longer directed to the respective progress indicator for at least a second threshold amount of time.

113. The method of claim 94, including:
while displaying the respective progress indicator and adjusting the respective current value for at least one of the first parameter and the second parameter in accordance with a first portion of the first user input, detecting that an attention of the user has moved away from the respective progress indicator;
after the attention of the user has moved away from the respective progress indicator and while the attention of the user remains away from the respective progress indicator, detecting a second portion of the first user input following the first portion of the first user input; and
in response to detecting the second portion of the first user input, continuing to adjust the respective current value for the at least one of the first parameter and the second parameter in accordance with the second portion of the first user input.

114. The method of claim 94, wherein displaying the respective progress indicator includes displaying a first progress indicator indicating a current value of the first parameter concurrently with a second progress indicator indicating a current value of the second parameter, and the method includes:
while concurrently displaying the first progress indicator and the second progress indicator and adjusting the current value for the first progress indicator in accordance with a third portion of the first user input, detecting that an attention of a user has moved to the second progress indicator; and
in response to detecting that the attention of the user has moved to the second progress indicator, continuing to adjust the current value for the first progress indicator in accordance with a fourth portion of the first user input following the third portion of the first user input, until a pause in the first user input is detected; and
in response to detecting the pause in the first user input, ceasing to adjust the current value for the first progress indicator in accordance with the first user input.

115. The method of claim 94, wherein detecting the first user input includes detecting a movement associated with a hardware control of the computer system.

116. The method of claim 115, wherein adjusting a current value of a respective parameter in accordance with the first user input includes:
in accordance with a determination that the first user input includes movement in a first movement direction, adjusting the current value of the respective parameter in a first adjustment direction that corresponds to the first movement direction; and
in accordance with a determination that the first user input includes movement in a second movement direction that is different from the first movement direction, adjusting the current value of the respective parameter in a second adjustment direction that corresponds to the second movement direction, wherein the second adjustment direction is different from the first adjustment direction.

117. The method of claim 115, wherein adjusting the current value of the respective parameter in accordance with the first user input includes:
in accordance with a determination that the first user input includes a first magnitude for a first characteristic of movement associated with the hardware control, adjusting the current value of the respective parameter by a first adjustment amount that corresponds to the first magnitude for the first characteristic of movement; and
in accordance with a determination that the first user input includes a second magnitude for the first characteristic of movement associated with the hardware control that is different from the first magnitude for the first characteristic of movement associated with the hardware control, adjusting the current value of the respective parameter by a second adjustment amount that corresponds to the second magnitude for the first characteristic of movement, wherein the second adjustment amount is different from the first adjustment amount.

118. The method of claim 115, wherein adjusting the current value of the respective parameter in accordance with the first user input includes:
in accordance with a determination that the first user input includes a first magnitude for a first characteristic of movement associated with the hardware control, adjusting the current value of the respective parameter at a first adjustment speed that corresponds to the first magnitude for the first characteristic of movement; and
in accordance with a determination that the first user input includes a second magnitude for the first characteristic of movement associated with the hardware control that is different from the first magnitude for the first characteristic of movement, adjusting the current value of the respective parameter at a second adjustment speed that corresponds to the second magnitude for the first characteristic of movement, wherein the second adjustment speed is different from the first adjustment speed.

119. The method of claim 94, including:
when adjusting a respective parameter of the first parameter and the second parameter in accordance with the first user input and after an end value of a respective value range of the respective parameter has been reached, detect a respective input corresponding to a request for continued adjustment of the current value of the respective parameter; and
in response to detecting the respective input corresponding to the request for continued adjustment of the current value of the respective parameter after the end value of the respective value range of the respective parameter has been reached, providing feedback responsive to the respective input; and
after providing the feedback responsive to the respective input, detecting an end of the respective input; and
in response to detecting the end of the respective input, ceasing to provide the feedback responsive to the respective input and setting the current value of the respective parameter to the end value of the respective value range of the respective parameter.

120. The method of claim 94, wherein the one or more input devices includes a rotatable input device, and the method includes:
before detecting the start of the first user input that meets the adjustment criteria, detecting, via the rotatable input device, a first activation input of a first type;
in response to detecting the first activation input of the first type, displaying a menu that includes a plurality of options for adjusting settings of the computer system, and selecting a first option of the plurality of options for adjusting settings of the computer system;
while displaying the menu that includes the plurality of options for adjusting settings of the computer system, detecting, via the rotatable input device, a second activation input of a second type that is different from the first type; and
in response to detecting the second activation input of the second type, selecting a second option, different from the first option, of the plurality of options for adjusting settings of the computer system.

121. The method of claim 120, wherein the plurality of options for adjusting settings of the computer system includes an option for adjusting a volume of the computer system.

122. The method of claim 120, wherein the plurality of options for adjusting settings of the computer system includes an option for adjusting a level of immersion of the computer system.

123. The method of claim 120, wherein the plurality of options for adjusting settings of the computer system includes an option for adjusting a level of zoom of the computer system.

124. The method of claim 123, wherein a respective option of the first option and the second option of the plurality of options for adjusting settings of the computer system, is the option for adjusting the level of zoom of the computer system; and, the method includes:
while the option for adjusting the level of zoom of the computer system is selected, displaying a zoom user interface, including displaying, within the zoom user interface, a portion of a respective view of a three-dimensional environment that includes the zoom user interface, at an increased scale.

125. The method of claim 123, wherein displaying the menu that includes the plurality of options for adjusting settings includes:
in accordance with a determination that a setting for enabling zoom functionality is enabled for the computer system, displaying the option for adjusting the level of zoom of the computer system.

126. The method of claim 125, including:
while the menu is not displayed, detecting a third activation input of the first type; and
in response to detecting the third activation input of the first type:
in accordance with a determination that the setting for enabling zoom functionality is not enabled for the computer system and that the first criteria are not met, changing the second parameter in accordance with the third activation input of the first type.

127. The method of claim 120, wherein:
detecting the first activation input of the first type includes detecting a first portion of the first activation input followed by a second portion of the first activation input;
displaying the menu that includes the plurality of options for adjusting settings of the computer system and selecting the first option of the plurality of options for adjusting settings of the computer system are performed in response to detecting the first portion of the first activation input without adjusting a first setting corresponding to the first option of the plurality of options; and
the method includes:
in response to detecting the second portion of the first activation input, adjusting the first setting corresponding to the first option of the plurality of options, in accordance with the second portion of the first activation input.

128. The method of claim 120, wherein:
selecting the first option of the plurality of options for adjusting settings of the computer system includes displaying the first option of the plurality of options with an appearance that is visually emphasized relative to respective appearances of other options of the plurality of options; and
selecting the second option of the plurality of options for adjusting settings of the computer system includes displaying the second option of the plurality of options with an appearance that is visually emphasized relative to respective appearances of other options of the plurality of options.

129. The method of claim 120, wherein:
selecting the first option of the plurality of options for adjusting settings of the computer system includes displaying a first progress indicator that indicates a current value for a first setting corresponding to the first option of the plurality of options for adjusting settings of the computer system;
selecting the second option of the plurality of options for adjusting settings of the computer system includes displaying a second progress indicator that indicates a current value for a second setting corresponding to the second option of the plurality of options for adjusting settings of the computer system;
the first progress indicator is not displayed when the first option of the plurality of options for adjusting settings of the computer system is not selected; and
the second progress indicator is not displayed when the second option of the plurality of options for adjusting settings of the computer system is not selected.

130. The method of claim 120, including:
after selecting a respective option of the plurality of options for adjusting settings of the computer system, detecting a fourth activation input; and
in response to detecting the fourth activation input, adjusting a respective setting corresponding to the respective option based on the fourth activation input.

131. The method of claim 130, wherein the fourth activation input is an activation input of the first type; and adjusting the respective setting corresponding to the respective option includes:
in accordance with a determination that the respective option is the first option, adjusting a first setting corresponding to the first option in accordance with the fourth activation input of the first type; and
in accordance with a determination that the respective option is the second option, adjusting a second setting corresponding to the second option in accordance with the fourth activation input of the first type.

132. The method of claim 130, wherein the fourth activation input includes movement of a user's hand; and
adjusting the respective setting corresponding to the respective option includes:
in accordance with a determination that the respective option is the first option, adjusting a first setting corresponding to the first option in accordance with the movement of the user's hand during the fourth activation input; and
in accordance with a determination that the respective option is the second option, adjusting a second setting corresponding to the second option in accordance with the movement of the user's hand during the fourth activation input.

133. The method of claim 132, wherein the respective option is an option of the plurality of options to which a user's attention was directed when the fourth activation input was detected.

134. The method of claim 120, wherein detecting the second activation input of the second type includes detecting activation of a button of the rotatable input device.

135. The method of claim 120, wherein detecting the second activation input of the second type includes detecting activation of a button of the rotatable input device for at least a threshold amount of time.

136. The method of claim 120, including:
while displaying the menu that includes the plurality of options for adjusting settings of the computer system, selecting a respective option of the plurality of options for adjusting settings of the computer system in accordance with a determination that attention of a user is directed to the respective option of the plurality of options.

137. The method of claim 120, including:
prior to detecting the first activation input of the first type, enabling user inputs corresponding to a first portion of a user; and
in response to detecting the first activation input of the first type, disabling user inputs corresponding to the first portion of the user and enabling user inputs corresponding to a second portion of the user that is different from the first portion of the user.

138. The method of claim 94, including:
in accordance with a determination that the first criteria are met, generating a first audio output corresponding to the first parameter, and generating a second audio output indicating a current value of the first parameter in conjunction with adjusting the first parameter in accordance with the first user input; and
in accordance with a determination that the second criteria are met, generating a third audio output corresponding to the second parameter, and generating a fourth audio output indicating a current value of the second parameter in conjunction with adjusting the second parameter in accordance with the first user input.

139. (canceled)

140. (canceled)

141. (canceled)

142. A non-transitory computer-readable storage medium storing one or more programs configured to be executed by one or more processors of a computer system that is in communication with a display generation component and one or more input devices, the one or more programs including instructions for:
detecting, via the one or more input devices, a start of a first user input that meets adjustment criteria; and; and
in response to detecting the start of the first user input that meets the adjustment criteria:
in accordance with a determination that first criteria are met, adjusting a first parameter of the computer system in accordance with one or more first characteristic values of the first user input; and
in accordance with a determination that second criteria different from the first criteria are met, adjusting a second parameter of the computer system, different from the first parameter of the computer system, in accordance with the one or more first characteristic values of the first user input.

143. A computer system that is in communication with a display generation component and one or more input devices, the computer system comprising:
one or more processors; and
memory storing one or more programs configured to be executed by the one or more processors, the one or more programs including instructions for:
detecting, via the one or more input devices, a start of a first user input that meets adjustment criteria; and; and
in response to detecting the start of the first user input that meets the adjustment criteria:
in accordance with a determination that first criteria are met, adjusting a first parameter of the computer system in accordance with one or more first characteristic values of the first user input; and
in accordance with a determination that second criteria different from the first criteria are met, adjusting a second parameter of the computer system, different from the first parameter of the computer system, in accordance with the one or more first characteristic values of the first user input.

144-196. (canceled)
